(19) United States
(12) Patent Application Publication
(10) Pub. No.: US 2005/0089027 A1
(43) Pub. Date: Apr. 28, 2005

(54) Intelligent optical data switching system

(76) Inventor: John R. Colton, Freehold, NJ (US)

Correspondence Address: SMITH, GAMBRELL & RUSSELL, LLP;SUITE 3100, PROMENADE II, 1230 PEACHTREE STREET, N.E., ATLANTA, GA, 30309-3592, US

(21) Appl. No.: 10/464,784

(22) Filed: Jun. 18, 2003

Related U.S. Application Data
(60) Provisional application No. 60/389,971, filed on Jun. 18, 2002.

(51) Int. Cl. H04Q 11/00

(52) U.S. Cl. 370/380

(57) ABSTRACT

The present invention enables a multi-wavelength band to be maintained as an optical signal through only a band switch, and provides a switch node with expandable capacity for switching data optically.

### CROSS-REFERENCE TO RELATED APPLICATIONS

This application claims the benefit of priority of U.S. provisional application No. 60/389,971, filed Jun. 18, 2002, which is incorporated herein by reference.

### BACKGROUND

The present invention relates to optical transport systems and Dense Wave Division Multiplexing (DWDM)-based switched wavelength services.

### SUMMARY OF THE INVENTION

The present invention provides a system and method for transferring data optically via an intelligent optical switching network.

### BRIEF DESCRIPTION OF THE DRAWINGS

FIG. 1 is a diagram of the intelligent optical switch and management software hierarchial planes in an embodiment of the present invention.

FIG. 2 is a front view of the intelligent optical switch system bay in an embodiment of the present invention.

FIG. 3 is a front view of the two bay intelligent optical switch configuration in an embodiment of the present invention.

FIG. 4 is a block diagram of the single bay intelligent optical switch data plane in an embodiment of the present invention.

FIG. 5 is a block diagram of the multibay intelligent optical switch data plane in an embodiment of the present invention.

FIG. 6 is a diagram of the optical control plane hierarchy in an embodiment of the present invention.

FIG. 7 is a block diagram of the system node controllers and test resources in an embodiment of the present invention.

FIG. 8 is a block diagram of the intelligent optical switch optical test port connections in an embodiment of the present invention.

FIG. 9 is a block diagram of the high-level optical services system architecture in an embodiment of the present invention.

FIG. 10 is a block diagram of the control interface between the alarm interface managers and the system node managers in an embodiment of the present invention.

FIG. 11 is a block diagram of the control interface between the system node managers and the ethernet network controllers in an embodiment of the present invention.

FIG. 12 is a diagram of the major intelligent optical switch data plane functions in an embodiment of the present invention.

FIG. 13 is a block diagram of a five node example optical circuit in an embodiment of the present invention.

FIG. 14 is a block diagram of the intelligent optical switch data plane functions in an embodiment of the present invention.

FIG. 15 is a block diagram of the fast power monitors in an embodiment of the present invention.

FIG. 16 is a block diagram of the optical wavelength interface shelf in an embodiment of the present invention.

FIG. 17 is a block diagram of the 2.5 Gb/s optical wavelength interface transponder circuit pack in an embodiment of the present invention.

FIG. 18 is a block diagram of the 10 Gb/s optical wavelength inter-face-transponder circuit pack in an embodiment of the present invention.

FIG. 19 is a block diagram of the head end bridge implementation in an embodiment of the present invention.

FIG. 20 is a block diagram of the tail end switch implementation in an embodiment of the present invention.

FIG. 21 is a block diagram of the transport module circuit pack in an embodiment of the present invention.

FIG. 22 is a block diagram of the band equalization control loop in an embodiment of the present invention.

FIG. 23 is a block diagram of the transport module circuit pack electrical functions in an embodiment of the present invention.

FIG. 24 is a block diagram of the intellioptics controller in an embodiment of the present invention.

FIG. 25 is a block diagram of the optical switch fabric and wavelength multiplexer shelf interconnections in an embodiment of the present invention.

FIG. 26 is a block diagram of the optical switch fabric circuit pack in an embodiment of the present invention.

FIG. 27 is a block diagram of the wavelength multiplexer circuit pack in an embodiment of the present invention.

FIG. 28 is a block diagram of the wavelength multiplexer circuit pack electrical functions in an embodiment of the present invention.

FIG. 29 is a block diagram of the optical wavelength interface-wavelength conversion circuit pack in an embodiment of the present invention.

FIG. 30 is a block diagram of the optical wavelength interface-transparent gain circuit pack in an embodiment of the present invention.

FIG. 31 is a block diagram of the optical wavelength interface-transparent passive circuit pack in an embodiment of the present invention.

FIG. 32 is a diagram of the system node controller circuit functions in an embodiment of the present invention.

FIG. 33 is a block diagram of the intellioptics controller major features in an embodiment of the present invention.

FIG. 34 is a block diagram of the system node manager cross couples in an embodiment of the present invention.

FIG. 35 is a block diagram of the system node manager circuit pack in an embodiment of the present invention.

FIG. 36 is a block diagram of the system node manager 0 internal enternet configuration in an embodiment of the present invention.

FIG. 37 is a block diagram of the alarm interface manager interface in an embodiment of the present invention.

FIG. 38 is a block diagram of the optical test port optical connectivity in the intelligent optical switch system in an embodiment of the present invention.

FIG. 39 is a block diagram of the optical test port functions in an embodiment of the present invention.

FIG. 40 is a block diagram of the optical performance manager optical connectivity in the intelligent optical switch system in an embodiment of the present invention.

FIG. 41 is a block diagram of the optical performance manager functions in an embodiment of the present invention.

FIG. 42 is a block diagram of the system node manager architecture in an embodiment of the present invention.

FIG. 43 is a block diagram of the physical link, band, and band path concepts in an embodiment of the present invention.

FIG. 44 is a block diagram of the interfaces between the intelligent optical switch optical control plane, the services delivery system, the intelligent optical switch data plane, and the client device in an embodiment of the present invention.

FIG. 45 is a block diagram of the i+I path protection feature in an embodiment of the present invention.

FIG. 46 is a block diagram of the 1:1 path protection feature in an embodiment of the present invention.

FIG. 47 is a block diagram of the 1:1 path protection feature after failure in an embodiment of the present invention.

FIG. 48 is a block diagram of the 1:1 path protection feature for low priority type of service level traffic in an embodiment of the present invention.

FIG. 49 is a block diagram of the link management protocol in an embodiment of the present invention.

FIG. 50 is a block diagram of an original circuit before re-optimization in an embodiment of the present invention.

FIG. 51 is a block diagram of the interim bridged stage of a circuit during the re-optimization procedure in an embodiment of the present invention.

FIG. 52 is a block diagram of a circuit after re-optimization in an embodiment of the present invention.

FIG. 53 is a data flow diagram of the fast, low resolution optical power measurement in an embodiment of the present invention.

FIG. 54 is a data flow diagram of the optical performance manager, high resolution optical power measurement in an embodiment of the present invention.

FIG. 55 is a directory tree diagram of the file organization in the intelligent optical switch software version control in an embodiment of the present invention.

FIG. 56 is a directory tree diagram of the flash file layout in a system node manager in an embodiment of the present invention.

FIG. 57 is a block diagram of the intellioptics controller implementation model for the non-shelf controller function in an embodiment of the present invention.

FIG. 58 is a block diagram of the intellioptics controller implementation model for the shelf controller function in an embodiment of the present invention.

FIG. 59 is a block diagram of the intellioptics controller architecture in an embodiment of the present invention.

FIG. 60 is a block diagram of the management plane architecture in an embodiment of the present invention.

FIG. 61 is a block diagram of the services delivery system instance in an embodiment of the present invention.

FIG. 62 is a data flow diagram of the system dependence and data flow in the services delivery system graphical user interface in an embodiment of the present invention.

FIG. 63 is a block diagram of the single services delivery system instance over multiple workstations configuration in an embodiment of the present invention.

FIG. 64 is a block diagram of the warm and hot standby configuration in an embodiment of the present invention.

FIG. 65 is a block diagram of the network planning tool concept in an embodiment of the present invention.

FIG. 66 is a block diagram of the network planning tool server functional architecture in an embodiment of the present invention.

FIG. 67 is a block diagram of the network planning tool planner functional architecture in an embodiment of the present invention.

FIG. 68 is a front view of the intelligent optical switch single bay configuration in an embodiment of the present invention.

FIG. 69 is a front view of the intelligent optical switch add/drop two bay configuration in an embodiment of the present invention.

FIG. 70 is a front view of the intelligent optical switch add/drop three bay configuration in an embodiment of the present invention.

FIG. 71 is a front view of the intelligent optical switch add/drop two bay configuration with remote optical wavelength interface shelf assemblies in an embodiment of the present invention.

FIG. 72 is a view of dispersion compensation module installation and removal in an embodiment of the present invention.

FIG. 73 is a front view of the transport module in an embodiment of the present invention.

FIG. 74 is a front view of the optical performance monitor in an embodiment of the present invention.

FIG. 75 is a front view of the wavelength optical switching fabric version of the optical switch fabric in an embodiment of the present invention.

FIG. 76 is a front view of the optical test port in an embodiment of the present invention.

FIG. 77 is a front view of the system node manager in an embodiment of the present invention.

FIG. 78 is a front view of the ethernet switch in an embodiment of the present invention.

FIG. 79 is a front view of the optical wavelength controller in an embodiment of the present invention.

FIG. 80 is a front view of the optical wavelength interface-wavelength converter in an embodiment of the present invention.

FIG. 81 is a front view of the optical wavelength interface-transparent gain in an embodiment of the present invention.

FIG. 82 is a front view of the optical wavelength interface-transparent passive in an embodiment of the present invention.

FIG. 83 is a front view of the optical wavelength interface-transponder in an embodiment of the present invention.

FIG. 84 is a front view of the wavelength multiplexer in an embodiment of the present invention.

FIG. 85 is a front view of the wavelength multiplexer shelf assembly in an embodiment of the present invention.

FIG. 86 is a front view of the optical wavelength interface shelf assembly in an embodiment of the present invention.

FIG. 87 is a front view of the optical switch fabric shelf assembly in an embodiment of the present invention.

FIG. 88 is a front view of the transport module shelf assembly in an embodiment of the present invention.

FIG. 89 is a front view of the controller shelf assembly in an embodiment of the present invention.

FIG. 90 is a front view of the smart fan tray assembly in an embodiment of the present invention.

FIG. 91 is a rear view of the smart fan tray assembly in an embodiment of the present invention.

FIG. 92 is a front view of the power distribution panel in an embodiment of the present invention.

FIG. 93 is a rear view of the power distribution panel in an embodiment of the present invention.

FIG. 94 is a front view of the air-intake-baffle assembly with command line interface and alarm cutoff in an embodiment of the present invention.

FIG. 95 is a block diagram of the tiered network architecture in an embodiment of the present invention.

FIG. 96 is a block diagram of the local packet architecture concept in an embodiment of the present invention.

FIG. 97 is a block diagram of the logical link creation circuit routing scenario in an embodiment of the present invention.

FIG. 98 is a block diagram of the single link optical circuit routing scenario in an embodiment of the present invention.

FIG. 99 is a block diagram of the multiple link optical circuit routing scenario in an embodiment of the present invention.

FIG. 100 is a block diagram of the new logical link creation circuit routing scenario in an embodiment of the present invention.

FIG. 101 is a block diagram of the logical link band path splicing circuit routing scenario in an embodiment of the present invention.

FIG. 102 is a block diagram of the logical link band path splitting circuit routing scenario in an embodiment of the present invention.

FIG. 103 is a block diagram of the wavelength converter at source intelligent optical switch circuit routing scenario in an embodiment of the present invention.

FIG. 104 is a block diagram of the wavelength converter at intermediate intelligent optical switch circuit routing scenario in an embodiment of the present invention.

FIG. 105 is a block diagram of the multiple optical circuit request within one logical link circuit routing scenario in an embodiment of the present invention.

FIG. 106 is a block diagram of the multiple optical circuit request over multiple logical links circuit routing scenario in an embodiment of the present invention.

FIG. 107 is a block diagram of the optical circuit request blocking without wavelength converter circuit routing scenario in an embodiment of the present invention.

FIG. 108 is a block diagram of a fault at the input of the transport module circuit pack in an embodiment of the present invention.

FIG. 109 is a block diagram of a band optical switch fabric failure in an embodiment of the present invention.

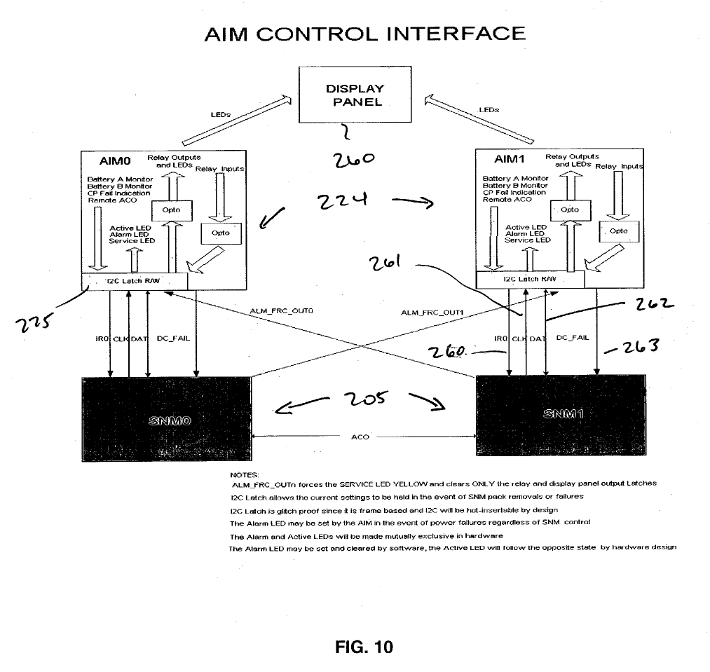

FIG. 10 is a block diagram of a failure at the input of a wavelength multiplexer in an embodiment of the present invention.

FIG. 111 is a block diagram of a wavelength optical switch fabric failure in an embodiment of the present invention.

FIG. 112 is a block diagram of the inter-node fault isoloation for failure at input outside node A in an embodiment of the present invention.

FIG. 113 is a block diagram of the inter-node fault isoloation for failure at input inside node A in an embodiment of the present invention.

FIG. 114 is a block diagram of a fiber cut between nodes A and C in an embodiment of the present invention.

FIG. 115 is a block diagram of a fiber cut between nodes C and D in an embodiment of the present invention.

FIG. 116 is a block diagram of a failure at the input outside of node A with no user traffic in an embodiment of the present invention.

FIG. 117 is a block diagram of a failure inside of node A with no user traffic in an embodiment of the present invention.

FIG. 118 is a block diagram of a fiber cut between nodes A and C with no user traffic in an embodiment of the present invention.

FIG. 119 is a block diagram of a fiber cut between nodes C and D with no user traffic in an embodiment of the present invention.

FIG. 120 is a table showing optical signal to noise ratio values for various numbers of uniform spans and span losses using XP receiver with worst case received power level at an OSNR of 22 db.

FIG. 121 is a table showing optical signal to noise ratio (OSNR) values for various numbers of uniform spans and span losses using the 2.5 Gb/s XP with worst case received power level at an OSNR of 19 dB.

FIG. 122 is a table showing optical signal to noise ratios for one node intermediate node switching.

FIG. 123 is a table showing optical signal to noise ratios for two node intermediate node switching.

FIG. 124 is a table showing optical signal to noise ratios for three node intermediate node switching;

### DETAILED DESCRIPTION OF THE INVENTION

The following abbreviations and terms are provided for reference throughout this description:

AAA: Authentication, Authorization, and Accounting

ABN: Abnormal Condition

ACO: Alarm Cutoff

AIM: Alarm Interface Manager

APC: Angled Physical Contact

ARP: Address Resolution Protocol (maps IP and Ethernet addresses)

ASHRAE: American Society of Heating, Refrigerating, and Air Conditioning Engineers

BB DCS: Broadband Digital Cross-connect Switch

BER: Bit Error Rate

BOSF: Band Optical Switching Fabric

BSP: Board Support Package

CC: Control Channel between OWRs or between OWR and client device

Client: Service provider's customer (equivalent to user)

CLI: Command Line Interface enabling craft to access OWR locally

CO: Central Office

CORBA: Common Object Request Broker Architecture for communication between objects

CR-LDP: Constraint-based Routing-Label Distribution Protocol

CSS: Center Stage Switching

Data flow: Bit stream transmitted over the optical network

DM: Device Manager

DNC: Data Networking Center

DP: Data Plane

DWDM: Dense Wavelength Division Multiplex format

EIA: Electronic Industries Association

EDFA: Erbium Doped Fiber Amplifier

EMC: Electromagnetic Compatibility

EMI: Electromagnetic Interference

EPOC: Endpoint Provisioned Optical Circuit

ESD: Electrostatic Discharge

ETH: Ethernet Network Controller

ETSI: European Telecommunications Standardization Institute Electromagnetic

FCAPS: Fault Management, Configuration Management, Accounting Management, Provisioning Management and Security Management

FPGA: Field Programmable Gate Array

GbE: Gigabit Ethernet

GMPLS: Generalized Multi-Protocol Label Switching

GUI: Graphical User Interface

FTP: File Transfer Protocol for software downloads

GMPLS: Generalized Multiprotocol Label Switching

HEB: Head End Bridge

IOC: Intelligent Optical Controller

IOS: Intelligent Optical Switch

IEETF: Internet Engineering Task

IP: Internetworking Protocol

IPCC: Internet Protocol Control Channel

IPD: Integrated Photodetector(s)

IR: Intermediate Reach

LDAP: Lightweight Directory Access Protocol used for storage of network database

LDP: Label Distribution Protocol used in GMPLS and OIF UNI

LMP: Link Management Protocol

LOA: Linear (Semiconductor) Optical Amplifier

LOS: Loss of Signal

LP: Low Priority type of service level

LSOs: Local Switching Offices in a Service Provider Network

MAC: Media access control protocol for accessing shared media

MIB: Management Information Base object definition used for communication between SNMP manager and agents

MP: Management Plane

NEBS: Network Equipment Building System

NFS: Network File System protocol specified by SUN Microsystems

NNI: Network to Network Interface (interface between OWRs or between OWR and third party optical router

NOC: Network Operations Center

NPT: Network Planning Tool

OCC: Optical Control Channel

OCN: Optical Control Network

OCP: Optical Control Plane

OIF: Optical Internetworking Forums standards body for developing optical networking standards and ensuring interoperability

OLI: Optical Link Interface defining interface between optical router and DWDM equipment

OPM: Optical Performance Manager

Optical Circuit: Connection between endpoints (plus associated attributes) in the optical network

OSA: Optical Spectrum Analyzer

OSF: Optical Switch Fabric

OSNR: Optical Signal to Noise Ratio

OSPF: Open Shortest Path First routing protocol

OSS: Operations Support System

OTP: Optical Test Port

OWI: Optical Wavelength Interface (XP, TR, or λC)

OWI-λC: Optical Wavelength Interface-λ Converter

OWI-TR: Optical Wavelength Interface-TRansparent (with Gain or Passive)

OWI-XP: Optical Wavelength Interface-TransPonder (XP)

OWC: Optical Wavelength Interface Controller

Path: Set of data links between endpoints

POC: Provisioned Optical Circuit

POPs: Points of Presence in Service Providers networks

POS: Packet Over SONET transport signals

PRD: Product Requirements and Definitions

RFC: Request for Comment name for Internet standards

RMON: Remote Monitoring of Network at MAC protocol layer

RPOC: Route Provisioned Optical Circuit

RSVP: ReSource reserVation Protocol used in GMPLS and OIF UNI

RSVP-TE: ReSource reserVation Protocol with Traffic Engineering

RTOS: Real-time operating system

SDH: Synchronous Digital Hierarchy

SDS: Services Delivery System

SF: Switch Fabric

SNC: System Network Controller

SNM: System Node Manager

SNMP v3: Simple Network Management Protocol, version 3

SOA: Semiconductor Optical Amplifier

SOC: Switched Optical Circuit

SON FT: Synchronous Optical Network

SPI: Serial Peripheral Interface

SR: Short Reach

SRD: Systems Requirements Document

SR: Short Reach

SRL: Signal Routing Logic

TCP: Transmission Control Protocol

TE: Traffic Engineering

TES: Tail End Switch

TFTP: Trivial File Transfer Protocol

TL/1: Transaction Language 1

TMN: Telecommunications Management Network

TPM: TransPort Module: 32-wavelength DWDM bi-directional optical line termination

TRG: TRansparent interface circuit-Gain (amplification)—see OWI-TR

TRP: TRansparent interface circuits-Passive (no amplification)—see OWI-TR

UL: Underwriters Laboratories

UNI: User-to-Network Interface

User: Service provider's customer (equivalent to client)

VOA: Variable Optical Attenuator

VPN: Virtual Private Network

VSR: Very Short Reach

WMX: Wavelength Multiplexer

WOSF: Wavelength Optical Switching Fabric

XML: Extensible Markup Language

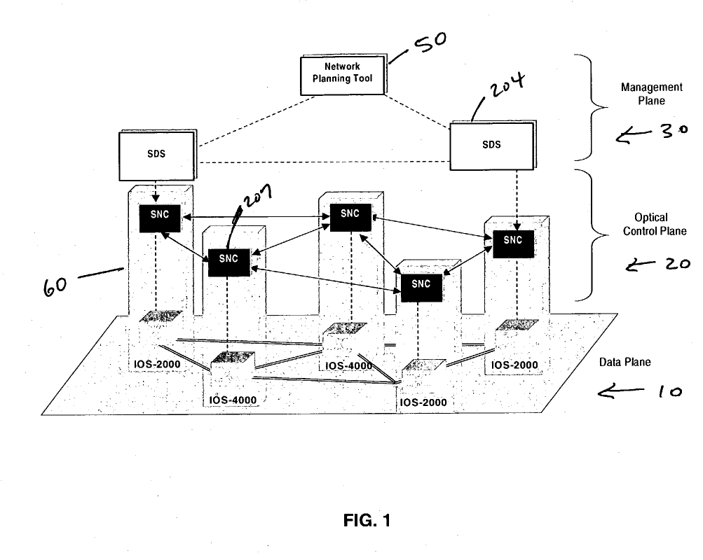

Referring to FIG. 1, the system of the present invention is characterized by three hierarchical planes.

The Data Plane 10 consists of all of the functions through which transmission passes. These functions include the optical wavelength interface (OWI), transport module (TPM), wavelength converter (λC), redundant optical switch fabric Band Switch Optical Switch Fabric (BOSF) and Wavelength (λ) Switch Optical Switch Fabric (WOSF), and redundant wavelength multiplex (WMX) circuit packs and their associated equipment and cabling.

The Optical Control Plane 20 (OCP) includes the Control Shelf 90 circuit packs, the Alarm Interfaces, all IOCs 210 that control Data Plane 10 functions (including those resident on Data Plane circuit pack and in Data Plane Shelves), and all software resident in the system node mangers (SNMs) 205 (intelligent optical switch (IOS) Control Level 1) and IOCs 210 (IOS Control Level 2). The OCP 20 also includes the optical control network (OCN) optical control channel (OCC) 1510 nm data links that provide peer IOS 210 communication.

The Management Plane (MP) 30 includes the services delivery system (SDS) 240 and the network planning tool (NPT) 50. The SDS software includes two Telecommunication Management Network (TMN) levels of functionality: the Element Management Layer (1), the Network Management Layer (2), and additionally provides interfaces to the Services Management Layer (3). The MP 30 and OCP 20 communicate using a 100 BaseT external IP network.

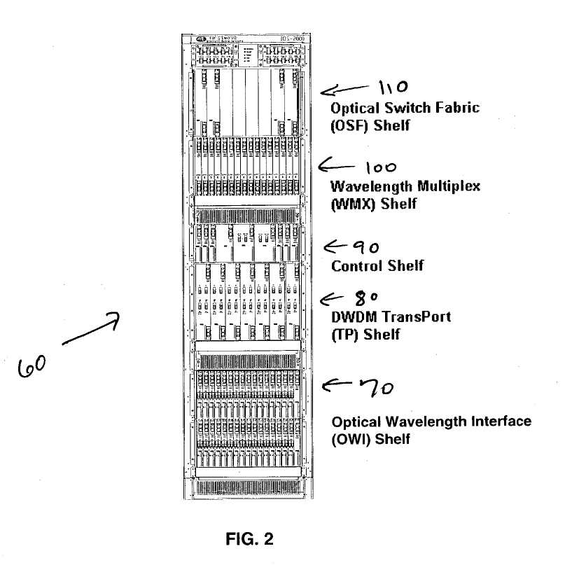

A physical rendering of a single bay IOS 60 of the present invention is shown in FIG. 2 in an exemplary configuration, providing a 32-add/drop port single bay arrangement. In an embodiment of the invention, the single bay comprises an Optical Wavelength Interface (OWI) Shelf 70, a DWDM Transport (TP) Shelf (or TPM Shelf) 80, an Optical Switch Fabric (OSF) Shelf 70, a Control Shelf 90, a WMX Shelf 100, and panels for power distribution, system alarms, and fan trays and air intakes.

The OWI Shelf 90 accommodates up to 32 Optical Wavelength Interface Circuit Packs 219 plus two Optical Wavelength Interface Controllers circuit packs (OWCs) 220. The redundant OWCs 220 operate and maintain the OWI Shelf 90. An OWI 219 can be of a TRANSPonder type (OWI-XP) 219A, a Transparent ITU-compliant type (OWI-TR) 219B, or a wavelength Converter (λC) 140. As used herein, ITU-compliance refers to the ensemble of C Band transmission wavelengths set forth in Table 5.

Each XP Circuit Pack 219A terminates one bidirectional 1310 or 1550 nm intra-office Optical Data Link, providing a single bidirectional port, with ingress and egress signals on separate fibers. Each TR Circuit Pack 219B terminates one bidirectional ITU-compliant single wavelength termination, with ingress and egress signals on separate Fibers. Each λC Circuit Pack 140 provides wavelength conversion for any single ITU-compliant wavelength to any other ITU-compliant wavelength. The OWI Shelf 70 provides up to 32 circuit pack slots for add/drop ports or single wavelength conversion in any type and wavelength mix.

The TP Shelf 80 comprises up to seven TPM circuit packs 121, each of which terminates a single bidirectional optical line with 32 DWDM wavelengths in each direction and with ingress and egress signals on separate fibers. Each TPM circuit pack 121 includes a terminating optical amplifier configuration and band demultiplex for the ingress side plus a band multiplex and booster amplifier for the egress side. The TP Shelf 80 thus provides up to 7 fibers (224 wavelengths in 56 wavelength bands, four wavelengths per band) in each direction of DWDM termination.

The Optical Switch Fabric Shelf 110 provides a redundant 64 port Band Switch 124 and a redundant λ Switch 137 plus four reserved slots for growth of additional add/drops in a second bay. This total of four OSF 214 and sixteen WMX Circuit Packs 136 constitutes a fully redundant optical switch fabric for this single bay, one OWI Shelf 70 configuration.

The Control Shelf 90 comprises redundant System Node Manager 205 and Ethernet Control circuit packs plus simplex and additional slots for the Optical Performance Manager 216 and Optical Test Port Manager 218 Circuit Packs. Additionally, redundant Alarm Interface circuit packs 224 are located on the Alarm Panel at the top of the bay.

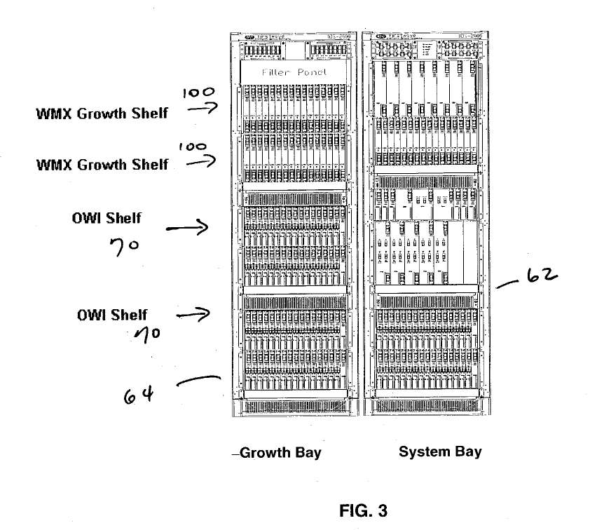

If more than 32 wavelength add/drop is required, the two bay configuration shown in FIG. 3 provides an alternative embodiment of the present invention. The System Bay 62 in this configuration is identical to the IOS 60 of FIG. 2, and the Growth Bay 64 includes two additional OWI Shelves 70, and two additional WMX Shelves 100. The growth OWI shelves 70 provide up to 64 additional OWI (or λCON) circuit packs 140 for up to 64 additional add/drop, for a total of up to 96 add/drop wavelengths for this two bay configuration. Up to four additional OSF Circuit Packs 214 are accommodated by the reserved slots in the System Bay OSF Shelf and used for the growth configuration. OSF Shelf 110 and the growth WMX shelves 100 provide up to two additional redundant λ Switches 137 plus the associated redundant WMX circuit packs 136, required for the add/drop increase.

### Data Plane

Band Switching

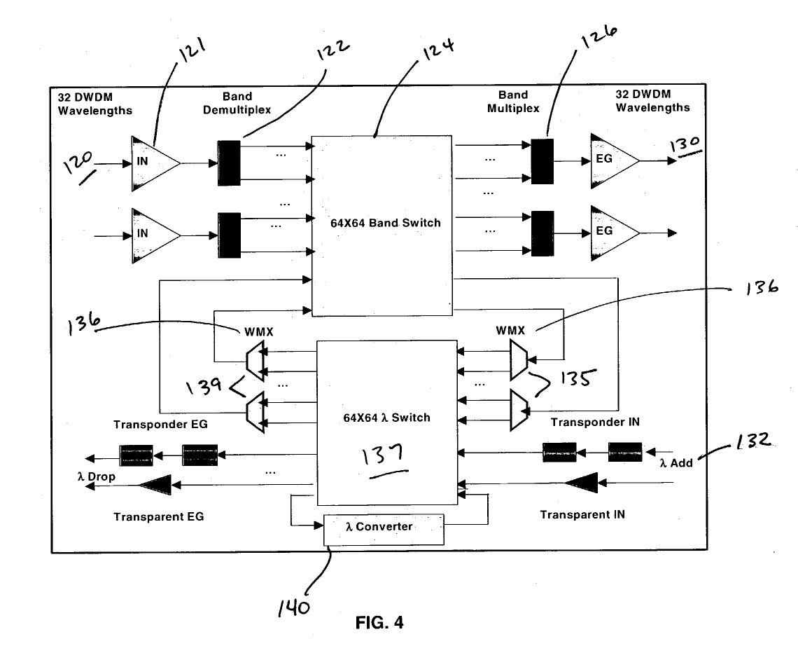

FIG. 4 shows a block diagram of the Data Plane 10 in a single bay IOS 60 emobdiment of the present invention. All Data Plane 10 circuit packs have both the transmit and receive configurations on the same circuit pack; however, for convenience, the ingress and egress portions of the path are shown separately.

Up to seven optical lines, each with eight bands of four wavelengths, constitute part of the Data Plane 10. In the ingress direction, the TPM terminating amplifier 121A amplifies the received 32-channel DWDM signal 120, and the Band Demultiplex 122 demultiplexes the eight-band amplified signal into eight individual bands. Thus, up to 56 bands are delivered to the Band Switch 124, with each of the bands terminating on a single Band Switch 124 input port. If this IOS 60 is a network transit node and the band is to stay intact as the same numbered band, the band switch switches this band to a Band Multiplex 126 that multiplexes eight bands into a 32-channel DWDM egress signal 130. This signal 180 is amplified by a booster amplifier and delivered to the optical line. Thus, for bands that require only band X to band X switching, the Band Switch 124 is the only switch the band encounters.

Add/drop

If a particular band contains wavelengths that add/drop at this IOS 60, the Band Switch 124 routes the band to the 1×4 demultiplex 135 on the appropriate Wavelength Multiplex (WMX) circuit pack. The WMX demultiplex 135 delivers the four wavelengths to four of the 32 WMX input ports on the λ Switch 137. The λ Switch 137 routes a drop wavelength to an OWI egress configuration (XP or TR) that is hard fibered to one of 32 output ports used for dropping. Likewise, the OWI shelf ingress 70 signals are hard fibered to 32 of the λ Switch 137 input ports. The λ Switch 137 routes any XP or TR wavelength 132 that adds at this node from one of these ports to the 4×1 multiplex 139 on the appropriate WMX circuit pack 136 for banding. The band 133 created by this multiplex 139 terminates on the input side of the Band Switch 124, which routes the wavelength to the TPM Band Multiplex 126, creating the 32 wavelength composite signal 130 for the egress optical line.

Wavelength Conversion

If a particular band that requires wavelength conversion for any (i.e. individual wavelength conversion) or all (i.e. band conversion) of its wavelengths, the Band Switch 124 and WMX 136 route the band to four of the 32 WMX 136 input ports on the λ Switch 137. The λ Switch 137 routes each wavelength that requires wavelength conversion at this node to an OWI shelf 70 slot. For wavelength conversion, this slot is occupied by a single channel wavelength converter (OWI-λC) Circuit Pack 140 that converts the received wavelength into the desired one. The wavelength converter 140 delivers the new wavelength to the λ Switch 137, which routes it to the WMX multiplex circuit pack 136 for banding. The band 133 created by this multiplex 139 terminates on the input side of the Band Switch 124 as for the other cases. Wavelength conversion results from a policy of wavelength assignment that does not perfectly assign wavelengths to bands based on destination. This conversion, either for individual wavelengths or bands, reduces the ports available for add/drop and increases network cost, so routing and wavelength assignment should be carefully planned to minimize wavelength conversion.

Wavelength Reorganization

Bands may require demultiplexing to the wavelength level for reorganization. For example, if wavelengths λ1 and λ2 are received on an incoming fiber but need to be switched to different out(going fibers, they are demultiplexed to one of the wavelength switches and then multiplexed into separate bands. Reorganization results from a policy of wavelength assignment that does not perfectly assign wavelengths to bands based on destination. This reorganization reduces the ports available for add/drop and increases network cost, so routing and wavelength assignment should be carefully planned to minimize reorganization.

Provisioning Considerations

Thus, the OWI Shelf 70 is hard fibered to 32 input and 32 output ports of the λ Switch 137. The remaining 32 λ Switch input ports are hard fibered to the demux outputs of the 8 WMX demultiplex 135 circuit pack slots, and the remaining 32 λ Switch output ports are hard fibered to the mux inputs of the 8 WMX multiplex 139 slots. When an add/drop is provisioned into an existing band that terminates at this IOS 60, the appropriate OWI circuit pack 219 (i.e. the XP with the desired ITU wavelength or the TR with the ITU wavelength to be supplied) is inserted into the OWI Shelf 70. While the OWI circuit pack 219 must have the specified ITU grid wavelength, it can reside in any available slot in the OWI Shelf 70 since the λ Switch 137 connects the ingress and egress signals to the proper λ Switch 137 WMX ports.

When an add/drop is provisioned into a new band at this IOS 60, the associated OWI circuit pack 219 is inserted into the OWI Shelf 70, and the pair of WMX circuit packs 136 (for the desired band) is inserted into two slots (one for optical switch fabric 0 and one for optical switch fabric 1) on the WMX shelf 100.

Likewise, a provisioned λC Circuit Pack 140 must have the specified “convert-to” wavelength, but it can reside in any OWI Shelf 70 slot, the λ Switch 137 routing the output to the appropriate WMX 136.

Therefore, when an add/drop or wavelength conversion is provisioned, the OWI Shelf 70 slot, the λ Switch 137 mapping, the WMX Shelf 100 slots, and the Band Switch 124 mappings form a consistent set of provisioning specifications.

For an RPOC or EPOC, the wavelength and band for the path are first determined by the SDS/NPT. A frequently encountered situation is the add/drop circuit pack (e.g. OWI-XP) 219A, possibly the WMX 136, and (rarely) the WOSF 137 are not inserted into the IOS 70 of the present invention at that network path provisioning time. For that case, the provisioning process reserves the network path and re-enters provisioning (for such functions as network testing) when the SDS 204 discovers that the equipment resources are in position.

For the case that the transponders and WMXs at the circuit enpoints are already in place at the time of circuit provisioning, the provisioning process proceeds through to the circuit verification in a single step.

For SOCs, the terminating equipment is always available, so a two-step provisioning procedure is not required.

Other λ Switch Applications

The assignment of wavelengths to bands relies on the typically narrow network communities of interest to assign wavelengths to bands based on destinations. For those bands, transit nodes between IOS 60 endpoints require only single ports for those bands, reducing the number of required ports and the node switching cost by up to a factor of four. In addition, λ Switch 137 mapping is required only at endpoint IOSs 60. Occasionally, however, it is necessary (at least temporarily until additional bands are available) to provision a new add/drop into a band with endpoints in other IOSs 60 i.e. at an intermediate point in the network).

If a new add/drop wavelength is provisioned into an existing unfilled band that is transiting the node in such an imperfect wavelength engineering case, the band must be routed to the λ Switch 137 to pick up the additional add/drop. For this case, a pair of WMXs 136 for this band is provisioned (assuming this is the first wavelength provisioned into the band at this intermediate point) along with the appropriate OWI Circuit Pack 219.

Additional λ Switch Capability

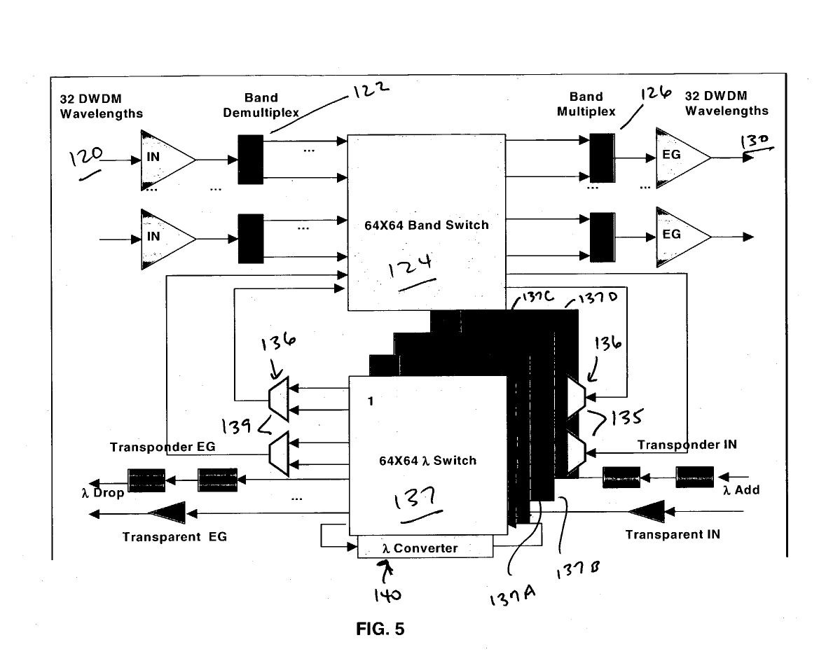

Multibay IOS 60 embodiments of the present invention allow additional individual wavelength add/drop, conversion, wavelength reorganization, or routing capability, as previously described. FIG. 5 shows a block diagram of such a multibay arrangement.

For a multibay arrangement, additional OSF Circuit Packs 219, Transponder Shelves 80, and WMX shelves 100 provide additional λ Switch planes, WMX mux 139/demux 135, and OWI add/drop and SC slots. For a multibay arrangement, the Band Switch 124 is fibered to provide additional ports to λ Switch 137 planes at the expense of fewer Band Switch 124 ports connected to TPMs 121, and therefore optical lines, for a total Band Switch 124 wavelength capability that sums to 256, as Table 1 shows.

TABLE 1

| DWDM | DWDM | | Add/Dropλs | Band Switch |
|---|---|---|---|---|
| Optical | Bands | DWDMλs | Plus | Total λs |
| 7 | 56 | 224 | 32 | 256 |
| 6 | 48 | 192 | 64 | 256 |
| 5 | 40 | 160 | 96 | 256 |
| 4 | 32 | 128 | 128 | 256 |

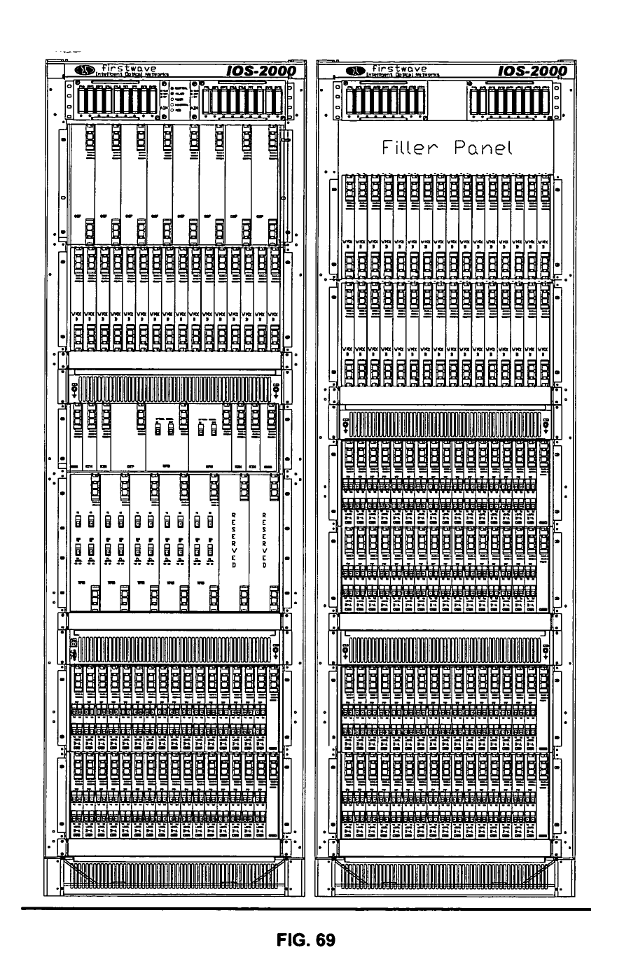

To avoid multiple λ Switch plane interconnections, bands are associated with one and only one λ Switch plane. Row 1 of Table 1 corresponds to the single λ Switch plane single bay arrangement of FIG. 2. Rows 2 and 3 correspond to the two and three λ Switch plane two bay arrangement of FIG. 3. Additional configurations of FIG. 69 correspond to the four λ Switch plane arrangement of row 4.

Redundancy

The IOS optical switch fabric, including the Band Switch 124, the WMX wavelength multiplex 139 and demultiplex 135, and the λ Switch 137 planes are fully redundant. The circuit packs that reside within the DWDM Shelf 80 and the OWI Shelf 70 are all simplex with splitters on the TPM 121, XP 219A, TR 219B, and λC 140 Circuit Packs driving both optical switch fabrics and with switches on those circuit packs selecting signals from Optical Switch Fabric 0 or 1.

The default Optical Switch Fabric 214 service configuration is that one and only one OSF is in-service and the other out-of-service at any time. Changing the service status of the OSFs can result from failure recovery action or a command from the SDS 204 or CLI. For the default mode of operation during an in-service optical switch fabric fault, OSF Fault Recovery exits after switching all circuits to the other fabric. Changing the service status of the OSFs 214 by command takes place without a loss of existing service, and all OSF 214 service status changes are non-revertive.

In addition to this OSF 214 default service configuration, a user configurable option is available in which the user overwrites the default condition to provide for exit of OSF Fault Recovery with only the affected failed channels switched to the opposite fabric. For this user configurable option, no channels that were unaffected by the fabric failure receive errored seconds at the time of fault recovery action. However, for this option, the SDS 204 or CLI stimulates an overriding side switch at a less sensitive time before the craft replaces the failed circuit packs, incurring the errored seconds at that time.

### Optical Control Plane

The Optical Control Plane (OCP) 20 monitors and controls the functions of the Data Plane 10, which carries the customer traffic. Within a single IOS 60, the Optical Control Plane (OCP) 20 consists of a two-tier monitor and control structure. The first tier (Level 1) consists of the redundant System Node Controllers (SNCs) 207. The primary control function in each SNC 207 is the System Node Manager (SNM) 205. The other redundant entities in the Level 1 SNC 207 are the Ethernet Switches (ETH) 222 and the Alarm Interface Module (AIM) 224.

The second tier (Level 2) of the OCP 20 consists of the Intelligent Optical Controllers (IOCs 210 ) that are clients of the System Node Manager server and which are the controllers embedded in the Data Plane 10 and Test Resource circuit packs.

Control Hierarchy

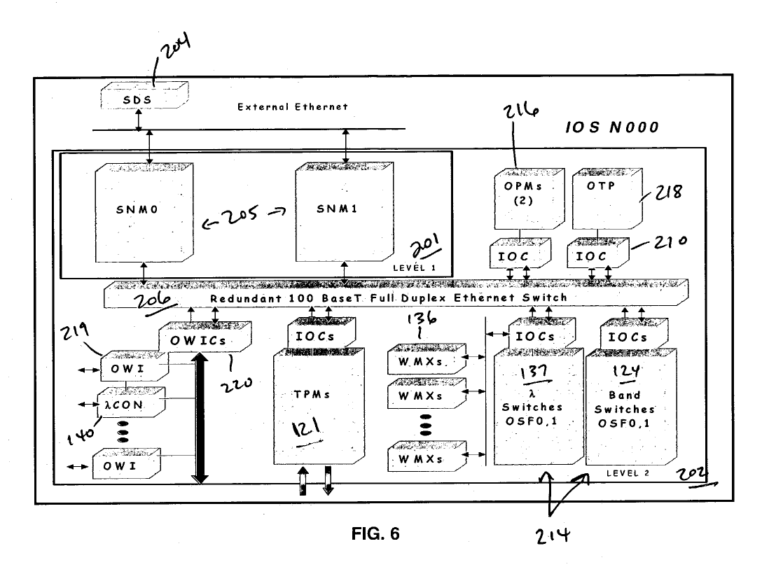

FIG. 6 depicts the hierarchical view of the portion of the OCP 20 that resides within a single node. Within an IOS 60, level 1 201 of the OCP 20 comprises the System Node Managers (SNMs) 205, which interface with the SDS 204 over the external IP network and with other IOSs 60 over the OCN. The SNMs can communicate with the IOS 60 level 2 202 Intelligent Optical Controllers (IOCs 210) 210 using the redundant internal Ethernet Control Bus 206. Level 2 controllers 210 reside on TPM 212, OSF 214, Optical Performance Manager (OPM) 216, and Optical Test Port (OTP) 218 circuit packs. In addition, redundant Optical Wavelength Interface Controllers (OWCs) 220 reside in each Transponder Shelf 70. Level 2 controllers 210 can communicate with SNMs 205 over the redundant internal IOS Ethernet Control Bus 206.

System Node Controllers

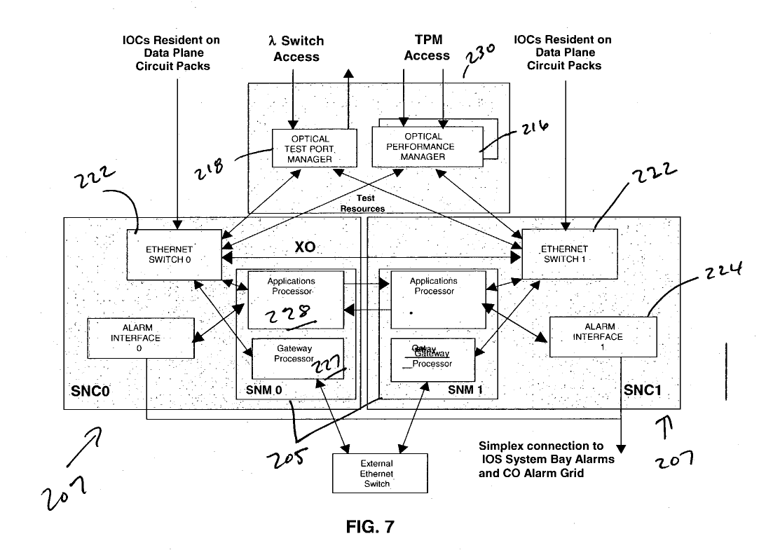

FIG. 7 shows a block diagram of the functions comprising the redundant System Node Controller 207 and the (optional) simplex Test Resources 230. Each System Node Controller 207 includes: (1) the System Node Manager (SNM) 205, (2) the Ethernet Switches (ETH) 222, and (3) the Alarm Interface Manager (AIM) 224. The Test Resources 230 comprises an (optional) Optical Test Port (OTP) 218 plus up to two (optional) Optical Performance Managers (OPMs) 216.

System Node Managers

The SNMs 205, located in the System Bay 62 Control Shelf 90, provide the centralized level 1 control function within the System Node Controller 207. Each SNM comprises a two-processor multiprocessing configuration, one processor serving as a gateway processor 227 and the other serving as the application processor 228. Using the external IP network, the gateway processor 227 provides the communication interface to the Management Plane 30 Services Delivery System (SDS) 204, and it also provides access for the Craft Line Interface (CLI). The CLI access is by means of a single RS-232 DB9 connector that appears on the front of the IOS 60 System Bay 62 and which is wired to both SNMs 205. The Applications Processor 228 executes OCP 20 application software that provides the centralized operational and maintenance functions within the IOS 60 including the corresponding OCP 20 FCAPS functionality.

Ethernet Switches

The System Node Controller Ethernet Switches (ENCs) 222, located in the Control Shelf 90 of the System Bay 62, are for internal IOS 60 communication only, and they are not available to any external entity. Ethernet Switch 0 provides for communication among SNM 0, AIM 0, the Data Plane, and the (optional) OPM and OTP Test Resources. Separately, Ethernet Switch 1 provides for communication among SNM 1, AIM 1, the Data Plane, and the OPM and OTP test resources. A crossover (XO) Ethernet connection 223 exists between ETH 0 and ETH 1 only at the System Node Controllers 207 for SNM 0/1 updates and heartbeats. The ETH 0 and ETH 1 switches in the System Bay 62 are the main junction points in the Ethernet routing topology, with duplicated EtherNet spokes emanating to any Growth Bays 64 and to any remote Optical Wavelength Interface 70 and DWDM Transport 80 Shelves. The IOS Ethernet cabling is therefore fully redundant, connecting the processor cluster within each SNM 205 to the IOCs 210 60 resident on the other circuit packs.

In addition to the Ethernet crossover monitoring capability, each of the SNMs 205 has a direct sanity (SAN) monitoring capability of the other SNM 205. This capability provides basic SNM sanity (equipped, cycling) without relying on availability of both internal Ethernets.

Alarm Interface Manager

The AIMs 224, located on the Alarm Panel at the top of the System Bay 64, drive the IOS 60 Local Alarm Panel LEDs (CRitical, MaJor, MiNor, Alarm Cut Off, ABNormal Condition) and provide the IOS 60 interface to the Central Office Alarm Grid. The AIM0 and AIM1 contacts are pairwise multipled at the Alarm Panel to provide closures to the office alarm grid and local alarm display. The out-of-service AIM alarms contacts are inhibited at the out-of-service SNM, and the in-service AIM alarms are the ones driving the grid and display.

The AIM 224 provides normally open contact closures (alarm contacts close when there is an alarm present) to drive the CO Alarm Grid audible and visual alarms, with a local IOS Alarm Cutoff Switch available for the maintenance craft to cut off the audible alarm while standing in front of the IOS 60.

As an alternative means of performing such circuit testing and verification, certain transponder types are equipped with a capability to generate and receive/verify the same test signals in the same sequence of steps, but without the need for a port 65 on the wavelength switch. For such transponder cases, the testing is accomplished in a similar way using the actual ports on the wavelength switch that the transponder will use in service.

Test Resources

The IOS Test Resources 230 are simplex and optional, and for the OPM 216 could be multiple, and they reside on the System Bay 62 Control Shelf 90 in a power and operational partition that is independent of both SNC0 and SNC1. Each SNM 205 can access any Test Resource 230 using the internal Ethernet. For Feature Release 1, IOS Test Resources 230 include the Optical Performance Manager (OPM) 216 and Optical Test Port (OTP) 218.

Optical Performance Manager

The Control Shelf 90 accommodates circuit packs for up to two OPM 216 instances. Within each TPM circuit pack on the DWDM shelf 80, multiplex DWDM access points exist at the ingress and egress optical line termination points. These access points are separately fibered to each of the two OPM 216 Control Shelf 90 positions using dedicated point-to-point fibers. Using these access points, the OPM 216 can measure optical power level or Optical Signal-To-Noise Ratio (OSNR) for the entire composite signal or for any wavelength within the composite signal. In addition, the OPM 216 provides the means to do wavelength registration for any wavelength within the IOS DWDM band. The OPM 216 is a high resolution, slow speed (seconds) measurement that is invoked on either a directed (camp-on) or background exercise scan basis. The lower resolution, high speed power measurement (<2 ms), required for such activities as fabric switching, is accomplished by the local OSF IOCs 210 210, so these activities do not involve the OPM 216. When two OPMs 216 are included within an IOS 210, both may be used for camp-on measurements, both may be used for background exercise scans, or one may be used for camp-on while the other is used for background exercises.

Optical Test Port

The Control Shelf 90 accommodates one OTP 218 instance. The OTP 218 is invoked by the OCP 20 to establish a test port for network pre-service or troubleshooting testing, typically with a circuit involving multiple IOSs 60 in the network. For example, the OCP 20 may establish a multiple IOS circuit with endpoints or route specified by the SDS 204 and then may use the OTP 218 to test the circuit before completing the provisioning task. For such a test, the OCP 20 may test between two OTPs 218 at the endpoint IOSs 60 of the multiple-IOS circuit or the OCP 20 may establish a network hairpin at the OWI 70 at the far end IOS 60 and utilize the OTP 218 at the near end IOS 60 to generate and receive test signals.

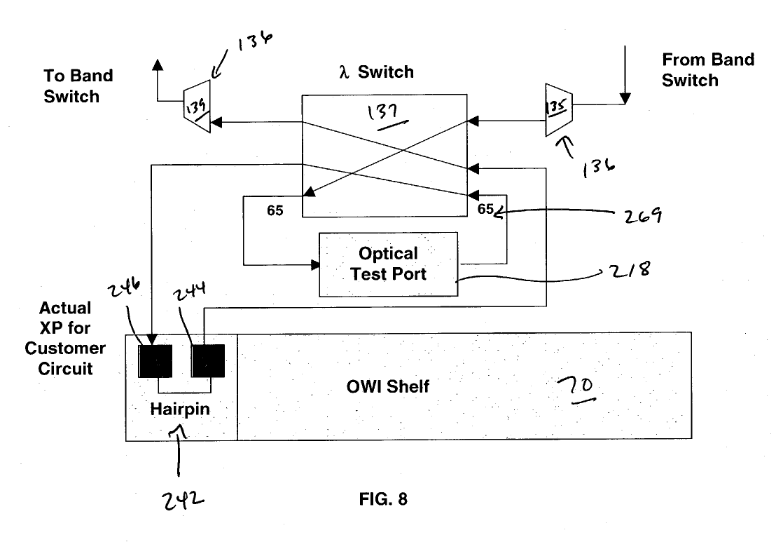

FIG. 8 shows the near end IOS 60 connections for the latter case. The OTP 218 is connected to a special OTP maintenance port ( 65 ) 219 on each λ Switch 237 plane, a port that is not available for end customer circuits. The OCP 20 routes port 65 269 to the λ Switch 137 plane port connected to the OSF fabric receiver of the actual OWI 70 that is earmarked for use by the end customer. With the OWI switch fabric hairpin loop 242 operated, the signal is converted to the wavelength for the circuit and appears at the λ Switch 137 plane port connected to that OWI transmitter 244. The λ Switch 137 routes this signal to the appropriate WMX multiplexer 139 for banding. The resulting band is routed by the Band Switch 124 to the appropriate Band Multiplex 126, assembled onto the appropriate optical line, sent over the network to the far end IOS 60, returned over the network through the far end hairpin to the corresponding ingress band, and routed to the appropriate near end WMX demultiplexer 135 in FIG. 8 for connection to the λ Switch 137. The λ Switch 137 routes the received signal to the OTP 218 for signal verification.

The OCP 20 selects the internal OWI 2.5 Gb/s or 10 Gb/s transponder 219 and generates a test signal with a fixed data pattern using the format (e.g. OC-192, 10 GbE, OC-48, etc.) required for the network connection. The OTP 218 monitors the received data, compares with the fixed data pattern, and thereby verifies the circuit.

After testing is complete, the optical switch fabric port 65 269 connections are released and the receiver 246 of the end customer circuit OWI 219 is connected directly to the network. Thus, the Optical Control Plane 20 can test the circuit in the network up to the OWI hairpin loops 242 at both circuit endpoints using the data format and wavelength earmarked for the end customer.

Redundancy

One and only one System Node Controller 207 is in service, with the other System Node Controller 207 out of service at any time. The redundant IOS System Node Controllers 207, Optical Switching Fabrics 214, and A/B Power Distributions constitute independent duplex system partitions such that a failure of one side for any of them does not affect duplex operation of any of the other entities.

Accordingly, one and only one SNM 205 is in-service at any time, with the other one out of service. The service status of the SNCs 207 can change by SDS 204 or CLI command or by the result of fault recovery activity. Faults in the SNM 205, Ethernet Switches 222, or AIM 224 can render an entire SNC 207 out of service or cause SNC switchover. All SNC 207 service changes are non-revertive. The in-service SNM 205 operates and maintains the node and prepares the out-of-service SNM 205 to take its place by updating its database after every transaction. The SNMs 205 utilize the Ethernet Crossover (XO) 223 for updating, communication, software download, and for monitoring heartbeat messages. In addition, each SNM 205 also directly monitors the other (SAN) for basic sanity (equipped, cycling) independently of the internal Ethernet.

The IOS 60 has a primary and an alternate external IP address, with the in-service SNM 205 assuming the primary IP address and the out-of-service SNM 205 assuming the alternate IP address. Only the in-service SNM 205 supports external communication using the primary IP address at any one time. Connections to the external IP network include configurations using an external IP switch (one IP socket) and configurations in which both SNMs 205 are directly connected to the network (two IP sockets). For the latter case, the heartbeat exchange between the SNMs 205 includes an exchange over the external IP network.

The OPM 216 and OTP 218 Test Resources 230 are not part of the SNC 207 redundant partitions but rather occupy a separate power and operational partition. Failures in the Test Resources 230 functions therefore do not initiate an SNC 207 service status change. Both SNM0 and SNM1 can avail themselves of the Test Resources 230 when they are the in-service SNM 208.

The out-of-service AIM 224 is held inactive for the IOS alarms and the CO alarm grid multiples, with the in-service AIM 224 driving the local display and the grid. Physical removal of the out-of-service AIM 224 circuit pack does not affect the ability of the in-service AIM pack to drive the alarm grid. All control of the AIM 224 is through the corresponding SNM 205, which determines the IOS alarm state, escalates the alarm conditions if necessary, and provides for a requested alarm cutoff.

### Management Plane

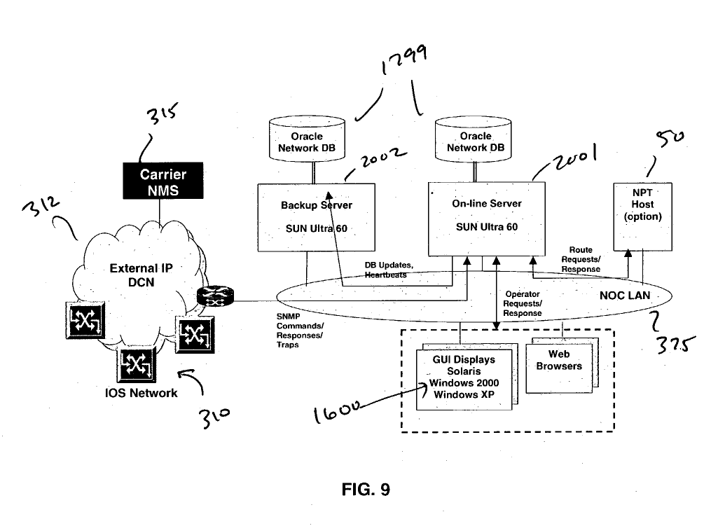

Referring to FIG. 9, the standard implementation configuration of the management plane 30 utilizes redundant SUN servers 2001 and 2002 running the ORACLE database system 1799. In this configuration, all of the SDS 204 application software is running on the on-line server, or functional load sharing can exist between the two servers in some modes. As the network database changes, the database software on the on-line server updates the database on the backup server such that replicated copies of the database are maintained. If the on-line server fails, the backup takes over the on-line operation with a current copy of the database. The SDS 204 backup operates in either a hot-standby mode performing an automated switchover within 2 minutes, or a warm-standby mode performing a manually assisted switchover within 15 minutes.

Network operators access the on-line server configuration, connection, topology, fault, and performance applications from client devices using the graphical user interface (GUI) display 1600. This interface provides point-and-click network management capabilities with high fidelity displays of the IOS 60 configuration as well as the physical and logical network topology. These devices may use SUN Solaris, Windows 2000, or Windows XP operating systems since the Java software implementing the GUI is portable across many operating systems.

The on-line server 375 is responsible for the management of the IOS network 310 using SNMP over an external IP network 312. It utilizes both a request/response interaction and an asynchronous interaction for receiving SNMP traps from the optical switches. To improve performance, the IOS 60 forwards optical performance data to the SDS 206 using TCP. Also, the SDS downloads software to the IOS 60 using FTP.

The IOS 60 provides direct Management Plane 30 access using a Command Line Interface (CLI) in order to perform element management. The CLI offers a proprietary and TLI interface and may be accessed locally via an RS232 port or remotely via the external IP network using the Telnet protocol.

The SDS 204 also supports northbound access by any service provider NMS 315 to the SDS 204 services. This features is based on the CORBA Connection and Service Management Information Model specified by the Telecommunications Management Forum.

The Management Plane 30 also includes a Network Planning Tool (NPT) 50 that consists of an on-line server used by the SDS 204 and an off-line planner. When operating in the off-line mode, the NPT 50 Supports the service provider by generating routes in response to circuit requests or generating new logical link assignments. In the on-line mode, the NPT 50 provides the capability to analyze current network performance or plan network enhancements as well as operate in consultative mode to identify and avoid network bottlenecks or underutilized components. When operating off-line, the NPT 50 provides a data import/export capability such that network state data can be downloaded from the SDS 204 for use in analyses and planning studies. Also, the results, e.g., new band assignments, may be uploaded to the SDS 204.

The SDS platform and SDS software offer other implementation options to improve performance and availability. While both servers are resident on the same LAN in the standard configuration described above, the servers may be remotely located, provided an IP network interconnects the servers. This option protects the SDS 204 against facility type failures.

The SDS software utilizes the SUN JINI infrastructure for communications between modules (e.g., configuration and fault) as well as with the database. With JINI, these modules may be located on different servers. When the service provider's network grows and there is a need for increased computing power, an additional server can be introduced rather than replacing the existing servers.

### Intelligent Optical Switch and Control Software

### Configurations, Capacity, Modularity and Scalability

The IOS 60 of the present invention is a non-blocking Intelligent Optical Switch 60 with a Band Switch 124 capable of switching up to 256 wavelengths in 64 total bands. The integrated DWDM wavelength bands and wavelength bands that require per-wavelength processing (add/drop, wavelength conversion, or wavelength reorganization) sum to 64 for all IOS configurations in accordance with preceding Table 1.

Single Bay Configuration

Referring again to FIG. 2, a single bay IOS 60 embodiment of the present invention is approximately 7′ high×2′2″ wide×2′ deep.

The IOS 60 single bay configuration supports a single DWDM Shelf 80 with up to seven terminating optical lines, with each optical line supporting up to 32 wavelengths arranged in eight four-wavelength bands.

The IOS 60 single bay configuration supports a single OWI Shelf 70 that provides 32 slots for any mix of Optical Wavelength Interface 219 (XP and TR) and Wavelength Converter (λCON) 140 Circuit Packs.

The IOS 60 single bay configuration supports a single WMX Shelf 120 that accommodates up to 16 WMX Circuit Packs 136, eight for optical switch fabric 0 and eight for optical switch fabric 1. A WMX Circuit Pack 136 for any wavelength band can reside in any pair (optical switch fabric 0 and 1) of WMX slots. WMX Circuit Packs 136 are normally equipped on both optical switch fabrics 0 and 1 for IOS service applications.

The IOS 60 single bay configuration supports a single OSF Shelf 110 that provides a configuration of two Band Switch OSF Circuit Packs 124 and two λ Switch OSF Circuit Packs 137. Band Switch 124 and λ Switch Circuit Packs 137 are normally equipped on both optical switch fabrics 0 and 1 for IOS service applications. Four additional OSF slots are reserved for possible addition of a Growth Bay 64 to establish a two bay configuration.

The IOS 60 single bay configuration supports a Control Shelf 90 that provides a configuration of two System Node Managers 205, four Ethernet Switches 222, plus slots for optional Test Resources 230. In addition, the IOS 60 single bay configuration supports an Alarm Interface Shelf 224 that provides a configuration of two Alarm Interface Module Circuit Packs 224. The SNM 205, ETH 205, and AIM Circuit Packs are normally equipped for both SNC0 and SNC1 for IOS service applications.

Table 2 shows the IOS 60 single bay minimum configuration, growth, and maximum configuration for growable and optional capabilities. To provide optical communications capability, the IOS 60 will require a TPM circuit for interconnection with another IOS 60 or an OWI circuit pack for interconnection with a user device. The WMX circuit packs are added in pairs to provide redundancy.

TABLE 2

| | | OWI + | | | |
|---|---|---|---|---|---|
| Circuit Pack Type | TPM | λCON | WMX | OPM | OTP |
| Minimum Configuration | 0 | 0 | 0 | 0 | 0 |
| Growth Module | 1 | 1 | 2 | 1 | 1 |
| Maximum Configuration | 7 | 32 | 16 | 2 | 1 |

Two-Bay Configuration

Referring again to FIG. 3, the two-bay configuration of the IOS 60 of the present invention comprises one System Bay 62 plus one Growth Bay 64, 7′high×4′4″wide×2′deep. The System Bay 62 wired equipment is identical to that of the single bay configuration, but the equipage of the OSF Shelf 110 allows for one or two additional redundant λ Switches 137 for additional per-wavelength processing.

For the two-bay configurations, installation of the Growth Bay 64 wired equipment and interconnection to the System Bay 62 could take place either at the time of the System Bay 62 installation as an out-of-service operation or later as an in-service add/drop growth installation. For the two-bay configuration, the Growth Bay 64 and System Bay 62 are always collocated with the Growth Bay 64 to the right of the System Bay 62 when viewed from the front. However, it will be appreciated that alternative embodiments may be implemented. For example, in the case of later in-service add/drop growth, the bay position for the Growth Bay 64 is reserved in the CO bay lineup.

The IOS 60 two bay configuration supports up to six terminating optical lines, with each optical line supporting up to 32 wavelengths arranged in eight four-wavelength bands.

The IOS 60 two bay configuration supports up to three OWI Shelves 70 that provides up to 96 slots for any mix of Optical Wavelength Interface 219 (XP 219A and TR 219B) and Wavelength Converter (λC) Circuit Packs 140.

The IOS 60 two bay configuration System Bay 62 supports a single OSF Shelf 110 with up to eight OSF Circuit Packs 214, two for the redundant Band Switch 124 and up to six for the redundant 1, 2, or 3 λ Switches 137. Band Switch 124 and λ Switch 137 Circuit Packs 1 are normally equipped on both optical switch fabrics 0 and 1 for IOS service applications.

The IOS 60 two bay configuration supports up to three WMX Shelves 100, each of which accommodates up to 16 WMX Circuit Packs 136, eight for optical switch fabric 0 and eight for optical switch fabric 1. A WMX Circuit Pack 136 for any wavelength band can reside in any pair (optical switch fabric 0 and 1 ) of WMX slots. WMX Circuit Packs 136 on optical switch fabrics 0 and 1 are normally equipped on both optical switch fabrics 0 and 1 for IOS service applications.

The IOS 60 two bay configuration System Bay 62 supports a Control Shelf 90 that provides a configuration of two System Node Managers 205, four Ethernet Switches 222, plus slots for optional Test Resources 230. In addition, the IOS two bay configuration supports an Alarm Interface Shelf that provides a configuration of two Alarm Interface Module Circuit Packs. The SNM 205, ETH 222, and AIM Circuit Packs 224 are normally equipped for both SNC0 and SNC1 for IOS service applications.

Table 3 shows the IOS 60 two bay minimum configuration, growth module, and maximum configuration for growable and optional capabilities. The maximum number of supported TPMs 212 is either 6 or 5, depending on the number of equipped λ Switches 137 (2 or 3), as a result of the total number of IOS bands summing to 256. To provide optical communications capability, the IOS 60 two bay configuration will require a TPM 121 circuit for interconnection with another IOS 60 or an OWI circuit pack 219 for interconnection with a user device.

TABLE 3

| | | OWI + | | | | |
|---|---|---|---|---|---|---|
| Circuit Pack Type | TPM | λCON | OSF | WMX | OPM | OTP |
| Minimum Configuration | 0 | 0 | 4 | 0 | 0 | 0 |
| Growth Module | 1 | 1 | 2 | 2 | 1 | 1 |
| Two λ Switch | 6 | 64 | 8 | 32 | 2 | 1 |
| Maximum Configuration | | | | | | |
| Three λ Switch | 5 | 96 | 8 | 48 | 2 | 1 |
| Maximum Configuration | | | | | | |

Three Bay Configuration

The IOS 60 three bay configuration comprises one System Bay 62 plus two Growth Bays 64 approximately 7′high×6′6″wide×2′deep. The System Bay 62 wired equipment is identical to that of the single bay configuration, but the equipage of the OSF Shelf allows for one or two additional redundant λ Switches 137 in one Growth Bay 64 for additional per-wavelength processing.

For the three-bay configuration, installation of the wired equipment for either-or both Growth Bays 64 and interconnection to the System Bay 62 takes place either at the time of the System Bay 62 installation as an out-of-service operation or later as an in-service add/drop growth installation. For the three-bay configuration, the Growth Bays 64 and System Bay 62 are always co-located, with the first Growth Bay 64 to the right of the System Bay 62 and the second Growth Bay 64 to the left of the System Bay 62, when viewed from the front. For the case of later in-service add/drop growth, the bay positions for the Growth Bays 64 are reserved in the CO bay lineup.

The IOS 60 three bay configuration supports up to four terminating optical lines, with each optical line supporting up to 32 wavelengths arranged in eight four-wavelength bands.

The IOS 60 three bay configuration supports up to four OWI Shelves 70, providing up to 128 slots for any mix of Optical Wavelength Interface 219 (XP 219A and TR 219B) and Wavelength Converter (λCON) 140 Circuit Packs.

The IOS 60 three bay configuration System Bay 62 supports a single OSF Shelf 110 with up to eight OSF Circuit Packs, two for the redundant Band Switch 124 and up to six for the redundant 1, 2, or 3 λ Switches 137. In addition, two OSF slots are available in the second Growth Bay to implement a fourth redundant λ Switch 137. Band Switch 124 and λ Switch 137 Circuit Packs are normally equipped on both optical switch fabrics 0 and 1 for IOS service applications.

The IOS 60 three bay configuration supports up to four WMX Shelves 100, each of which accommodates up to 16 WMX Circuit Packs 136, eight for optical switch fabric 0 and eight for optical switch fabric 1. A WMX Circuit Pack 136 for any wavelength band can reside in any pair (optical switch fabric 0 and 1) of WMX slots. WMX Circuit Packs 136 on optical switch fabrics 0 and 1 are normally equipped on both optical switch fabrics 0 and 1 for IOS service applications.

The IOS 60 three bay configuration System Bay 62 supports a Control Shelf 90 that provides a configuration of two System Node Managers 205, four Ethernet Switches 222, plus slots for optional Test Resources 230. In addition, the IOS 60 two bay configuration supports an Alarm Interface Shelf that provides a configuration of two Alarm Interface Module Circuit Packs. The SNM 205, ETH 222, and AIM Circuit Packs 224 are normally equipped for both SNC0 and SNC1 for IOS service applications.

Table 4 shows the IOS 60 three bay minimum configuration, growth module, and maximum configuration for growable and optional capabilities. With four λ Switches 137, the maximum number of supported TPMs is 4 as a result of the total number of IOS bands summing to 256. To provide optical communications capability, the IOS 60 three bay configuration will require a TPM circuit for interconnection with another IOS 60 or an OWI circuit pack 219 for interconnection with a user device.

TABLE 4

| | | OWI + | | | | |
|---|---|---|---|---|---|---|
| Circuit Pack Type | TPM | λCON | OSF | WMX | OPM | OTP |
| Minimum Configuration | 0 | 0 | 4 | 0 | 0 | 0 |
| Growth Module | 1 | 1 | 2 | 2 | 1 | 1 |
| Four Switch | 4 | 128 | 10 | 64 | 2 | 1 |
| Maximum Configuration | | | | | | |

Growable and Optional Modules

(a) TPM

Each bidirectional optical line terminates in a single TransPort Module (TPM) Circuit Pack 121, which provides a complete transmit and a receive configuration interfacing the separate ingress and egress fibers of the optical line with eight 4-wavelength bands.

TPM Circuit Packs 121 grow from zero to the maximum supported by the bay configuration with a growth module of one TPM Circuit Pack 121.

(b) OWI

Each OWI Circuit Pack 219 provides a bidirectional single wavelength IOS termination.

Table 5 identifies the IOS 60 bands and wavelengths:

TABLE 5

| Band-wavelength | Wavelength registration (nm) | Frequency (THz) |
|---|---|---|
| 1-1 | 1560.61 | 192.1 |
| 1-2 | 1559.79 | 192.2 |
| 1-3 | 1558.98 | 192.3 |
| 1-4 | 1558.17 | 192.4 |
| 2-1 | 1556.55 | 192.6 |
| 2-2 | 1555.75 | 192.7 |
| 2-3 | 1554.94 | 192.8 |
| 2-4 | 1554.13 | 192.9 |
| 3-1 | 1552.52 | 193.1 |
| 3-2 | 1551.72 | 193.2 |
| 3-3 | 1550.92 | 193.3 |
| 3-4 | 1550.12 | 193.4 |
| 4-1 | 1548.51 | 193.6 |
| 4-2 | 1547.72 | 193.7 |
| 4-3 | 1546.92 | 193.8 |
| 4-4 | 1546.12 | 193.9 |
| 5-1 | 1544.53 | 194.1 |
| 5-2 | 1543.73 | 194.2 |
| 5-3 | 1542.94 | 194.3 |
| 5-4 | 1542.14 | 194.4 |
| 6-1 | 1540.56 | 194.6 |
| 6-2 | 1539.77 | 194.7 |
| 6-3 | 1538.98 | 194.8 |
| 6-4 | 1538.19 | 194.9 |
| 7-1 | 1536.61 | 195.1 |
| 7-2 | 1535.82 | 195.2 |
| 7-3 | 1535.04 | 195.3 |
| 7-4 | 1534.25 | 195.4 |
| 8-1 | 1532.68 | 195.6 |
| 8-2 | 1531.90 | 195.7 |
| 8-3 | 1531.12 | 195.8 |
| 8-4 | 1530.33 | 195.9 |

Each XP circuit pack 219A interfaces a standard 1310 nm or 1550 nm bidirectional single wavelength CO optical data link with one bidirectional signal on an ITU-compliant IOS wavelength (Table 5) on an IOS optical line.

Each TR circuit pack 219B interfaces an IOS ITU-compliant (Table 5) bidirectional single wavelength CO optical data link with the corresponding bidirectional signal on an ITU-compliant IOS optical line.

XP and TR Circuit Packs 219 are pairwise configurable into a Head End Bridge (HEB) and/or a Tail End Switch (TES) using adjacent slots of an OWI Shelf 70.

Alternatively, one can use two way cables to multiple two transponder ingress and two transponder egress ports, selecting one of the transponders for egress transmission and inhibiting the other, to implement a HEB/TES arrangement that also protects the transponder circuit pack.

Each XP and TR Circuit Pack 219 is configurable into independent hairpin loops facing the CO and/or facing the IOS optical switching fabric. These hairpin loops are also independent of any other configuration on the XP 219A or TR 219B circuit pack including HEB/TES configurations.

(c) λCON

Each λC Circuit Pack 140 converts any single IOS C Band wavelength into a specific ITU-compliant IOS wavelength.

The number of wavelength conversion slots is a function of the degree to which wavelengths are assigned to bands and the bands are preserved from network endpoint to endpoint. However, the number of λC Circuit Packs 140 in an IOS configuration are not limited except for the maximum number of OWI Shelf slots available for the configuration.

(d) Capacity Growth

Each configuration is in-service λ Switch 137 upgradeable from the minimum configuration to the maximum configuration using the redundant optical switch fabrics to maintain service while upgrading.

The number of λ Switches 137 grows by OSF Circuit Pack insertion in the out-of-service switch fabric with no service impact (beyond an errored second to switch fabrics, if a fabric switch is required) to existing IOS 60 service.

Growth of TPM, XP, and TR termination capacity is by means of OWI circuit pack 219 additions, together with appropriate optical switch fabric configuration. Inserting TPM, XP or TR Circuit Packs cause no service impact to any existing IOS service.

Growth of λC capacity is by means of λC circuit pack 140 additions, together with appropriate optical switch fabric configuration. Inserting λC Circuit Packs 140 cause no service impact to any existing IOS service.

Band growth with existing λ Switch 137 capacity is by means of WMX Circuit Pack 136 addition, together with other appropriate optical switch fabric configuration. The number of WMXs 136 grows by WMX Circuit Pack 136 insertion in the out-of-service switch fabric with no service impact (beyond an errored second to switch fabrics, if a fabric switch is required) to existing, IOS service.

(e) Test Resources

The Optical Test Port 218 is an optional capability for an IOS configuration, and an IOS 60 may have none or one equipped in the Control Shelf 90.

The Optical Performance Monitor 216 is an optional capability for an IOS configuration, and an IOC 60 may have none, one, or two equipped in the Control Shelf 90.

### Redundancy, Reliability, and Availability

The redundant IOS System Node Control 207, OWCs 220, Optical Switching Fabrics 214, and A/B Power Distributions constitute independent redundant system partitions such that a failure of one side of any of them does not affect continuing redundant operation of any other.

The SNCs 207, OWCs 220, and Optical Switching Fabrics 214 have independent fault status (failed, not failed) and service status (in service, out of service). A red ALARM and green ACTIVE LEDs represent fault status locally, while a two-color SERVICE LED represents the service status locally, with a green color identifying the in-service condition and a yellow color representing the out-of-service condition.

For the SNCs 207, OWCs 220, and Optical Switching Fabrics 214, one and only one side is in service with the other out of service at any snapshot of time (a specific exclusion exists for a user-configurable fault recovery option for only the optical switching fabric, detailed below). Either side is capable of serving as the in-service entity for an arbitrarily long period of time with no loss of functionality or performance degradation, independent of the fault status of the other side.

The service status for SNCs 207, OWCs 220, and Optical Switching Fabrics 214 can change by SDS 204 or CLI command or by the result of fault recovery activity for that entity. The SDS 204 or CLI can change the service status of the SNCs 207, OWCs 220, or Optical Switching Fabrics 214 only if the out-of-service SNC 207, OWC 220, or Optical Switching Fabrics 214 is not already failed.

For the SNCs 207, OWCs 220, and Optical Switching Fabrics 214, service status change is non-revertive; that is, an SDS 204 or CLI command is required to revert to the pre-fault status of the entity, once the failure is cleared.

Capacity expansion, software download, and database download/upload are in-service operations that do not affect the service or operations availability of the IOS 60.

Each circuit pack in a redundant entity receives both A and B power distribution and generally operates in a load-sharing manner during normal operation. Failure of one power distribution results in instantaneous switchover to the other distribution without impact to existing service or any operations in progress.

Redundant entities reside on both A and B power distribution partitions such that one power distribution can be depowered with secondary circuit breakers without affecting redundant operation of the entity.

All circuit packs in redundant entities are replaceable, accessible from the front of the IOS 60, and are hot swappable.

Sufficient redundancy exists for the IOS fan trays such that failure or physical removal of a fan tray does not result in a local ambient temperature that causes failure or significant loss of lifetime in a redundant or non-redundant IOS entity. The MTBF of any IOS fan is greater than 75K hours at 40 degrees Celsius ambient temperature.

Sufficient redundancy exists for the IOS fan shelves such that failure of a fan shelf does not result in a local ambient temperature that causes failure or significant loss of lifetime in a redundant or non-redundant IOS entity within a maintenance replacement interval of four hours, given a normal (25 degrees Centigrade) CO aisle temperature.

There is no single IOS point of failure that affects service for more than one wavelength. The entities with one wavelength are OWIs and λCs, and failures of these circuit packs affect only the single wavelength of service that goes through them. The TPMs 121 are simplex but are protected at the network level.

Optical Switching Fabric

The IOS optical switching fabric 214, which includes a Band Switch 124, λ Switches 137, and WMXs 132 and 139, is fully redundant, and either optical switching fabric 0 or 1 is capable of serving as the in-service entity for an arbitrarily long period of time with no degradation of functionality or performance, independent of the fault status of the other optical switching fabric.

The IOS 60 provides a service availability of 99.999%. Service availability means providing service that is fully compliant with IOS Data Plane functional and performance requirements. Service unavailability means loss of all or a substantial percentage of service terminating on IOS or failure to comply with IOS Data Plane 10 functional and performance requirements for the entirety of service terminating on IOS 60. For the purposes of service availability calculations, failure of a single OWI 219 or λC 140 Circuit Pack or a single TPM 121, with other terminations providing service that is fully compliant with IOS Data Plane 10 functional and performance requirements, does not constitute service unavailability.

System Node Controller

The IOS System Node Controller 207, which includes a System Node Manager 205, two Ethernet Switches 222, and an Alarm Interface Module 224, is fully redundant, and either SNC 0 or 1 is capable of serving as the in-service entity for an arbitrarily long period of time with no degradation of functionality or performance, independent of the fault status of the other SNC 207.

The IOS provides operations availability of 99.999%. Operations availability means providing operations that are fully compliant with IOS 60 Optical Control Plane 20 functional and performance requirements. Operations unavailability means loss of all operations capability or failure to comply with IOS 60 OCP 20 functional and performance requirements. For the purposes of operations availability calculations, failure of a single OCC or failure of the external IP network, with other OCP 20 operations access providing service that is fully compliant with IOS 60 OCP 20 functional and performance requirements, does not constitute operations unavailability.

### IOS and Management Software Performance

Switching Performance

The IOS 60 architecture is optimized to minimize the time required for implementing a single path switch in the optical switch fabric through parallel control of the optical switching element. Additionally, pipelining of multiple path switch commands at both the SNC 207 and OSF 214 IOC levels allows a multiple path switch to take advantage of the delay time in reconfiguring the optical switching element, thereby implementing those delays in parallel.

Individual channel switching time is defined as the the interval that begins with the in-service SNM 205 reception of the complete switch command and that ends when the switched optical signal has reached 0.5 dB (90%) of its final value at the egress optical connector. Multiple channel switching time is defined as the time interval that begins with the in-service SNM 205 reception of the complete multi-channel switch command and that ends when all of the multiple switched optical signals have reached 0.5 dB (90%) of their final values at all the egress optical connectors.

The IOS 60 single channel switching time has a statistical distribution that depends on several factors (e.g. actual path used in the switching element), but the worst-case path is nominally 10 milliseconds (9.5 ms-10.5 ms). Of that worst case switching time, the SNM 205 plus IOC command decoding and software processing time requires less than 500 microseconds.

The IOS multiple channel switching time for four channels is less than 15 milliseconds.

The IOS multiple channel switching time for up to 32 channels is less than 50 milliseconds.

Failure Recovery Performance

(a) Optical Switch Fabric

In order to minimize the time required to recover from failures and to minimize the impact of such failures to existing IOS 60 service, a distributed approach exists for Optical Switch Fault Recovery. Failure detectors exist on the IOS TPMs 121 and OWIs 219 (XP 219A and TR 219B) that monitor the health of received signals from the in-service optical switch fabrics. The associated in-service OWC 220 and the TPM 121 IOC 210 scan these detectors over a short scan cycle. Should a failure occur on the in-service switch fabric, the IOS 60 TPM 121 IOCs 210 and in-service OWCs 220 integrate (hit time) apparent failures for the affected OWIs 219 or TPMs 121 and, after concluding that signal has failed, they report the condition to the in-service SNC 207 and switch fabric selection for the affected TPM 121 and OWI 219 wavelengths to the other fabric.

In parallel with TPM 121, IOC 210, and OWC 220 activity, the in-service SNM has received hit-timed alarms from the fabric IOCs 210 and has proceeded with fault recovery action of its own. The SNM 205 resolves whether a fabric failure has occurred or the apparent failure is actually due to a line failure. If due to a line failure, the in-service SNM 205 directs the TPM IOCs 210 210 and OWCs 220 to perform the appropriate reversions to the former optical switch fabric. If the IOS 60 is an endpoint and the circuit is protected, the SNM 205 directs the data plane to perform appropriate reversions to the former working path.

If the SNM 205 determines a fabric failure has occurred, the default operation is to immediately force a switch of all other traffic to the fabric side that does not have the fault. This action reinforces the individual actions of the TPM IOCs 210 210 and OWCs 220 for the affected connections and forces the switchover for all other service. As a user-configurable option, the customer can cause optical switch fabric fault recovery to complete with only the affected connections on the other optical switch fabric. Under this condition, command to force a switch for all unaffected traffic is deferred until a later time but prior to maintenance activity on the IOS 60.

IOS 60 provides user configurable optical switch fabric failure recovery. The default operation is to switch all channels to the opposite fabric from the Optical Control Plane 20, reinforcing the TPM IOC 210 and OWC 220 switch of the affected channels and causing the switch of the previously unaffected channels. The user-configurable option is to exit fault recovery with only the affected channels switched and the unaffected channels remaining on the previous fabric.

In the default fault recovery mode, IOS 60 detects optical switch fabric faults and switches all channels to the opposite fabric within 50 milliseconds of the onset of the fault. The 50-millisecond period includes all fault detection hit timing, fault recovery reconfiguration, and optical settling time at the egress optical connectors to 0.5 dB (90%) of the final optical power levels.

Optical Switch Fabric 214 fault detection by Data Plane 10 TPM 121 IOCs 210 210, OWCs 220, and OSF 214 [OC 210 is an integrated hit timing procedure with a minimum 16 milliseconds of scan samples indicating failure. The Data Plane 10 level 2 control elements report such failures to the in-service SNM 205 within 20 milliseconds of the onset of the failure.

For the default operation, those channels unaffected by the original failure experience a failover transient that does not exceed 30 milliseconds, including optical settling time.

Table 6 summarizes the failure recovery time distribution function for the default fault recovery case.

TABLE 6

| | Time (ms) from |
|---|---|
| Optical Switch Fabric Recovery Time | onset of failure |
| Minimum Data Plane level 2 IOCs 210 failure | 16 |
| detection time (multiple scans with hit timing) | |
| Maximum time for Data Plane level 2 IOCs 210 | 20 |
| to report failures to SNM | |
| Maximum time for Data Plane TPM IOC and | 25 |
| OWCs to perform local fabric selections | |
| Maximum time for SNM and IOCs 210 to force all | 40 |
| Channels to the other optical switch fabric | |
| Optical Settling Completed to 0.5 dB (90%) | 50 |
| of final power level at egress optical connectors | |

For the user-configurable option, IOS 60 detects optical switch fabric 214 faults and switches only the affected channels to the opposite fabric within 50 milliseconds of the onset of the fault. The 50-millisecond period includes all fault detection hit timing, fault recovery reconfiguration, and optical settling the at the egress optical connectors to 0.5 dB (90%) of the final optical power levels.

Table 7 summarizes the failure recovery time distribution function for the user-configurable override fault recovery case.

TABLE 7

| | Time (ms) from |
|---|---|
| Optical Switch Fabric Recovery Time | onset of failure |
| Minimum Data Plane level 2 IOCs 210 failure | 16 |
| detection time (multiple scans with hit timing) | |
| Maximum time for Data Plane level 2 IOCs 210 | 20 |
| to report failures to SNM | |
| Maximum time for Data Plane TPM IOC and | 25 |
| OWCs to perform local fabric selections | |
| Optical Settling Completed to 0.5 dB (90%) | 50 |
| of final power level at egress optical connectors | |

IOS 60 responds to a command from the SDS 204 or CLI to switch any or all of its associated ports to the fabric selected by the SDS 204 or CLI on an override basis. The SNM does not perform this switching if an alarm already exists on the requested switch-to fabric and no alarm exists on the requested switch-from fabric. The switched channels experience a failover transient that does not exceed 30 milliseconds, including optical settling time.

All switching of IOS 60 optical switching fabrics 214 is non-revertive; that is, an SDS 204 or CLI command is required to revert to the pre-switch status, once the fault is cleared.

When an entire optical switching fabric is out-of-service, such as under the default fault recovery condition or after a forced switch prior to maintenance activity with the override option, any reasonable craft activity on that fabric, including pack extractions and insertions, signal and control cable connector insertions or extractions, IOC resets, and all or partial depowering, does not affect service (no errored seconds) on existing connections, and does not cause spurious craft maintenance activity.

(b) Optical Control Plane

On emerging from a cold boot or power up, if both SNCs 207 are non-faulted, SNC0 becomes the in-service SNC 207 and SNC 1 becomes the out-of-service SNC 207.

Should the in-service SNC 207 fail, the service status change of the SNC 207 is complete within 15 seconds of the onset of the failure, making the other SNC 207 the in-service SNC 207. The service status change is complete when the newly in-service SNC 207 is ready for all operations, fully compliant with IOS Optical Control Plane 20 functional and performance requirements.

The in-service SNM 205 changes the SNC 207 service status on command from the SDS 204 or CLI within 15 seconds of receipt of the command. The SNC 207 service status does not change if an alarm already exists on the out-of-service SNC 207 with no alarm in the in-service SNC 207. The change of service status of the SNCs 207 is non-revertive; that is, an SDS 204 or CLI command is required to revert to the pre-fault status, once the fault is cleared.

When a SNC 207 is out-of-service, any reasonable craft activity on that SNC 207, including pack extractions and insertions, signal and control cable connector insertions or extractions, IOC 60 resets, and all or partial depowering, does not affect service (no errored seconds) on existing Data Plane 10 connections, does not impair the operational capability of the in-service SNC 207, does not affect availability of the IOS 60, and does not cause spurious craft maintenance activity.

On emerging from a cold boot or power up, if both OWCs 220 in an OWI shelf 70 are non-faulted, OWC0 becomes the in-service OWC 220 and OWC1 becomes the out-of-service OWC 220. After that, the service status of OWCs 220 for a particular OWI Shelf 70 is independent of the service status of OWCs 220 in any other OWI Shelf 70.

Should an in-service OWC 220 fail, the service status change of the OWCs 220 for that OWI Shelf 70 is complete within 1 second of the onset of the failure, malting the other OWC 220 the in-service OWC 220 for that OWI shelf 70. The OWC service status change is complete when the newly in-service OWC 220 is ready for all operations, fully compliant with IOS Optical Control Plane 20 functional and performance requirements.

The in-service SNM 205 changes an OWC 220 service status on command from the SDS 204 or CLI within 1 second of receipt of the command. The in-service SNM 205 does not send such a command if the out-of-service OWC 220 is already failed. The change of service status of the OWCs 220 is non-revertive; that is, an in-service SNM 205 command is required to revert to the pre-fault status, once the fault is cleared.

When an OWC 220 is out-of-service, any reasonable craft activity on that OWC 220, including pack extractions and insertions, OWC 220 resets, and all or partial depowering, does not affect service (no errored seconds) on existing Data Plane 10 connections, does not impair the operational capability of the in-service OWC 220, and does not cause spurious craft maintenance activity.

(c) Services Delivery System

The on-line SDS 204 updates the backup SDS 204 to take its place as the on-line SDS 204 as a result of fault recovery or operator command. The customer may choose a hot standby or warm standby model of recovery.

The SDS 204 is typically implemented in redundant configurations so that redundant copies of MP data are maintained. The SDS 204 location is independent of the locations of the IOSs 60, supporting any of the following options: (1) Both SDS platforms co-located with a single IOS 60, (2) SDS platforms located with different IOSs 60, and (3) SDS platforms located remotely from all IOSs.

One SDS 204 typically operates as the primary (in-service) and the other as backup (out-of-service) with switchover in case of the failure of the primary. The primary is responsible for all interaction with the IOSs 60. However, the backup maintains a copy of the network database and may also operate in a functional load-sharing mode to support user applications.

When an SDS 204 failure occurs in the MP 30, automatic switchover to the hot standby out-of-service SDS 204 is completed within 2 minutes after detection of the failure, with no manual action required. Upon switchover, the newly in-service SDS 204 is responsible for all control actions within the MP 30, fully compliant with Management Plane 30 functional and performance requirements.

When an SDS 204 failure occurs in the MP 30, the partly manual switchover to the warm standby out-of-service SDS 204 is completed within 15 minutes after detection of the failure. For warm standby backup, manual action is required, and the 15 minutes switching time assumes the availability of craft to perform those manual activities. Upon switchover, the newly in-service SDS 204 is responsible for all control actions within the MP 30, fully compliant with MP functional and performance requirements.

A configuration with two SDS 204, each a primary SDS 204 with their own domains of IOSs, and with each SDS serving as backup to the other, with both hot and warm standby models, is available.

Other

In the event of total power failure, soft reset, or hard reset, the IOS 60 recovers to the operational condition within one minute after power is restored.

Circuit Setup and Teardown Performance

The IOS 60 performs point-to-point circuit switched data services between endpoint client devices, supporting 10 Gigabit Ethernet, OC 48 SONET, and OC 192 SONET client devices. The circuit types are as follows.

(a) Provisioned Optical Circuit (POC, EPOC, and RPOC)

This circuit type is requested and established via the SDS 204. The SDS 204 operator may optionally choose to design the POC either a span at a time or to instruct the SDS 204 to auto-design the circuit.

In the auto-design case, the SDS 204 can determine the complete Network Route of the POC and request this pre-designed circuit to be implemented as an RPOC using the Optical Control Plane 20. As an alternative in the auto-design case, the SDS 204 may communicate with the Endpoint IOSs 60, and the Endpoint IOSs 60 establish the rest of the path as an EPOC by pair-wise negotiation via signaling.

Once provisioned, the SDS 204 manages POCs, RPOCs, and EPOCs in an identical manner. The setup time for EPOCs and RPOCs begins when the SDS 204 operator initiates route generation in the MP 30 and ends when the MP 30 informs the SDS 204 operator that the circuit is ready for data transfer.

(b) Switched Optical Circuit (SOC)

This circuit type is requested via signaling from an OIF UNI or GMPLS enabled client and established by means of Optical Control Plane 20 signaling. For SOCs, the OCP 20 receives a circuit request from a client device over the user network interface, and the OCP 20 generates the route, performs the signaling between IOSs 60 to establish the circuit, and notifies the MP 30 regarding the disposition of the circuit setup. The setup time for SOCs begins with OCP 20 receipt of a circuit request over the UNI and ends when the OCP 20 informs the UNI client that the circuit is ready for data transfer. Additional material on SOCs is available in Section 5.

(c) Circuit Setup Performance

The SDS 204 completes the setup of EPOCs within 3 seconds for circuits with paths having up to 5 IOSs. For EPOCs, the OCP 20 notifies the SDS 204 that the circuit is established within 1.5 seconds of receipt of the command from the SDS 204.

The SDS 204 completes the setup of RPOCs within 3 seconds for circuits with paths having up to 5 IOSs, excluding the time required to generate the routes. For RPOCs, the OCP 20 notifies the SDS 204 that the circuit is established within 1 second of receipt of the command from the SDS 204.

The OCP 20 completes the setup of SOCs within 3 seconds for circuits with paths having up to 5 IOSs 60.

When multiple circuits are set up along the same route, these single circuit setup times are satisfied.

(d) Auto-Restoration Performance

The OCP 20 has the capability to restore SOCs and EPOCs with the restoration time defined as the time from the expiration of the Wait for Restoration timer in the OCP until all circuits have been restored.

The OCP 20 restores at least 128 circuits consisting of any mix of SOCs and EPOCs within the following time constraints: (1) 2 minutes for networks with 10 IOSs 60, (2) 5 minutes for networks with 20 IOSs 60, and (3) 10 minutes for networks with 30 IOSs 60.

This performance requirement assumes that sufficient reserve capacity is available to restore the circuits and that all restoration actions by the MP 30 are deferred until the OCP 20 completes, i.e., the MP WTR timer is set to appropriately delay MP 30 restoration.

The MP 30 has the capability to restore all types of optical circuits, with the restoration time defined as the time from the expiration of the Wait for Restoration timer in the MP 30 until all circuits have been restored.

The MP 30 restores at least 128 circuits consisting of any mix of RPOCs, EPOCs, and SOCs within the following time constraints: (1) 2 minutes for networks with 10 IOSs 60, (2) 5 minutes for networks with 20 IOSs 60, and (3) 10 minutes for networks with 30 IOSs 60.

When restoring circuits under the direction of the MP 30, the OCP 20 notifies the MP 30 that the circuit has been established within 1 second upon receipt of an SNMP command from the MP 30 to set up a circuit with a specified route.

This performance requirement assumes that sufficient reserve capacity is available to restore the circuits.

Path Protection Performance

IOS 60 considers all 1+1 circuits as unidirectional circuits and makes independent tail-end-switch decisions for each direction of transmission. For circuits with the 1+1 Protection Service Level, IOS 60 completes the switchover from a failed working path to the protection path within 50 ms of the onset of the failure.

For SOCs, EPOCs, and RPOCs with the 1:1 or 1:N Protection Service Level, the OCP 20 completes the switchover from a failed working path to the protection path within 200 ms of onset of the failure. This switchover time includes the pre-emption of an LP circuit if active.

### Alarms and Alarm Handling

IOS System Alarms

The IOS system bay 62 incorporates an alarm panel with LEDs capable of displaying the aggregate current alarm condition of the node as a whole.

The Alarm Panel LEDs summarize the alarm condition for the full IOS node: (i) Critical Red; (ii) Major—Red; (iii) Minor—Yellow; (iv) Alarm Cut Off (ACO)—Yellow; and (v) Abnormal Condition—Yellow.

Three alarm severities exist for IOS alarm conditions: Critical, Major, and Minor. The default conditions are: (i) CRITICAL—Loss of service on any connections; (ii) MAJOR—Loss of major system functionality or power distribution fault detected; and (iii) MINOR—Failure that does not involve loss of service, power distribution fault, or loss of major system functionality.

IOS 60 generates the alarms summarized in Table 8 and reports them to the SDS:

TABLE 8

| Alarm Category | Example |
|---|---|
| Critical | Circuit Pack Failure in Both Fabrics |
| | TPM Circuit Pack Failure |
| | Automatic Power Shut Down |
| | Optical Wavelength Interface/Line Failure |
| | Power failure on an A and a B distribution |
| | Fan Tray Failure involving more than one fan |
| | Circuit pack failure in both System Node |
| | Controllers |
| | Both OWC failed in Optical Wavelength Interface |
| | Shelf |
| | Both internal IOS Ethernets failed |
| | Both AIMs failed |
| | Protection Switchover Failure |
| | Auto-restoration Failure |
| | Circuit Verification Failure |
| | Excessive UNI Request Rate |
| Major | Circuit Pack Failure(s) on one fabric |
| | Circuit Pack Failure(s) in one SNM |
| | Circuit Pack Failure(s) in one internal IOS |
| | Ethernet |
| | Circuit Pack Failure(s) in one AIM |
| | One OWC Circuit Pack failure in OWI Shelf |
| | Failure in Test Port Manager Circuit Pack |
| | Failure in OPM Circuit Pack |
| | Single Power Failure |
| | Loss of Heartbeat with Adjacent IOS |
| | Loss of Heartbeat with UNI Client |
| | Boot Failure |
| Minor | Circuit Request Blocked |
| | Circuit Pack Inserted/removed |
| | Failure of a single fan |
| | Fan filter replacement required |

IOS 60 has a local Alarm Cut Off key to retire the audible alarm. In addition, IOS AIMs 224 support a remote ACO from a centralized location in the CO. When an audible alarm is retired, the ACO LED on the IOS Alarm Panel is illuminated for the duration of the specific failure that initiated the audible alarm. If a new failure occurs before the initial failure is cleared, the IOS 60 initiates a new audible alarm.

IOS 60 supports the configuration of severity of alarms. SDS downloads a selected alarm profile to some or all IOSs in the network. After the profile has been activated, the IOS OCP uses the new alarm severities while declaring alarms.

Replaceable Modules

Simplex IOS circuit packs have two distinct indicators: (1) ALARM—Red (failure of any severity); and (2) ACTIVE—Green (normal operation, no alarms).

Redundant IOS circuit packs have three distinct indicators: (1) ALARM—Red (failure of any severity), (2) ACTIVE—Green (normal operation, no alarms); and (3) SERVICE—Green/Yellow (Green: in-service; Yellow: out-of-service).

IOS fan shelves have a visible indicator of fan failure conditions: (1) ALARM—Red (failure of any severity); and (2) ACTIVE—Green (normal operation, no alarms).

SNC Alarm Handling

FIG. 10 shows the control interface and alarm handling between the AIMs 224 and SNMs 205 in SNC 0 and SNC 1. Each SNM 205 has an 12C interface with the AIM 224 within its SNC 207, and this interface includes CLOCK 261, serial DATA 262, and Interrupt Request 260, together with a supplementary DC Failure Lead 263. The SNM 205 loads all AIM 224 configuration and control information by writing the AIM 12C latches 225. This information drives the AIM 224 LEDs, the IOS Alarm Display Panel 260 LEDs, and the relay outputs that drive the CO Alarm Grid. Thus, the AIM 224 stores all control information in its latches and can drive the CO Alarm Grid and the IOS Alarm Panel without relying on the SNM 205 after the latch is originally loaded. Accordingly, these states bridge such actions as SNC 207 service status changes or SNC 207 extraction without creating a hole in the alarm state.

In the incoming direction, CO relay inputs are isolated and then directly feed the 12C latches 225. In addition, AIM status and failure information is loaded into the 12C latches. Any state change in the latches interrupts the SNM 205, and the SNM 205 services the interrupt by reading all bits in the latches 225 over the 12C serial bus. Additionally, an alarm that monitors the AIM low voltage power converter bypasses the 12C latches and proceeds directly to the SNM Circuit Pack GPIO to guard against the disablement of the IRQ.

A cross couple exists from the opposite side SNM 205 to an AIM 224 that forces the AIM SERVICE LED to the out-of-service state (yellow) and that inhibits (masks) the latches controlling the relay and Alarm Panel LEDs (the latches themselves retain their information and are readable by the SNM). This capability allows an in-service SNM 205 to prevent the out-of-service AIM 224 from controlling the Office Alarm Grid and Alarm Panel, so that SNC 207 power down, SNM and AIM extraction, and an insane out-of-service SNM 205 does not create spurious CO alarms. The cross couple is maskable from the in-service SNM 205, and the cross couple signal state change is detectable by the in-service SNM 205 because the cross couple state is an 12 C latch 225 bit that interrupts the in-service SNM 205.

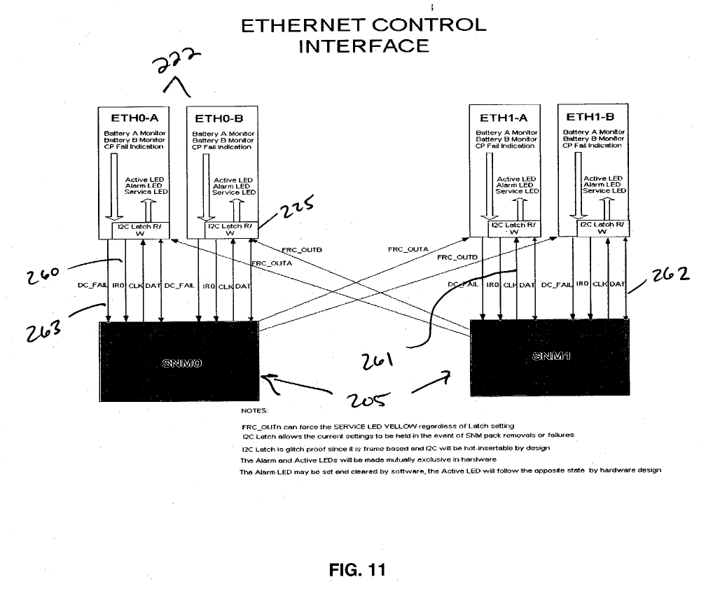

The control interface between the SNMs 205 and the ETH 222 Circuit Packs is structured in a similar manner, as shown in FIG. 11, and the alarm handling is identical.

Each SNC 207 has an 12C interface that allows the SNC 207 to read and write latches on the corresponding AIM 224, ETH A, and ETH B Circuit Pack in that SNC 207 for all control and status information such as Circuit Pack Status LED states, Alarm Panel LEDs, and Alarm Grid relay closures. The 12C bus consists of CLOCK 261, serial DATA 267, and Interrupt Request 260.

Each AIM 224 and ETH A, and ETH B Circuit Pack loads failure information into its 12C latches 225 and interrupts its corresponding SNM 205. The SNM 205 services this interrupt by reading all the latch data from the corresponding circuit pack. Failures that can prevent the IRQ 260 from being generated bypass the 12C latches and directly interrupt the SNM 205 via a GPIO Included in this category are low voltage power converter failures.

Each AIM 224, ETH A, and ETH B Circuit Pack provides information directly to its SNM 205 GPIO around the 12C latches 225 for all failures that can prevent the latches from generating an interrupt. This failure information includes low voltage power converter failure.

Each AIM 224 provides ingress relay contact information directly to its SNC 207 SNM 205.

A cross couple exists between each SNM 205 and the opposite AIM 224 to prevent the out-of-service AIM 224 from controlling the CO Alarm Grid and IOS Alarm Panel LEDs. This cross couple clears only the relay output bits and the Alarm Panel bits but does not clear any other bits in the latches. This is the mechanism for the in-service AIM 224 to control these outputs independent of the out-of-service AIM 224.

A cross couple exists between each SNM 205 and the opposite AIM 224, ETH A, and ETH B to directly write the SERVICE LED to the out-of-service state.

All cross couples between SNCs 207, including the one mentioned in the above two specifications, are status bits in the 12C latches of the driven circuit packs, interrupt the local SNM on change of state, and are maskable by the in-service SNM 205.

All CO interfaces, both inputs and outputs, are isolated from the AIM circuit ground and power by relay contacts or opto-isolators, as appropriate. The cable between SMN 205 and AIM 224 for each SNC 207 is isolated from all other cables or leads and runs in separate the left and right vertical cable raceways on the System Bay 62. This cable also contains a looping ground signal on both sides of the connector to detect physical removal or connector cocking.

The ACO switch is a momentary switch that is mounted on the System Bay Control/TPM Shelf Air Intake Baffle and which is connected, through opto-isolators, to both SNMs 205. Each SNM 205 can be interrupted by the ACO switch and can reset the GPIO to verify the switch is not permanently operated.

Data Plane and Test Resources Alarm Handling

The IOC 210 configurations on both redundant and non-redundant Data Plane 10 and Test Resource 230 Circuit Packs have terminations for both sides of the redundant IOS Ethernet Control Bus. The Ethernet Control buses 206 are the means for these IOCs 210 to report failures, alarms and status changes in the local devices and circuit packs they control.

The in-service OWC 220 monitors failures on the OWI-XP 219A, OWI-TR 219B, and OWI-λC 140 Circuit Packs through the OWI FPGA over the 12C bus in the OWI Shelf 70, decides any status change for the circuit packs, directly writes the ACTIVE/ALARM circuit pack status LEDs, and reports the alarm and status change information to the SNMs 205 over the redundant internal Ethernet. OWI 219 failures that can prevent an interrupt from being generated, e.g. low voltage power supply failures, bypass the 12C latches 225 and write the OWC GPIO directly. This handling is invariant, regardless of whether the OWI Shelf 70 resides in a System 62 or Growth Bay 64 or is miscellaneously mounted in a remote bay. The in-service SNM 205 monitors the OWCs by means of heartbeats.

The SNM 205 selects which OWC 220 that is in service and which is out of service. A cross couple exists between OWCs 220 that allows the in-service OWC 220 to disable OWI Shelf bus write operations of the other OWC 220.

Separate cross couples allow the in-service OWC 220 to directly write the ALARM/ACTIVE circuit pack status LEDs of the out-of-service OWC 220.

A separate cross couple allows the in-service OWC 220 to directly write the SERVICE LED of the out-of-service OWC 220 to the out-of-service state.

All cross couples appear as a status bits in the 12C bus latch 225 of the driven IOC 210, interrupting the OWC 220 on any change of state. The in-service OWC 220 can also mask the bits.

The TPM 21 IOC 210 monitors the failures, alarms, and status changes of devices on the associated TPM Circuit Pack 121, decides any status change for the circuit pack, directly writes the ACTIVE/ALARM circuit pack status LEDs, and reports the alarm and status change information to the SNMs 205 over the redundant internal Ethernet. This handling is invariant, regardless of whether the TPM Shelf resides in a System Bay 62 or in a Growth Bay 64 or is miscellaneously mounted in a remote bay. The in-service SNM 205 monitors the TPM 212 IOCs 210 by means of heartbeats.

The WOSF 137 IOC 210 monitors the failures, alarms, and status changes of devices on the associated WOSF 137 and WMX 136 Circuit Packs, decides any status change for the circuit pack, directly writes the ACTIVE/ALARM circuit pack status LEDs, and reports the alarm and status change information to the SNMs 205 over the redundant internal Ethernet. The OSF 214 IOC 210 communicates with its associated WMX circuit packs 136 over the 12C bus that interconnects the WOSF slot to its corresponding WMX shelf 100 slots.

The WOSF IOC 210 can directly write the circuit pack status LEDs for all associated WMX Circuit Packs 136 over the 12C bus. No cross couples exist to the other optical switch fabric. The in-service SNM 205 monitors the WOSF 137 IOCs 210 by means of heartbeats.

The BOSF 124 IOC 210 monitors the failures, alarms, and status changes of devices on the associated BOSF Circuit Pack 124, decides any status change for the circuit pack, directly writes the ACTIVE/ALARM circuit pack status LEDs, and reports the alarm and status change information to the SNMs over the redundant internal Ethernet. No cross couples exist to the other optical switch fabric 214. The in-service SNM 205 monitors the BOSF 124 IOCs 210 by means of heartbeats.

The OTP 218 and OPM 216 IOCs monitor the failures, alarms, and status changes of devices on its associated OTP 218 or OPM 216 Circuit Pack, decides any status change for the circuit pack, directly writes the ACTIVE/ALARM circuit pack status LEDs, and reports the alarm and status change information to the SNMs 205 over the redundant internal Ethernet 206.

Alarm Suppression and Correlation

IOS 60 implements alarm correlation and suppression algorithms wherever applicable to provide a focus for the root cause failure, avoid inundation at the SDS 204, and reduce confusion at the SDS site as well as facilitate desensitizing appropriate portions of the IOS 60 during craft maintenance activities, intermittent failure conditions, and higher level trouble scenarios at the SDS site.

IOS 60 supports suppression (pesting) and clearing of any alarm under command from the SDS 204 or CLI. All or selectable types of alarms are suppressible for the entire IOS 60 as well as any subset of alarms (e.g. OSF Alarms). IOS 60 reports all alarms to the SDS 204 upon generation of the alarm unless the SDS 204 or CLI has suppressed the alarm.

Traffic dependent alarms are independently pestable as a class by the SNC 207 and also independently unpestable on a per circuit pack basis.

MP Alarm Processing

The MP 30 receives alarm messages from the OCP 20 for analysis and display. The MP 30 also enables the operator to suppress alarms by severity level such that the OCP 20 does not generate the alarms. The MP 30 allows the operator to organize the alarm display based on IOS 60 ID, alarm type, alarm severity, and time stamp. The MP 30 allows he operator to sort the alarms or suppress them from the display based on these parameters.

The MP 30 provides a GUI display of alarms with the following parameters: (1) Alarm Type, (2) Alarm Severity, (3) Alarm Status, (4) IOS ID and (5) Time Stamp.

The MP 30 also monitors the status of the OCP 20 and generates an alarm if communications connectivity is disrupted.

The MP 30 maintains a history of the circuit pack alarms for a configurable time period and database size that can be displayed upon client request.

The CLI displays the alarm history in textual format.

The SDS 204 and OCP 20 applications allow for the SDS Administrator to change the default alarm severity for each class of alarm to any one of the following five severities and save this preference as a profile: (1) Critical, (2) Major, (3) Minor, (4) Not Reported (used for suppressing alarms) and (5) Not Alarmed.

The OCP/SDS stores historical fault and performance monitoring data minimally for the past 500 events/alarms and 24 hours respectively. The SDS 204 efficiently retrieves historical information after connectivity loss between the SDS 204 and the IOS 60. The SDS 204 stores historical information for up to two days (the current & previous days information). The CLI can display this historical information to an operator. The SDS 204 displays historical information in a GUI format to an administrator.

### IOS Power and Electrical

IOS 60 accepts dual redundant −36 to −72 VDC, with a nominal −48 VDC, power, as measured at the circuit breaker input power lug. This power can be supplied by office battery in certain environments or by (external) AC to DC Converters in other environments.

Each redundant entity (e.g. optical switch fabrics 214, System Node Controllers 207 ) within IOS 60 receives power distributions from both of the two redundant power sources through separate secondary circuit breakers. The redundant optical switch fabric and the redundant SNC 207 can be depowered with separate secondary circuit breakers without affecting the duplex operation of the other.

Each replaceable unit within IOS 60 receives power distributions from the two redundant power sources. In the event of failure of one power source, the other power source provides the power without requiring manual intervention and without interrupting service or functionality.

In the event of total duplex power failure, IOS 60 recovers to the operational condition when power is restored.

All primary and secondary IOS 60 circuit breakers are plainly marked to show on and off positions, and a plainly available red alarm light is illuminated whenever a circuit breaker is in the off position.

IOS 60 provides a single point low impedance connection to the protective grounding system and is consistent with CO grounding requirements listed in GR-78-Core General Requirements for the Physical Design and Manufacture of Telecommunications Products and Equipment, Issue 1, September 1997, GR-63-Core Network-Building System (NEBS) Requirements (Physical Protection), Issue 1, October 1995, TR-NWT-000078 Generic Physical Design Requirements for Telecommunications Products and Equipment, and GR-1217-Core Generic Requirements for Separable Electrical Connectol-s Used in Telecommunications Hardware.

The IOS 60 equipment meets the power dissipation requirements identified in Table 9:

TABLE 9

| | | Max Power | Max Power | |
|---|---|---|---|---|
| Equipment | Type | Dissipation | Density | |
| IOS | System Bay | 2175 Watts | 181 | w/ft² |
| IOS | Growth Bay | 2175 Watts | 181 | w/ft² |
| IOS 4000 | System Bay | 2175 Watts | 181 | w/ft² |
| IOS 4000 | Growth Bay | 2175 Watts | 181 | w/ft² |
| OWI | Remote Shelf | 440 Watts | 27.9 | W/ft²/ft |
| TPM | Remote Shelf | 440 Watts | 27.9 | W/ft²/ft |

Table 9 is designed in accordance with GR-63-Core O4-12 and Requirement R4-11. The aisle spacing used for these calculations is 48″ for maintenance & 48″ for wiring. When calculating the above maximum power dissipations an area of ½ of the total extended aisle space was utilized. The size of the IOS 60 bay for these calculations is 7′×2′2″×2′. The effective floor space utilized is 26″×26″ (W×D). Requirement R4-11 from Bellcore GR-63-Core states a Maximum equipment frame Heat Release of 181.2 w/ft² under forced convection. The Maximum Shelf heat release is to be 27.9 W/ft²/ft of vertical frame space the equipment uses.

### IOS Engineering Rules

All IOS engineering rules are established to guarantee 10⁻¹² errors per bit or better in the worst case for optical circuits that adhere to them. This is a no-quibble guarantee: there are no assumptions made about signal coding by the end customer.

The primary IOS 60 engineering rules are for optical lines that include at least one 10 Gb/s wavelength, since customers normally cannot say with certainty that they require no 10 Gb/s wavelengths over the provisioning lifetime of the optical line.

A secondary set of engineering rules for special applications are for optical lines that include a maximum bit rate of 2.5 Gb/s for all wavelengths provisioned over the lifetime of the optical line.

The IOS 60 primary engineering rules assume the presence of a Dispersion Compensation Module (DCM) in the egress optical amplifier interstage at every node, with a DCM code appropriate for the compensation of next span chromatic dispersion, including the specific fiber type, span length, and any special degradations (e.g. legacy and non-standard fiber, non-uniform fiber concatenations, splices, in-line amplifiers, and connectors).

The IOS primary engineering rules assume that the DCM, while a compromise compensator, provides sufficient matched chromatic dispersion compensation that the resulting optical circuit is noise limited.

If a DCM must be added or changed for any reason, a service interruption in general occurs for that optical line while the DCM is added or changed.

The primary IOS 60 engineering rules assume the IOS OWI ITU-compliant XP transmitter and receiver.

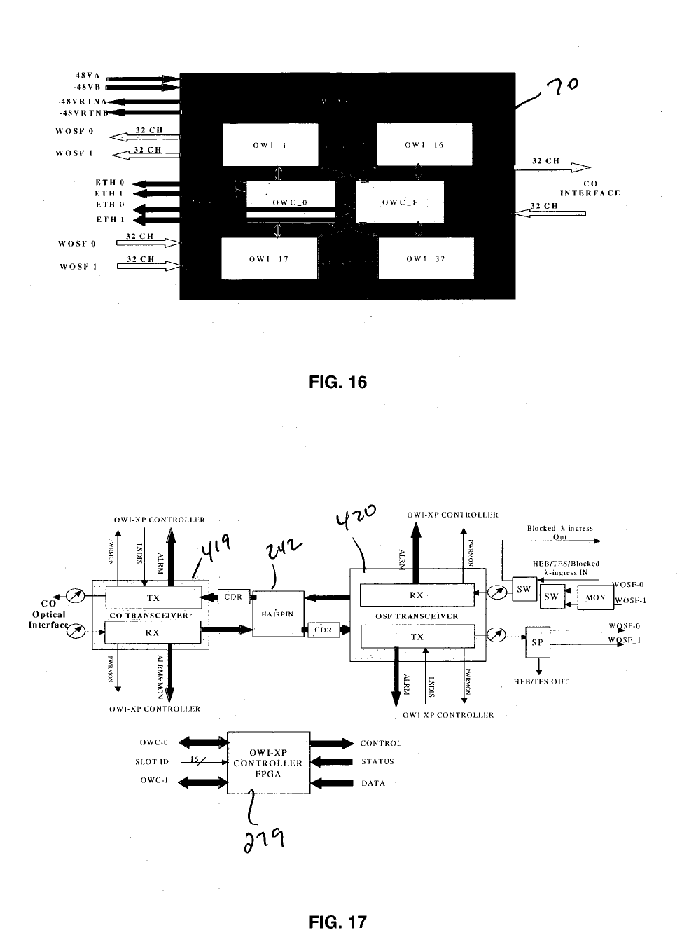

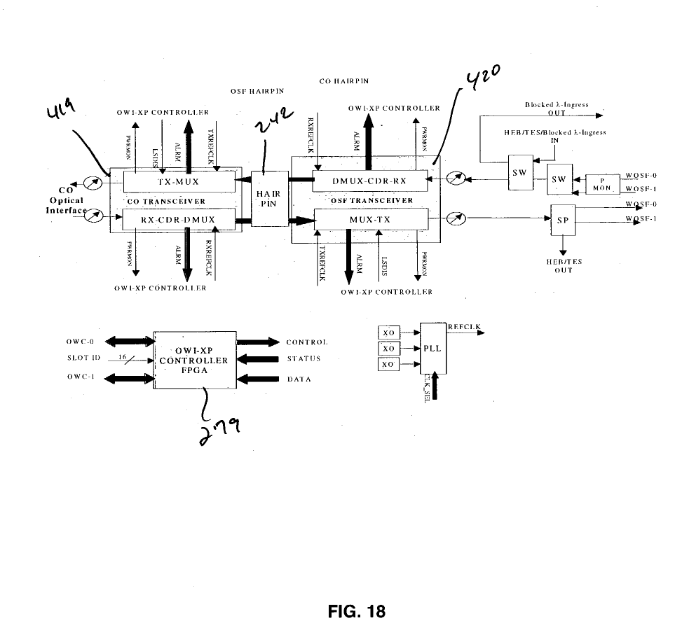

The IOS 60 engineering rules do not apply to customer-provided transmitters and receivers (e.g. transmitters and receivers that utilize the transparent TRP and TRG access) unless they meet the specifications of tables 10 and 11 and FIGS. 16 and 17 (and associated descriptions), including specifications on bit rate, minimum and maximum power levels and wavelength purity.

The MP 30 and OCP 20 maintain an OSNR characterization table of the receive signals at all IOS DWDM node receive points in the IOS network 310. This characterization table is built from: (a) Customer-supplied data, (b) Span Characterization Service Data, (c) OPM Data, where available, and (d) Simulation Data.

The MP 30 and OCP 20 utilize the OSNR characterization table to guarantee that the new wavelength provisioning meets the 10 exp (−12) errors/bit IOS BER guarantee for each provisioned circuit.

The OCP 20 establishes the set point for each TPM 212 in the circuit by transmitting updates to them regarding the number of wavelengths that are physically lit in each of the DWDM bands. Fast power detection at the WMXs at each endpoint result in OCP 20 messages that change the TPM 212 equalization trigger points for all nodes in the circuit when a wavelength appears or drops out.

The IOS 20 primary engineering rules do not take advantage of the new optical partition resulting from O-E-O wavelength conversion due to the possibility of an affordable future all-optical wavelength conversion function for alternative embodiments that may coexist in the network with O-E-O wavelength conversion. The IOS engineering rules do not hold for inclusion of other vendor equipment in the optical lines or any mid-span meet with other vendors DWDM equipment.

IOS Uniform Span Engineering Rules

Uniform spans do not occur in nature, but they are useful for characterizing the performance of a DWDM system. FIGS. 120-124 provide the OSNR for various numbers of uniform spans and span losses, illustrating the effects of λ switching at intermediate nodes (i.e. wavelength conversion, wavelength reorganization among bands, or additional add/drop at the intermediate nodes).

For optical power launch and detection reasons, the maximum span loss for uniform span characterization is 24 dB.

The MP 30 sets the engineering rules for the IOS network 310. Normally, IOS 60 optical lines are engineered with the primary engineering rules, which are the default engineering rules for the system. The service provider customer may override this default by setting a user-configurable option for the secondary engineering rules.

For the primary engineering rules, the maximum number of instances of intermediate node λ switching on any provisioned EPOC, RPOC, or SOC is one. For the secondary engineering rules, the maximum number of instances of intermediate node λ switching on any provisioned EPOC, RPOC, or SOC is three. Wavelengths are normally assigned to bands on the basis of common source and destination. The use of λ switching at an intermediate node is the provisioning option of last resort. The first choice provisioning option is to add a wavelength to an unfilled band that has the same source and destination as the wavelength being provisioned. The second choice is to create a new band for that source and destination. For both of these choices, all paths through the network between source and destination are candidates.

An IOS provisioned circuit is compliant with the IOS primary (default) engineering rules for uniform span provisioning if the DWDM receive signals for all nodes traversed by the circuit have an OSNR that exceeds 25 dB. An IOS provisioned circuit is compliant with the IOS secondary (override) engineering rules for uniform span provisioning if the DWDM receive signals for all nodes traversed by the circuit have an OSNR that exceeds 22 dB.

For the default (primary) engineering rules, circuit provisioning is rejected if the OSNR of the DWDM receive signals at any node traversed by the circuit, for all paths through the network, for any wavelength in the band or on the fiber is less than 25 dB. For the secondary engineering rules, provisioning is rejected if the OSNR of the DWDM receive signals at any node traversed by the circuit, for all paths through the network, for any wavelength in the band or on the fiber is less than 22 dB. The SDS craft may override a provisioning rejection by forcing the provisioning. The OCP 20 communicates all instances of overrides of provisioning rejection to the MP 30. The MP 30 produces a report of all provisioning rejection overrides on a daily basis.

IOS Nonuniform Span Engineering Rules

For power launch and detection reasons, the maximum span loss for nonuniform span engineering is 24 dB.

An IOS provisioned circuit is compliant with the IOS primary (default) engineering rules for nonuniform span provisioning if the DWDM receive signals for all nodes traversed by the circuit have an OSNR that exceeds 25 dB. An IOS provisioned circuit is compliant with the IOS secondary (override) engineering rules for uniform span provisioning if the DWDM receive signals for all nodes traversed by the circuit have an OSNR that exceeds 22 dB. The number of nodes and spans, the degree of special degradations, the degeneracy of individual spans, and all other factors are subordinate to this primary OSNR requirement.

For the default (primary) engineering rules, circuit provisioning is rejected if the OSNR of the DWDM receive signals at any node traversed by the circuit, for all paths through the network, for any wavelength in the band or on the fiber is less than 25 dB. For the secondary engineering rules, provisioning is rejected if the OSNR of the DWDM receive signals at any node traversed by the circuit, for all paths through the network, for any wavelength in the band or on the fiber is less than 22 dB. The SDS craft may override a provisioning rejection by forcing the provisioning. The OCP communicates all instances of overrides of provisioning rejection to the MP 30. The MP 30 produces a report of all provisioning rejection overrides on a daily basis.

### Data Plane Specifications

Overall Data Plane

Integrated DWDM transport and optical switching systems such as the IOS 60 of the present invention must meet additional requirements compared to point-point DWDM optical system or integrated optical O-E-O switching systems. These additional requirements include dynamic transient control, dynamic channel power equalization, and cross-talk control. The band and wavelength architecture of IOS 60 of the present invention demands tight control of these functions and others to meet QoS expectations and greater provide advantages over prior art systems.

Overview of IOS Data Plane Functions

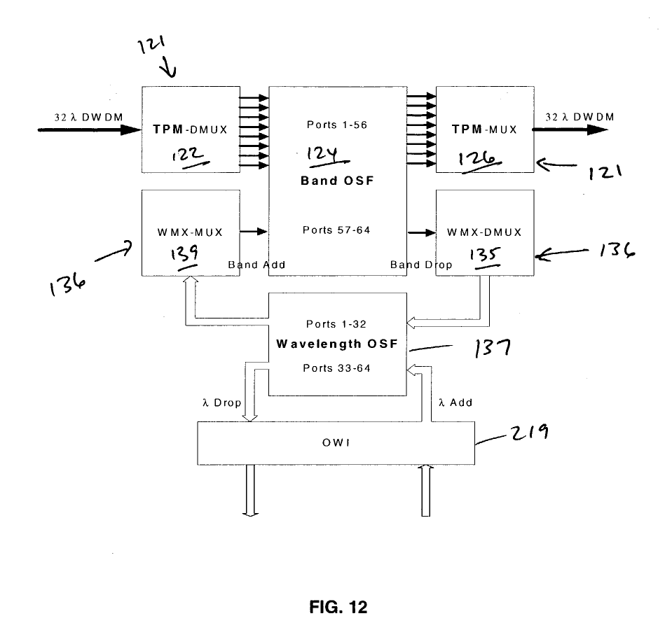

FIG. 12 shows the five major IOS Data Plane functions—Optical Wavelength interface (OWI) 219, Wavelength Optical Switch Fabric 137 (WOSF—also known as λ Switch), Wavelength Mux/demuX (WMX) 135 and 139, Band OSF (BOSF) 124, and TransPort Module (TPM) 121.

The non-redundant TPM Circuit Pack 121 includes an egress and ingress optical amplifier and also a Band Demultiplex 122 in the ingress direction and a Band Multiplex 126 in the egress direction. The ingress OA amplifies the terminated 32-wavelength DWDM signal 120 and drives the Band Demultiplex 122, which delivers eight four-wavelength bands to the Band OSF 124. The ingress Band Multiplex 126 multiplexes eight four-wavelength bands into a 32-channel DWDM signal and delivers that signal to the egress (booster) OA, which is a two stage EDFA. Both the terminating and booster amplifiers are EDFAs to provide the substantial optical signal level gain and overall system noise performance. A key function of the TPM Circuit Pack 121 is band channel power equalization, which equalizes the power levels of the various bands on the optical Data Plane 10. Where required, a Dispersion Compensation Module (DCM) to compensate for optical line chromatic dispersion is connected at the interstage of the egress (booster) amplifier. Up to seven TPM Circuit Packs 121 can be equipped in the TPM Shelf 80 providing IOS 60 terminations for up to seven bidirectional fibers, with ingress and egress signals on separate fibers, with 32 wavelengths (eight bands) per fiber.

The redundant Band OSF 124 Circuit Pack provides a 64×64 optical switch fabric that switches up to 64 bands of wavelengths. Some of these bands are between TPM Circuit Packs 121, providing a band switching point for transit nodes that are intermediate between circuit endpoints. Other bands interface the WMX 136 1×4 and 4×1 demux 135/mux 139, which presents the individual wavelengths to the WOSF 137 for purposes of add/drop, possible wavelength conversion, and occasional reorganization of wavelengths among bands or filling of bands at an intermediate point in the band source/destination circuit. One BOSF 124 is required for optical switch fabric side 0 and one for side 1 in normal operation. These two BOSF 124 Circuit Packs reside in the OSF Shelf 70.

The redundant WOSF Circuit Pack 137 is a 65×65 optical switch fabric (one input and output port is used for circuit testing and verification) that switches up to 64 user wavelengths for purposes of add/drop, possible wavelength conversion, and occasional reorganization of wavelengths among bands or filling of bands at an intermediate point in the band source/destination circuit. In addition, a 65^{th} port 269 that is not available to users exists on its input and output for use by the IOS Optical Test Port 218. One to four WOSF circuit packs 137 are required for each of side 0 and side 1, the exact number depending on the number of required OWI Shelves 70. Up to six WOSF Circuit Packs 137 (0-A, 1-A, 0-B, 1-B, 0-C, 1-C) can reside in the OSF Shelf 70, with two additional WOSF Circuit Pack 137 slots available in a growth bay 64 for configurations requiring more than three OWI Shelves 70.

Both the BOSF 124 and the WOSF 137 are the same OSF 214 Circuit Pack code, with the OSF Shelf 70 slot providing the distinction between BOSF 124 or WOSF 137, side 0 or side 1, and WOSF 137 A-D.0

The WMX Circuit Pack 135 demultiplexes four wavelengths from a single band and multiplexes four wavelengths into a single band. Both the mux 139 and demux 135 paths employ optical amplification (SOAs) to compensate for the additional loss of the WOSF 137 functionality and ensure proper optical signal level and overall system noise performance. A key function of the WMX pack is per wavelength power equalization, which equalizes the levels of the individual wavelengths within a band.

The OWI 219 may be a transponder (OWI-XP) 219A or Transparent (OWI-TR) 219B Circuit Pack. Each OWI-XP 219A interfaces a 1310 nm or 1550 nm intraoffice data link single wavelength signal with an IOS ITU-compliant wavelength for the IOS switching fabric. Each OWI-TR 219B interfaces an IOS ITU-compliant single wavelength intraoffice signal with the IOS optical switching fabric. Because each OWT-XP 219A or OWI-TR 219B Circuit Pack interfaces a single wavelength, they are not redundant. The OWI circuit packs 219 also include wavelength converter OWI-λC circuit packs 140, and all of these OWI circuit packs 219 reside in the Optical Wavelength Interface Shelf 70, which provides 32 slots for any mix of OWI-XPs 219A, OWI-TRs 219B, and OWI-λCs 140.

Overall Data Plane Optical Circuit

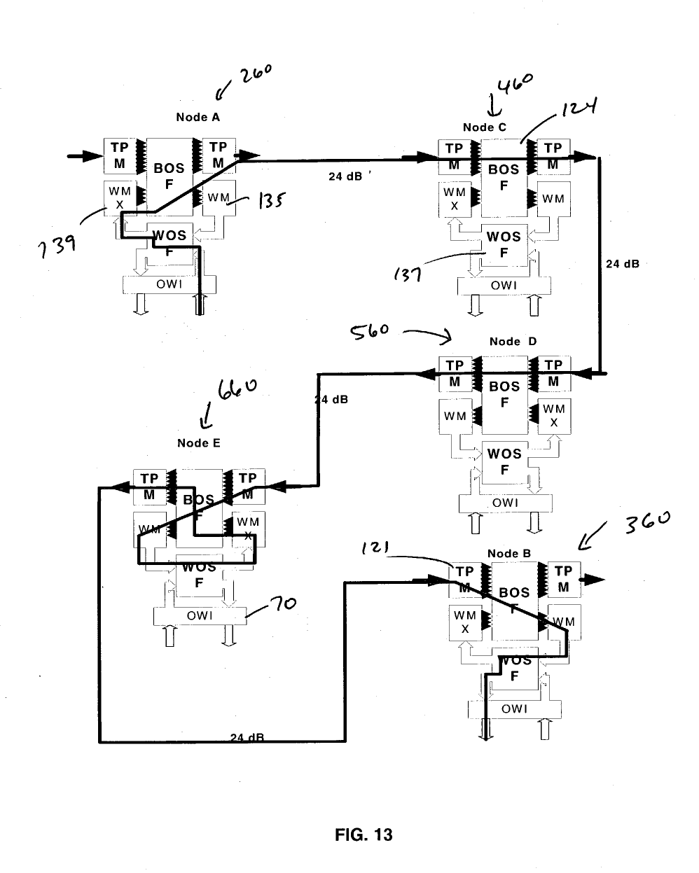

Referring to FIG. 13, the IOS network 310 is designed to transport a 10 Gb/s or 2.5 Gb/s customer signal from Node A 260 to Node B 360 through intermediate nodes, with a maximum error rate of 10 exp (−12) errors per bit. The maximum span loss is 24 dB for reasons of transmit and receive optical power. The DCM provides compromise compensation for chromatic dispersion for various types of fiber and certain special degradations up to a maximum of 1360 ps/nm at wavelength 1544.5 nm. A typical optical circuit with 4 spans is illustrated in FIG. 13, shown with a worst-case loss of 24 dB for each span. The primary IOS engineering rules require not more than one intermediate node with wavelength switching, such as Node E 660 in FIG. 13. In the example of FIG. 13, traffic enters the IOS at the Node A 260 OWI Shelf 70, which converts it to an IOS ITU-compliant wavelength. The wavelength terminates on the WOSF 137 at the port associated with the OWI 70 (within the WOSF port field 33-64). The WOSF switches 137 the wavelength to the appropriate WMX port (within the WOSF port field 1-32).

The wavelength is connected to a specific WMX input 139, amplified, and multiplexed with up to three other wavelengths to form an IOS band with up to 4 wavelengths, equalizing the wavelength channel power on the WMX Circuit Pack. The equalized band terminates on the BOSF 124 at the WMX ports (within the port field 33-64, with 56-64 for WOSF 1). The BOSF 124 routes the band signal to one of the TPMs 121 through the TPM ports (within port field 1-32, with 1-8 associated with TPM 1). The bands are multiplexed to an eight band, 32-wavelength DWDM signal, with the band channel power equalized on the TPM Circuit Pack 121, and sent to the egress optical line.

The DWDM signal goes through a maximum span loss of 24 dB within the inter-node fiber connection before it reaches the adjacent node. At transit nodes, the DWDM signal is amplified, demultiplexed into bands, and band switched to the appropriate TPM 121, where eight bands are multiplexed into a 32-wavelength DWDM signal, power equalized, and sent to the next node.

In nodes C 460 and D 560 of FIG. 13, the wavelength proceeds through only the band switching stage of the IOS Data Plane 10, while the wavelength traverses both the band switching and wavelength switching stages in Node E 660, which therefore has a higher noise degradation than have Node C 460 and D 560.

The example traffic drops at Node B 360, with the associated band traversing the TMP 121 Ingress amplifier and band demultiplex, and the BOSF 124 band switches it to the appropriate WMX 135, at which point the wavelength is further amplified and demultiplexed into a single wavelength, and finally dropped to the appropriate OWI 219 through the WOSF 137.

Fibers and Spans

If required, the dispersion in each fiber span is compensated by a single DCM device, which is connected at the interstage of the TPM Egress Optical Amplifier. The DCM consists of dispersion compensation fiber (DCF) with negative dispersion slope to compensate for a positive dispersion slope of the span fiber. The DCM contributes a maximum insertion loss of 10 dB (including connectors). Typically, the DCF dispersion value is about 80% to 100% value of dispersion in the fiber span, and optimized values have to be determined by numerical simulations.

The maximum fiber loss is 24 dB, including special degradations (e.g. connectors, splices, patch panels, etc.). The translation of the fiber loss into fiber span distance depends on the type of fiber and the nature of the special degradations.

For premium/standard grade single mode fiber (such as SMF-28), the maximum loss is 0.25-0.30 dB/km @ 1550 nm. In addition, the maximum loss difference between 1550 nm and all other wavelengths in the C-band is 0.05 dB/km. In these cases, the maximum span loss over the C-band would be 0.30-0.35 dB/km.

NZ-DSF

The loss specification for NZ-DSF fiber, such as Corning LEAF, is identical to the premium grade SMF-28. Normally, no DCM is required for NZ-DSF.

### Optical Performance

The IOS DWDM transport is optically engineered so that chromatic dispersion is adequately compensated for up to 10 Gb/s. Therefore, the primary limiting factors in this optical transport system are power level and OSNR. A key parameter for the optical circuit is the OSNR at the endpoint (drop) OWI receiver, and the engineering rules are designed to ensure that OSNR is larger than 25 dB with span loss of up to 24 dB.

IOS Node Functional Blocks

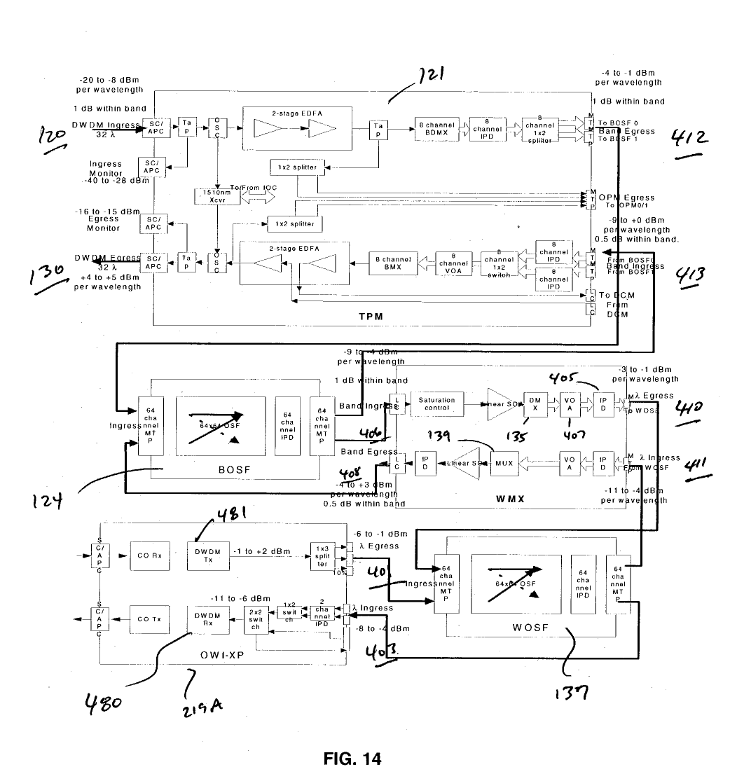

To satisfy the optical system requirements, the functional blocks of an IOS 60 node are shown in FIG. 14.

FIG. 14 (with further reference to FIGS. 4, 5 and 12) shows that DWDM Ingress 120 and Egress 130 signals have 3 alternative paths within the IOS 60 node: an entirely band switching path, a wavelength switching path, and an add/drop path, as follows: (1) Band switching path: TPM Band Demux 122, BOSF 124, and TPM Band Mux 126; (2) Wavelength switching path: TPM Band Demux 122, BOSF 124, WMX Demux 135, WOSF 137, WMX Mux 139, BOSF 124, and TPM Band Mux 126; (3) Drop path: TPM Band Demux 122, BOSF 124, WMX Demux 135, WOSF 137, OWI Rx 480; and (4) Add Path: OWI Tx 481, WOSF 137, WMX Mux 139, BOSF 124, and TPM Band Mux 126.

The Wavelength Conversion path is same as the add/drop path in terms of optical performance. Each path as its own distinct optical characteristics, and must be considered separately.

Additionally, signals from different paths are combined in WMX 136 and TPM 121 Circuit Packs at the individual wavelength and band levels, and the equalization functionality on those circuit packs brings them to the lowest level from all paths to equalize them.

Optical Wavelength Interface-XP Circuit Packs

The optical power level for a wavelength at the OWI-λ-Egress point 401 at the bottom left of FIG. 14 is between −6 dBm and −1 dBm, accounting for the insertion losses between the OWI transmitter (Tx 481 on the OWI XP block) and the OWI-λ-Egress point 401. This requires that the optical power generated by the OWI transmitter 481 is between −1 dBm and +2 dBm.

The optical power level at the OWI-λ-Ingress point 403 at the bottom left of FIG. 14 is −8 dBm to −4 dBm, and the optical power level at the OWI receiver 480 (Rx on the OWI XP block) are −11 dBm to −6 dBm.

Other OWI Circuit Pack 219 system functions include Head End Bridge/Tail End Split and interconnection with the OTP 218.

Key OWI-2.5G optical specifications are: (i) 100 GHz ITU-compliant DWDM Tx; (ii) Tx power: min: −1 dBm, max: +2 dBm; (iii) Tx Extinction ratio: >8.2 dB; (iv) Tx chirp factor: <2; (v) Rise/fall time: <135 ps; (vi) Tx RIN: <−140 dB/Hz; (vii) Tx dispersion: >1600 ps/nm for 1 dB penalty; (viii) Rx sensitivity: min −14 dBm; (ix) OSNR for Rx for 10 exp (−12) errors/bit: 19 dB; (x) Rx overload: >0 dBm; (xi) 1×3 10%/45%/45% splitter: <10 dB loss at 10% port, <4 dB loss at 45% ports; (xii) 2×2 switch: <1 dB loss; and (xiii) 1×2 switch: <0.5 dB loss.

Key OWI-10G optical specifications are: (i) 100 GHz ITU-compliant DWDM Tx; (ii) Tx power: min: −1 dBm, max: +2 dBm; (iii) Tx Extinction ratio: >10 dB; (iv) Tx chirp factor: <0.5; (v) Rise/fall time: <35 ps; (vi) Tx RIN: <−140 dB/Hz; (vii) Tx dispersion: >1600 ps/nm for 1 dB penalty; (viii) Rx sensitivity: min −14 dBm; (ix) OSNR for Rx for 10 exp (−12) errors/bit: 22 dB; (x) Rx overload: >−1 dBm; (xi) 1×3 10%/45%/45% splitter: <10 dB loss at 10% port, <4 dB loss at 45% ports; (xii) 2×2 switch: <1 dB loss; and (xiii) 1×2 switch: <0.5 dB loss.

BOSF/WOSF Circuit Packs

OSF packs 214 64×64 optical switches. In addition, the WOSF 137 requires an extra (65^{th}) I/O port 269 for use by the OTP 218. Since the same circuit pack code is used for both the BOSF and the WOSF 137, the maintenance port is used only when the circuit pack is in a WOSF slot in the OSF shelf 110. This OTP 218 maintenance port must have the same insertion loss as the other ports. In this circuit pack, integrated photodiodes (IPD) 405 are placed at the egress side of OSF only.

This circuit pack should have insertion losses among all the ports between 3.0 dB and 5.0 dB. It is desirable to store the insertion loss information for each path in the circuit pack EEPROM.

Key BOSF/WOSF optical specifications are: (i) OSF loss at C-band: between 1.8 and 3 dB for all paths; (ii) PDL: <0.1 dB; (iii) Isolation: >50 dB; (iv) PMD: <0.5 ps; (v) Reflection: >27 dB; and (vi) Switching time: <10 ms.

WMX Circuit Pack

At the Band Ingress 406 of the WMX pack 136 (demultiplex 135 path), the optical power levels are −9 dBm and −5 dBm per channel, and the power equalization within the band is 1 dB. The single channel IPD 405 and VOA 407 ensure that the SOA is operated entirely in the linear range. The four channel VOAs 407 and IPDs 405 serve (1) as dynamic wavelength channel power control to equalize the optical power among the wavelengths at the λ Egress 410 and (2) to ensure that the optical powers at the λ Egress 410 are −3 dBm to −1 dBm.

At the λ Ingress 411 of the WMX pack 136 (multiplex 139 path), the optical power level is −11 dBm and −4 dBm for the signals from the OWI 219 and wavelength path from WMX-λ-Egress 410. The VOA 407 and IPD 417 of the mux path serve (1) as a dynamic wavelength channel power control to equalize the power level among the wavelengths at the Band Egress 408 and (2) to ensure that the SOA is operated entirely in the linear range and the optical power level at the Band Egress 408 is −4 dBm to +3 dBm.

Key WMX Circuit Pack optical specifications are: (A) LSOA: (i) Total input level: −13 dbBm to −3 dBm per wavelength; (ii) Total output level: up to +10 dBm; (iii) Linear gain: 13 dB; (iv) NF: <8.0 dB; and (v) Gain flatness: <1 dB; (B) Mux loss <2.8 dB; (C) Demux: (i) Loss <2.8 dB; and (ii) Isolation >30 dB; (D) VOA insertion loss <1.0 dB; and (E) VOA Dynamic range: >20 dB.

TPM Circuit Pack

At the DWDM Ingress of the TPM Circuit Pack 121 (demux 122 path), the optical power levels are between −20 dBm and −8 dBm per wavelength, and power equalization for individual wavelengths within a band is 1 dB. The EDFA control ensures that the optical power levels at the band Egress 412 are between −4 dBm and −1 dBm. This guarantees that the WMX demux LSOA is operated in the linear region without significant degradation of weaker signals.

At the Band Ingress 413 of the TPM Circuit Pack 121 (mux 126 path), the optical power levels are between −9 dBm and +0 dBm per wavelength for the signals coming from a WMX Circuit Pack 136. The optical power levels for the signals of the band-switching path are controlled within this range. Power equalization for individual wavelengths within a band is (1) 0.5 dB from the WMX and (2) 1 dB from TPM-Band-Egress. A dynamic band equalizer (not shown in the figure) ensures that the optical power level is +4 dBm to +5 dBm per wavelength at the DWDM Egress 130. The TPM Circuit Pack 121 must be aware of the number of wavelengths lit in each band in order to operate the dynamic equalizer properly.

Key optical TPM specifications are: (A) Ingress EDFA: (i) Total input level −22 dBm to −10 dBm per channel; (ii) Total output level up to +22 dBm; (iii) NF <6.0 dB; (iv) Gain flatness <1 dB; and (v) No interstage required; (B) Egress EDFA: (i) Input level −5 dBm to −15 dBm per channel; (ii) Output level up to +21 dBm; (iii) NF: <6.0 dB; (iv) Gain flatness: <1 dB; and (v) Inter-stage loss for DCM −0 dB to 10 dB; (C) Band Mux loss <4 dB; (D) Band Demux: (i) Loss <4 dB; and (ii) Isolation >30 dB; (E) VOA: (i) Insertion loss <1 dB; and (ii) Dynamic range >20 dB.

Transient Control, Power Equalization, and Crosstalk

Transient control is the time domain control of average power of a band or of a wavelength. It could be thought of as the initial, fast phase of the optical power equalization of the band or the wavelength. This type of transient control is accomplished by an EDFA transient control loop, and the power equalization described below should be disabled during this period, typically less than 100 ms.

IOS 60 requires two levels of channel power equalization controls—band level and wavelength level. The required VOA 407 dynamic range is not more than 20 dB.

The TPM 121 mux path should have band channel power equalization so that the band channel power is controlled to within 1 dB at the TPM DWDM Egress 130. This capability is realized with a dynamic channel balance scheme. In addition, the TPM Circuit Pack 121 must know how many wavelengths in each band to establish a set point. Manufacturing calibration cancels out the measurement error from this dynamic channel balance.

Other channel power variations, caused by EDFA gain tilt as well as gain flatness variation with temperature and input power level, are balanced by this dynamic power balance scheme. The equalization range is determined by the repeatability of the calibration measurements. The TPM demux path requires band channel power equalization within I dB.

The mux path 139 of WMX should have band channel power equalization so that the wavelength channel power is controlled to within 0.5 dB at the band egress. The capability is realized with a dynamic channel balance scheme. Manufacturing calibration cancels out the measurement error from this dynamic channel balance. Other channel power variations in the mux path, caused by linear SOA tilt as well as gain flatness variation with temperature and input power level, are well controlled over 400 GHz bandwidth. The equalization range is determined by the repeatability of the calibration measurements.

Isolation in the demux is critical to cross-talk for a combined DWDM Transport and switching system, and 30 dB isolation is specified.

Fast Optical Power Monitoring and LOS

Each circuit pack provides optical power monitoring points to monitor LOS at the inputs and at the outputs except for the BOSF/WOSF, which provides optical power monitoring points at the outputs only. The IOCs 210 that scan and read these power-monitoring points provide a cycle time of less than 2 ms. The accuracy of these measurements is ±0.5 dB.

The LOS threshold power level is a dynamically set by the OCP 20. In this mode, a safe margin is set aside to prevent false alarms when the OSF 214 cross-connect configurations of are changed.

In alternative embodiments, an optical power level “learning” mode is desirable for setting LOS power level thresholds so that threshold alerts could be provided before a LOS alarm condition is declared. For such a future capability, a 3 dB change of any power levels at any monitoring point would be reported to OCP 20.

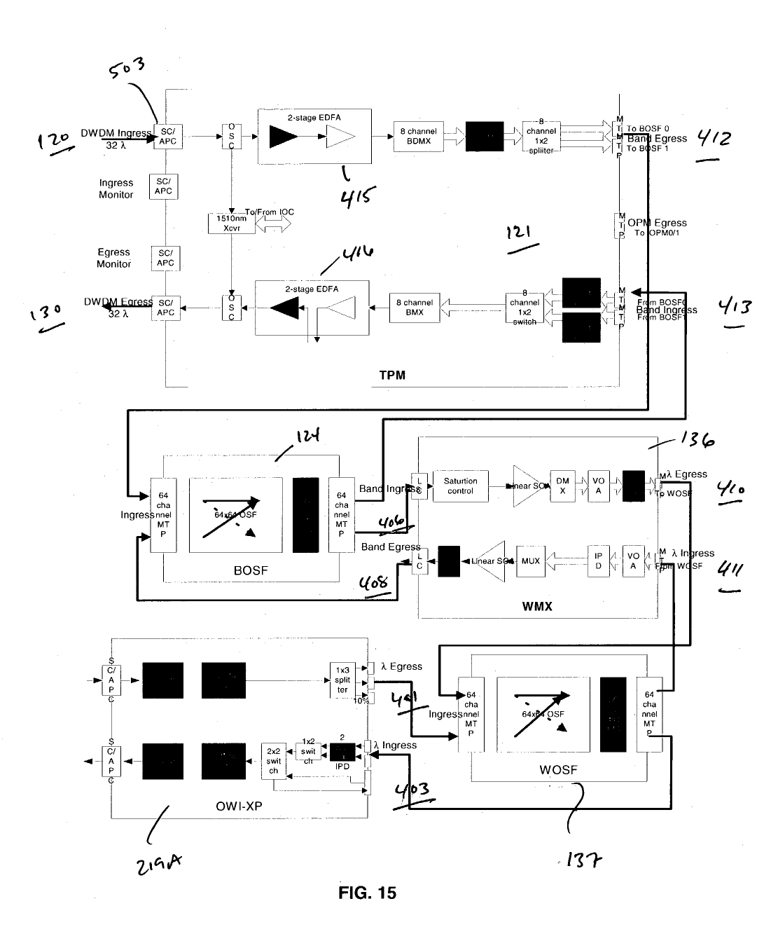

Referring to FIG. 15, the locations of these fast power monitors, many of which are also used by TPM 121 as part of dynamic equalizers are shown. In the figure, amplifiers are also highlighted, indicating the TPM Ingress amplifier 415 has an input power monitor and the TPM Egress amplifier 416 has an output power monitor. All Tx and Rx in OWI-XP 219A, OWI-TR 219B, and OWI-λ C 140 packs have built-in power monitors.

The optical power level in the fiber is sufficiently low that the OSNR penalty is less than 0.1 dB from fiber non-linear effects.

The back reflection OSNR penalty is less than 0.1 dB.

The TPM Ingress EDFA tolerates up to 9 dB OSNR ASE at signal optical power levels from −22 dBm to −8 dBm per wavelength.

The total dispersion penalty for 4 spans totaling 320 km is less than 2 dB in terms of OSNR, including both chromatic and polarization dispersions.

The total node distortion penalty for signals going through 5 nodes is less than 3 dB in terms of OSNR, including Tx, Rx, EDFAs, Linear SOAs, and other passive components.

The total node cross talk penalty for signals traversing 5 nodes is less than 2 dB in terms of OSNR, including Linear SOAs, and other passive components (mux and demux).

Isolation of band and λdemux is >30 dB.

The absolute power level per wavelength at the TPM DWDM Egress 130 is between +4 and +5 dBm, given the absolute power level per wavelength at the TPM Band Ingress 120 is between −9 and 0 dBm.

Power equalization between wavelengths in the TPM DWDM Egress 130 is less than ±0.5 dB, given the condition that the wavelengths are equalized less than ±0.25 dB at the input of the band mux.

The absolute power level per wavelength at the TPM Band Egress 130 is between −4 and −1 dBm, given the condition that the absolute power level per wavelength at the TPM DWDM Ingress 120 is between −20 and −8 dBm.

Power equalization for wavelengths within a band at the TPM Band Egress 130 is less than 1 dB.

The absolute power level per wavelength at the WMX Band Egress 408 is between −4 and +3 dBm, given the condition that the absolute power level per wavelength at the WMX λ Ingress 411 is between −11 and −4 dBm.

Power equalization for wavelengths within a band at the WMX band Egress 408 is less than ±0.25 dB.

The absolute power level per wavelength at the WMX λ Egress 410 is between −3 dBm and −1 dBm, given the condition that the absolute power level per wavelength at the WMX Band Ingress 406 is between −9 and −4 dBm.

Power equalization for wavelengths within a band at the WMX λ Ingress 411 is less than 1 dB.

The optical power level for the wavelength at the OWI-XP λ Egress 401 is between −6 dBm and 1 dBm.

The optical power level for the wavelength at OWI-XP λ Ingress 403 is between −8 dBm and −4 dBm.

The attenuation of OSF packs 214 is between 3 dB and 5 dB.

The TPM ingress/egress power level monitors are 18 dB to 22 dB down from the DWDM ingress/egress power levels.

### Data Plane Functionality

The IOS Data Plane functionality is set forth in an embodiment of the present invention as follows.

OWT-XP (Transponder Circuit Packs)

Optical Transceivers provide the Optical Wavelength Interface-Transpondel (OWI-XP) 219A function in the IOS System. The OWI-XP Circuit Pack 219A incorporates a tandem transceiver design to interface standard single wavelength 1310 nm and 1550 nm optical data link signals and the IOS Optical Switch Fabric 214. All OWI-XP Circuit Packs provide a 3R termination function for the optical data link.

This section provides the development specifications for OWI-XP circuit packs 219A. Other OWI circuit packs 219, OWI-TR 219B and OWI-λC 140 Circuit Packs, are physically compatible and electrically and optically pin-for-pin compatible, and these circuit packs can reside in the same OWI Shelf 70 slots as the OWI-XP 219A.

(a) OWI Shelf

Each OWI Shelf 70 supports up to thirty-two OWI circuit packs 219 with any mix of OWI-XP, OWI-TR, and OWI-λC Circuit Packs. Each OWI circuit pack 219 is controlled and monitored by the redundant OWI Controller (OWC) Circuit Packs 220 via serial interfaces. Each OWC Circuit Pack 220 communicates to the redundant SNM circuit packs 205 via duplicated 100 BaseT Ethernet Switches. FIG. 16 shows the OWI shelf 70 functional overview.

(b) 2.5 Gb/s OWI-XP Circuit Pack

Referring to FIG. 17, the 2.5 Gb/s OWI-XP Circuit Pack 219A interfaces either a SONET/POS 2.488 Gb/s or FEC 2.667 Gb/s optical data link signal with an IOS C-band ITU Grid wavelength for the Optical Switch Fabric 214 in both directions of transmission. Transponder operation only cares about the data rate and not the data format. This OWI-XP/OSF interface is redundant, with the OWI-XP 219A connected to both the in-service and out-of service optical switch fabrics for both transmission directions.

IOS OCP 20 software configures the 2.5 Gb/s OWI-XP Circuit Pack 219A for the 2.488 Gb/s (SONET) or 2.667 Gb/s (FEC) data rates, selecting the local crystal oscillator used for CDR functions. OCP 20 software also configures the OWI-XP 219A to provide a local loopback (Hairpin) 242 function for both the Central Office interface side and OSF interface side of the OWI-XP. OCP 20 Software can also configure a pair of OWI-XP Circuit Packs 219A to implement a Head End Bridge of the ingress optical signal or a Tail End Switch of the egress signal. These HEB and TES functions are available for 1+1 circuit configurations implemented by the IOS at the circuit head end and tail end. The two hairpins are independent of each other and the hairpins are each independent of the HEB/TES configuration. This means CO loopback testing does not interfere with network loopback testing, and either or both hairpins are available for testing all OWI-XP circuit configurations, including 1+1. An alternative HEB/TES configuration may be implemented with two wye cables that join ingress sides and egress sides of a pair of transponders.

On the 2.5 Gb/s OWI-XP 219A, both CO 419 and OSF 420 transceivers have an optical power monitor, and they report a loss of signal condition to the in-service OWC 220. The circuit pack also reports other alarms and abnormal conditions to the IOC 60, such as power alarms and Laser Temperature Alarms. The in-service OWC 220 can also block the transmitter optical output signals. The OWI Controller FPGA 279 provides OWI-XP 219A control and monitor functions, and the interface between the OWIs 219 and the redundant OWC Circuit Packs 220 is via redundant serial links.

(c) 10 Gb/s OWI-XP Circuit Pack

Referring to FIG. 18, the 10 Gb/s OWI-XP Circuit Pack 219A interfaces a SONET/POS 9.953 Gb/s, 10.3 GbE, or 10.709 Gb/s OTN optical data link signal with an IOS C-band ITU Grid wavelength for the Optical Switch Fabric in both directions of transmission. Transponder operation cares only about the data rate, not the data format. This OWI-XP/OSF interface is redundant, with the OWI-XP 219A connected to both the in-service and out-of service optical switch fabrics for both transmission directions.

As with the 2.5 Gb/s OWI-XP, IOS OCP 20 software configures the 10 Gb/s OWI-XP Circuit Pack 219A for one of the various clock rates used for 10 Gb/s optical data links. The 10 Gb/s OWI-XP incorporates three reference clocks generated by three crystal oscillators. The PLL selects one of the reference clocks (data rate selection) and provides multiple copies of reference clock outputs that meet the jitter required by the transponders. As with the 2.5 Gb/s OWI-XP 219A, OCP 20 software also configures the 10 GB/s OWI-XP 219A to provide a local loopback (Hairpin) 242 function for both the Central Office interface side and OSF 220 interface side of the OWI-XP. OCP 20 Software can also configure a pair of OWI-XP Circuit Packs 219A to implement a Head End Bridge of the ingress optical signal or a Tail End Switch for the egress optical signal. These HEB and TES functions are available for 1+1 circuit configurations implemented by the IOS at the circuit head end and tail end. The two hairpins are independent of each other and the hairpins are independent of the HEB/TES configuration. This means CO loopback testing does not interfere with network loopback testing, and either or both hairpins are available for all OWI-XP circuit configurations, including 1+1. An alternative HEB/TES configuration may be implemented with two wye cables that join ingress sides and egress sides of a pair of transponders.

On the 10 Gb/s OWI-XP 219A, both CO 419 and OSF 420 transceivers have an optical power monitor and they report a loss of signal condition to the in-service OWC 220. The circuit pack also reports other alarms and abnormal conditions to the IOC 60, such as power alarms and Laser Temperature Alarms. The in-service OWC 220 can also block the transmitter optical output signals. The OWI Controller FPGA 279 provides OWI-XP control and monitor functions, and the interface between the OWIs 219 and the redundant OWC 220 Circuit Packs is via redundant serial links. FIG. 18 provides a functional view of the 10 Gb/s OCWI-XP Circuit Pack 219A.

(d) 2.5 Gb/s and 10 Gb/s OWI-XP Optical Specifications

The OWI-XP circuit packs provide the optical interface to the optical data link signals, meeting the following specifications set forth in Table 10.

TABLE 10

| Intra-Office | | | Wave- | Max | | |
|---|---|---|---|---|---|---|
| signal type | | Reach | length | distance | | Specification |
| 2.5 | Gb/s SR | SR | 1310 nm | 2 | km | GR-253, ITU-T |
| | | | | | | G.691 |
| 2.5 | Gb/s IR-1 | IR | 1310 nm | 15 | km | GR-253, ITU-T |
| | | | | | | G.691 |
| 2.5 | Gb/s IR-2 | IR | 1550 nm | 15 | km | GR-253, ITU-T |
| | | | | | | G.691 |
| 10 | Gb/s SR-1 | SR | 1310 nm | 2 | km | GR-253, ITU-T |
| | | | | | | G.691 |
| 10 | Gb/s IR-2 | IR | 1550 nm | 40 | km | GR-253, ITU-T |
| | | | | | | G.691 |
| 10 | Gb/s VSR-2 | VSR | 1310 nm | 600 | m | OIF-VSR4-2.0, |
| | | | | | | ITU-T G.691 |

The OWI-XP circuit packs provide the interface to the ITU-compliant OSF signals indicated in Table 11.

TABLE 11

| | Min | | Typical | Max | |
|---|---|---|---|---|---|
| 2.5 Gb/s: | | | | | |
| Rx Sensitivity* | −18 | dBm | −20 dBm | | |
| Rx Overload | 0 | dBm | | | |
| Tx Power | −1 | dBm | 0 dBm | +1 | dBm |
| Extinction Ratio | 8.2 | dB | | | |
| Optical Rise/Fall | | | | 135 | ps |
| 10 Gb/s: | | | | | |
| Rx Sensitivity* | −14 | dBm | −16 dBm | | |
| Rx Overload | 0 | dBm | | | |
| Tx Power | −1 | dBm | 0 dBm | +1 | dBm |
| Extinction Ratio | 10.0 | dB | | | |
| Optical Rise/Fall | | | | 35 | ps |

*Receiver sensitivity is measured at BER = 1E−12 using the optical signal input with OSNR = 22 dB for 10 Gb/s and 19 dB for the 2.5 Gb/s.

(e) OWI-XP Hairpin Implementation

The hairpin (loop back) 224 function is electrically implemented.

(f) OWI-XP HEB and TES Implementation

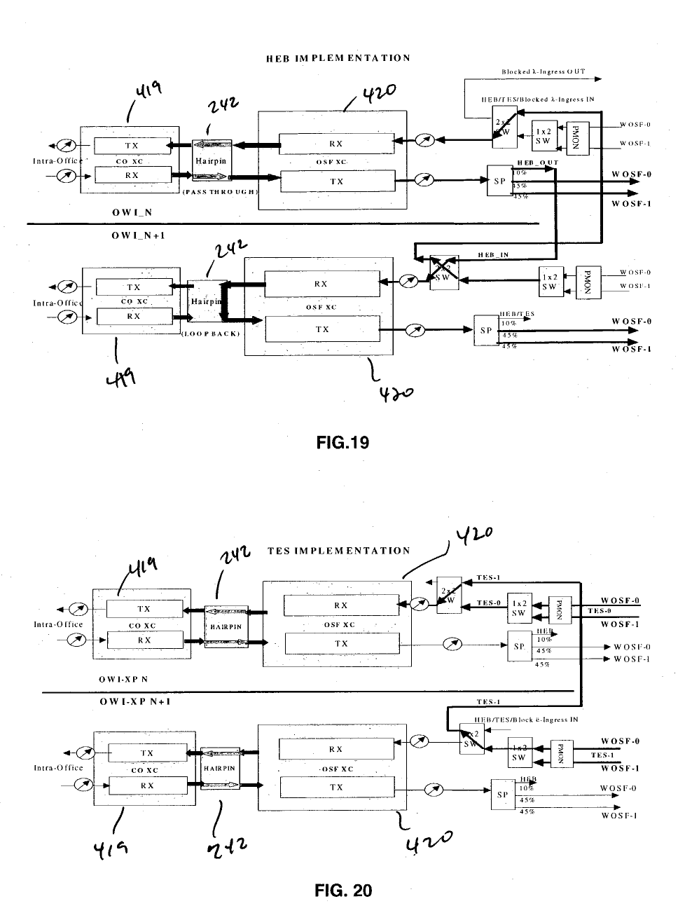

HEB and TES functions are optically implemented using a pair of OWI-XP circuit packs. FIG. 19 (HEB) and FIG. 20 (TES) show the implementation. An alternative HEB/TES configuration may be implemented with two wye cables that join ingress sides and egress sides of a pair of transponders.

(g) Connectors

The faceplate connectors are SC/UPC type, labeled TX and RX, for the CO side optical interface.

(h) Signal LEDs

Green/yellow bicolor LEDs are associated with the TX and RX terminations, indicating Optical Power level in range (green) or out of range (yellow). The thresholds for the in-range and out-of-range condition are determined by the CO transceiver 419.

(i) Circuit Pack Status LEDs

The OWI-XP has the red ALARM LED and green ACTIVE LED that are standard for non-redundant IOS circuit packs.

TPM: DWDM and Band Mux/Demux

The TPM Circuit Pack 121 provides the optical interface for DWDM optical transport as well as band multiplexing and demultiplexing. The TPM circuit pack 121 is comprised of the six basic functions listed below.

(a) TPM Circuit Pack Functions & Features

1. DWDM Input Signal Amplification: (i) Provides gain (with low NF) for a low power optical input signal; (ii) Maintains low tilt, gain flatness and transient response; (iii) Maintains a nominal per channel output power from the amplifier; and (iv) Provides for DWDM signal monitoring via front panel and dual OPMs.

2. DWDM Input Signal Band Demux: (i) Demultiplex the DWDM signal into bands; (ii) Provides band input power detection & band LOS; and (iii) Divides each band for dual BOSF support.

3. Band Mux to DWDM Output Signal: (i)—Accepts band signals from each dual BOSF; (ii) -Provides band output power detection & LOS; and (iii)—Provides protection switching capability between dual BOSFs.

4. DWDM Output Signal Amplification: (i)—Provides gain to supply a high power optical signal for transport; (ii)—Provides for Dispersion Compensation; (iii)—Maintains low tilt, gain flatness and transient response; (iv)—Maintains a nominal per channel output power from the amplifier; and (v)—Provides for DWDM signal monitoring via front panel and dual OPMs.

5. Band Equalization Capability: (i)—Provides for band optical power output signal detection; and (ii)—Maintains equal band optical power (dependent on occupied in band channels).

6. Optical control channel capability: (i)—Provides for in network supervisory communication; and (ii)—Out-of-Band 1510 nm Optical Control Channel.

(b) TPM Optical Features

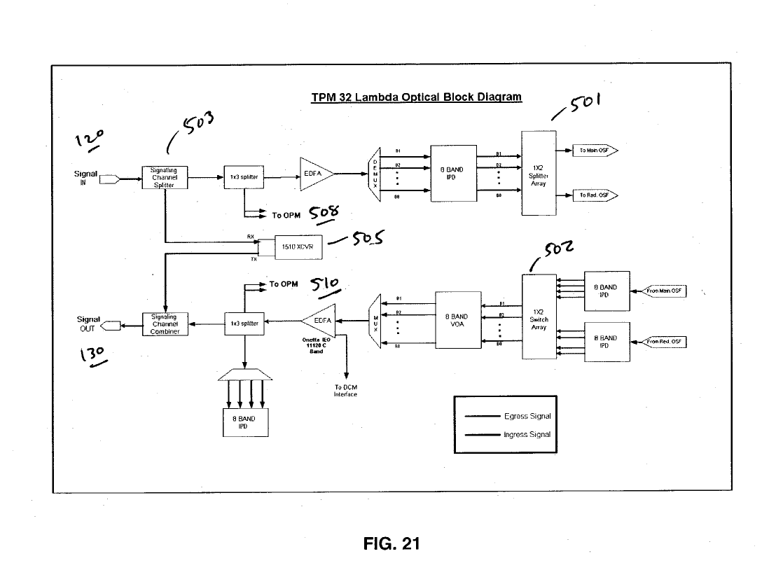

FIG. 21 is a functional optical diagram of the TPM Circuit pack 122.

(c) Optical Amplifier Module

The Optical Amplifier modules included in the circuit pack function as independent units and provide the following features and alarms: (i) Transient control; (ii) ASE control; (iii) Tilt control; (iv) Input signal monitoring detector; (v) Mid stage access for Dispersion Compensation Module (egress amplifier 416 only); and (vi) Support for up to 32 channels (8 Bands).

(d) IOC Amplifier Module Control

The IOC 210 has the ability to increase and decrease the Amplifier module output power.

(e) ASE Control

The TPM IOC 210 controls the TPM set points as a function of the number of lit wavelengths in a band and reduces the required dynamic range of the amplifier. In the event that all bands associated with an amplifier module are at Loss of Signal condition (LOS), the IOC can decrease the output to a pre-defined power level.

(f) Transient Laser Power Adjustment

In the event that any signal is added or dropped the amplifier module is adjusted to maintain the same power levels for the remaining bands.

(g) Equalization Control Loop

The TPM circuit pack 121 contains a band equalization control loop, which is located in the egress portion of the circuit pack. It involves the use of the egress amplifier module 416, a VOA 407 array, an 8 band MUX & DEMUX and a photo diode array.

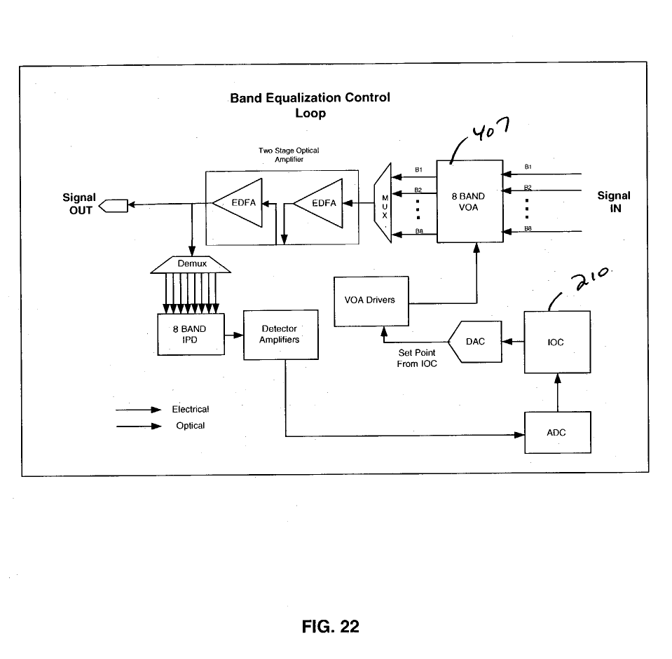

Referring to FIG. 22, this loop uses the output signal levels of each band to control the attenuation of band VOAs 407. The attenuation is adjusted via feedback from the photo diode array to equalize the band levels at the output of the circuit pack. The [OC 210 determines the set point of the VOA 407 control loop. The gain of each band control loop is factory calibrated to provide a minimum inter-band equalization error. These loop gains are determined during factory testing of the TPM circuit pack.

(h) OSF Selection

With continuing reference to FIGS. 21 and 22 the TPM circuit pack ingress portion 120 transmits to both sides of the redundant optical switching fabric via (50/50) 1×2 splitters 501. On the TPM egress portion 130, an array of 1×2 optical switches 502 provides the means to select signals from either optical switching fabric. In all cases, the TPM IOC 210 determines which optical switch fabric is selected.

(i) Optical Control Channel

The Optical Control Channel (OCC) utilizes the TPM 1510 nm Transceiver 505. On the TPM ingress portion 120, a filter separates the OCC from the DWDM data channels; on the TPM egress portion 130, a filter adds the OCC to the data channels.

In the event of transmitter failure, receiver failure, or loss of OCC signal, the transceiver sends an alarm to the TPM 121 IOC 210.

(j) DCM Interface

In the event dispersion compensation is required, the TPM Circuit Pack 121 provides for insertion of a Dispersion Compensation Module in the mid stage of the egress amplifier. If dispersion compensation is not required, a fiber jumper (with fixed loss) is used at the TPM Shelf backplane DCM interface instead of a DCM to complete the mid stage access connection.

(k) Optical Signal Power Monitoring

The TPM circuit pack 121 provides multiple optical signal power monitoring points.

(I) Face Plate Signal Termination and Monitor Connectors

The TPM 121 provides optical transmit and receive monitor points that are located on the circuit pack faceplate. The transmit and receive monitor access points are just before and after, respectively, the egress and ingress signal termination SC/UPC connectors 503. The signals are routed through taps and splitters to the faceplate Transmit Monitor and Receive Monitor SC/UPC connectors 503, and the signal levels are 20 dB down from the signal levels at the transmit and receive termination points, respectively. The designations on the monitor connectors are “Tₓ−20 dB” and “Rₓ−20 dB”, respectively.

Because the monitor access is at the line terminations, all 32 DWDM channels and the OCC are available for external OSA measurement using the Monitor connectors.

(m) OPM Monitoring

The TPM circuit pack 121 provides for an ingress and egress access point for each of two Optical Performance Monitors (OPMs) 216. The ingress OPM monitoring point 508 is at output of the ingress amplifier module 415 (an access point at the input of the ingress amplifier also is part of the OPM measurement due to the referencing of the measurement to the transmission level at the RX input.). The egress OPM monitoring point 510 is at the output of the egress optical amplifier 416. These four signals are routed to the optical backplane via splitters and transmitted to the Control Shelf via dedicated fiber.

(n) Output Variation

The variation in the TPM circuit pack 121 output optical signal is less than ±0.5 db

(o) Electrical Features

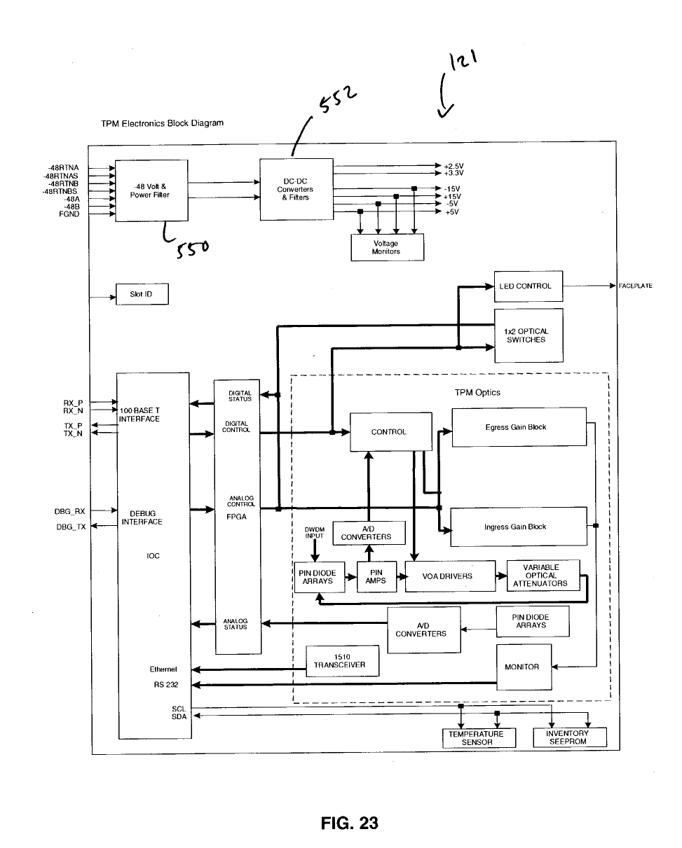

Referring to FIG. 23, the TPM circuit pack 121 supports intelligent electrical features such as soft start, under voltage detection, and redundant −48V supplies.

DC Voltage

The TPM Circuit Pack 121 provides dual (A & B) −48 volt input power distributions from the backplane as shown in the electrical block diagram. In the event an A or B power distribution fails, the circuit pack automatically switches to the other distribution without affecting service or operations of the circuit pack. The −48V filter 550 is the primary interface for delivering power to the circuit pack, providing coarse filtering and protection for the TPM DC-DC converters 552 it drives. The DC-DC power converters 552 are on the TPM parent board, and they convert the −48 volts to the required low voltages.

(a) Soft Start

The TPM Circuit Pack 121 has a negative voltage hot swap controller for preventing inrush current upon circuit pack insertion.

(b) Intelligent Optical Controller

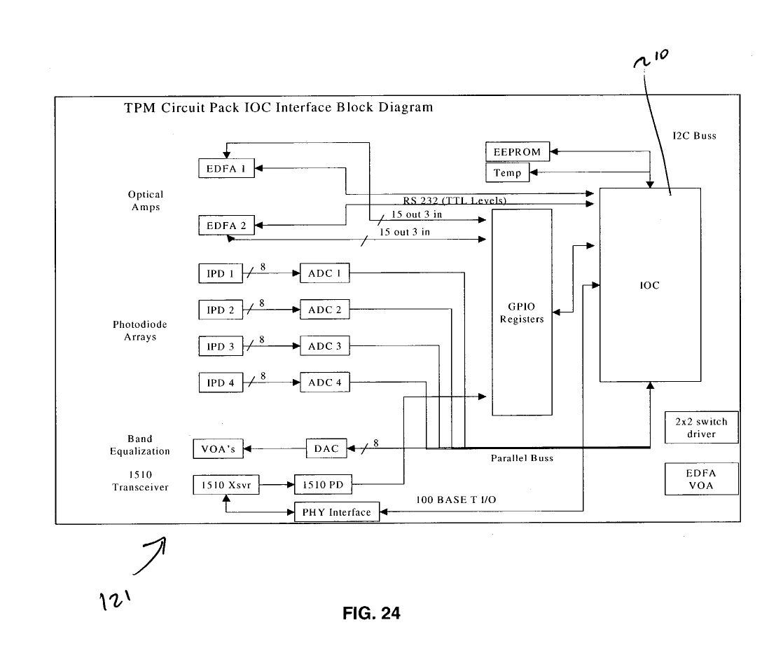

The TPM Circuit Pack 121 contains an IOC 210 that performs all control and monitoring of the TPM Circuit Pack 121. The IOC also provides all the communication between the TPM 121 and System Node Manager 205. FIG. 24 shows the communication paths to and from the IOC 210.

(c) Circuit Pack Status LEDs

The TPM Circuit Pack 121 contains the standard IOS non-redundant circuit pack status LEDσ on the faceplate: (i) ACTIVE (green); and (ii) ALARM (red).

Redundant Optical Switch Fabric

(a) OSF Shelf

The Optical Switch Fabric (OSF) Circuit Pack 214 is a common circuit pack code that performs the band switching (BOSF) 124 and individual wavelength switching (WOSF) 137 functions. Band switching 124 and individual switching 137 are implemented using individual 65×65 non-blocking optical space division switch fabrics. Of these, 64 input and output ports are used for data wavelengths. An additional input and output switch port (the 65^{th} port) 269 of the WOSF 137 is a test port used by the IOS Optical Test Port module (OTP) 218. Both the BOSF 124 and WOSF 137 Circuit Packs are redundant to support high IOS 60 availability. The 4-channel Wavelength Mux 139/Demux 135 (WMX) packs that provide the interface between the band OSF 124 and wavelength OSF 137 are also redundant.

Each BOSF circuit pack 124 provides band switching for 64 bands. The number of bands associated with integrated DWDM terminations plus the number of bands associated with individual wavelength switching must sum to 64. The BOSF 124 IOC 210 controls and monitors the BOSF Circuit Pack 124.

Each WOSF circuit pack 137 provides a 65×65 wavelength switch that interfaces wavelengths from the BOSF 124 via the WMXs 136 with an OWI Shelf 70. The WOSF IOC 210 controls and monitors the WOSF 137 and, in addition, controls and monitors eight WMX circuit packs 136 via 8 bidirectional serial links.

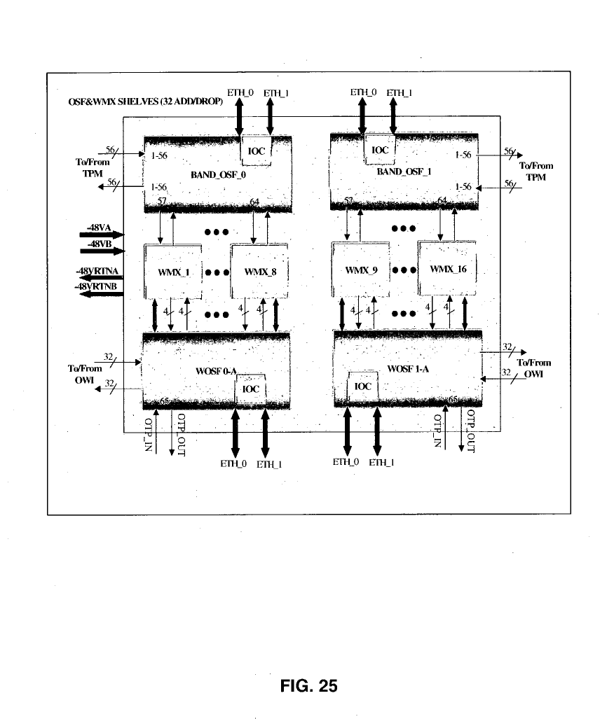

FIG. 25 is an overview of the IOS redundant Optical Switch Fabric & WMX shelf interconnections.

(b) OSF Circuit Pack

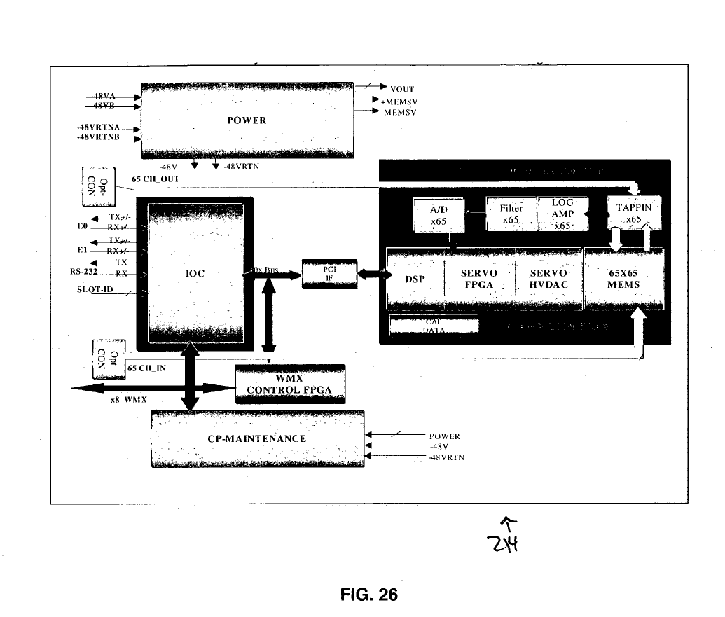

The OSF circuit pack 214 (FIG. 26) provides a 65×65 non-blocking optical switch fabric for the IOS system. The 65^{th} port 269 is reserved as a test port used by the OTP module 218. The OSF Circuit Pack 214 code is a common code used for both the BOSF 124 and the WOSF 137 functions.

The 65 OSF output optical signals are tapped and monitored by the OSF 214 IOC 210. A loss of signal condition on any output port is detected and reported to the SNM 205 via the OSF 214 IOC 210. The OSF 214 IOC 210 controls the 65×65 optical switch module directly, using a PCI protocol across the interface to a DSP device that is within the Switch Module.

The OSF 214 IOC 210 communicates to the redundant SNM 205 via a duplicated 100BaseT Ethernet.

Redundant −48V A and B power distributions are delivered to a filtering, monitoring, and power selection function that reacts to loss of the A or B distribution by automatically selecting all power the other distribution without loss of service or operations. Power alarms are monitored directly by the OSF IOC 210. Power converters are provided on the OSF 214 to derive the high voltage required for the switching device as well as the low voltages required for the control circuitry.

(c) Circuit Pack Status LEDS

The OSF Circuit Pack 214 Supports the red ALARM LED, green ACTIVE LED, and bicolor SERVICE LED (green in service, yellow out of service) common to all redundant IOS 60 circuit packs.

Wavelength Multiplex and Demultiplex

The WMX Circuit Pack 136 receives four individual wavelengths from the Wavelength Optical Switch Fabric (WOSF) 137 and multiplexes them for input to the Band Optical Switch Fabric (BOSF) 124. The WMX Circuit Pack 136 receives a Multiplexed (four wavelengths) optical signal from the BOSF 124 and demultiplexes the signal into four individual optical signals for input to the WOSF 137. Refer to Table 6 to identify the IOS ITU-compliant grid wavelengths and bands supported by the WMX CP.

WMX Circuit Pack 136 Optical Functions include (i) De-multiplexes WDM signal form BOSF 124 into four individual wavelengths; (ii) Multiplexes four individual wavelengths into a WDM signal to the BOSF 124; (iii) Variable Optical Attenuators (VOAs) 407 for signal equalization of individual wavelengths; (iv) Linear Optical Amplifiers (LOAs) 571A and 571B for amplifying the WDM optical signals; and (v) Tap/PIN diodes for optical signal power monitoring and VOA control.

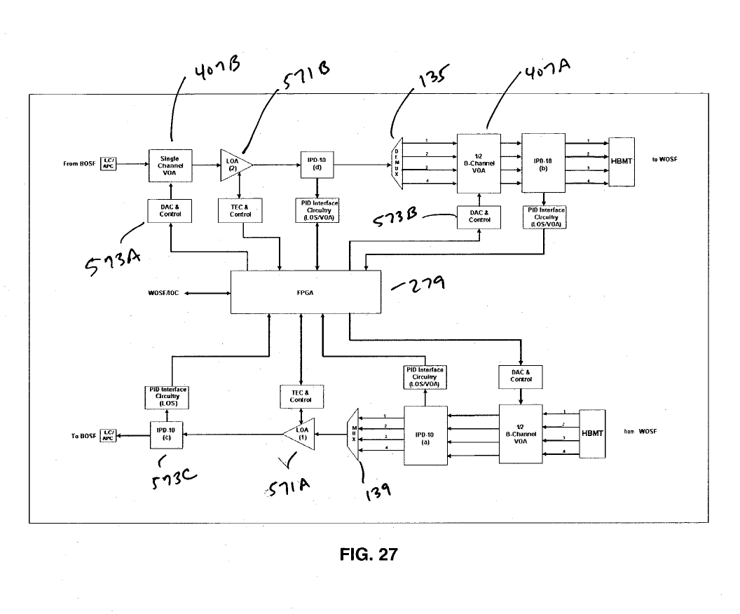

FIG. 27 details the optical signal flow and electrical control/monitoring of the active optical components.

(a) Wavelength to WDM Optical Path

This path takes four individual wavelengths from the Wavelength Optical Switch Fabric (WOSF) 137 and multiplexes the optical signals for input to the Band Optical Switch Fabric (BOSF) 124.

(b) 8-Channel VOA

The four individual wavelengths from the WOSF 137 pass through four of the eight channels of the VOA 407 A. The Tap/PIN diodes (IPD-10-a) tap off 5% of the optical power for monitoring by the WOSF IOC 219. The WOSF IOC 210 adjusts the optical power of the individual wavelengths through the Digital to Analog converter.

(c) MUX

The four individual wavelengths are multiplexed at mux 139 into a Band. The WMX circuit pack 136 bands that are supported in IOS 60 are listed in Table 6.

(d) LOA (1)

The WDM optical signal out from the Band Multiplexer 139 is amplified by LOA (1) 571A.

(e) IPD-10-c

The JPO-10(c) is a Tap/PIN is used for monitoring the WDM optical signal power for the signal going to the BOSF 124.

(f) WDM to Wavelength Optical Path

This path takes the WDM optical signal from the Band Optical Switch Fabric (BOSF) 124 and de-multiplexes the optical signals into four individual wavelengths for input to the Wavelength Optical Switch Fabric (WOSF) 137.

(g) Single Channel VOA

The WDM signal from the BOSF passes through the single channel VOA 407B and a Tap/PIN diode, which provides 5% of the optical power for monitoring by the WOSF/IOC. The WOSF/IOC via a Digital to Analog Converter (DAC) 575A can attenuate the optical signal to keep the LOA within its linear operating range.

(h) LOA (2)

The WDM optical signal out from the BOSF is amplified at LOA (2) 571B.

(i) DEMUX

The WDM signal is de-multiplexed at demux 135 into four individual wavelengths.

(j) 8-Channel VOA

The four individual wavelengths from the Demux pass through four of the eight channels of the VOA 407A. The Tap/PIN diodes (IPD-10(b) 573B tap off 5% of the optical power for monitoring by the WOSF/IOC. The WOSF/IOC adjusts the optical power of the individual wavelength through Digital to Analog converter 575B.

(k) Optical Performance

The overall optical performance of the WMX circuit pack 136 is provided in the described embodiment to conform to the parameters listed below.

(I) Equalization Control Loop

The WMX circuit pack 136 contains an equalization control loop, which involves the use of the IOA, VOA array, band MUX/DEMUX and a photo diode array.

This loop uses the output signal levels of each wavelength to control the attenuation of the wavelength VOAs. The attenuation is adjusted via feedback from the photo diode array to equalize the wavelength levels at the output of the circuit pack. The WOSF/IOC determines the set point of the VOA control loop. The gain of each wavelength is set by a digitally controlled potentiometer that is programmed from the WOSF/IOC. These loop gains are determined during manufacturing testing of the WMX circuit pack 136.

Output Variation

The output variation in optical signal of the WMX circuit pack 136 is less than ±0.5 dB.

(a) Optical Budget

The estimated power levels through the WMX Circuit Pack 136: (i) Per wavelength power from BOSF 124: −9 dBm to −4 dBm per wavelength (<1 dB variation within band); (ii) Per wavelength optical power from WOSF 137: −5 dBm; (iii) Power Out to BOSF 124: 4 to +3 dBm per wavelength (<0.5 dB variation within band); and (iv) Power Out to WOSF 137: −3 to −1 dBm per wavelength.

(b) WMX Electrical Features

WMX Circuit Pack 136 Electrical Features: (i) Supports common IOS dual −48 Volt power feed circuitry; (ii) Supports IOS 60 redundant circuit pack LEDs on faceplate; (iii) Supports two LOA/TEC circuits with control/monitor by the WOSF 137 IOC 210; and (iv) Supports IOS Temperature and Inventory SE²PROM.

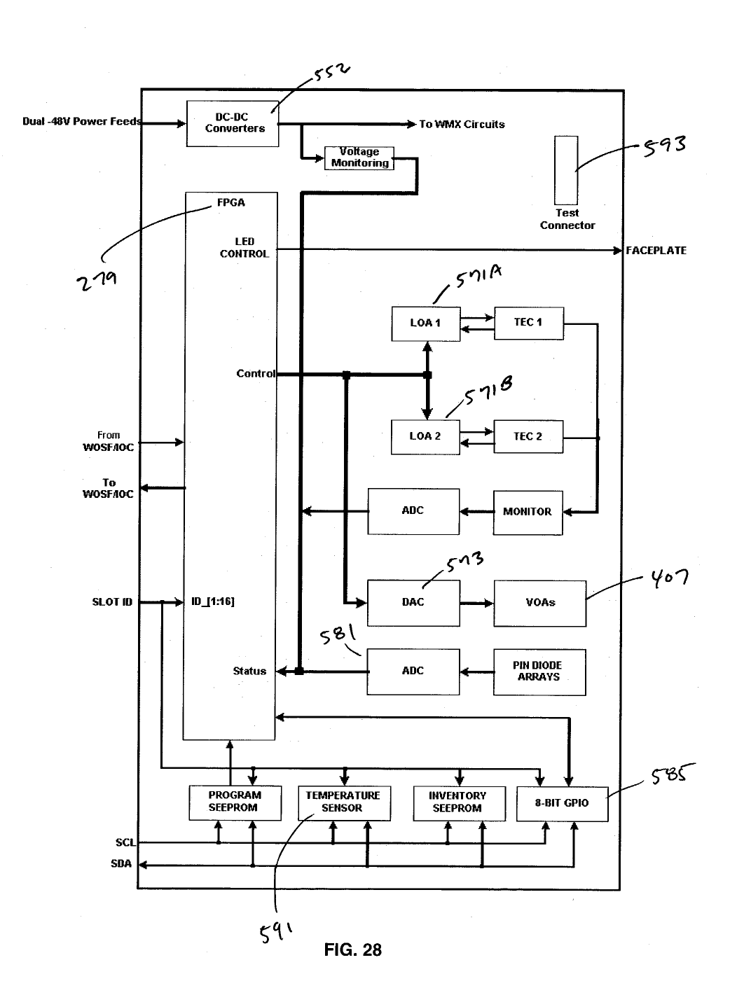

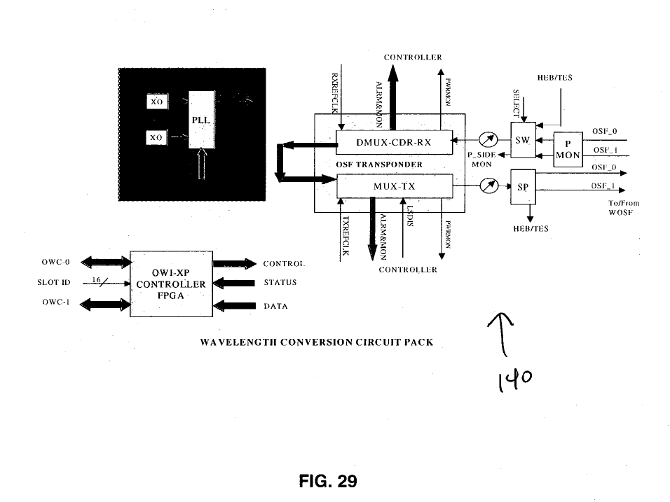

FIG. 28 is an electrical block diagram of the WMX Circuit Pack 136.

(c) LOA & TEC Control/Monitor

Embedded Analog to Digital Converters (ADCs) 581 on the WMX Circuit Pack monitor various analog parameters of the Linear Optical Amplifiers (LOA) and Thermoelectric Coolers (TEC): (i) -LOA Current; (ii) -LOA Voltage; (iii) -LOA Temperature; and (iv) TEC Current.

Each LOA/TEC pair can be disabled (turned off) through a control signal from the WOSF/IOC.

(d) Loss Of Signal (LOS)

The WMX Circuit Pack 136 provides Integral Tap/PIN diodes for optical power monitoring of the following optical paths: (i) WDM optical signal from BOSF 124; (ii) WDM optical signal to BOSF 124; (iii) Wavelength optical signals ( 4 ) from WOSF 137; and (iv) Wavelength optical signals ( 4 ) to WOSF 137.

Analog to Digital Converters (ADCs) 581 allow the WOSF/IOC to monitor the power levels.

(e) VOA Control & Monitor

The Tap/PIN diodes also provide the means for the WOSF/IOC to monitor the optical power in-order to equalize the individual wavelength levels. Variable Optical Attenuators (VOAs) 407 on the WMX Circuit Pack 136 are controlled by Digital to Analog Converters (DACs) 573.

(f) Voltage Monitoring

The WMX Circuit Pack 136 monitors the dual X 8 Volt power feeds and provides a status for each readable by the WOSF/IOC.

All secondary DC voltages are monitored for low voltage and provide individual status indications to the WOSF/IOC.

(g) Temperature

The WMX Circuit Pack 136 contains a temperature sensor 591 accessed via the I²C interface 588.

(h) Circuit Pack Status LEDs

The WMX Circuit Pack 136 contains the standard IOS 60 redundant circuit pack status LEDs on the faceplate: (i) ACTIVE (green); (ii) ALARM (red); and (iii) SERVICE (green: in service, yellow: out of service).

(i) Field Programmable Analog Array (FPGA)

The WOSF 137 IOC 210 monitors and controls the WMX Circuit Pack 136, and an FPGA 279 interfaces the WOSF 137 IOC 210 and the WMX devices.

8-Bit GPIO

The WMX Circuit Pack 136 contains an 8-bit general-purpose I/O (GPIO) device 585 accessible through the I²C interface 588 to support the FPGA 279 firmware upgrade.

(a) • Slot ID

The WMX Circuit Pack receives sixteen slot ID signals from the shelf back plane.

(b) Test Connector

The WMX Circuit Pack contains a test connector 593 for use by external test equipment for monitoring of various analog parameters

Wavelength Conversion (OWI-λC):

Referring to FIG. 29, the 2.5 Gb/s and 10 Gb/s OWI-λC circuit packs 140 are used to provide the wavelength conversion function for the IOS system 60. The 2.5 Gb/s and 10 Gb/s OWI-λC Circuit Packs 140 convert one IOS C Band wavelength to any valid IOS C Band wavelength. The OWI-λC 140 is similar to the OWI-XP pack 219A, but it does not require the Central Office optical interface (CO transceiver). The electrical output signals of the DWDM transponder (receiver section) are looped back (hard wired) to its electrical input signals (transmitter section). The OWI-λC Circuit Pack 140 resides in the OWI shelf 70, requiring one OWI Shelf 70 circuit pack slot per converted wavelength.

The transceiver facing the optical switch fabric 214 receives an optical signal (e.g. λⱼ) from each switch fabric, the OWC 220 selects one of these signals, and sends the signal to the broadband receiver, which converts it to an electrical signal. This electrical signal is looped back to the transmitter, and the transmitter converts it to the desired IOS ITU-compliant wavelength (e.g. λₖ) and transmits it to both optical switch fabrics via the splitter. The clock rate selection function is required for the 2.5 Gb/s and 10 Gb/s OWI-λC Circuit Packs to provide continuity of the format through the wavelength conversion function.

(a) OWI-λC HEB and TES Implementation

The OWI-λC 140 supports the HEB and TES functions required for 1+1 protection, and is the preferred vehicle for the secondary path generation since (1) no CO configuration exists on the OWI-λC 140, reducing cost and (2) no faceplate connectors or SIGNAL LEDs exist on the OWI-λC, eliminating CO craft confusion, and (3) no configurable hairpin loopback (the loopback is permanent) is required for the OWI-λC, reducing operations. The HEB and TES are optically implemented using an OWI-λC secondary circuit pack with an OWI-XP or OWI-TR primary circuit pack. These connections are not used when two transponders are used in conjunction with two wye cables to implement the HEB/TES functions.

(b) Circuit Pack Status LEDs

The OWI-λC Circuit Pack contains the standard IOS non-redundant circuit pack status LEDs on the faceplate: (i) ACTIVE (green); and (ii) ALARM (red).

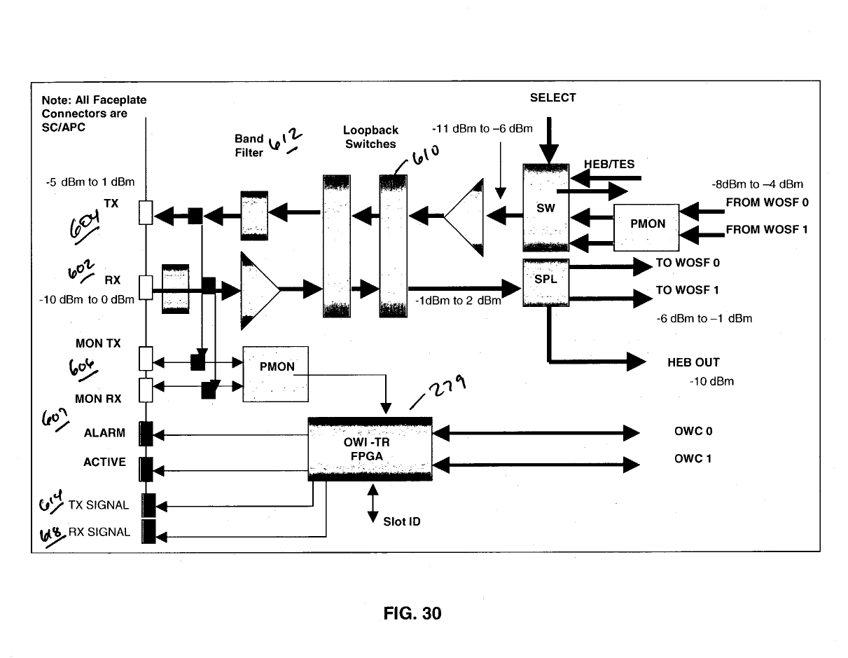

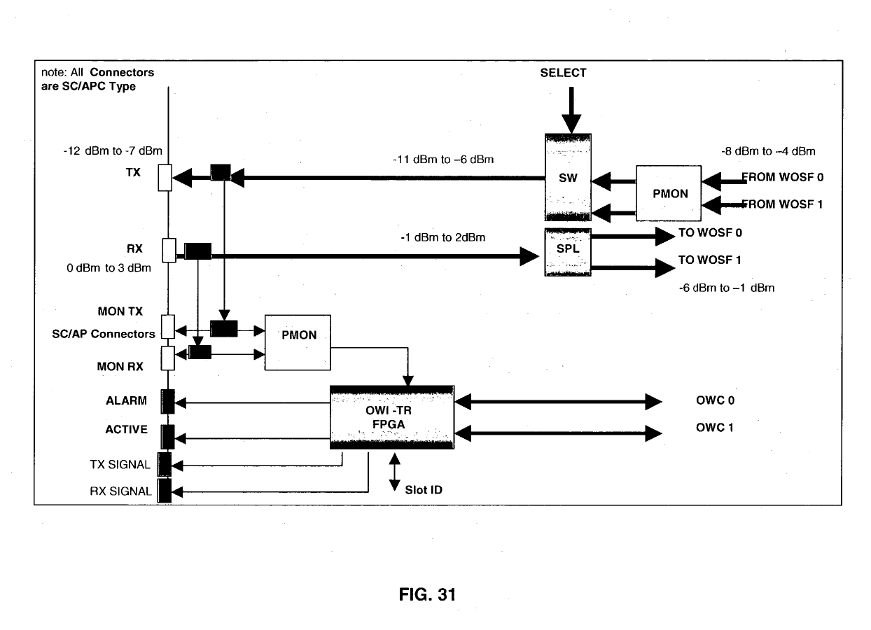

Transparent Interfaces (OWI-TRP and OWI-TRG) FIGS. 31 and 30, respectively)

This section identifies the specifications for the IOS TRansparent interface Circuit Packs 219B OWI-TRP and OWI-TRG. These circuit packs terminate single wavelength optical data links that have the required IOS ITU-compliant wavelengths (established external to the IOS).

The OWI-TRP is a Passive Transparent Interface circuit pack (no internal gain) that typically resides close to the external IOS ITU-compliant transponder or close to external amplifiers that boosts the signal level in both directions. This circuit pack operates with required transmit and receive signal levels that are already within the range required to interface optical switch fabric ingress and egress. Accordingly, the OWI-TRP provides no gain in either the transmission direction, and this passive interface limits the features available on the OWI-TRP relative to the OWI-XP 219A or the OWI TRG.

The OWI-TRG is a Transparent Interface Circuit pack 219B with Gain (internal gain is supplied in both transmission directions) that typically interfaces a fiber that connects with a significant amount of transmission loss to another building. This circuit pack operates with required transmit and receive signal levels that require OWI-TRP gain in both transmission directions to interface the optical switch fabric ingress and egress.

The OWI-TRP and OWI-TRG Circuit Packs reside in the OWI Shelf 70 in any numbers and with any mix of OWI-XP 219A and OWI-λC 140 Circuit Packs co-residing in the same shelf. Since the OWI-TRG Circuit Pack both requires band filters for noise reduction, there are eight unique OWI-TRG circuit pack codes, one for each IOS band.

In general, bit error rates and engineering rules are not guaranteed for wavelengths accessing the IOS network 310 through TR circuit packs 219B. The IOS does not reject an input to an OWI-TRG or OWI-TRP for reasons of wavelength, bit rate, optical power level, or any other reason, but instead allows the signal to pass to the fabric. If the wavelength is not an ITU grid wavelength, or it is the wrong ITU Grid wavelength, the WMX multiplex 139 doing the banding blocks the wavelength from entering the BOSF 124. If the wavelength is a marginal version of the correct ITU wavelength (C Band location offset, spectral purity), an improper level can result in the band, affecting the error performance of all wavelengths in the band. If the signal is not 2.5 Gb/s or 10 Gb/s, an error rate higher than 10-12 errors per bit can result. If the ingress power levels are not within those stated in this section, an error rate higher than 10-12 errors per bit for all wavelengths in the band can result.

(a) OWI-TRG Circuit Pack Block Diagram

FIG. 30 shows the high-level block diagram for the OWI-TRG Circuit Pack. Single wavelength, IOS ITU-compliant optical signals enter and leave the circuit pack at the RX 602 and TX 604 SC/UPC connectors, respectively. Taps and splitters extract a portion of the optical power for transmit and receive power monitoring and for delivery to the MON TX 606 and MON RX 608 monitor connectors, respectively. The loss from the access point to the MON connectors is designed for a nominal 20 dB, and the MON connectors are labeled are TX LEVEL −20 dB and RX LEVEL −20 dB, respectively. The power monitor circuit provides the power level to the OWCs 220 through the OWI-TRG FPGA 279.

The ingress signal enters at a level range of −10 dBm to 0 dBm, is amplified and sent through two loopback switches to OWI-TRG outputs that drive WOF0 and WOSF1, respectively. At the low input power level range, the amplifier is linear, but it saturates at an output level of about 2 dBm, providing a drive range for the splitter of about −1 dBm to 2 dBm. Band filtering is required in this direction of transmission to filter possible out-of-band ASE noise from external idle optical amplifiers, thereby confusing the broadband power measurements and the RX SIGNAL LED. This filtering supplements the optical switch fabric WMX filters, which remove noise outside the ITU wavelength passband of the WMX multiplex port to which the signal is connected.

The OWC 220 monitors the optical power level of the signals from WOSF0 and WOSF1 and selects the signal from one fabric using the fabric egress switch. Since 1+1 circuits are supported by the OWI-TRG, the HEB OUT and HEB/TES configuration for pairwise adjacent OWI-TRG Circuit Packs is identical to that discussed for OWI-XP circuit packs. The signal emerges from the switching configuration with a power level range of −11 dBm to −6 dBm and is sent through an amplifier and the two loopback switches to a band filter, which removes the noise outside the IOS band that the amplifier generates. The optical signal emerges at the OWI-TRG faceplate with a transmit level range of −5 dBm to 0 dBm.

The loopback switches 610 are available to provide independent loops back to the CO or toward the optical switch fabric. Loops toward the optical switch fabric 214 rely on the filtering at the associated WMX to remove the noise contributed by the single amplifier that is in the looped optical circuit.

For the CO loop, the Band Filter 612 removes noise outside the four-wavelength band contributed by the single amplifier in that looped circuit. Since the Band Filter 612 is unique to an IOS band, there are eight codes of OWI-TRG circuit pack, one for each band.

If the ingress optical power level requires external adjustment, using the RX Monitor connector or some other means, the CO loopback is normally operated to prevent too low or too high optical signal from reaching the optical switch fabric while the adjustment is in progress.

The threshold for the TX 614 and RX 618 SIGNAL LEDS depends on the application. Accordingly, the thresholds for a particular application, in dBm, is entered at the CLI or SDS 204 and stored by the OWC 220. The OWC 220 then operates the TX and RX SIGNAL LEDs to the green or yellow states, depending on whether the optical signal is in range or out of range relative to the thresholds. In addition, the OWC inserts the proper hysteresis in the threshold to avoid SIGNAL LED flashing if the signal level is at threshold.

For 1+1 circuits using a TRG as the primary circuit pack, at least one of the working and protection paths is at the wavelength entering the TRG Circuit Pack. If a wavelength converter is used as the secondary circuit pack, the wavelength of the other path is an arbitrary IOS C Band wavelength.

The OWI-TRG Circuit Pack includes all the common features of OWI circuit packs 219, including interface to redundant OWCs, ALARM and ACTIVE LEDs, and common features slot IDs. In addition, redundant −48V A and B distributions drive the low voltage converters through filtering, distribution failure detection, low voltage shutdown, and distribution selection. These alarms and all others are sent to the OWC through the OWI-TR FPGA.

(b) OWI-TRP Circuit Pack Block Diagram

FIG. 31 shows the high-level block diagram for the OWI-TRP Circuit Pack. This circuit pack is very similar to the OWI-TRG, except that there is no gain supplied in either transmission direction. Because of the passive nature of the circuit pack, loopback switching and 1+1 circuit configurations are not supported, as the signal levels are too low without on-board gain or signal regeneration and the economics of the TRP eliminates all bells and whistles. No band filters are supplied. Since the OWI-TRP is completely transparent to wavelength and bit rate, there is only one code of OWI-TRP circuit pack.

The faceplate connectors and LEDs are identical for the TRP and TRG. The TX and RX monitor connectors are also 20 dB below the termination points. Thresholds are programmable in the same way for the two circuit packs.

For the OWI-TRP, the ingress signal level must be in the range of 0 dBm to 3 dBm and the output signal level is in the range −12 dBm to −7 dBm.

(c) OWI-TRG and OWR-TRP Specifications

The OWI-TRG and OWR-TRP Circuit Packs are physically compatible with OWI Shelf 70 slots and are electrically and optically backplane compatible with operation in those slots.

The OWI-TRG and OWI-TRP may reside in the OWI Shelf 70 in any numbers and with any mix of OWI-XP and OWI-λC co-residing in the same OWI Shelf 70.

The OWI-TRG supports independent loopback toward both the CO and optical switch fabrics, but the OWI TRP supports neither loopback.

The OWI-TRG supports 1+1 HEB/TES operation for adjacent OWI-TRA Circuit Packs in the OWI Shelf 70, but the OWI-TRP is not used for this configuration.

The OWR-TRG provides proper operation with an input level of −10 dBm to 0 dBm, and delivers an output level of −5 dBm to 1 dBm.

The OWR-TRP provides proper operation with an input level of 0 dBm to 3 dBm, and delivers an output level of −12 dBm to −7 dBm.

Both OWI-TRP and OWI-TRG provides MON TX 686 and MON RX 607 monitor connectors on the circuit pack faceplate for monitoring the input and output optical signal levels. The transmission levels for these monitor connectors are 20 dB down from the optical signal levels at the TX and RX connectors, respectively.

Optical power levels are measured at the input and output of the OWI-TRP and OWI-TRG on the CO side, and those power levels are available from the CLI and SDS 204.

Since the OWI-TRG Circuit Pack requires two band filters for noise reduction, there are eight OWI-TRG Circuit Pack codes. There is one OWI-TRP Circuit Pack Code.

The OWI-TRG and OWI-TRP support the standard interfaces with the OWI Shelf OWCs. All alarms are forwarded to the OWCs 220 for disposition. All status and configuration changes on the circuit pack are controlled directly by the in-service OWC 220. The circuit packs also support the common Slot ID structure.

The OWI-TRG and OWI-TRP support the standard Circuit Pack Status LEDs for non-redundant IOS circuit packs: a red ALARM LED and a green ACTIVE LED. These LEDs reflect normally complementary states.

Both the OWI-TRG and OWI-TRP monitor the ingress and egress optical power and provide the levels to the OWC. In addition, the TRP and TRG also support RX and TX SIGNAL LEDS that are driven by the OWC 220 through the FPGA 279. The OWC stores a default in-range threshold value that is the associated signal range limit point (e.g. −10 dBm in the case of RX low power threshold for OWI-TRG). For the default case, the actual threshold is outside the in-range band by 1 dB, and the hysteresis of the threshold is equal to this bias, providing a hysteresis of 1 dB. The user can override the OWC default value with an SDS or CLI entry of the specific threshold for the application. The OWC 220 biases the user-supplied value by 1 dB and sets the hysteresis at 1 dB. The TRP and TRG PMON optical paths are calibrated at circuit pack manufacture, and the calibration values are stored on an on-board EEPROM that is readable by the OWC 220. The OWC 220 offsets the DAC outputs by the flat loss and the room temperature tolerances captured at circuit pack manufacture.

The OWI-TRG and OWI-TRP support redundant −48A and −48B power distribution into the circuit pack, detection of failure of one of those distributions, and automatic selection of the non-failed −48 volt distribution without impact on service or the operations of the circuit pack, and distribution of the selected 48 volt distribution to the circuit pack low voltage power converters. The circuit packs also support low voltage shutdown.

### Optical Control Plane Specifications: Node Level (1)

### Overall Optical Control Plane Level 1 Specifications

The SNC 207 of the IOS 60 is redundant, with one SNC in service and the other out of service at any snapshot of time. The overall level 1 operation and maintenance of the node relies on the SNM 205 within the in-service SNC 207. Each of the redundant SNMs 295 contains two IOCs 210 210, one for gateway processing and one for application processing. The level one controller communicates to the level 2 control functionality by means of the internal IOS Ethernet, and the operation is primarily client-server, with level 1 as the server and level 2 as the client.

IOC 210 child cards on different circuit packs implement level 2 controllers. For most IOS 60 functions, an IOC 210 resides on the same circuit pack as the device functions it controls. Each TPM 121, OPM 216, and OTP 218 Circuit Pack has its own IOC 210. Each OSF circuit pack 214 has its own IOC 210, and for the BOSF 124, that IOC 210 controls that BOSF 0 or 1 functionality in its entirety. For the WOSF 137, however, the WOSF IOC also controls the associated 8 WMX Circuit Packs 136 on the same fabric side and in the same optical transmission path. Redundant shelf controller cards, OWC 0 and 1, reside within the OWI shelf, with one in service and the other out of service at any snapshot of time. Note that the AIM 224 and Ethernet 222 Circuit Packs do not have an IOC 210 on them. But they are monitored and controlled by the SNM 205 in the same SNC 207.

### Redundant System Node Controller 0 and 1

System Node Manager

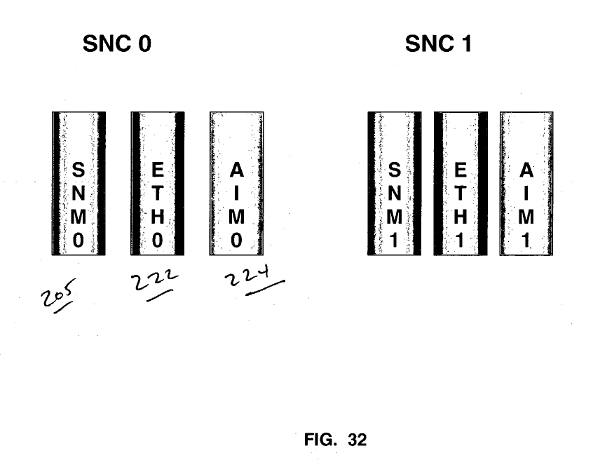

The System Node Manager (SNM) 205 performs the highest level of control within the Optical Control Plane 20 that is within each IOS 60. The System Node Manager 205, Ethernet Switches 222 (ETH), and Alarm Interface Module (AIM) 224 comprise the redundant System Node Controller. Accordingly, the System Node Controller is a fully redundant function within the IOS node. FIG. 32 shows the partitioning of the redundant System Node Controller into SNC 0 and SNC 1.

The SNM circuit pack 205 includes all of the CPU functions needed to operate and maintain the IOS from a node perspective. To achieve this, the SNM 205 is divided into an Application Processor 228 and a Gateway Processor 227. The SNM Circuit Pack utilizes the Intelligent Optical Controller (IOC) 210 twice on the circuit pack to create these separate processor modules. By using two IOC modules 210, the SNM 205 can easily be upgraded with higher performance processors at a future time without redesigning the main circuit board. The IOC 210 also thus incorporates a common CPU design used throughout the IOS system.

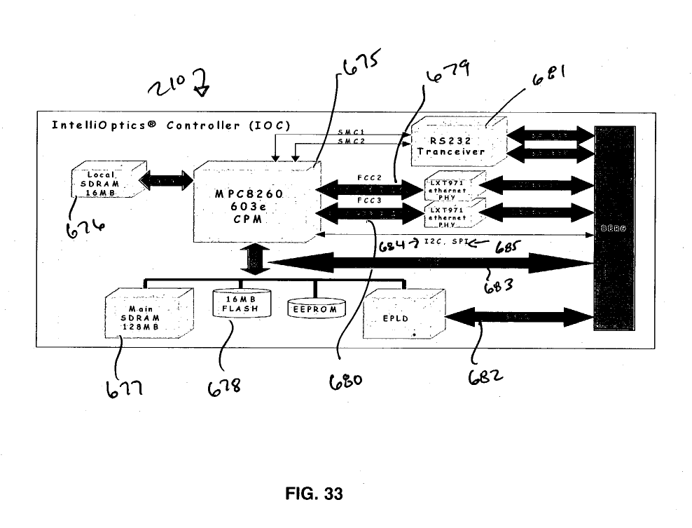

Referring to FIG. 33, the hardware features supported on the IOC 210 include: (1) MPC8260 PowerPC 675 running at a minimum 200 Mhz CPU, 133 Mhz CPM, and 66 Mhz Bus; (2) 16 MB Intel StrataFlash Boot Memory 678; (3) 64 to 256 MB Main Processor SDRAM Memory 677; (4) 16 MB Local SDRAM Memory (used to buffer Ethernet packets) 676; (5) 10/100BaseT Interface on FCC2 679; (6) 10/100BaseT Interface on FCC3 680; (7) RS-232 Port on SMC1 681; (8) RS-232 Port on SMC2; (9) General Purpose Inputs and Outputs 682; (10) 60X Bus extension (data and control) 683 to parent card; (11) I²C 684; (12) SPI BUS 685; and (13) Slot ID, LED Control, Resets, Interrupts, and Power Monitors. By utilizing two of the IOC 210 child cards, the SNM 205 creates the separate Applications Processor 228 and Gateway Processor 227 engines.

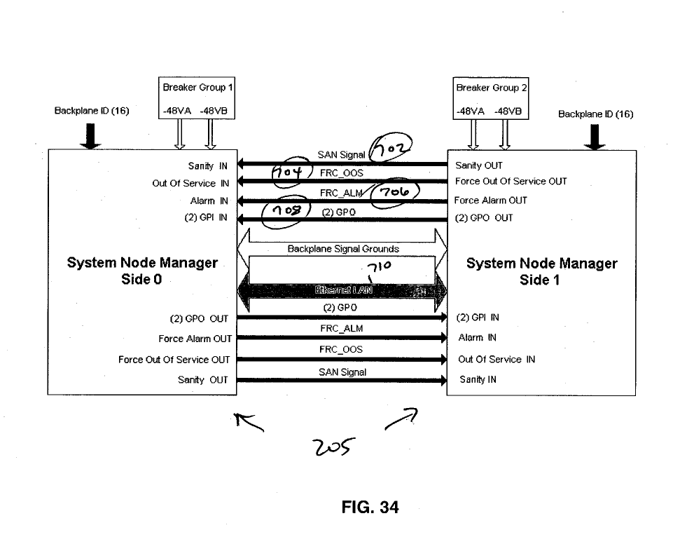

FIG. 34 shows the cross couples that exist between SNM 0 and SNM 1. Each SNM 205 sends the other a Sanity (SAN) signal 702 to provide an Ethernet-independent means to determine whether or not the other SNM 205 is cycling. Additionally, the in-service SNM 205 can force the other out of service using the Force_Out_Of_Service cross couple 704 or can force the circuit pack to the ALARM state using the Force Alarm cross couple 706. In addition, two GPO bits 708 from each SNM 205 connect to two GPI bits for the other SNM 205. All these cross couples interrupt the receiving SNM 205 and are maskable by the receiving SNM 205 when in service.

The Ethernet connections 710 depicted in FIG. 34 are via ETH 0A and ETH 1A, forming the crossover connection between the redundant internal Ethernet structures.

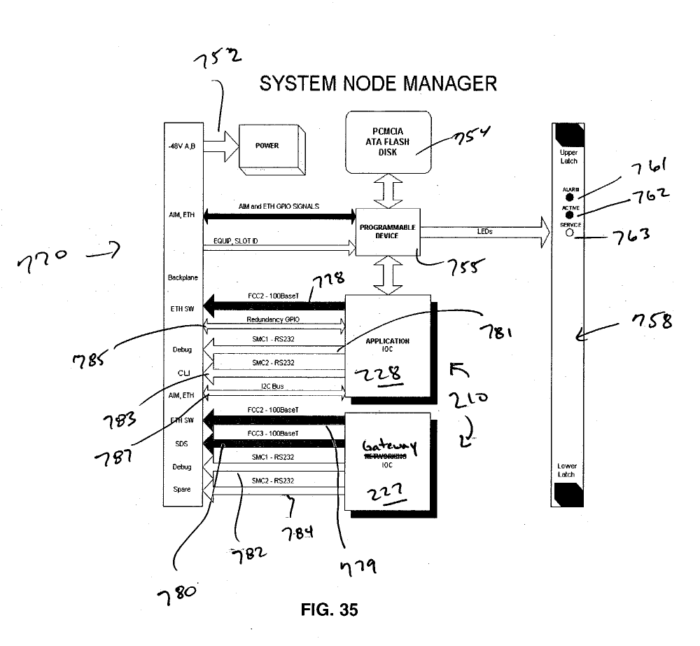

Referring to FIG. 35, the SNM circuit pack 205 includes the following components: (1) A and B −48V Power inputs and returns with supporting circuitry 752; (2) DC-to-DC conversion to 3.3V and 2.5V distribution (with hooks for possible lower voltages in alternative embodiments); (3) Two IOC child module circuit cards 210; (4) One 256 MB PCMCIA FLASH ATA Memory Card 754; (5) One programmable device 755 for glue logic and interface signals; (6) Redundancy control signals; (7) Opto-Isolator circuits for the AIM; (8) Faceplate Interface 758; and (9) Backplane Interface 770 (including AIM GPIO). The major processor peripherals reside within the IOC child card 210; accordingly, the SNM 205 parent board major blocks are quite simple.

(1) A and B 48V lower

The SNM 205 brings in two separate busses of −48V and Return. Each bus is diode ORed and used as a redundant powering scheme for the DC-to-DC converters. The power circuitry utilizes a common feature set used on all circuit packs in the IOS 60 system.

(2) DC-to-DC Conversion

The SNM 205 provides the appropriate DC-to-DC conversion to bring the redundant −48V inputs to +3.3V and +2.5V. It is important to note that alternative embodiments of the IOC 210 may require a lower voltage DC supply. The hooks for lowering the +2.5V supply to a lower voltage are present in the SNM 205 design.

(3) Intelligent Optical Controller (IOC) X 2

The Applications Processor function and the Gateway Processor functions result from the utilization of two separate IOC 210 child boards. The functions present on these child boards allow an SNM 205 migration path towards higher performance processor chips as they become available.

(4) PCMCIA ATA FLASH Memory

The Applications Processor IOC is connected to an ATA FLASH Memory card 754. The initial density is 256 MB and the interface allows for an 8 or 16 bit data transfer between the 60X bus and the PCMCIA controller.

(5) Programmable Device

The SNM 205 utilizes a programmable device 755 for numerous circuit pack level functions. One necessary feature of the programmable device is to provide the ATA FLASH card 754 with the compliant control and data paths needed for proper operation. Other glue logic and signal manipulation are also provided inside this device.

(6) Redundancy Control

IOS software maintains the SNM0 and SNM1 circuit packs in an in-service/out-of-service relationship at all times. However, it is desirable to have a SANITY (SAN) signal routed directly between the two SNMs 205 to provide information (equipped, cycling) about the overall sanity of the source SNM software to the other SNM. Therefore, each SNM 205 routes a unidirectional SANITY signal towards the other SNM 205. Likewise, some additional spare net signaling is routed between the two SNM circuit packs 205 in the event that some other communication or interrupt features are needed in an alternative embodiment.

(7) Opto-Isolator Interfaces

The SNM 205 acts as the master controller for the Alarm Interface Module 224. Since there must be complete isolation between these two circuit packs for protection, opto-isolators are used to protect the general-purpose inputs and outputs between the SNM 205 and the AIM 224.

(8) Faceplate Interface

The SNM 205 has a faceplate interface 758 that is compliant with all of the other redundant circuit packs in the IOS 60. The SNM faceplate contains the standard three IOS LEDs for redundant circuit packs as follows: (1) ALARM (red) 761; (2) ACTIVE (green) 762; and (3) SERVICE (bi-color yellow out-of-service/green in-service) 763.

The ALARM LED 761 is activated by three sources: (1) Voltage detectors for failures of any dc-to-dc converters; (2) Direct software control via the on-board controller; and (3) Direct software control via the other SNM circuit pack 205, with the ACTIVE 762 and SERVICE 763 LEDs set accordingly.

(9) Backplane Interface

The SNM circuit pack contains the following electrical I/O on the backplane connector 770:
1) A and B −48V Power Inputs and Return (Special Blade Connectors) 752
2) Frame Ground (Special Blade Connector)
3) Signal Ground (distributed along the I/O pin connectors)
4) 10/100BaseT 778 to and from the Applications IOC to the internal IOS Ethernet
5) 10/100BaseT 779 to and from the Gateway IOC 227 to the internal IOS Ethernet
6) 10/100BaseT 780 to and from the Gateway IOC 227 to the external IP network port
7) One RS-232 port 781 for Debug Port on Applications IOC 228
8) One RS-232 port 782 for Debug Port on Gateway IOC 227
9) One RS-232 port 783 for CLI Interface for the Applications IOC 228
10) One RS-232 port 784 for Fan Control use on the Gateway IOC 227
11) Equipage Leads from packs on the Control Shelf 90 backplane and (via cable) AIMs 224
12) Redundancy Leads 785 for monitoring in-service/out-of-service status
13) Alarm Cut Off (ACO) Switch Input
14) Ground Loop for AIM Cable Integrity
15) AIM DC to DC FAIL and IRQ Inputs
16) AIM I²C 787
17) AIM Force Out of Service Output
18) 7 General Purpose Inputs from AIM (including remote ACO)
19) ETH DC to DC FAIL and IRQ Inputs
20) ETH I²C (possibly two interfaces in the case of two ETH packs)
21) ETH Force Out of Service Output
22) 16 Slot ID Signals

The CLI RS-232 port 783 connects to the CLI DB9 connector mounted on the System Bay 62 Air-Intake-Baffle Assembly mounted under the TPM Shelf. This connector is wired to both SNM 0 and SNM 1 for both inputs and outputs. The in-service SNM 205 gates the inputs to the Application Processor, and the out-of-service SNM ignores such inputs. The out-of-service SNM also tri-states its CLI outputs to prevent collisions on the common path to the CLI connector.

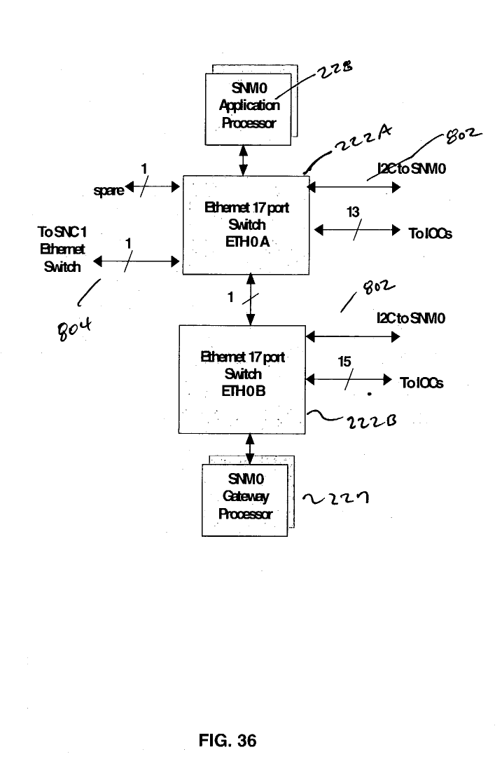

Ethernet Switches Referring to FIG. 36, each System Node Manager 205 communicates to level 2 Optical Control Plane 20 circuit packs via the Ethernet 100 BaseT set of switches that reside on ETH Circuit Packs within its SNC 207. Each Ethernet Switch Circuit Pack 222 includes a 17-port switch. These are interconnected in a layered manner to establish an overall 32-port switch for each of the redundant Ethernet control buses, with 100 BaseT interconnections among level 1 and level 2 processors.

FIG. 36 is a high-level block diagram for the SNM 0 Internal Ethernet configuration, including the two ETH Circuit Packs 222 for SNCO, denoted A and B. Each Ethernet Switch circuit pack collects information of two types: (1) Circuit Pack alarms and (2) status of the Ethernet port. The circuit board alarms include dc-to-dc power failure as well as loss of the −48 volt A or B power source. The Ethernet board also gathers the status of all 17 ports and provides these thru an I2C interface 802 to the SNM 205 in the same SNC 207. The purpose of this status information is for debugging and fault isolation in the case of Ethernet port failure. The Ethernet packs also report dc-to-dc conversion failure and circuit pack extraction.

ETH A 222A interfaces with the SNM Application Processor 228 and ETH B 222B interfaces with the SNM Gateway Processor 227, providing the interconnection path between these processors. ETH A 222A provides the crossover path to SNC 1 over which heartbeats are exchanged and database updates occur for the out-of-service SNM 205. Both ETH Circuit Packs 222 use a port to interface with each other, and ETH A 222A and ETH B 222B have 13 and 14 ports, respectively for level 2 IOCs 210. Additionally, each ETH Circuit Pack 222 supports an I2C interface 802 with the SNM 205 that is within the same SNC 207.

ETH Circuit Pack 222 alarms are stored in on-board latches. Failures on an ETH Circuit Pack interrupt the SNM Application Processor 228 using the I2C interrupt request signal. The SNM 205 can then read the entire set of ETH latches over the I2C bus to ascertain the details of the alarm profile.

The SNM 205 directly controls the LEDs for both ETH Circuit Packs 222 by writing latches using the I2C bus. The ALARM and ACTIVE LEDs are made mutually exclusive in hardware. There is a SVC_LED signal from the opposite SNM 205, which can force the active Ethernet switch card into standby mode. This LED cross couple is used only in the case that the in-service SNM fails, and it ensures that the LEDs on the failed SNC 207 are all written to the out-of-service state.

The SNM 1 Internal Ethernet configuration follows SNM 0 Inernal Ethernet configuration depicted in FIG. 36.

SNC 0 ETH 0 A supports an internal Ethernet crossover 804 with SNC 1 ETH 0 A.

ETH A supports the SNM Gateway Processor 227 within the same SNC 207, and ETH B supports the Application Processor 228 within the same SNC 207.

The SNM faceplate contains the standard three IOS LEDs for redundant circuit packs as follows: (1) ALARM (red); (2) ACTIVE (green); and (3) SERVICE (bi-color yellow Out-of-service/green in-service).

Alarm Interface Module

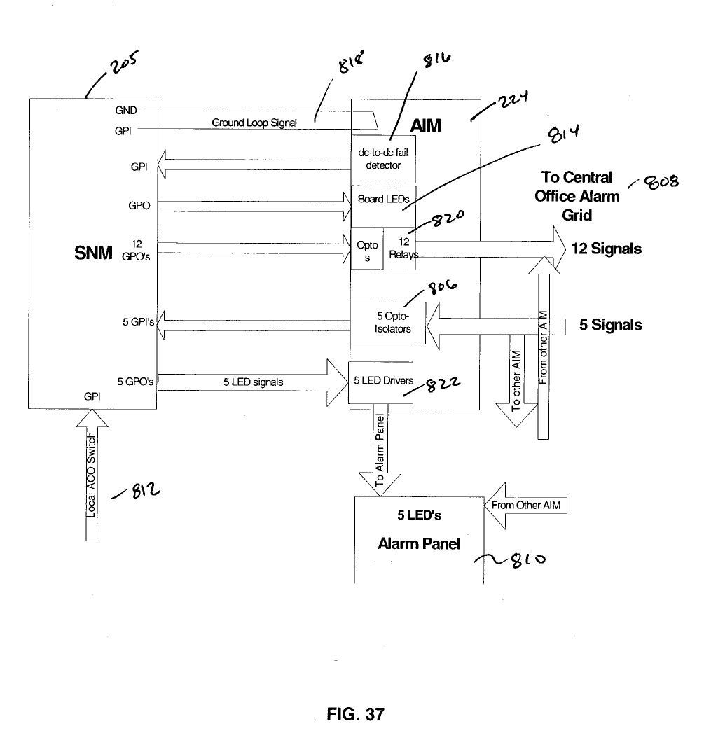

Referring to FIG. 37, the Alarm Interface Module (AIM) 224 is the circuit pack that provides the SNC 207 interface to the Office Alarm Grid and other CO control structures (e.g. Remote ACO) as well as the IOS System Bay Alarm LEDs. The AIM 224 is fully redundant with AIM 0 controlled by SNM 0 within SNC 0 and AIM 1 controlled by SNM 1 within SNC 1. Since the Office Alarm Grid 808, the other CO Control Structures, and the IOS Alarm LEDs have non-redundant inputs and outputs, corresponding outputs of the two AIMs 224 are multipled at the IOS Alarm Panel and corresponding inputs drive both AIMs 224 at the IOS System Bay Alarm Panel. The in-service SNM 207 drives the in-service AIM 224 to reflect the alarm condition of the IOS, and monitors the in-service AIM 224 to obtain the CO inputs.

The relays that drive the office alarm grid, the opto-isolators that receive CO contact closures, and the drive circuits for the Alarm LEDs are located on the AIMs 224. AIM 0 directly interfaces the SNM 0 Application Processor through GPOs and GPIs with suitable isolation. AIM 0 also interfaces SNM 0 via an I2C bus. Similarly, AIM 1 directly interfaces the SNM 1 Application Processor 228 through GPOs and GPIs suitable isolation and with an I2C bus.

(a) CO Alarm Grid Interfaces

The Office Alarm Grid 808 Outputs are: (1) Audible Alarms: (a) Critical; (b) Major; (c) Minor; and (d) Abnormal; (2) Visual Alarms: (a) Critical; (b) Major; (c) Minor; and (d) Abnormal.

(b) IOS Alarm LEDs

There are a total of 5 LED signals driven by in-service SNM GPOs through the AIM 224, with appropriate isolation. The IOS Alarm Panel has the following LEDs: Critical, Major, Minor, Abnormal and ACO Active.

The alarm panel 810 includes these 5 LEDs, all connected to ground on one terminal, with current limiting resistors and diodes located on the AIM 0 and AIM 1 Circuit Packs 224. These resistors and diodes provide isolation for multipling corresponding signals into an effective wired-OR function between the two AIMs 224 driving the (non-redundant) LED. The in-service AIM 224 activates its output circuit by using an output driver with a current limiting resistor and diode in the high state. The out-of-service AIM 224 provides high impedance on this wired OR connection with a reverse biased diode, effectively disabling it from driving the LED while in that out-of-service state.

Under normal conditions, the four IOS Alarm Panel 810 alarm condition LEDs mirror the Visual Alarm information that the IOS communicates to the CO Alarm Grid. IOS Growth Bays 64 have no separate Alarm LEDs, Office Alarm Grid connections, or connections to other CO control structures. Instead, the IOCs 210 210 in those bays 64 communicate failure information to the in-service SNM 205 over the internal Ethernet, and the SNM 205 performs the same functions using the in-service AIM as it does when the failure is in the System Bay 62.

(c) IOS Alarm Handling

There are two sets of these alarms, audible and visual. When an IOS 60 failure occurs, the in-service SNM 205 identifies the severity class of the failure and closes both the audible and visual relay contacts for that alarm. For example, when a major alarm is indicated, the in-service SNM 205 activates both the major audible and major visual alarm relays. In addition, the in-service SNM 205 lights the IOS Alarm Panel 810 MAJOR Alarm LED. The craft responding to this alarm would immediately push the (momentary) IOS System Bay Alarm Cut Off switch (ACO) 812 or would push a similar remotely located ACO switch in the central office.

Either of these actions directs the in-service SNM 205 to retire the audible alarm but retain the visual alarm. So in this example, the major audible alarm is cleared after the ACO 812 but the major visual is still active. To indicate that the ACO 812 function has been activated, the in-service SNM 205 lights the ACO LED on the IOS Alarm Panel 810. The Visual Alarm closure to the Alarm Grid 808 and the IOS alarm LED remains active until the failure is cleared. At that time, the SNM 205 deactivates the Visual Alarm closure and extinguishes the IOS Visual Alarm LED.

If another failure occurs while the IOS 60 is in an alarm condition but after the ACO 812 has retired the Audible Alarm, the SNM 205 reestablishes the audible alarm by activating the appropriate audible alarm relay contact. As with the initial failure, the craft can retire the audible alarm by activating the momentary ACO switch 812 at the IOS System Bay 62 or remotely. Successive failures therefore reactivate individual audible alarms that the attending craft must retire individually.

(d) ACO Interfaces

There is an ACO switch 812 conveniently located on the IOS System Bay Air-Intake-Baffle Assembly mounted under the TPM Shelf. This switch has momentary double pole double throw contacts. One contact set directly drives SNM 0 and the other directly drives SNM 1 through appropriately isolated GPIs.

The Central Office Remote ACO Switch is an input into both AIMs 224 in the form of a contact closure multipled to both AIM 0 and AIM 1. When the in-service AIM 224 receives this contact closure through appropriate isolation, it sends this information to the in-service SNM 208 as a GPI signal.

(e) I2C Bus

The I2C bus is the primary signaling medium between the AIM 224 and its SNM 205.

The AIM latches associated with this bus allows the AIM Circuit Pack 224 to have memory of the last operation that the SNM 205 sent. So the SNM 205 can fail or be physically removed from the shelf without destroying that information.

The SNM 205 sends LED states, IOS Alarm Panel LEDs, and states for the output relays that drive the Office Alarm Grid 808, all to the AIM 224 as serial information over the I2C bus. In addition, AIM 224 faults interrupt the SNM 205 and prompt it to read all the AIM 224 registers for the detailed alarm profile.

(f) Miscellaneous Inputs and Outputs

The IOS 60 also supports 4 user-specified miscellaneous outputs and 4 user-specified miscellaneous inputs to and from the central office alarm grid and/or other CO control structures.

The service provider may provision these miscellaneous inputs and outputs in a flexible manner over the lifetime of the IOS 60. For example, a particular CO may have a separate alarm grid scan point for MAJOR Power Alarms than for other MAJOR alarms. Another example could be an acknowledgement from an Alarm Grid 808 that stimulates the in-service SNM 205 to change the Visual Alarm from flashing (unacknowledged) to steady on (acknowledged). There are many possibilities that could require SNM software customization to requirements for specific customers at the time of customer deployment.

The miscellaneous outputs are generated through relay closures the same way as the audible and visual alarms closures are generated. The inputs are handled the same way as the remote ACO, a contact closure from the Central Office terminating on the AIMs 224 on opto-isolators and then forwarded to the in-service SNM 205 in the form of a GPI.

The AIM Circuit Pack 224 has the standard three circuit pack status LEDs 814 used on all IOS redundant circuit packs: ALARM (red), ACTIVE (green) and SERVICE (bicolor yellow out-of-service/green in-service).

One (GPO-generated) bit of the SNM I2C bus signal controls the AIM bicolor SERVICE LED. The green ACTIVE LED is on whenever the AIM 224 has dc power. The red ALARM LED is activated by the voltage detector 816 that checks for failure of the dc-to-dc converter. This alarm circuit also sends a GPI signal to the SNM 205 to tell it about the power failure. The SNM 205 ensures that the ACTIVE LED and the ALARM LED are complementary at all times.

A cable loop signal 818 is provided for the SNM 205 to detect physical removal of the cable between an SNM 205 and AIM 224 or physical removal of the AIM Circuit Pack 224.

This cable loop signal 818 is a ground provided by the SNM 205 that is included within the cable that carries the control signals between the SNM 205 and AIM 224. At the AIM pack 224, the associated termination pin is looped to another lead in the cable and returned to the SNM 205. At the SNM 205, the Application Processor 228 monitors the signal through a GPI. The cable loop signal is at the opposite ends of the DB connector to insure good seating of the connector.

The AIM output relays 820 are normally open, and the AIM Alarm Panel LED drivers 822 are normally high impedance, so that physical removal of the AIM circuit pack 224 or loss of power on the AIM Circuit Pack 224 does not directly cause a CO alarm or IOS Alarm Panel 810 system alarm indication.

The polarities of the signals at the SNM 205 and AIM 224 interface are chosen so that the removal of this interface cable does not directly cause a CO alarm or IOS Alarm Panel system alarm indication.

Since the AIM Circuit Pack 224 is part of the SNC 207 redundant control partition, physical removal of the pack, loss of power on the pack, removal of the SNM/AIM interface cable, or like faults, normally causes the SNC 207 service status to change. The newly in-service SNM 205 determines the severity level of the fault, closes the appropriate Visual and Audible contacts of its own AIM Circuit Pack 224, and lights the appropriate IOS Alarm Panel 810 LED through its own AIM 224.

All inputs to the AIM 224 from the central office are isolated using opto-isolators 806. The remote ACO function is a contact closure that should be opto-isolated on the AIM 224 board. The miscellaneous inputs are isolated in the same way as the remote ACO function.

All inputs to the SNM 205 from the AIM 224 and all outputs from the SNM 205 to the AIM 224 are opto-isolated in order to keep an isolation barrier around the AIM 224.

The AIM output relays 820 provide dry contacts that are rated for the current and voltage of CO alarms. The miscellaneous output contacts are rated in an identical manner.

### Test Resources

The IOS Test Resources 230 are the Optical Performance Manager (OPM) 216 and Optical Test Port (OTP) 218. These resources 230 are non-redundant, optional, and can be multiple for the OPM. They reside in the System Bay 62 Control Shelf 90 on a power and operational partition that is independent of both SNC0 and SNC1. Each SNM 205 can access any Test Resource 230 using the internal Ethernet.

Optical Test Port

The IOS Optical Test Port (OTP) Circuit Pack 218 is used to perform pre-service link testing, link integrity testing, and troubleshooting testing. The OTP 218 provides a 2.5 Gb/s transponder that supports two data rates: (1) 2.488 Gb/s basic SONET and (2) 2.667 Gb/s SONET FEC. Additionally, the OTP 218 provides a 10 Gb/s transponder that supports three data rates: (1) SONET/POS 9.953 Gb/s, (2) 10.3 GbE, and (3) 10.709 Gb/s SONET FEC. For SONET formatted signals, the OTP 218 format is POS. These are the transponder data rates that the Transponder (XP) Circuit Packs support, and the OTP 218 must match these bit rates while communicating through these OWI circuit packs 219. The in-service SNM 205 selects the OTP transponder and bit rate that is required for testing through a particular transponder. Specification of the bit rate selects one of the reference clocks used by the receiver clock and data recovery circuits.

The OTP 218 generates and transmits one and only one optical signal and receives one and only one optical signal at a given time. The wavelength generated by the OTP 218 2.5 Gb/s and 10 Gb/s transmitters is 1550 nm, but the XP used to transmit over the optical line changes this wavelength to the desired channel wavelength for the test. The OTP 2.5 Gb/s and 10 Gb/s receivers are broadband and capable of receiving any IOS C Band wavelength and converting it to a 2.5 Gb/s or 10 Gb/s electronic signal for analysis.

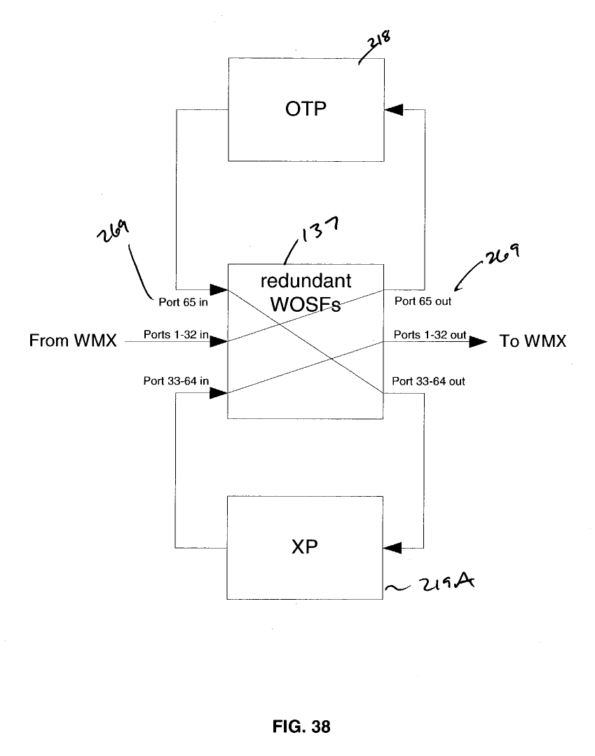

FIG. 38 shows how the OTP is optically connected into the IOS data plane. The in-service SNM 205 selects the OTP 2.5 Gb/s or 10 Gb/s transponder and configures it for the format and clock rate for the customer circuit. The OTP 218 is connected to each of the up to four WOSF circuit packs 137 on each of optical switch Fabric 0 and 1, a total of up to eight transmit fibers and eight receive fibers. The 2.5 Gb/s or 10 Gb/s OTP transmit optical signal, is switched into one of the WOSF Circuit Packs 137 at the 65^{th} port 269 of the in-service and out-of service sides. This 65^{th} port 269 is used for OTP 218 maintenance operations only, and it is not available as a customer port. From the WOSF 137, the signal is routed to the OWI-XP 219A under test and sent through the redundant WOSFs 137 and banded at the redundant WMX Circuit Packs 136. From the WMXs, the signal is sent to the redundant BOSFs 124 and then to the network. Normally, the egress signal is transmitted through a TPM 121 out onto an optical line in the network, and sent to a distant IOS 60 in the network, there looped at the XP under test, and returned over the network to the originating IOS 60. After reception through a TPM 121, the redundant BOSFs 124 send the signal to the WMXs demultiplexers 135 to demultiplex into individual wavelengths. The WOSFs 137 route the received OTP 218 optical signal to the 65^{th} port 269, connected from both the optical Switch Fabric 214 0 and 1 to the OTP 218 receiver, which selects the optical signal from the in-service fabric 214 for signal analysis.

The test data that the OTP 218 can transmit under the wavelength is either (1) pseudorandom data or (2) discrete LMP verification messages. The in-service SNM 205 selects the data transmit mode and sends the OTP 218 IOC 210 an LMP message to be transmitted, if appropriate. The OTP 218 inserts the data fields along with the marker bits that are appropriate to the format selected and provides a data input to the OTP 218 transmitter. The test data that the OTP 218 can verify is either (1) pseudorandom data or (2) discrete LMP verification messages. The OTP 218 receiver and IOC 210 verify the marker bits for the selected format, verify the data field for the pseudorandom data stream or LMP verification message, and communicate the results to the in-service SNM 205.

(a) OTP Functionality

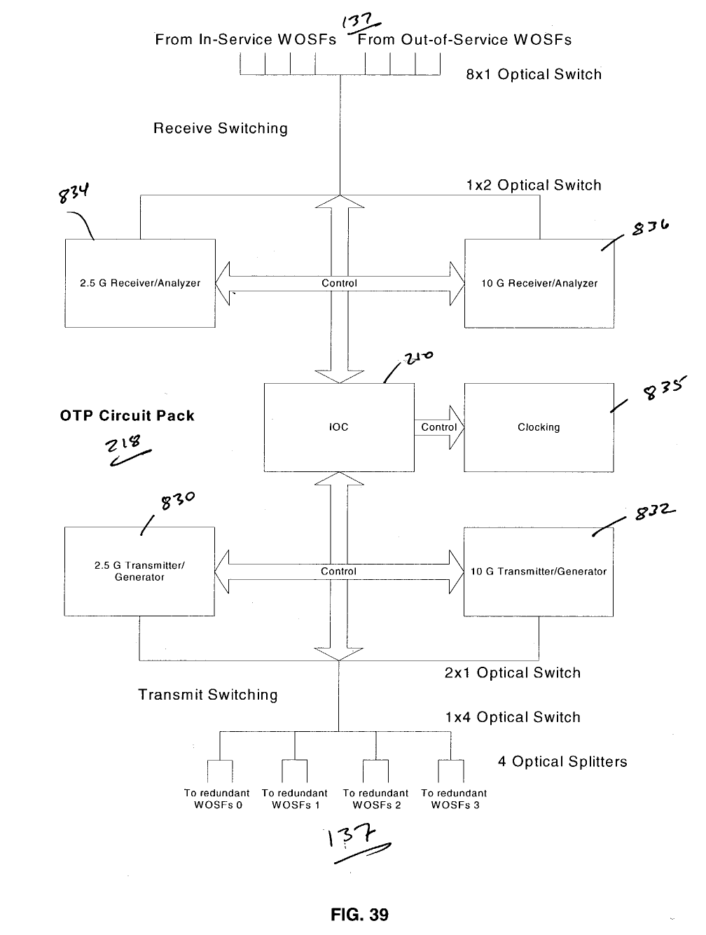

Referring to FIG. 39, the OTP 218 generates and receives an optical signal with embedded test data. The OTP 218 transmitted wavelength is 1550 nm. The data mode is selected by the in-service SNM 205 and is either pseudorandom or LMP messages.

The OTP 218 provides a 2.5 Gb/s transponder 830 that supports two data rates: (1) 2.488 Gb/s basic SONET and (2) 2.667 Gb/s SONET FEC. Additionally, the OTP provides a 10 Gb/s transponder 832 that supports three data rates: (1) SONET/POS 9.953 Gb/s, (2) 10.3 GbE, and (3) 10.709 Gb/s SONET FEC. The in-service SNM 205 selects the transponder and the data rate.

The OTP 218 sends and receives optical signals to and from any of four (4) wavelength optical switch fabrics (WOSF) 137 for both the in-service and out-of-service optical switch fabrics. Transmission to both switch fabrics is accomplished by means of an optical splitter that resides on the OTP 218. Selection from an optical switch fabric is by means of an optical switch that resides on the OTP 218. Selection of signals going to and coming from a particular WOSF 137 is by means of an optical switch that resides on the OTP 218.

The OTP 137 IOC 210 executes primitives under the command the in-service SNM 205 via the 100 BaseT Ethernet port.

The OTP 137 IOC 210 interfaces with the 2.5 Gb/s SONET receiver/analyzer 834, the 10 Gb/s SONET/10 GbE receiver/analyzer 836, the clocking function 835 and the optical switches. In addition, the OTP 137 IOC 210 provides the LMP message data field to the 2.5 Gb/s and 10 Gb/s generators 830 and 832 and verifies the received LMP messages from the 2.5 Gb/s and 10 Gb/s analyzers 834 and 836.

For pseudorandom data testing, the OTP 218 transmits and/or receives a framed Pseudo Random Bit Stream with a 2²³−1 pattern. This data field is applicable to the two SONET 2.5 Gb/s and the three 10 Gb/s SONET and Ethernet format. The receiver/analyzer 834 provides a Pass/Fail indication to the IOC 60 at the completion of the data analysis.

For LMP verification testing, the OTP 218 transmits the LMP message requested by the in-service SNM and verifies reception of the message, if requested.

The OTP 218 supports common circuitry for power distribution monitoring, alarming, selection, and low voltage shutdown.

The OTP 218 supports ACTIVE (green) and ALARM (red) faceplate LEDs common to the non-redundant IOS circuit packs.

The OTP 218 supports the common circuit pack features for latches, equipage, temperature sensor, Ethernet connections, and a debug port.

Table 12 identifies the key OTP 218 optical parameters. For the power levels and losses, connector losses are not included:

TABLE 12

Level

| Parameter | Min. | Max. | Units |
|---|---|---|---|
| Transmitter | | | |
| 10 Gb/s TX power to WOSF | −5 | −1 | DBm |
| Wavelength | 1529 | 1561 | nm. |
| Extinction Ratio | 6 | | DB |
| TX Off Power | | −30 | DBm |
| Eye Mask | ITU G.691 compliant | | |
| Jitter Generation | GR-253 compliant | | |
| 2.5 Gb/s Tx Power to WOSF | −4 | −1 | DBm |
| Wavelength | 1529 | 1561 | nm. |
| Extinction Ratio | 8 | | DB |
| TX Off Power | | −30 | DBm |
| Eye Mask | ITU G.691 compliant | | |
| Jitter Generation | GR-253 compliant | | |
| Receive | | | |
| 10 Gb RX Sensitivity | | −14 | DBm |
| OSNR (10 exp-12 errors/bit) | 22 | | DB |
| RX Overload | 0 | | DBm |
| Power from OSF | −14 | | DBm |
| Wavelength | 1529 | 1561 | nm. |
| Opt. Return Loss | 24 | | DB |
| Jitter Tolerance | GR-253 compliant | | |
| 2.5 Gb RX Sensitivity | | −18 | dBm |
| OSNR (10 exp-12 errors/bit) | 19 | | dB |
| RX Overload | 0 | | dBm |
| Power from OSF | −18 | | dBm |
| Wavelength | 1529 | 1561 | nm. |
| Opt. Return Loss | 27 | | dB |
| Jitter Tolerance | GR-253 compliant | | |
| Operating Temperature | −5 | 70 | Celsius |

| | |
|---|---|
| Dispersion | 1360 ps/nm |

Optical Performance Monitoring

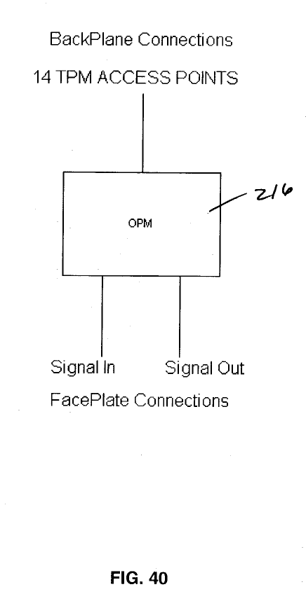

The IOS Optical Performance Monitor (OPM) Circuit Pack 216 measures optical power and OSNR and additionally provides wavelength registration and spectral data. The OPM 216 selects one of fourteen TPM access points from within the IOS system 60 using optical switches, with additional TPM access points selectable for larger capacity IOS products. FIG. 40 shows the OPM 216 as used in the IOS system 60.

(a) OPM Functionality

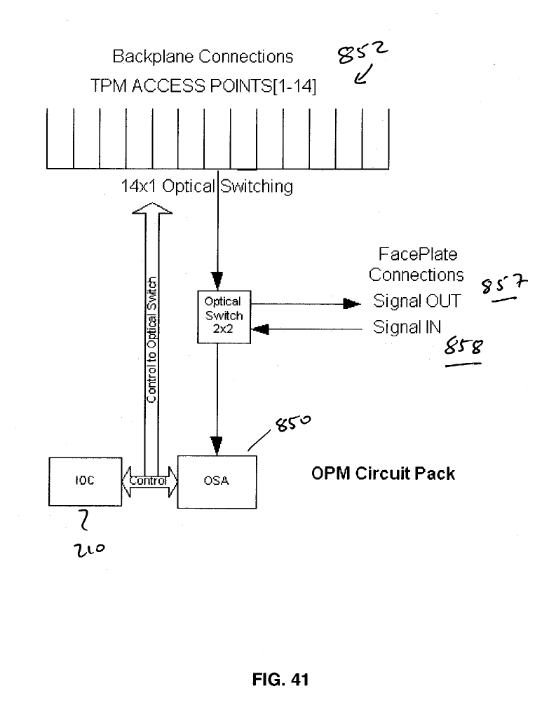

Referring to FIG. 41, the OPM 216 includes a controller (IOC) 210, an Optical Spectrum Analyzer (OSA) 850, and optical selector switches.

The OPM 216 IOC 210 executes primitives under the command the in-service SNM 205 via the 100 BaseT Ethernet port.

The OPM 216 measures and characterizes the following optical signal parameters: optical power level, OSNR, wavelength registration, and the C-Band optical spectrum.

The OPM selects up to 14 TPM access points 852 for IOS system using optical switches, with additional TPM 121 access points selectable for larger capacity IOS products. Each access point emanates from a tap at a TPM DWDM 32-wavelength egress or ingress signal.

At manufacture, the calibration procedure for the OPM Circuit Pack 216 measures and stores in parent board EEPROM the losses associated with connectors, on-board fiber, OSA 850 flat loss error, and other correlated losses. The OPM 216 IOC 210 compensates for this correlated flat loss by offsetting the measurement from the OPM 216 OSA 210 by this fixed calibration offset value.

The OPM 216 IOC 210 compensates for nominal loss from the TPM access points 852 to the OSA 216 by offsetting the OSA 216 measurement to correct for the nominal loss. The ingress configuration access point is at the output of the ingress amplifier. The TPM 121 IOC 210 compensates for the higher transmission level for this OPM access point and possible saturation of the amplifier by reading the power levels at the input and output of the ingress amplifier and referencing the egress amplifier output power measurement to its input. The egress configuration access point is at the output of the egress amplifier.

At TPM 121 installation, the installation procedure includes the calibration of the specific path from OPM 216 access taps in the TPM 121 to the OPM 216 OSA 850 to provide the data to compensate for this loss during OPM measurements. This calibration procedure includes the in-service SNM 205 reading the TPM access point 852 calibration data from the TPM 121 EEPROM that stores the TPM 121 calibration data and writing that information into the OPM 216 IOC 210. The OPM 216 IOC 210 thus has a unique per TPM 121 component of loss to add to the nominal loss of the TPM 121 access points 852 to compensate for the unique variable component of the TPM 121. The nominal loss of the access points refers to the slightly variable connections onto the TPMs that are selected by the 14×1 optical switch on the OPM Circuit Pack.

The OPM 216 IOC 210 therefore translates the OPM 216 OSA 850 measurement to the appropriate receive or transmit Transmission Level Point corresponding to the TPM DWDM receive termination or the transmit termination, including offsets for (1) OPM 216 calibration data, (2) nominal correlated flat loss, and (3) variable TPM-dependent loss and saturation.

The OPM 216 supports an OPTICAL SIGNAL IN 858 SC connector on the OPM Circuit Pack 216 faceplate that the customer can use in conjunction with an external precision optical source to verify or calibrate the OPM 216 OSA 850. The Transmission Level Point of the OPTICAL SIGNAL IN connector is the same as that of the OSA 850. The OPM 216 IOC 210 compensates for the variable loss over an ensemble of OPM Circuit Packs 216 by offsetting the measurement using the OPTICAL SIGNAL IN 858 access point manufacturing calibration data in the OPM EEPROM.

The OPM 216 supports an OPTICAL SIGNAL OUT 857 SC connector on the OPM Circuit Pack 216 faceplate that the customer can use to make measurements at the OPM 216 Data Plane 10 access points using an external OSA 850 test set. The Transmission Level Point of the OPTICAL SIGNAL OUT 857 connector is the same as that of the OTP 216 OSA 850, and the OPTICAL SIGNAL OUT 857 connector shows a nominal offset on the faceplate for the external OSA 850 reading.

The OPM 216 supports common circuitry for power distribution monitoring, alarming, selection, and low voltage shutdown.

The OPM 216 supports ACTIVE (green) and ALARM (red) faceplate LEDs common to the non-redundant IOS 60 circuit packs.

The OPM 216 supports the common circuit pack features for latches, equipage, temperature sensor, Ethernet connections, and a debug port.

The OPM 216 supports a fail-safe feature to prevent OSA 850 damage due to insertion of a high power optical signal into the faceplate connector.

(b) OPM Optical Performance

Table 13 lists the OPM 216 optical parameters:

TABLE 13

| | Specifications | | |
|---|---|---|---|
| Parameter | Min. | Max. | Units |
| Spectral Range | 1529 | 1561 | nm |
| Wavelength Accuracy (Absolute) | +/−50 | | pm |
| Peak to valley (100 GHz) OSNR | 20 | | dB |
| (Power >− 35 dBm) | | | |
| Peak to valley (50 GHz) OSNR | 15 | | dB |
| (Power >− 40 dBm) | | | |
| Peak Input Power Range | −40 | −10 | dBm/per |
| | | | channel |
| Absolute Power Error | +/−0.6 | | dB |
| Relative Power Error | +/−0.4 | | dB |
| Noise Floor (0.1 nm BW) | | −55 | dBm |
| Return Loss | 30 | | dB |
| Operating Temperature | −5 | 70 | Celsius |
| Request to Response Time - | | 2 | Seconds |
| Spectral Data | | | |
| Request to Response Time - | | .5 | Seconds |
| OSNR/Power/Wavelength | | | |
| Durability (scanning motor type) | 10 Million | | Cycles |

### Packet Networking

The specification for the OCP 20 Level packet networking, including descriptions of the external interfaces, internal interfaces, and the 1510 nm Optical Control Network is set forth as follows:

External Interfaces

Each SNM Gateway Processor 227 has an external Ethernet address that the IOS 60 uses for packet communication. Only the interface on the in-service Gateway Processor 227 is active.

The IOS 60 always uses its external interface for interchanging signaling messages with the UNI client control device. When the OCN is not available or the SDS 204 is co-located, this interface is also used for interchange of request, response, and trap messages with the SDS 204 using SNMP and transfer of bulk management data to the SDS 204 using UDP.

Depending upon on the remote location of the user, the external Ethernet interface is used for remote access of the CLI and TLI services using TELNET.

When the OCN is not available, the IOS 60 also uses the external Ethernet interface to access the external IP network for communication of network management, signaling, routing, and link management messages.

When the SDS 204 is co-located with the IOS 60, the IOS 60 operates as an IP packet switch to provide communication for this SDS 204 with remote IOSs 60 or other SDS 204 platforms using the external Ethernet interface.

The IOS 60 also has a serial port enabling the craft to access CLI and TLI services directly using VT100 emulation.

Internal Interfaces

The IOS 60 uses an IP-based interface, referred to as the Backplane Interface (BI), for all communication between circuit packs. IP runs over the private, redundant internal LAN. Messages between Applications Processors 228 on different IOSs 60 transit this LAN in order to be transmitted or received on the OCN. The IP addresses of this LAN are not advertised on any external network or the OCN.

Optical Control Network

The specifications for the Optical Control Network (OCN) address the software resident on the System Node Manager (SNM) 205 and IP addresses used in the OCN.

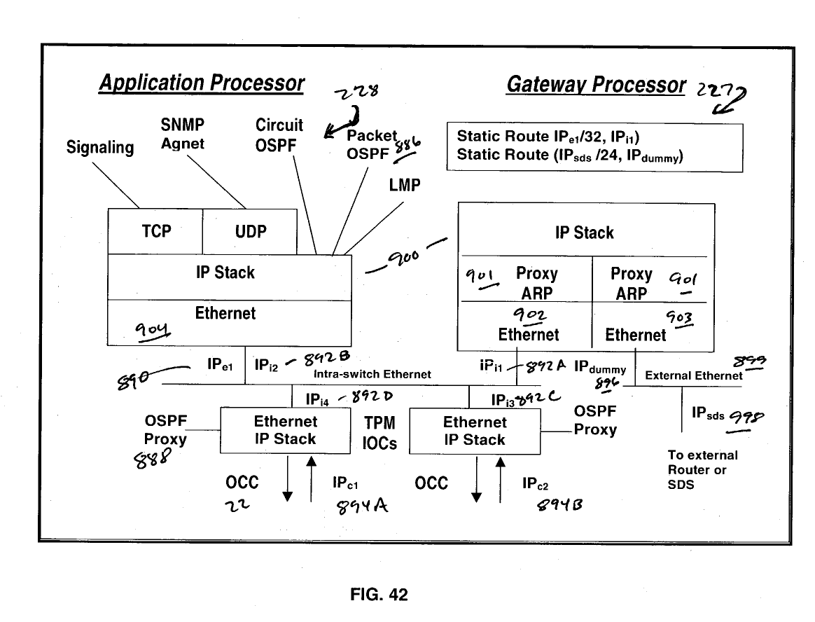

FIG. 42 depicts the SNM 205 architecture. The SNM 205 includes two processors: an Application Processor 228 and a Gateway Processor 227. All Optical Control Plane 20 software, such as Configuration Manager, Signaling, Routing, and LMP, runs on the Application Processor 228. The Gateway Processor 227 is used solely to forward Optical Control Network packets. The introduction of the Optical Control Network using the 1510 nm Optical Control Channel (OCC) 22 requires a packet routing function in the SNM 205 software. OSPF is the choice for this packet routing function. In order to distinguish this function from the lightpath calculation function, the lightpath calculation function is termed Circuit OSPF and the packet routing function is termed Packet OSPF 886. Both the Circuit OSPF and Packet OSPF run on the Application Processor 228. The Packet OSPF module implements the complete OSPF protocol including initialization, link state advertisement, and forwarding table generation. When a new forwarding table is generated, the Packet OSPF 886 module updates the forwarding tables on the Gateway Processor 227 and all TPMs 121 so that control packets are forwarded correctly. With this architecture, all packets transiting the IOS 60 can be forwarded without any involvement of the Application Processor 228.

As shown in FIG. 42, there are 4 different categories of IP addresses used in an IOS 60: the external IP address (IPₑ₁) 890, the intra-switch IP addresses (IPᵢ₁˜IPᵢ₄) 892A-892D, the OCC IP addresses (IP_{c1} and IP_{c2}) 894A and 894B, and a dummy IP address (IP_{dummy}) 896.

The external IP address 890 is a public IP address. This is the only IP address that is visible outside of the OCN. SDS 204 uses this IP address 890 to access the IOS 60. The intra-switch IP 894A-894D addresses are private IP addresses, which are used only within an IOS. The forwarding table update module uses these addresses. The OCC IP addresses 894A and 894B are also private IP addresses, which is advertised within the OCN. The dummy IP address 896 associated with the external Ethernet interface of the Gateway Processor 827 is used only facilitates the Proxy ARP 888. For the packet OSPF 886 routing, the IOS advertises external IP addresses 890 into the OCN. However, the intra-switch IP addresses 892 are not advertised in the External IP Network or the OCN.

Since all software modules run on the Application Processor 228, Telnet/FTP/SNMP traffic from SDS 204 cannot be implemented on the Gateway Processor 227 to make the software modules accessible to SDS 204 stations.

The OCN specification for the IP address assignment is first described below, followed by the Packet OSPF, Proxy ARP, Forwarding Table Generation and Update, and Packet Forwarding modules, respectively.

(a) IP Address Assignment

The Intra-switch IP addresses 892 are assigned automatically to correlate with the bay, shelf, and slot location of the circuit pack. These addresses are drawn from the private IP addresses specified in RFC 1918. The network part of these IP addresses is configurable by the Management Plane 30. The host part is derived from the location of the circuit pack. These addresses are not advertised to the external IP network or the OCN.

The Management Plane configures OCC IP addresses 894 through the Configuration Manager on the Application Processor 228. Preferably these addresses are also drawn from the private IP addresses specified in RFC 1918. Since these addresses are advertised into the OCN, each OCC IP address 894 is unique within the OCN. These addresses are not advertised into the external IP network.

The Management Plane 30 configures the external IP address 890 through the Configuration Manager on the Application Processor 228. This IP address 890 is associated with the intra-switch Ethernet interface 897 of the Application Processor 228. This IP address 890 is advertised into the OCN.

The dummy IP address 896 is a fixed IP address, there is no possibility of colliding with other IP addresses used in the Internet and the OCN.

(b) Packet OSPF Module

The Packet OPSF Module 886 implements the OSPF protocol in accordance with RFC 2328 and the associated MIB RFC 1850 to generate packet forwarding tables for use in the IOS Optical Control Network using the OCC IP addresses 894. The IOS OCC 22 interfaces are numbered. Packet OSPF 888 runs on the Applications Processor 228 and executes the OSPF routing protocol over all OCC 22 interfaces.

The Packet OSPF 886 transmits/receives protocol messages via Backplane Interface (BI) (see incorporated Specification Attachment 1—Backplane Interface Definition Document). To transmit a packet, it constructs the OSPF packet including the IP header and then sends the packet via BI message to the OSPF Proxy 888 on the IOC 210 on the TPM circuit pack 121. When an OSPF packet arrives at the IOC 210 on the TPM 121, the OSPF proxy 888 forwards the packet along the original IP header as an BI message to Packet OSPF.

The Packet OSPF 886 transmits Link State Advertisements (LSA) periodically according to the RFC 2328 when connectivity changes occur. Upon receipt of an LSA, the Packet OSPF module updates the forwarding tables by re-running the shortest path first algorithm if necessary.

The Packet OSPF 886 uses a value for the Link Cost metric in its LSAs for OCC interfaces as configured by the Management Plane 30. These costs are used in the shortest-path-first algorithm. The external IP network is reached through a default route configured by the Management Plane 30.

The Packet OSPF module 886 retransmits LSAs when it does not receive an acknowledgement. The Packet OSPF module 826 uses a retransmission interval configured by the Management Plane 30 in determining when to retransmit unacknowledged LSAs.

To estimate the time it takes to receive an LSA acknowledgment to its neighbors, the Packet OSPF module 886 uses a transit delay value configured by the Management Plane 30.

In determining when to query adjacent IOSs 60 that were determined to be not operational, the Packet OSPF 886 module uses a polling interval configured by the Management Plane 30.

The Packet OSPF module 886 learns the IP addresses of its neighbors by sending/receiving “Hello” messages via BI messages to/from the OSPF proxy 888 on the TPM 121 IOCs 210 210.

The Packet OSPF module 886 uses the External IP address of the SNM 205 as the RouterID in OSPF messages.

The Packet OSPF module 886 monitors the status of adjacent IOSs 60. The Packet OSPF module uses a “Hello” Interval and RouterDead Interval values configured by the Management Plane. The “Hello” Interval determines the frequency for sending OSPF “Hello” messages to the neighbors. If no Hello messages are received in any period exceeding the RouterDead Interval, the IOS declares its neighbor to be not operational and generate new LSAs.

The Packet OSPF module 886 receives notification from the SNM Fault Manager when any IOS 1510 nm Optical Control Channels 22 have failed.

The Packet OSPF module 886 receives notification from the SNM Configuration Manager when any IOS 1510 nm Optical Control Channels have been placed in/out of service.

The Packet OSPF 886 uses its OCC IP addresses (IP_{c1} and IP_{c2} 894A and 894B) in all its OCN advertisements. When there are multiple 1510 nm links, the interfaces have individual IP addresses.

The external IP address (IPₑ₁) 890 is configured as a host route into the Packet OSPF module and advertised into the OCN. But intra-switch 892 and OCC IP addresses 894 are not advertised into the External IP Network.

The Packet OSPF module 886 does IP bootstrapping for IOS 60. Since the external IP address 890 of the IOS 60 is used as the RouterID in Packet OSPF, the IP address of a neighboring IOS is readily available when a “Hello” message is received. The Packet OSPF module 886 informs LMP of the IP address for the neighboring IOSs.

The Management Plane configures static routes for SDS 204 stations reachable from the IOS 60. Packet OSPF 886 advertises these routes into the OCN so that other IOSs can reach the SDS stations via the IOS.

(c) Proxy ARP

Since the external IP address 90 is associated with the intra-switch Ethernet interface 904 of the Application Processor 228, SDS 209 does not communicate with this IP address 290 without the help of the Gateway Processor 227. Proxy ARP and static routes are automatically configured on the Gateway Processor 227 to enable this communication.

Proxy ARP is performed on the external Ethernet interface 903 of the Gateway Processor 228 for the external IP address (IPₑ₁) 890 associated with the intra-switch Ethernet interface 904 of the Application Processor 828.

Proxy ARP is performed on the intra-switch Ethernet interface 902 of the Gateway Processor 227 for the IP address (IP_{sds}) 998 associated with the SDS 209 station or an external router.

Static host route for IPₑ₁ 890 via IPᵢ₁ 892A is automatically added into the forwarding table of the Gateway Processor 227 so packets for IPₑ₁ 890 can be forwarded to the intra-switch Ethernet 897.

Static route for the subnet of IP_{sds} 898 via IP_{dummy} 896 is added automatically to the forwarding table of the Gateway Processor 227 so that packets for IP_{sds} 898 can be forwarded to the external Ethernet 899.

(d) Forwarding Table Generation and Update

The Packet OSPF 886 function is resident on the Application Processor 228. It updates forwarding tables on the Application Processor, the Gateway Processor 227, and all TPM circuit packs 121.

The forwarding table on the Gateway Processor 227 routes via OCCs 22 for all IOS 60 external IP addresses 890, OCC IP addresses 892, and configured SDS stations' IP addresses 998. A default route to an external router is configured on the Gateway Processor 227. If there is a route via an OCC 22 to reach another IOS 60 or an SDS 204 station exists, that route is used. Only when no OCC 22 routes are available is the default route to the external router used.

The Packet OSPF module 886 is resident on the Application Processor 228 and generates new forwarding table in response to OCC 22 connectivity changes, Ethernet status changes, and static routes configuration changes.

The Packet OSPF module 886 updates the forwarding table on the Application Processor 228.

The Packet OSPF module 886 updates the forwarding table on the Gateway Processor 227 via BI messages.

The Packet OSPF module 886 updates the forwarding tables for the IOCs 210 on all TPM 121 circuit packs via BI messages.

(e) Packet Forwarding

The IP stacks 900 on the Application Processor 228, the Gateway Processor 227, and IOCs 210 on all TPM circuit packs 121 all contribute to the packet forwarding of the OCN. Transit traffic (IP packets with destination other than the external IP address 890 of the IOS 60) is forwarded to other IOSs 60 via OCCs 22 or an external router. Non-transit traffic (IP packets with destination of the external IP address 890 of the IOS 60) is forwarded to the Application Processor 228. Transit traffic may pass through the Gateway Processor 227, but not the Application Processor 228.

Transit traffic coining from the external Ethernet interface of the Gateway Processor 227 is forwarded to an IOC 210 (of a TPM 121) for further forwarding out of its OCC 22 interface.

Transit traffic coming from the OCC 22 interface of a TPM 121 and being forwarded over the local external LAN is forwarded to the Gateway Processor 227 for transmission on its external Ethernet interface 903.

Transit traffic coming from the OCC 22 interface of a TPM 121 and being forwarded to another IOS 60 over the OCN is routed to the forwarding TPM 121 IOC 210 for transmission on the OCC 22 interface.

Non-transit, inbound traffic coming from the external Ethernet interface 903 of the Gateway Processor 227 is forwarded to the Application Processor 228 for local processing.

Non-transit, inbound traffic coming from the OCC 22 interface of a TPM 121 is forwarded to the Application Processor 228 for local processing.

Non-transit, outbound traffic generated by the Application Processor 228 is forwarded to either an IOC 210 (of a TPM 121) or the Gateway Processor 228.

Non-transit, outbound traffic generated by the Gateway Processor 228 is forwarded to an IOC 210 (of a TPM 121) or an external router.

SNM Circuit Services Software

This section presents the specifications for the circuit services provided by the OCP 20 in the IOS 60.

Circuit Routing

The following description addresses the Optical Circuit Routing software resident on the System Node Manager (SNM 205) is an embodiment of the present invention. The scope covers the circuit routing aspects of the OCP 20 software in supporting the establishment of SOC, EPOC, and POC types of circuits, together with various service level agreements.

The following sub-sections present the details of the OCR software specification. The first sub-section defines the logical network topology and its creation procedure. Then the second sub-section outlines all the basic IOS operations for Band Path and Optical Circuit creation and deletion. The third sub-section introduces routing rules for optical circuit route generation. The last sub-section specifies routing procedures for various circuit type and service levels.

(a) Maintaining Logical Network Topology

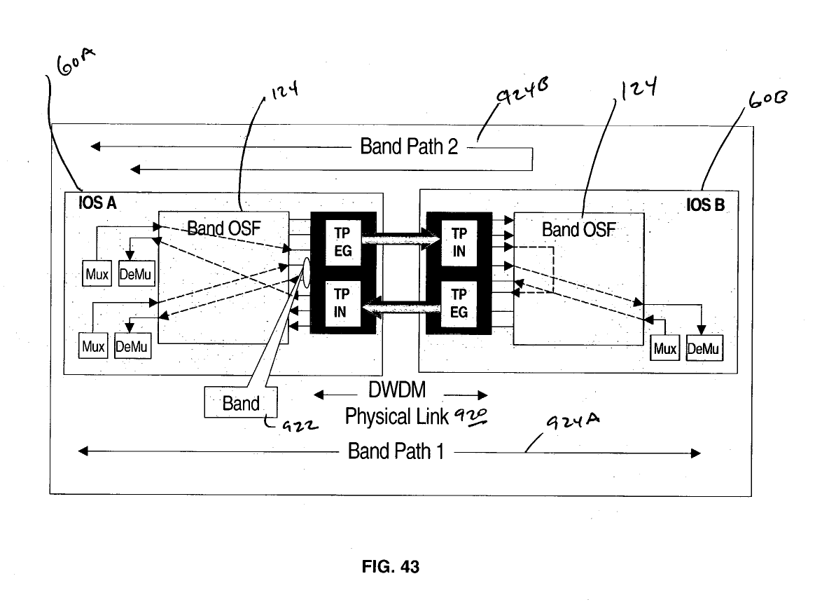

With reference to FIG. 43, the following terminology is used to define the physical network topology and logical network topology of IOS network 310.

DWDM Physical Link 920—A physical link is comprised of bi-directional DWDM TPM ports resident on two different IOSs 60 and the fibers that connect them.

Band 922—A band is a group of contiguous wavelengths within a DWDM physical link, which can be switched as one entity by the Band Optical Switch Fabric (BOSF) 124.

Band Path 924—A band path is formed by concatenating an ingress and an egress band together through a BOSF 124 at each IOS 60. The band path 924 terminates on WMXs on both end IOSs 60. FIG. 42 depicts two band paths. Band Path 1 924A is one hop from IOS A to IOS B. Band Path 2 924B starts from IOS A, loops back in IOS B BOSF, and back to IOS A. BP 2 924B is the configuration to test band switching when there are only two IOSs 60 available.

Logical Link—A Logical Link (LL) is defined on top of one Band Path (BP) 924 or a bundle of multiple BPs 924 traversing the same route. The LL is bi-directional. With TE properties specified, LL is equivalent to a TE Link as per the GMPLS definition. The source IOS 60 node of the LL is called the headend. For bi-directional LL, both end nodes are headends of the LL.

The Physical Network Topology is a graph in which the nodes represent IOS switches, and the links represent the DWDM Physical Links 920. It is assumed that the MP maintains the Physical Network Topology in its database, and uses it to create Band Paths 924 and Logical Links. The IOS routing module does not need to be aware of the physical network topology.

The Logical Network Topology is a graph in which the nodes represent IOS switches, and the links represent the Logical Links provisioned by the MP 30.

(b) Band Path Creation

The MP sends down requests to the source end point IOS 60 nodes to create a band path 924 between the two. The request specifies the band to be used, and the exact route through network the BP 924 takes. The IOS 60 OCP 20 validates the request by checking whether the specified resources are available. If not, the request is rejected. If yes, the resources are reserved for the BP 924.

The route generated by MP 30 complies with the engineering rules.

The OCP 20 then invokes GMPLS signaling to set up the BP 924 through the network (see the signaling section for details). Once the BP 924 is up, OCP 20 informs Network Management Services (NMS).

The MP 30 can also set up the BP 924 by provisioning Band Switch Cross Connects on each individual IOS node.

(c) Logical Link Configuration

The MP 30 sends down request(s) to configure a LL at the headend IOS node on top of an existing BP 924 or multiple BPs 924 traversing through same route. The request specifies the BP(s) to be included, traffic engineering parameters as specified in [GMPLS_HIER| and |GMPLS_BUND]. MP 30 must set the admin status of the LL to be In Service to activate the link. Both headends are configured for bi-directional LL. LMP is invoked to validate the configuration.

The request to configure the LL can be combined with the request to create BP(s) 924, so that a single MP 30 command triggers both the BP creation and LL configuration.

When a LL is configured and activated, the headend IOS Routing Module advertise the LL into its routing domain. Each IOS 60 in the network maintains a logical topology of the network inter-connected by the LLs. The Optical Circuit Routing is based on this logical topology only. The advertisement of such LL contains the information about the path taken by the underneath BP(s) 924 that are associated with the LL.

The IOS Routing Module advertise the LL in conformance with the GMPLS routing extension [GMPLS_ROUT], and [GMPLS_OSPF], plus λ-aware information.

The default cost of the LL is defined based on the costs of the physical links that the LL traverses through. The MP 30 can always overwrite the default LL cost. The routing module advertises this cost to be associated with the LL.

When a wavelength is assigned to setup a new optical circuit, the headend IOS Routing Module updates the LL link utilization to its peers just as it does for ordinary links. The updates happen within 500 ms after a topology change, or ASAP as the protocol allows.

When a failure occurs that involves a LL, the headend IOS 60 is notified. If it is a partial failure, the routing module adjusts the bandwidth availability information and advertises it to the peers. If the failure completely disables the LL, the routing module sets the Operational Status of the LL to be Out-of-Service and stops advertising that LL until the failure is cleared.

MP 30 can modify the LL parameters after the LL is created. To change some of its parameters, the LL must be taken administratively out of service before any change can be made. These parameters include the SRL information, the resource class, deletion of underneath BP(s) 924, re-route of the BP(s) and the like.

A new BP 924 can be added to a LL to increase its capacity. The LL can remain in service while this change is made.

When the LL is administratively taken out of service, all the optical circuits using the link are released, either automatically through signaling, or manually by the MP.

(d) IOS Basic Operations for Band Path and Optical Circuit Setup

To set up and delete band paths, the OCP 20 provides the following basic operations. In case the MP 30 provisions the Band Path (BP) 924 manually, these operations are invoked directly by MP 30 through SNMP Agent. In case the band path is set up through signaling, these operations are invoked by OCP Call Control module.

OCP 20 supports creation of BP 924 at Terminating IOS 60 by setting up cross connects between WMX ports and DWDM band ports in the Band Optical Switch Fabric (BOSF) 124.

OCP 20 supports creation of BP 924 at Intermediate IOS 60 by setting up cross connects between DWDM band ports in the BOSF 124.

OCP 20 supports deletion of BP 924 at Terminating IOS 60 by deleting cross connects between WMX ports and DWDM band ports in the Band Optical Switch Fabric (BOSF) 124.

OCP 20 supports deletion of BP 924 at Intermediate IOS 60 by deleting cross connects between DWDM band ports in the BOSF 124.

To set up and delete optical circuits (OCs), the OCP 20 provides the following basic operations. In case MP 30 provisions the OC manually, these operations are invoked directly by MP 30 through SNMP Agent. In case the OC is set up through signaling, these operations are invoked by OCP Call Control module.

OCP 20 supports creation of an OC at the source IOS 60 node (add a OC on to a Band Path) by setting up cross connect between transponder (XP) Tx port and port of Wavelength Multiplexer of the band path in the Wavelength Optical Switch Fabric (WOSF).

OCP 20 supports creation of an OC at the destination IOS 60 node (drop an OC off a Band Path) by setting up cross connect between port of Wavelength Demultiplexer of the band path 924 and XP Rx port in the WOSF.

OCP 20 supports deletion of an OC at the source IOS 60 node by deleting the cross connect between transponder (XP) Tx port and port of Wavelength Multiplexer of the band path 924 in the Wavelength Switch Fabric (WOSF) 137.

OCP 20 supports deletion of an OC at the destination IOS node by deleting the cross connect between port of Wavelength Demultiplexer of the band path 924 and XP Rx port in the WOSF 137.A multi-link OC traverses through multiple LLs between its source and destination. An intermediate node is where the OC switch from one LL to another. OCP 20 support creation of a Multi-link OC at Intermediate IOS 60 by setting up cross connect in the WOSF 137, between Demux port of the incoming LL and Mux port of the outgoing LL.OCP supports deletion of a Multi-link OC at Intermediate IOS 60 by deleting cross connect in the WOSF 137, between Demux port of the incoming LL and Mux port of the outgoing LL. (e)

Wavelength Conversion

OCP 20 supports wavelength conversion at Source IOS 60 by setting up cross connects between input port of Wavelength Converter (WC) 140 and XP Tx port in the WOSF 137. Later this WC 140 output port is used as the XP Tx port in OC creation.

OCP 20 supports wavelength conversion at Intermediate IOS 60 by setting up cross connects in the WOSF 137, between input port of WC 140 and Demux port of the incoming LL, then the output port of WC and Mux port of the outgoing LL.

(f) Multi-Circuit Request

In order to support multi-circuit request, OCP 20 provides a new set of API functions to perform operations specified in the foregoing basic operations description on multiple wavelengths.

(g) Rules for Optical Circuit Routing Over Logical Links

The OCP 20 routing module generates route for OC request based on the logical link (LL) database that it obtained by exchange LSA information with its peers. Following is a set of routing rules the OCP applies when generating the route. For various routing scenarios, please refer to the sub-section “Routing Scenarios” that follows in this description.

The OCP 20 checks first whether there is a direct LL between the source and destination node. If yes, then this LL is used. No engineering rule validation is required for this case because each BP 924 underneath the LL is verified to comply with the IOS engineering rules upon set up, thus an OC going over a single LL must also comply.

If no direct LL can be found, OCP 20 uses constraint based routing to compute a route that includes multiple LLs. The route should be optimal in terms of the total cost. The constraint is that the route must pass all the engineering rule validation. In addition, the route must also meet various diversity conditions imposed by different service levels set forth in the following sub-section.

The validation of the engineering rules can be disabled by the MP 30 on a per-IOS 60 basis.

If still no route can be found, the routing module can consider wavelength conversion at the source IOS 60, and then apply to again. Wavelength conversion at intermediate IOS 60 is for future consideration.

Finally, the routing module may pre-empt existing a low priority circuit(s) that is (are) not associated with a protection OC, in order to free up resources for the new, higher priority request. The criterion is to pre-empt as few LP circuit as possible. If no route can be generated in the present embodiment, the OCP 20 rejects the OC request back to UNI (in case of SOC), or retry (in case of EPOC) for maximum configurable number of times.

In alternative embodiments, OCP 20 may dynamically generate a BP 929 to accommodate the OC request.

(h) Routing for Different Circuit Types and Service Levels

OCP 20 implements the IETF Open Shortest Path First (OSPF) routing protocol with opaque LSAs as extended for optical networks to support route generation for SOC (requested through UNI), and EPOC (requested through MP).

The OCP 20 supports networks having a single optical domain (all optical network with internal DWDM) for future embodiments. Support of networks having multiple optical domains (mix of integrated and external DWDM systems) is for future embodiments. The OCP 20 maintains the current network graph depicting the logical network topology for each Logical Links. The network graph includes both the NNI links, which are defined on top of LLs, and UNI links.

The OCP 20 supports route generation for Low Priority, Basic unprotected, and Auto-restored SOC, EPOC path request. The OCP generates a single route that complies with any diversity rules (Link, Node, SRL) specified in the request.

The OCP 20 supports route generation for 1:1 and 1+1 service level path request. The routing module generates two disjoint paths, one for the working and one for the protection path. The OCP 20 route generation supports the following disjoint path options: Link disjoint, Node disjoint and SRL disjoint.

In the disjoint path calculation, the OCP 20 offers the following computational options: Two Step only, Path Augmentation and Two Step with Path Augmentation if Two Step Fails. However, Path Augmentation need not be available for the SRLG disjoint path option.

When the path of a SOC or EPOC with auto-restoration capability fails due to network problems, upon request from OCP Service Level Manager (SLM), the routing module generates a new route to restore the failed path. The new route complies with the diversity rule (Link, Node, or SRL) of the original path request, and also avoids the network failure point.

When the working or protection path of a 1:1 or 1+1 SOC, EPOC path is down due to network fault, upon request from OCP Service Level Manager (SLM), the routing module generates a new route to restore the failed path. The new route complies with the diversity rule (Link, Node, or SRL) of the original path request, and also avoids the network failure point.

(i) Routing for a Multi-Circuit Request

Upon receiving a multi-circuit request, the OCP Routing Module computes and returns a single route, which can accommodate all the circuits requested. If such a route cannot be found, the request is rejected.

The rules specified in the preceding description apply when the routing module computes the route for multi-circuit request.

(j) Static Routing

The IOS 60 also performs static routing for SOCs and EPOCs. This protocol also operates on the logical topology where the MP 30 configures the routing tables.

Signaling

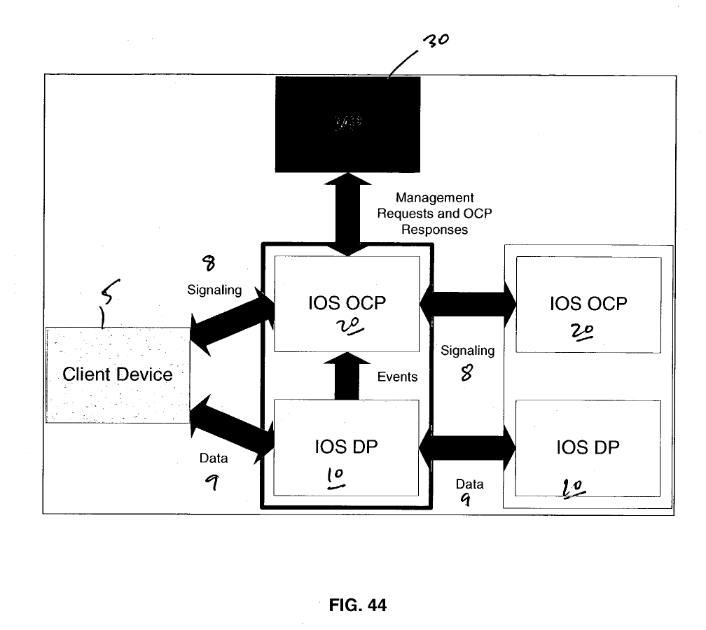

Referring to FIG. 44, the signaling function 8 of the IOS processes requests and events that come from the MP 30, DP 10, and client devices 5. The primary function of signaling is to provide the inter-switch protocol for creating and deleting Band Paths (BPs) 294 and Optical Circuits (OCs).

Four functional areas are described with respect to an embodiment of the present invention. The first, the Internal Network-Network Interface (NNI), describes signaling between switches in the same network. The second, External NNI, describes signaling between switches in different networks. The third, User-Network Interface (UNI), describes signaling between switches and client devices. The fourth, Service Level Management (SLM), describes the functions that stand between the UNI (or other circuit handler, such as for EPOCs) in order to map complex service level requests (such as protection) into elemental network operations.

(a) Internal NNI

The OCP 20 supports the Generalized Multi-Protocol Label Switching (GMPLS) signaling defined by the IETF as its NNI. For initial release, the OCP 20 supports only RSVP-TE with extensions for GMPLS. Further proprietary extensions are expected as needed to support protection and multi-circuit requests. Support for CR-LDP with extensions for GMPLS is for the future.

The OCP 20 uses GMPLS to provide an inter-switch protocol in support of creating BPs 294. All requests are validated against configuration and link state. The BP 294 creation procedure includes sufficient information for the OCP 20 routing module to establish a Forwarding Adjacency between the endpoints of the band path.

The OCP 20 uses GMPLS to provide an inter-switch protocol in support of deleting BPs created with GMPLS. All requests are validated against BP 294 state. The BP 294 deletion procedure includes sufficient information for the OCP 20 routing module to remove the Forwarding Adjacency that existed between the endpoints of the BP 294.

When there is a failure in a BP 229 that was created at the direct request of the MP 30 (as opposed to indirectly to satisfy a circuit request), the OCP 20 does not take any action to delete that BP 294 but notifies the MP 30.

In embodiments of the inventions, BPs 294 are created dynamically. Once a dynamically created BP 294 is established, the OCP 20 receives any defects pertaining to that BP 294 from the DP 10. If, after correlation, the OCP 20 determines that a failure is due to a local problem (on the local switch or an attached physical link), it sets a BP 294 Wait To Release (BP-WTR) timer. If that timer expires before the failure has been cleared, the OCP on that switch initiates the deletion of that BP 294, but only after completely releasing any Optical Circuits using that BP 294, and only if that BP 294 was created with GMPLS.

The OCP 20 uses GMPLS to provide an inter-switch protocol in support of creating OCs 20. All requests are validated against configuration and link state. In particular, circuit requests are accepted if there is a Logical Link through which to route the OC 20. This may involve using a previously existing BP 294, or creating a new one to support the request. These requests may specify multiple OCs to be created simultaneously as described below.

The OCP 20 uses GMPLS to provide an inter-switch protocol in support of deleting Optical Circuits (OCs). All requests are validated against circuit state. These requests may specify multiple OCs to be deleted simultaneously, as described below.

For EPOCs and SOCs, once a circuit is established, the OCP 20 receives any defects pertaining to that circuit from the DP 10. If after correlation the OCP 20 determines that a failure is due to a local problem (on the local switch or an attached physical link), it sets an OC Wait To Release (OC-WTR) timer. If, upon expiration of this timer, the failure has not cleared, the OCP 20 uses GMPLS to initiate the deletion of the OC.

When there is a failure in a POC or RPOC, the OCP 20 does not take any action to delete that circuit but notifies the MP 30.

The OCP 20 accepts special MP 30 Circuit Delete requests to delete signaled circuits. This is an abnormal condition and is distinct from a normal delete request described below. If the request is received at either endpoint, the OCP 20 attempts to forward the request to the other endpoint across the network using GMPLS. If the request is received at an intermediate switch, the OCP 20 attempts to forward the request to both endpoints across the network using GMPLS. If this is applied to a circuit that is part of a protection pair, only that circuit, not its mate, is deleted. If this circuit has service level Auto-Restoration, 1:1 Protection, or 1+1 Protection, the OCP 20 attempts to restore that circuit as described below.

The OCP 20 accepts requests to create up to 32 OCs from a single request. Routing of these OCs are not required to reside on the same fiber, although they must pass through the same nodes in the same order. The number of signaling messages sent and received to create these OCs is equal to the number sent and received for the creation of a single OC. The OCP 20 uses proprietary modifications to GMPLS as necessary to support this capability.

The OCP 20 accepts requests to delete up to 32 OCs with a single request.

The OCP 20 supports MP 30 requests to reroute BPs 894 and OCs to support network reoptimization.

(b) External NNI

The External NNI is not supported in the described embodiment.

(c) UNI

The OCP 20 supports the UNI defined by the Optical Internetworking Forum (OIF). The OCP 20 supports both RSVP-TE with extensions for OIF-UNI and CR-LDP with extensions for OIF-UNI.

The OCP 20 uses OIF-UNI to provide a client-network protocol in support of creating Optical Circuits (OCs). All requests are validated against configuration and link state.

The OCP 20 uses OIF-UNI to provide a client-network protocol in support of deleting Optical Circuits (OCs). All requests are validated against circuit state.

The OCP 20 allows for the sharing of port attributes between the switch and attached client devices through the use of OIF-UNI defined Service Discovery. This includes the exchange of the following information: (1) Signaling Protocol (RSVP-TE or CR-LDP); (2) Port Service Attributes, including Link Type (Gigabit Ethernet, SDH, SONET, Lambda, etc.), Signal Types (Gigabit Ethernet, OC 192, OC −48), Transparency and Local Interface ID; and (3) Network Service Attributes, including Transparency and Diversity.

(d) SLM

For EPOCs and SOCs, when the OCP 20 receives a request to create an OC with Low Priority service level, it first attempts to use an inactive (not carrying traffic) circuit that is serving as protection for a 1:1 circuit, and that meets any necessary criteria (lambda, diversity, etc.). Failing this, it initiates the creation of a new circuit.

When the OCP 20 receives a request to create a POC or RPOC with Low Priority service level it uses the route provided by the MP 30.

When the OCP 20 receives a request to create an OC with Basic service level, it initiates the creation of a new circuit. If this is a POC or RPOC, it uses the route provided by the MP 30, otherwise it determines the route using the OCP 20 routing module.

For EPOCs and SOCs, when the OCP 20 receives a request to create an OC with 1:1 service level, it initiates the establishment of two diverse OCs. One, which initially is the working circuit is created using previously unused resources. The other, which initially is the protection circuit, first attempts to reserve a Low Priority circuit that meets any necessary criteria (lambda, diversity, etc.). Failing this, it initiates the creation of a new circuit.

For EPOCs and SOCs, when the OCP 20 receives a request to create an OC with 1+1 service level, it initiates the establishment of two diverse OCs. Both the working and protection circuits are created using previously unused resources.

For POCs and RPOCs, when the OCP 20 receives a request to create an OC with 1:1 or 1+1 service level, it initiates the establishment of two OCs using the routes provided by the MP 30.

When the OCP 20 at the endpoint of an OC receives a request to delete that OC (distinct from the special deletion requests described previously), it initiates the deletion of that circuit (or circuits in the case of protection).

For EPOCs and SOCs with Auto-Restoration, 1:1 Protection, or 1+1 Protection, the OCP 20 at the source attempts to restore a failed circuit by creating a new circuit. The frequency and number of these attempts is configurable.

Provisioning—Resource Manager

The Provisioning functions performed by the Resource Manager in the IOS 60 are provided in an embodiment of the present invention as follows.

Resource Manager sets cross-connects during circuit set up and releases cross-connects during circuit release. Upon receipt of a command, it validates the command and rejects invalid commands where resources are not available for use in the case of set up or not being utilized in the case of release.

Resource Manager sets cross-connects in response to commands from the MP for test and diagnostic purposes. For example, the craft may set up a loopback circuit to perform tests.

The Resource Manager maintains port map for the Band Optical Switch Fabric and each Wavelength Optical Switch Fabric in the firstwave proprietary MIB enabling the MP to retrieve the port map using SNMP.

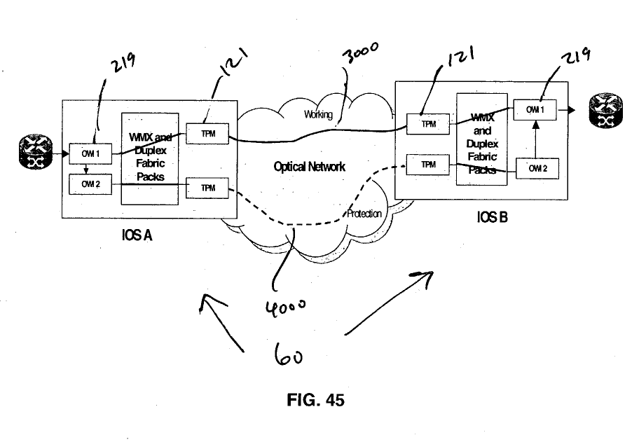

Service and Protection Configurations FIGS. 45-48 show the services and the special 1+1 and 1:1 configuration protection configurations provided by the IOS OCP 20.

The IOS OCP implements the Basic, Low Priority, Auto-restoration, 1+1 protection, and 1:1 protection service levels for each type of optical circuit. The 1:N and shared protection are implemented in alternative embodiments.

The IOS supports each of these service levels for each type of optical circuit: SOC—setup and routed by the OCP 20 in response to a user request received over the UNI; EPOC—setup and routed by the OCP 20 in response to a user request received from the MP 30; and POC—setup by the OCP 20 in response to a user request received from the MP using a route supplied by the MP 30.

The MP 30 may automatically generate the route using NPT. In this case the circuit is referred to as an RPOC, but this is transparent to the OCP 20.

When a service-affecting failure occurs, the IOS 60 releases circuits with the Basic Service level after the expiration of a Wait for Restoration timer for SOCs and EPOCs. If the circuit has the Auto-restoration service level, the OCP 20 releases the path and establish a new path for SOCs and EPOCs. For POCs, it performs these operations in response to commands from the MP 30.

The OCP 20 implements the 1+1 path protection feature for SOCs, POCs, EPOCs, and RPOCs by performing bridging and switching operations using adjacent OWIs 219 in the same OWI shelf 70. FIG. 45 illustrates the operational concept for a uni-directional circuit with data flow from A to B. For bi-directional circuits, the same functionality is provided in the B to A direction. The OCP 20 establishes disjoint working and protection paths according to link, node, or SRL criteria. At the source A, the client data flow is bridged between adjacent circuit packs and routed through the network on disjoint paths. At the destination, the client data flow is received on two different TPM circuit packs 121 and cross-connected to the adjacent OWIs 219. When a failure occurs, the in-service SNM 205 commands the transponder IOC 210 to set the tail-end switch on the OWI circuit pack 219 in order to forward the protection data flow to the client device.

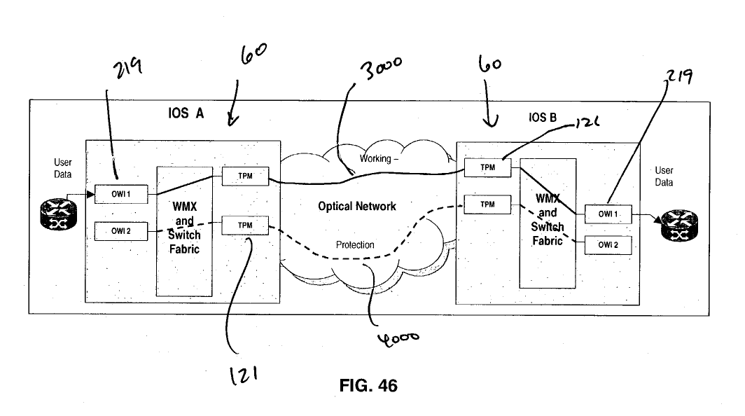

The OCP implements the 1:1 path protection feature for SOCs, POCs, EPOCs, and RPOCs with parallel paths set up using separate cross-connects. FIG. 46 illustrates the operational concept for a circuit with data flow from A to B. For bi-directional circuits, the same functionality is provided in the B to A direction. The OCP 20 establishes disjoint working and protection paths according to link, node, or SRL criteria. At the source A, the client transmits the user data flow on the working path, but protection path is idle. The OCP 20 routes the flow on the working path 3000 through the network to the destination. At the destination, the OCP 20 cross-connects the data flow to the client device. The protection cross-connects 4000 are not used.

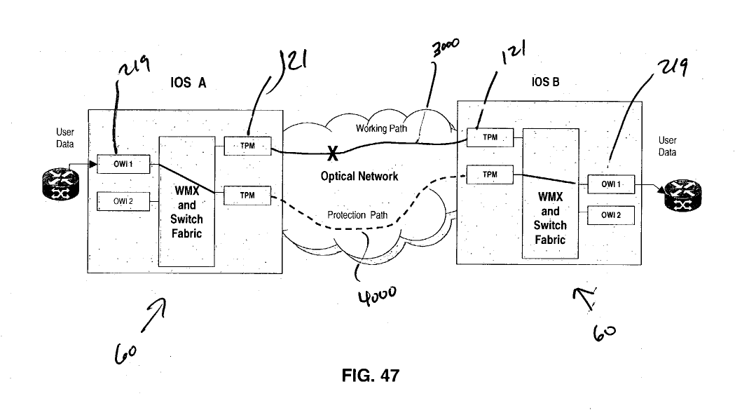

When a failure occurs on the working path as shown in FIG. 47, the endpoint IOS 60 co-ordinates the switchover with the other endpoint IOS 60 via signaling. Then the source IOS 60 cross-connects the user data flow on to the protection path 4000 at the source. At the destination, the IOS 60 cross-connects the received user data flow to the protected path client port. For bi-directional circuits, both of these actions are performed at each endpoint.

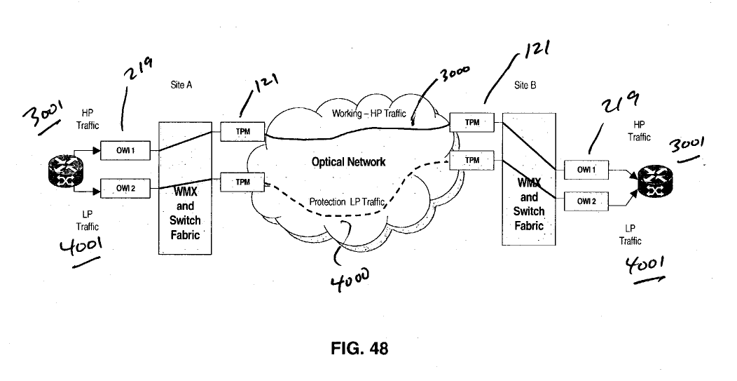

In the 1:1 protection service, the OCP 20 allows the protection path 4000 to carry LP circuits for SOCs and POCs as shown in FIG. 48. At the source A, the client transmits both a high priority data flow 3001 and optionally and a low priority data flow 4001. The OCP 20 routes these flows on disjoint paths through the network to the destination. At the destination, the OCP 20 cross-connects these data flows to separate ports on the client device. When a failure occurs on the working path 3000, the endpoint IOS 60 co-ordinates the pre-emption of the low priority data flow and switchover with the other endpoint IOS 60 via signaling. Then the source IOS 60 cross-connects the user data flow on to the protection path at the source. At the destination, the IOS cross-connects the received user data flow to the protected path client port.

The 1+1 and 1:1 services are non-revertive. The OCP 20 automatically establishes a new protection path after the expiration of the Wait for Restoration timer for SOCs and EPOCs or upon command from the MP for other types of POCs.

The OCP 20 allows the MP 30 to control the use of the working and protection paths. Based on receipt of commands from the MP 30 to an endpoint IOS 60, the OCP 20 performs the following actions: Forced—switch to the protection path pre-empting LP data flow if active; Lockout—do not allow switchover to the protection path; and Revert—switch from the protection path to the repaired working path.

Link Management Protocol (LMP)

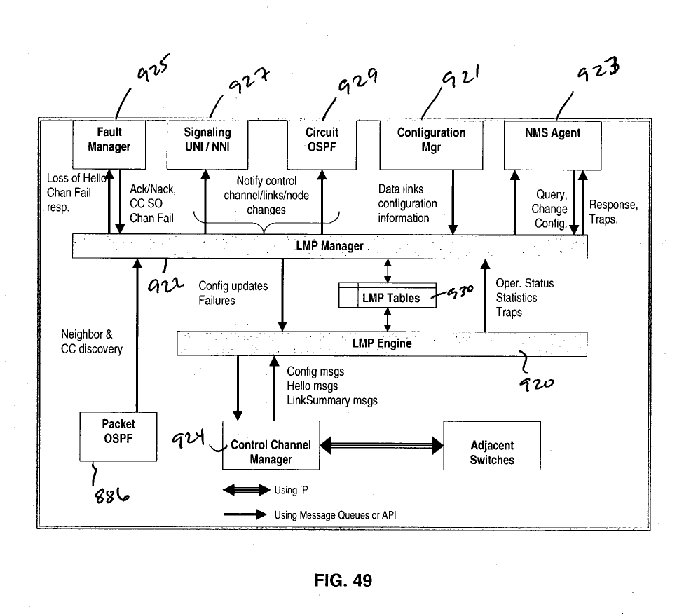

Referring to FIG. 49, the link management protocol (LMP) runs between neighboring nodes as part of the embedded control plane software running on the Switch Node Manager (SNM) 205. Two nodes are considered to be neighbors if they have a Traffic Engineering (TE) link connecting them. The TE link can be either a physical direct connection or a logical multi-hop Forward Adjacency (FA).

LMP is used to manage control channels, Traffic engineering links, and data-bearing links between adjacent switches. Specifically, LMP is used to maintain control channels' connectivity, verify the physical connectivity of the data-bearing channels, correlate link property information, and manage link failures. LMP consists of three components:
LMP Engine 920 maintains the finite state machines for all the node's control channels, Traffic Engineering links and data-bearing links. It also handles all external messages and events concerning the links' status;
LMP Manager 922 provides the interface between the LMP Engine 920 and external modules resident on the Node Manager. It also maintains the MIB and Command Line Interface (CLI) configuration interfaces; and
Control Channel Manager (CCM) 924 provides a socket interface to LMP and other applications (OSPF routing, signaling). The CCM 924 performs automatic error detection and socket connection handling.

FIG. 49 depicts the context diagram for the LMP Engine 920, LMP Manager 922 and CCM 924 during normal operation when LMP services are being provided. In this context, the LMP Manager 922/Engine 920 responds to SNMP requests from the NMS Agent 923 and fault related requests from the Fault Manager (FM) 925. The NMS Agent 923 may perform both get and set operations, e.g., activate or take down a data bearing channel, add or delete a T E link or change the protocol's timing intervals. When a set operation has been successfully executed to change the configuration, e.g., brought a new TE link into service, the LMP Manager 922/Engine 920 retrieves additional configuration information from the configuration manager 921 and broadcasts the updated configuration to Signaling 927 and Circuit OSPF 929. Neighbor nodes automatically discovered by Packet OSPF 926 Hello protocol are conveyed to LMP Manager 922 in order to establish logical control connectivity with them.

(e) LMP Standards

For an IOS 60 in an embodiment of the present invention, LMP is implemented according to the latest IETF draft or RFC. It is implemented on the NNI and the OIF UNI 1.0 on the UNI. On the NNI, it supports both neighboring IOSs 60 as well as forwarding adjacencies between remote IOSs 60.

For IOS 60 in the described emobdiments, LMP MIB definition would follow the latest IETF draft or RFC.

(f) LMP Initialization and Configuration

LMP table 930 consists of a set of scalars configuring general aspects of LMP, neighbor table, control channel table, TE link table and data bearing link table.

In SNM 205 initialization, LMP starts by loading previously saved LMP configuration table 930 from SNM 205 flash card.

If there is no saved table in the flash, LMP initializes using an empty table configuration.

When Packet OSPF 926 learns of an optical control channel 22 to a new neighbor node, it provides LMP with the IP address of that node. LMP adds the new node to its neighbor table, and establishes a logical control channel (IPCC) to that neighbor. The IPCC is added to the LMP control channel table, and the neighbor is added to the neighbor table.

When a logical link (LL) is configured between two IOS 60 nodes, they are considered LMP neighbors, and an IPCC is established between them.

UNI neighbors are always configured in the LMP table.

Configured LMP neighbors and control channels are retained when the SNM 208 is restarted.

Automatically discovered neighbors and control channels are not retained when the SNM 205 is restarted. They need to be re-discovered.

LMP saves the updated LMP table 930 to the flash database periodically or when there are committed configuration changes to the LMP table 930.

LMP Interfaces

LMP implements several interfaces to multiple OCP 20 software modules running on the SNM 205 as described below.

LMP has an interface to the Optical Test Port module through the BI to send and receive Test messages over data bearing links.

LMP provides an interface to perform MIB set and get operations for the different components of the LMP MIB table.

LMP has an interface to send MIB trap notifications through SNMP.

LMP provides an interface to configure LMP with automatically discovered neighbor nodes. LMP adds the nodes to the LMP table 930 and establishes an IPCC to each of these nodes.

LMP provides an interface to learn about LOL and LOS faults of data links and optical control channels. In case of data channel LOL, LMP runs the fault isolation protocol and convey the results back to the fault-handling module.

LMP has an interface to convey back fault isolation results to fault handling module.

LMP provides an interface to take down and bring up NNI TE links and data bearing links affected by fiber cuts and were subjected to automatic power shutdown (APSD).

LMP has an interface to inform NNI and UNI signaling of the addition, deletion, and state changes of IP control channels and TE links.

LMP has an interface to inform circuit routing module of the addition, deletion, and state changes of IP control channels and TE links.

LMP provides an interface to be notified about deletion and administrative status change of TE links and data bearing links.

LMP has an interface to query configuration and allocation information of TE links and data bearing links.

LMP configures new IP control channels to CCM 924 in order to be used to exchange control traffic through such control channel.

(g) LMP Operations

LMP establishes adjacency to each of its neighbor nodes by maintaining a single IPCC to each node.

A node is considered to be LMP neighbor node if it is connected to the IOS 60 with at least a single TE link. The TE link can be either a physical point-to-point TE link or a logical TE link.

In case of logical TE link, LMP starts the link bring-up process after signaling (GMPLS) has established the complete circuit (LSP) and a logical link is available for it.

Control channel bring-up starts by parameter negotiation phase with the adjacent device. After the negotiation is completed, LMP executes the fast Hello protocol.

When “Hello” messages are lost over a specific control channel for at least three consecutive “Hello” intervals, it is taken down and fault-handling module is notified.

TE link bring-up is conducted when a TE link is first configured, or when it is restored after a fiber cut.

The TE link bring-up process starts by the link verification procedure, if the Test port equipment and appropriate transponders are available, followed by the link correlation phase.

The link verification procedure is used to learn the remote link ID of a data channel only if the Test port and appropriate wavelength transponders are available.

If necessary equipment is not available to verify the connectivity of a specific data channel, the link verification procedure is not applied to that data channel, and it is brought up by the link correlation procedure using configured data only.

LMP maintains the operational status of neighbor nodes, control channels, TE links and data bearing links.

LMP performs the inter-IOS fault localization procedure as a result of data link failure notification. Fault isolation results are reported to the fault-handling module.

Circuit Re-Routing

Band level-reoptimization (single circuits) procedure includes two steps: (1) the identification of the circuit to be re-optimized and the available choices to where this circuit could be moved and (2) the staging of the new re-optimized circuit and the removal of the old circuit with minimum service disruption. The first part is handled at the SDS 204 level by presenting a suitable GUI to the client, and the second part is carried out by the IOS embedded signaling software as a special RPOC. The circuit identification procedure is manual and initiated by the SDS 204 user. In a future feature release this step is automated by the NPT 50 and a list of circuits that is candidate for re-optimization is provided by the NPT 50 and the SDS 204 user either proceeds manually and re-optimizes a circuit at a time or performs a full re-optimization.

The SDS 204 user identifies the candidate circuit to be re-optimized with a mouse click from a displayed list of circuits. In response, a list of available band path choices is made available from which the SDS 204 user selects its new re-optimized path.

The SDS 204 user is given the choice whether or not the available band path list is constrained to link/node/SRL disjoint choices from the original circuit. The list is sorted in ascending order using the logical link cost criteria used by the routing engine and possibly specifying whether or not it satisfies the engineering.

The SDS 204 user is given the choice to manually select with a mouse click from this list, and the selected band path and the original circuit identification are submitted as a special RPOC to the signaling software; or, automatically the SDS 204 sequentially tries in order from this list until it either exhausts the list and returns a failure or a successful re-optimization occurs. In either case the SDS 204 user is notified.

The staging of the new circuit occurs in two steps. First, a new circuit is created by setting cross-connect using the redundant WOSF-1 at the source and destination node and the given band path. Next, set the corresponding cross-connect to the given band path on WOSF-0.

A small service disruption (30 ms) occurs in the above two steps at both source and destination transponder 1×2 switches: first, when they are switched to WOSF-1; second when they are switched back to the WOSF-0.

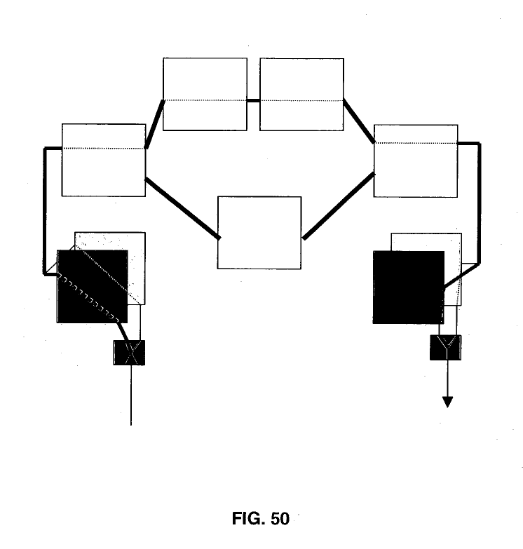

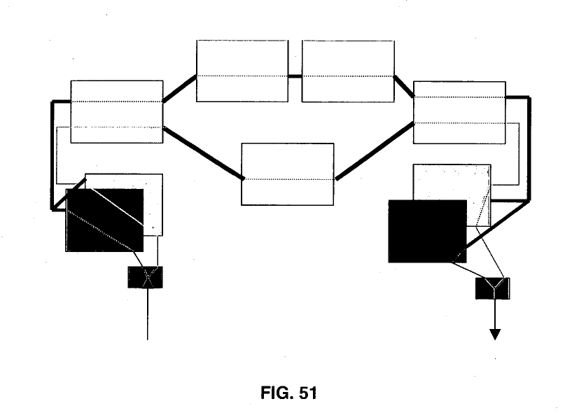

An original circuit (unprotected) going over 4 IOSs 60 including source and destination, e.g., in initial condition, is shown in FIG. 50.

Referring to FIG. 51, the first step is to delete the cross-connect part of the original circuit in the redundant fabric (WOSF-1) at the source and destination and replace it with a cross-connect to the new band path. This now looks like a 1+1 case. No service disruption occurs at this stage since all the changes are carried out on the WOSF-1.

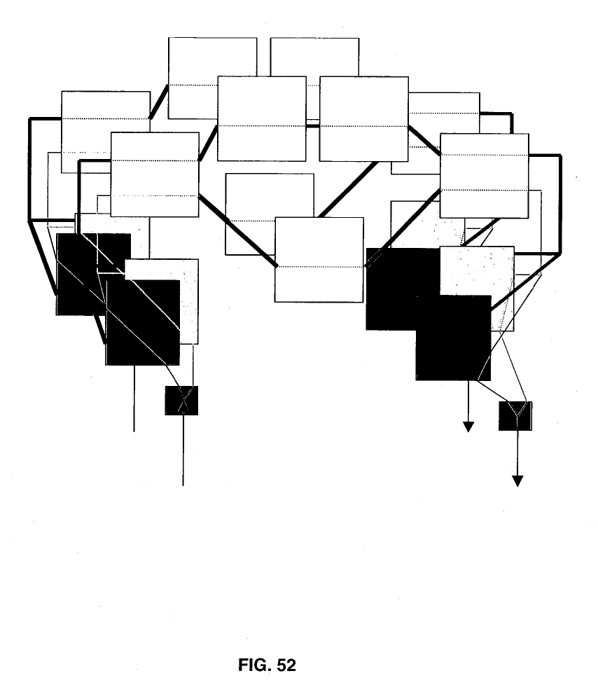

Referring to FIG. 52, the second step is to delete the original cross-connect at the source and destination WOSF-0 that used to connect to the original band path and replace them with cross-connects that go to the new band path on WOSF-0. A small service disruption (30 ms) occurs at the source and destination transponder 1×2 switches when they are switched to the WOSF-0.

### SNM Management Services Software

SNC Fault Recovery

In an IOS 60 system, each System Node Controller (SNC) 207 contains a dual-processor Node Manager (SNM) 205, two Ethernet Switches 222, and an AIM circuit pack 224. If any member (SNM 205, either Ethernet Switch 222, or AIM card 224) fails in an SNC 207, the SNC 207 is deemed failed.

There are two SNCs 207 in a system, with one in-service and the other one out-of-service. The Optical Control Plane (OCP) 20 software runs on both SNCs 207. Any software component failure cannot be recovered on that particular SNC 207. Instead, the recovery of the OCP 20 is achieved by having the non-failed SNC 207 take over and assume all the responsibilities.

The in-service SNM 205 in the SNC 207 is responsible for: communicating with the outside world, e.g., SDS 204, and other switches, through the external LAN; controlling the circuit packs in the IOS 60 system by monitoring and provisioning them through the internal LAN; and updating the out-of-service SNM 205 on completion of every transaction.

The out-of-service SNC 207 is responsible for: collecting and archiving the data from the in-service SNM 205 and monitoring the health of the in-service SNM 205, in order to take over the control if the in-service SNM 205 fails.

The areas of SNM 205 detection and monitoring, service status assignment, Inter-SNM communication, data replication, local health monitoring, protection switchover and software version control between SNMs 205 are provided as follows:

(a) SNM Detection and Monitoring

Each SNM 205 sends out heartbeat messages periodically via the IOS 60 internal Ethernet LAN for detection and monitoring purpose with a frequency of 1 message per second. A heartbeat message contains, among other things, the location ID in terms of node/bay/shelf/slot, service status (in-service, out-of-service, or undetermined), version number of the software currently running and Internal IP address of the sending microprocessor.

If an SNM 205 heartbeat has been missing for 3 consecutive times, the SNM 205 is deemed failed, and so is the associated SNC 207.

(b) Service Status Assignment

During system initialization, the algorithm presented in the following specifications is used to determine the service status of both SNMs 205.

If an SNM 205 cannot detect the other SNM 205 in 5 seconds after fully initialized, it is assigned in-service. Within the 5-second period, the SNM 205 heartbeats indicate its service status as “undetermined”.

If both SNMs 205 are present, by default the SNM 205 with a smaller location ID (in term of node/bay/shelf/slot) is assigned in-service, while the other one is assigned out-of-service.

(c) Inter-SNM Communication

Once the service status has been determined, the in-service SNM 205 assumes the control over the out-of-service SNM through the inter-SNM communication channels. The control can be used for (1) requesting the out-of-service SNM 205 to reboot; (2) downloading software, and database files if necessary, to the out-of-service SNM 205; and (3) upgrading or rolling back software on the out-of-service SNM 205.

There are two communication protocols used for inter-SNM communications, one for message passing and one for file transfers. The message based communication protocol is compliant to BI. The file-based communication channel is NFS based.

The communication sessions are established and destroyed dynamically, e.g., established when both SNMs 205 have been assigned the service status, and destroyed when one SNM 205 fails.

(d) Data Replication

The in-service SNM 205 should always synchronize its data with the out-of-service SNM 205. Once the service status has been determined for both SNMs 205, the in-service SNM 205 updates the out-of-service SNM 205 with all the relevant information it has accumulated. Afterward, for any changes that occur the in-service SNM 205 updates the out-of-service SNM 205 after the completion of every transaction.

Each sub-system retains at least the following data: (1) Information on any parameters set by users through SNMP and (2) Information on any already established cross-connects

(e) Local Health Monitoring

On each SNM 205 there is a software component (health checker) responsible for monitoring the health of the other software components. The software components are distributed across two microprocessors. In case a failure is detected on the in-service SNC 207, the health checker manages the service status transition.

There are heartbeat messages sent between the two microprocessors inside an SNC 207 to maintain the software integrity. The heartbeat interval is less than 1 second.

The health checker monitors the health of the Ethernet Switches 222 and the AIM circuit pack 224. Any failure detected causes an SNC 207 switchover.

(f) SNC Switchover

Switchover is performed due to either: (1) user-initiated request and (2) failure of the in-service SNC 207.

The switchover conditions are checked, e.g., the out-of-service SNC 207 must be non-failed and non-fault. The switchover history is checked since some intended switchover is non-revertible.

When switchover occurs, the original in-service SNM 205 disables the external IP address 890, sets the correct LEDs, and stops controlling the IOCs 210 210. The new in-service SNM 205 enables the external IP address and broadcasts an unsolicited ARP request to update the IP-MAC address mapping on every node in the same network segment. The SDS 204 is notified of this transition.

(g) Software Version Control between SNMs

To ensure the smooth communications between two SNMs 205 in an IOS 60, both SNMs 205 should run the same version of software (except in software installation process, which is a transient, not steady-state process), and both SNMs 205 should carry the same loads of software for fallback and upgrade purposes.

When both SNMs 205 have determined service status, the out-of-service SNM 205 advertises its current software version number in its outbound heartbeat messages. The in-service SNM 205 verifies the correctness that version number. In case discrepancy exists, the in-service SNM 205 downloads the correct software to the out-of-service SNM 205 and request it to switchover to that software.

The in-service SNM 205 also verifies the other software loads, e.g., for fallback and upgrade, to match with the loads it carries. If a discrepancy exists, the in-service SNM 205 downloads the correct load to the out-of-service SNM 205 and override the incorrect version.

When a new software load is downloaded into the in-service SNM 205, the in-service SNM 205 downloads the same load to the out-of-service SNM 205 as well.

When the in-service SNM 205 is instructed to do an upgrade or fallback on software, it requests the out-of-service SNM 205 to upgrade or fallback. When the out-of-service SNM 205 returns, the in-service SNM 205 requests the out-of-service SNM 205 to transit to the in-service status before it installs the new software. This implies after the software upgrade the service status is switched.

When the out-of-service SNM 205 has been upgraded to a higher version, the in-service SNM transfers the necessary data to the out-of-service SNM 205 before rebooting itself. The higher version of software on the out-of-service SNM 205 is able to understand the messages. In other words, the backward compatibility is ensured.

Alarms and Alarm Handling

The functionality of the Fault Management subsystem is distributed among all levels of control hierarchy: Level 2 OCP 20 (IOCs 210), Level 1 OCP 20 (SNM) 205, and the MP 30 (SDS 204, CLI). This section presents the specifications for and describes the operation of the Level 1 OCP 20 and its interactions with the Level 2 OCP 20 and the MP 30.

The responsibility of the Level 1 OCP Fault Management Subsystem is to detect, correlate and report failures. Depending on the nature of a reported failure, fault consequent actions may result, e.g. alarm, protection switch or APSD.

(a) Configuration

The OCP 20 configures default thresholds and hit time parameters for all alarms on all optical circuit packs.

The OCP 20 supports the configuration of parameters for individual alarms, where necessary, based on commands from the MP 30.

The IOS 60 OCP 20 supports the suppression and clearing of any alarms under command from the SDS 204. Alarm suppression is performed down to the individual circuit pack.

(b) Enabling/Disabling Alarms

Alarms can be classified into two types, traffic dependent and traffic independent. Traffic dependent alarms are detected by a change in the optical signal. Traffic independent alarms are caused by failures of circuit packs or circuit pack components within an IOS 60 that may occur even when there is no user traffic on the pack.

Traffic independent faults are detected only by the affected IOS 60, and may cause traffic dependent alarms on remote IOSs 60. For example, circuit pack or component failures cause disruptions in user traffic. These faults are then diagnosed as traffic dependent faults by remote IOSs 60 that share part of the user path with the affected IOS 60. However, if there is no user traffic, the remote IOSs 60 do not report any alarms in this case.

The OCP 20, by default, enables all traffic independent alarms and include power distribution, fan speed, circuit pack temperature, and optical amplifier current alarms.

When light starts to flow on a particular circuit, the upstream switch, with respect to the direction of traffic flow, informs the downstream switch using LMP Channel Status messages that the circuit is now active.

Upon receipt of an LMP Channel Status message indicating that a circuit is now active, the Fault Manager (FM), running on the SNM 205, notifies IOCs 210 for TPM 121, OSF 214, WMX 136, and OWI 219. These IOCs 210 then begin monitoring their tap points if this is the first circuit active at the tap point. Note the TPM 121 and WMX 136 can update the parameters in their signal equalization algorithms as well.

The IOC 210 monitors the optical signal at their various tap points. All circuit packs except the WOSF 137 and BOSF 124 packs monitor ingress and egress taps; the WOSF 137 and BOSF 124 monitor only the egress point. The WOSF 137 IOC 210 performs the monitoring for both the WOSF packs 137 and the associated WMX packs because the WMX packs do not have a dedicated IOC 210.

Traffic dependent alarms are disabled before the circuit is released. An endpoint switch sends Channel Status messages indicating the circuit is being released. Upon receipt of a channel message indicating a circuit is being released, the SNM 205 notifies the affected IOCs 210. If there are no longer any circuits associated with a tap point, the IOC 210 stops monitoring the tap. Note the TPM 219 and WMX 136 pack IOCs 210 also update the parameters in their signal equalization algorithm.

(c) Fault Isolation and Correlation

Fault correlation happens at different levels. The IOC 210 correlates failures at the circuit pack level and report the root cause as defects to the SNM 205. The SNM 205 correlates defects from different IOC at the IOS level. The SNM 205 can also correlate traffic dependant failures at the network level using LMP. SNM 205 reports the root cause of the failures, through fault isolation and correlation, to the SDS 204 as alarms. The SDS 294 correlates failures, at the network level, that are not correlated by the IOS 60, and present the root cause to the user. Fault isolation under different scenarios is described subsequently herein.

(d) Intra-IOS Fault Correlation

The TPM 121 IOCs 210 monitor both composite and single band DWDM signal levels and report out-of-range conditions to the SNM 205 within 20 ms.

The BOSF 124 and WOSF 137 IOCs 210 monitor band and single channel signal levels at egress points in the switch fabric, respectively, and report out-of-range conditions to the SNM 205 within 20 ms.

The WOSF 137 IOCs 210 monitor band and single channel signal levels at ingress points on the WMX packs and report out-of-range conditions to the SNM 205 within 20 ms.

The OWI 219 IOC 210 on transponder shelf, scans transponder power monitors for all the transponder ports and report out-of-range conditions to the in-service SNM 205 within 20 ms.

The TPM 121 IOC 210 monitors the status of the ingress (terminating) and egress (booster) optical amplifiers by checking the laser and back face currents and compare them with allowable thresholds and report out of range conditions to the SNM 205 within 20 ms of detection.

The SNM 205 monitors the defects reported from the different IOCs 210 210. These IOCs 210 perform the first level of correlation. When a failure occurs, IOC 210 checks both the ingress and egress taps and performs the lowest level fault isolation. It determines whether the failure occurred up stream (ingress signal failed) or on the pack (ingress ok but egress failed). It then notifies the SNM 205 of the correlated result.

The SNM 205 then performs fault isolation along the paths of the affected optical circuits such that multiple alarms with the same root cause are reported to the SDS 204 only once. It uses the alarm notifications received from the IOCs 210 in this process, but if the circuit pack has failed completely, it may not have received an alarm notification from the IOC 210. The SNM reports the result of its correlation to the SDS 204.

(e) Inter-IOS Fault Correlation

Some circuit pack or component failures cause disruptions in user traffic, which is diagnosed as traffic dependent faults by other IOSs 60 that share part of the user path with the affected IOS 60.

The SNM 205 also uses the Link Management Protocol (LMP) to exchange messages with its neighbors to isolate link level failures.

The SNM 205 also uses the Link Management Protocol (LMP) to exchange messages with logical link endpoints to isolate failures across logical links.

The SNM 205 correlates the different faults, to the isolate the fault to the root cause, and reports the results of the fault isolation to the SDS 204 as a single alarm when appropriate. The SNM 205 reports an alarm if and only if a component in the switch caused the failure, the fiber cut occurred on one of the switch's links, or the switch has lost network connectivity with the other endpoint.

The SDS 204 performs fault correlation analyses on the received alarms such that alarms received from different IOSs 60 are correlated to the root cause of the failure (IOS, link) in cases where the OCP 20 was unable to identify the root cause.

The SDS 204 reports the fault correlation results to the user as a single alarm.

(f) Failure Recovery

Based on alarms received from the DP 10, the OCP 20 identifies the failure conditions and provide self-healing capabilities where available.

On a failure on the in-service fabric, the SNM 205 changes the service status of the optical switch fabrics as the default condition. This generally means sending commands to all TPM 121, OWI-XP 219A, OWI-TR 219B, and OWI-λC 140 Circuit Packs 219 after the IOCs 210 210 associated with those circuit packs have effected a switchover for affected ports. Commands to switch to an already existing fabric selection are treated as reinforcing by the TPM 121 or OWI Circuit Packs 219. Alternatively, the OCP 20 leaves all of the unaffected circuits on the partially failed pack and only performs the switchover upon command from the MP 30.

The SNM 205 is responsible for implementing the fabric fault recovery endgame strategy (default or manual override) that the customer has selected.

When failure happens affecting a circuit that has 1+1 Path Protection, the SNM 205 commands the XP 219A IOC 210 to switch the traffic to the protection path. Since the IOC 210 may have switched to the out-of-service fabric, the SNM 205 also commands it to switch back to in-service fabric. When completed, the IOC 210 informs the SNM 205.

When failure happens on a circuit that has 1:1 Path Protection, the SNM 205 initiates switchover of the traffic to the protection path. It co-ordinates the switchover with the remote endpoint via signaling and pre-empts any low priority circuits if necessary. After co-ordination with the endpoint is completed, it sends commands to the WOSF 137 IOC 210 to move the circuit cross-connects from the working path to the protection path. When completed, the IOC 210 informs the SNM 205.

Failure on a circuit that has auto restoration results in the source endpoint SNM 205 re-routing the circuit via an alternate path after the WRT expires. The OCP 20 releases on the failed path and establishes a new one.

The SNM 205 notifies the SDS 204 of all repair actions that are performed. The SDS 204 reports the results to the user.

Performance Management

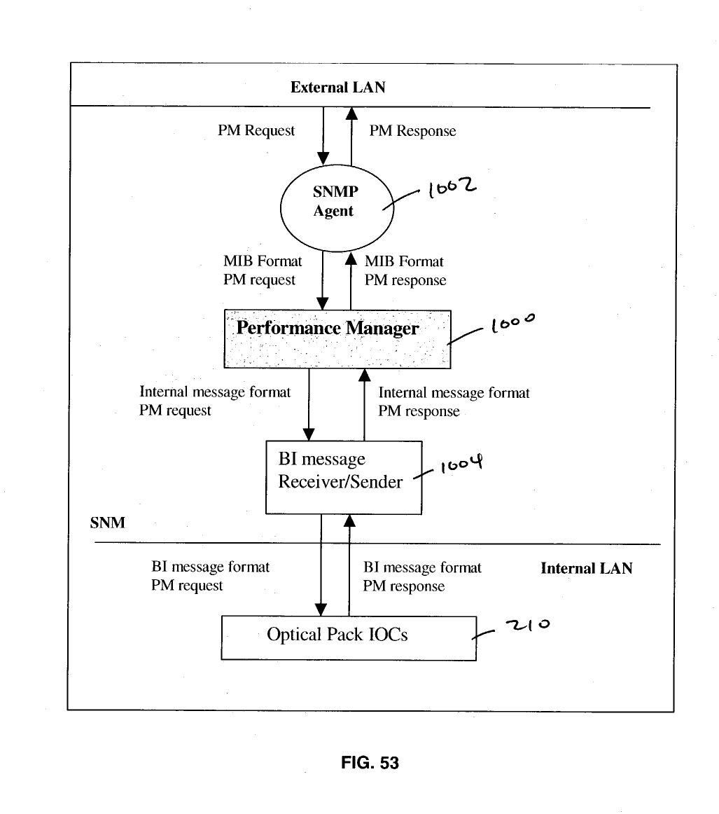

The Performance Manager (PFM) 1000 (FIG. 53) provides three performance management functions: Fast, wideband power measurement on all optical circuit packs as well as laser current backface current, laser temperature, and TEC current measurement on the TPM 121 packs.

Slower, narrowband optical measurements of signal power, optical signal to noise ratio, power spectrum, and wavelength measurement. For a given IOS 60, an OPM 216 is optional. Also, for a specific IOS 60, two instances of the OPM 216 can be equipped. Therefore, 0, 1, or 2 OPMs 216 can exist in a specific IOS 60.

Networking performance data used by the SDS 204 to quantify network performance metrics.

The specifications for the functions are presented in the following sub-sections.

(a) Fast Optical Power Measurement Referring to FIG. 53, the Performance Manager (PFM) 1000, through IOCs 210, monitors power levels at each transmit and receive port and at internal points within the data plane, without affecting the QoS of any connection. These measurements are wideband measurements, including both signal and noise power at various composite DWDM signal, band, or individual wavelength access points in the Data Plane 10. The power detection and measurement circuitry includes IPDs, scanners, amplifiers, and A/D circuitry, and the calculations and calibration offsets are performed by the associated IOCs 210. These power measurements are performed to within ±0.5 dB, and the scan cycle for a multiplicity of monitor points together with the integration (IOC hit timing) interval, is adjusted for the report time required for the application. These results are periodically reported to the SDS 204 where GUI displays of the data are provided to the user. Also, the SDS 204 may request power measurements at specific access points.

In addition to the fast power measurements on all Data Plane circuit packs, the PFM 1000 also reports laser temperature, TEC current, laser and backface current for TPM packs 121. The SDS 204 may also request these measurements.

Through the SNMP agent 1002, the user can command PFM 1000 to retrieve band or DWDM power level measurements, and the PFM 1000 converts the request to a BI message through the BI message sender/receiver 1004 and sends it to the appropriate IOC 210. After receiving the IOC 210 response, the PFM 1000 reformats the retrieved data and sends it to the SDS 204.

The Performance Manager requests IOCs 210 to monitor band, wavelength, or DWDM composite power at the measurement tap points and the results are periodically reported to the SDS 204. The SDS 204 configures the reporting rate, with a default value of five seconds. The Performance Manager 1000 supports all of the reporting options in S-PER-5 for fast power measurements.

For DWDM packs, the Performance Manager 1000 requests IOCs 210 to monitor band and/or DWDM power levels at the measurement tap points as well as laser temperature, TEC current, laser and backface current as a background exercise. The results are periodically reported to the SDS 204. The SDS 204 configures the reporting rate, with a default value of five seconds.

In response to a SDS 204 request, the Performance Manager 1000 commands the IOCs 210 to perform fast power measurements on specified circuit packs as well as temperature, laser and backface current for TPM circuit packs 121. These requests may specify measurements for any combination of tap and circuit points and may specify one time or periodic measurements. The Performance Manager 1000 reports these results to the SDS 204.

(b) Optical Performance Monitor Measurement

The Performance Manager 1000 uses the OPM circuit pack 216 to perform OSNR, power, and wavelength classification measurements on composite DWDM signals at selected tap points in the IOS 60. These access points are at composite DWDM TPM ingress and egress signal points, and the OPM 216 can perform the measurements on any wavelength within the composite DWDM signal. The Performance Manager 1000 supports two measurement modes: scanned (background exercise) and directed (camp-on). The camp-on measurements provide power, wavelength, and OSNR information for all wavelengths at that access point. For such camp-on measurements, a quasi real time update of the SDS 204 display is essential for effective troubleshooting. The background scan measurements monitor the access points at lower frequencies rate to identify trouble situations such as OSNR degradations.

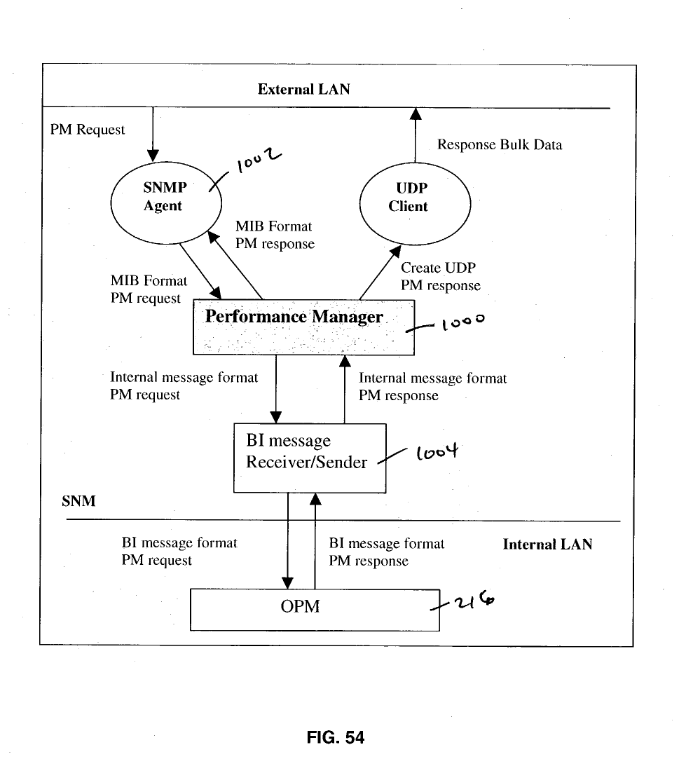

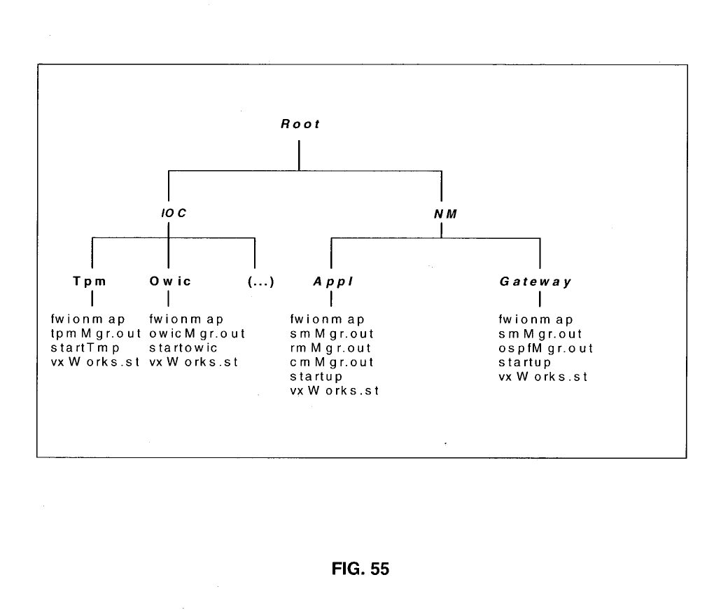

FIG. 54 is a data flow diagram of the OPM 216 optical measurements. After initialization, the PFM 1000 runs in background mode, sequentially scanning through all equipped access points of the IOS 60 and compiling a database for each equipped access point over time. The user can reconfigure the desired measurement points and the scanning interval between measurement sets through an SNMP request. When the PFM 1000 receives the first camp-on request, it immediately suspends the background scan for all access points and camp-on the request point. Up to 5 camp-on points can be supported simultaneously. For each camp-on point the PFM 1000 utilizes the OPM 216 to provide one complete scan of the C Band for that access point every 5 seconds (1 second scan plus 4 seconds dead time) and then forward the retuned readout to SDS 204. After eliminating a camp-on, due to user request, the PFM 1000 modifies the scan cycle to revert to the other camp-ons that are still active, or if no others are still active, reversion is to the background scan. On request from SDS 204 the PFM 1000 can command OPM 216 to read the optical spectrum for a specific tap point on a TPM circuit pack 121 and send response back to SDS 204. TCP is used to forward the spectrum data from PFM 1000 to SDS 204.

The accuracy of the OPM OSNR measurement is ±0.5 dB.

The accuracy of the OPM power measurement is ±1.0 dB.

The accuracy of the OPM wavelength measurement is ±0.05 nm

The Performance Manager 1000 supports an SDS 204 request to command the OPM 216 IOC 210 to report measurements of optical signal power, wavelength, and OSNR at an OPM 216 access point.

When two OPMs 216 are equipped in a specific IOS 60, either or both may be configured for camp-on, and either or both may be configured for background scanning. When both are used for background scanning, the SNM 205 directs the scanning for the two OPMs 216 on a load-sharing basis for the equipped OPM 216 access points.

The Performance Manager 1000 supports SDS 204 request to activate and deactivate performance measurements at each access point and provide the following options: (1) round robin of all measurements at all measurement points with a specified interval between measurement sets, (2) round robin of selected measurements at all measurement points with a specified interval between measurement sets, (3) round robin of selected measurements at selected measurement points with a specified interval between measurement sets, and (4) one-time selected measurements at selected measurement points (in support of diagnostic troubleshooting).

In the absence of camp-on requests, a background scan of all equipped access points occurs with a 15-minute cycle time.

When the Performance Manager 1000 receives the first camp-on request for a particular OPM 216, it immediately suspends the background scan for all access points and camps-on the requested access point. The Performance Manager 1000 utilizes the OPM 216 to provide one complete scan of the C Band for that specific access point nominally every 0.5 seconds (OSNR/power/wavelength) or 2 seconds (spectral data) (see previous description for request-to-response times). The OPM 216 IOC 210 controls the OPM 216 OSA 850 on a single threaded command/response basis. The OSA responds as quickly as it can for the requested measurement, and the IOC 210 can then send another command to the OSA 850 for the same or a different OPM 216 access point. Up to five simultaneous camp-ons can be supported for each OPM 216. If the Performance Manager 1000 receives a second through fifth camp-on request while the first is active, it sequentially scans the requested access points for the data interleaving the up to 5 scan periods. The Performance manager forwards the camp-on scan data immediately to the SDS 204, once collected.

For an OPM 216 in camp-on mode, the Performance Manager 1000 forwards the data to the SDS 204, which refreshes the client screen with a nominal period of 2 seconds through 10 seconds for spectral data and 0.5 seconds through 2.5 seconds for OSNR/power/wavelength data, for 1 to 5 camped-on access points.

The Performance Manager 1000 supports SDS 204 request to remove the camp-on condition from the access point(s).

If camp-on is requested at a sixth access point with five others already active, the Performance Manager 1000 responds with a message that connotes “OPM not available due to too many simultaneous camp-ons—try again later”.

On request from the SDS 204 to eliminate a camp-on the Performance Manager 1000 modifies the scan cycle to revert to the other camp-ons that are still active, or if no others are still active, reversion is to the background scan.

The Performance Manager 1000 supports SDS 204 request to report cycle information, the sum of the number of cycles consumed by camp-ons plus the number of cycles consumed by background scans.

When the IOS 60 is equipped with two OPMs 216, the Performance Manager 1000 is able to use one for background monitoring and the other for directed measurement. Alternatively, both are useable for background scan or both are usable for camp-on on a load-sharing basis.

The Performance Manager 1000 receives the measurement results (trend data) from the OPM 216 IOC 210 and forward to the SDS 204 as bulk data reports using TCP.

(c) Network Performance

SOCs, EPOCs, RPOCs, and POCs, the OCP Call Control Module reports network performance data on the set up and release of these circuits. Such data includes: (1) All circuit request parameters; (2) Time request received; (3) Time of begin service; (4) Disposition; and (5) Time of end of service.

SDS 204 retrieves Network Performance Data periodically, or upon receiving Optical Circuit (OC) setup/tear down traps from OCP.

The performance data records of the active OCs is kept in OCP memory. The data records for terminated OCs are purged once the SDS 204 retrieves them after the OC 22 terminates.

OCP 20 impose a maximum size of network performance data records. When the record size approaching the limit, OCP 20 sends a remind trap to SDS 204 to retrieve the data records immediately. If for any reason, the SDS 204 is unable to retrieve the records in time, the data records of the terminated OCs in the OCP 20 memory are overwritten in chronological order.

Configuration Management

This section presents the specifications for the IOS Configuration Management in the IOS 60.

The Configuration Manager (CM) 921 resident on the SNM 205 Application Processor 228 performs the auto-discovery of all circuit packs using the BI protocol. It detects the insertion and removal of all packs in co-ordination with the IOCs 210. It sends an SNMP trap to the SDS 204 when the insertion or removal occurs.

The CM 921 maintains the status of all packs in its MIB base such that the SDS can obtain the status by querying at any time. When the SDS 204 sets a configurable parameter in the MIB, the CM 921 sets the parameter on the circuit pack by sending a configuration message over the BI.

Time Stamping

The IOS 60 provides an identification capability such that events may be time stamped within an accuracy of 1 second. The IOS 60 maintains its clock using the Network Time Protocol (NTP) as specified in RFC 1305. It uses an external NTP server.

### System Management

Software Version Control

The IOS 60 software version control addresses preparation and delivery of new software releases or patches, downloading a new release of software into an IOS system and installation of new software or rollback to an old version

(a) Preparation and Delivery of Software Releases

There are two ways to deliver a release of software to users: (1) Store the software in a CD-ROM and send it to customers (in this case, users are required to install the CD to a CD-ROM drive attached to an FTP-enabled server); and (2) Store the software in a company-owned FTP server to allow users to remotely download.

The software version number is a four-byte integer in the following format: AA BB XC DD. Where:
AA—a byte, ma or release number
BB—a byte, minor release number
X—half byte, identifies type of release
   A=alpha
   B=beta
   C=controlled introduction
   G=general availability
C—half byte, sub-version of X above
DD—a byte, point release number

The software files are organized in a fixed directory tree format in the delivery. In OCP software case, the tree structure is illustrated in FTC. 55.

A control file name fwionmap is created for each directory. This file contains the information of the following attributes for each file in the directory: Software release number, File name, File size and File CRC checksum, generated using CRC-32 algorithm.

A program called generateMap is used to generate the fwionmap file for each directory. This program runs in Linux environment.

IOS Software Download

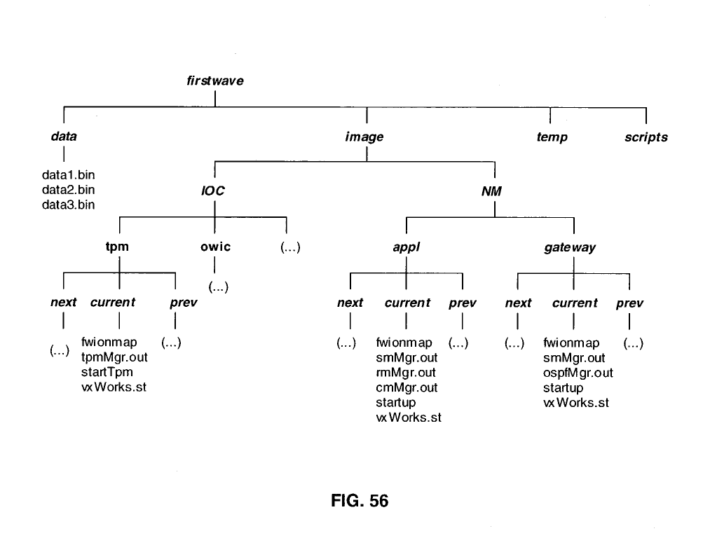

The software files are organized in a fixed directory tree structure in an SNM in an IOS system. Specifically, the Application SNM inside an SNC maintains these files. The layout of flash partitions is illustrated FIG. 56.

The software can only be downloaded into “next” directories for various branches (IOC, NM/appl, or NM/netw).

To download a release of software into an IOS 60 system, users configure the IOS 60 with the IP address of the FTP server, account name on the server, password of the account and complete path of the Root directory for the software.

The download process can be aborted on the users' request before it is completed.

For each branch the “fwionmap” is downloaded first and processed. All the files described in this file are downloaded. For each file downloaded, its file size and the CRC checksum are verified. If discrepancy is found, the process is aborted and no files are stored in the flash.

If all files are downloaded successfully, the in-service SNM 205 stores the files in the proper locations in its flash. It also manages to synchronize the out-of-service SNM 205 by sending the same files over.

On receipt of the notification of software file downloaded, the out-of-service SNM 205 copies the received files to the right location indicated in the request.

Installing software

IOS system 60 supports software upgrade and fallback. The upgrade procedure allows customers to install a new release of software, while the fallback procedure allows them to install the original version of software. There are different procedures for installing a version of software depending on the different scenarios: (1) for SNMs 205 or IOCs 210 and (2) for the in-service SNM 205 or the out-of-service SNM 205.

(a) Installing Software for SNMs

Installing Software for the out-of-server SNM 205 is controlled by the in-service SNM 205. This could happen in the following two cases: (1) Automatic software installation and (2) User-initiated software installation.

The first case happens after the out-of-service SNM 205 boots up and its software version is different from what the in-service SNM 205 expected. Therefore, the in-service SNM 205 downloads the correct software to the out-of-service SNM 205 and requests it to do an upgrade. For the software download procedure in this case, refer to the prior description on downloading software.

The second case happens when the management plane requests the installation. The request reaches the in-service SNM 205, who in turn requests the out-of-service SNM 205 to do the installation.

On receipt of an upgrade or fallback request, the out-of-service SNM 205 moves the software files to the proper location and reboots itself to have the desired software take effect.

Installing software for the in-service SNM 205 is only done on users' requests.

On receipt of the request, the in-service SNM 205 verifies the desired software is valid and the SNMs are non-faulted

To upgrade or fallback software, the in-service SNM 205 requests the out-of-service SNM 205 to do it first. When the out-of-service SNM 205 returns with the desired software version, the in-service SNM 205 transfers the in-service status to the out-of-service SNM 205, and proceeds to install the software for itself.

The software installation procedure causes the service change, e.g., in-service status is changed to out-of-service and vice versa. There is a 15-second budget for the whole process.

(b) Installing Software for IOCs

The design assumes one software load for each type of IOCs 210, e.g., TPMs 219, OWCs 220, WMXs 136 etc. Customers have the option to upgrade/fallback software for all IOCs 210 of type, or all IOCs 210. They can also request installation of the current software for one specified IOC 210. The software installation for IOCs 210 is initiated by user commands.

The IOC 210 software installation process is handled by the in-service SNM 205.

On receipt of an IOC 210 upgrade/fallback request, the in-service SNM 205 verifies the desired IOC software is valid and the IOCs are non-faulted.

To upgrade or fallback software for an IOC 210, the in-service SNM 205 downloads the software files to that IOC 210 (refer to prior details on downloading software) and reboots it to have the new software take effect.

In case of installing software for all IOCs 210, the in-service SNM 205 handles the IOCs 210 one by one. If an IOC 210 fails, the SNM 205 aborts the process, notify the SDS 204, and wait for further instructions.

If a newly inserted IOC 210 boots up and reports it is running a different version of software from expected, the in-service SNM 205 sends an alarm to SDS 204. The users can select to install the correct software on that IOC 210.

### IOS Growth

This following description sets forth the OCP 20 in support of the field upgrading of the IOS capacity. This may involve adding new TPM 121, OWI 219, WOSF 137, WMX 136 and OWC 220 circuit packs.

Additional TPM circuit packs 121 may be added to the IOS 60 to interconnect the IOS 60 with remote IOSs 60 using DWDM subject to the capacity limitations. After the new TPM circuit pack 121 is detected, tested (by the IOC 210), and configured with the appropriate link and interface parameters, the IOS 60 OCP 20 automatically establishes a link with the adjacent switch. The link is initially in the APSD Wait to Restore State. When the TPM 121 IOC 210 determines control integrity exists by detecting idle signals on the IEEE 802.3 Control Channel, the packet OSPF 926 invokes an IP bootstrapping procedure to learn the IP address of its peer and enter the OCC 22 link into the packet OSPF 926 database. LMP is then invoked to establish an IPCC between them, perform link verification if a test port is available, and exchange configuration parameters. When LMP has completed link establishment, the data-bearing link is added to the OSPF circuit database. The link is then available for circuit services.

Additional OWI circuit packs 219 (transponders) may be added to the IOS 60 to interconnect the IOS 60 to client devices (e.g., routers, ATM switches) subject to the capacity limitations. After the new OWI circuit pack 219 is detected, tested (by the IOC 210), and configured with the appropriate link and interface parameters, it is added to the circuit OSPF database and is available for POC use. For SOC use, the IOS 60 also establishes or modifies the UNI interface in co-ordination with its peer to include the new transponder. In some cases WMX may have to be added with the transponder packs.

Additional WOSF circuit packs 137 may be added to the IOS 60 to perform wavelength switching. After the new WOSF circuit pack 137 is detected, tested (by the IOC 210), and configured with the appropriate parameters, it is available for use.

Additional WMX circuit packs 136 may be added to the IOS 60 to perform band-wavelength multiplexing (with mux 139) and demultiplexing (with demux 135). After the new WMX circuit pack 136 is detected, tested (by the IOC 210), and configured with the appropriate parameters, it is available for use.

Additional OWC circuit packs 220 may be added to the IOS 60 in the transponder shelf to perform wavelength conversion. After the new OWC circuit pack 220 is detected, tested (by the IOC 210), and configured with the appropriate parameters, it is available for use.

### Optical Control Plane Specifications: IOC Level (2)

This section provides a functional view of the IOS Level 2 Optical Control Plane 20 and identifies Level 2 OCP 20 specifications.

Disributed control architecture is implemented through the use of Intelligen Optical Controllers (IOC) 210 connected via Ethernet to the System Node Managers 205. Key circuit packs are enabled with an IOC 210 to provide a system control point in the system.

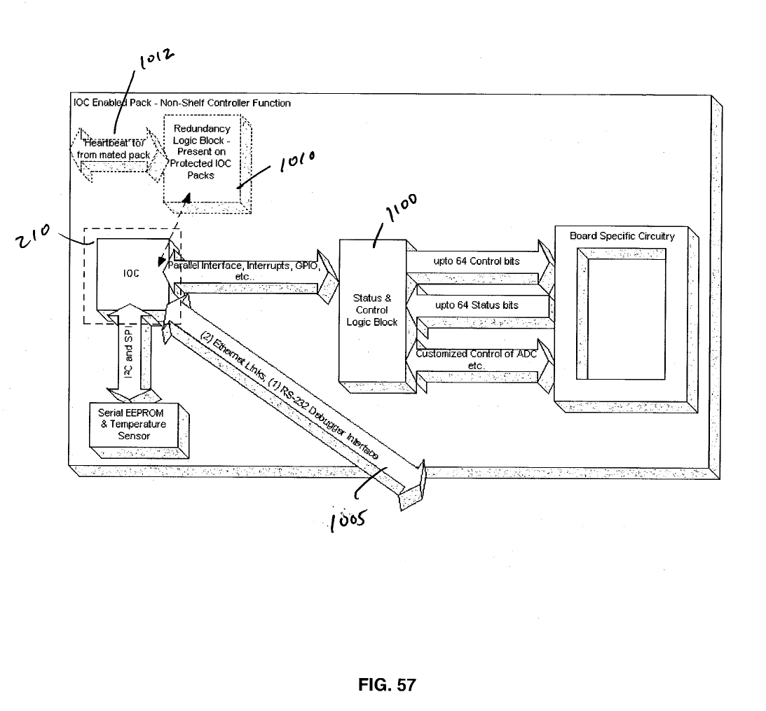

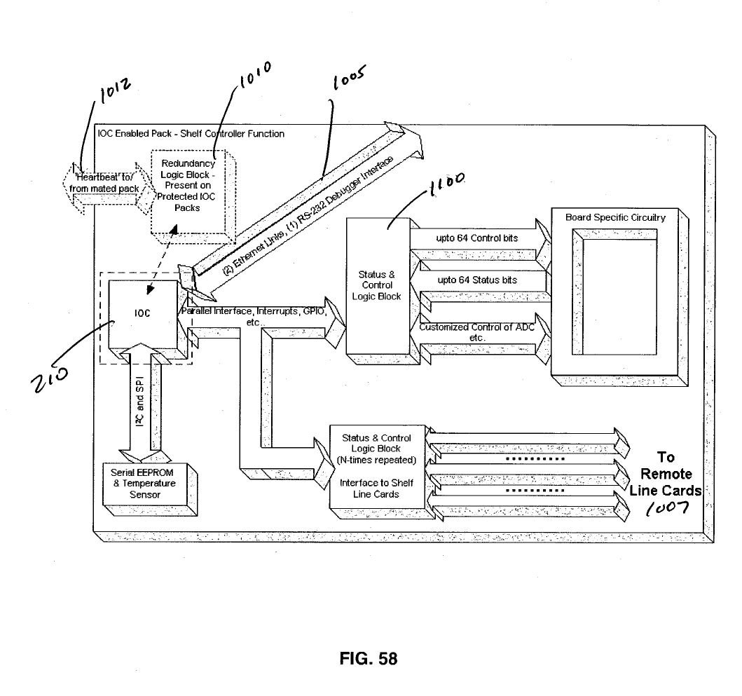

There are two models describing control functions implemented using the IOC. Referring to FIG. 57, the non-shelf controller model includes a line card carrying an IOC 210 that controls the functions for that parent pack. Referring to FIG. 58, the shelf controller model includes a line card carrying an IOC 210 that acts as a controller board for other line cards 1007 in the system.

Redundancy through Redundancy Logic Block 1010 can be implemented in either model. The introduction of redundancy requires hardware hooks between mated packs to facilitate a ‘health heartbeat’ 1012.

Although these two IOC 210 models are different, implementation is transparent to embedded IOC 210 software. A common status and control register interface 1100 provides for simplified software in either case. Peripheral hardware facilitates IOC control communication to both parent pack circuitry and circuitry on remote (non-IOC enabled) line cards.

A two-tiered control structure is maintained throughout the IOS 210. High-level system commands issued by the SNM 205 are executed by distributed IOCs 210 within the system bays 62.

A two-tiered control structure is maintained throughout the IOS 210. Low-level system status messages issued by system line cards are processed by a localized controlling IOC 210 and then passed to the SNM 205.

Redundant 100 Base-T Ethernet links 1005 provide fault-tolerant communication paths between IOCs and both SNMs.

All software and programmable logic firmware are remotely field-upgradeable.

Peripheral IOC hardware provides software with two types of status notification. Registers allow embedded firmware to schedule (poll) for a changed state. The hardware also associates a maskable interrupt to all reported events.

### Intelligent Optical Controllers (IOCs)

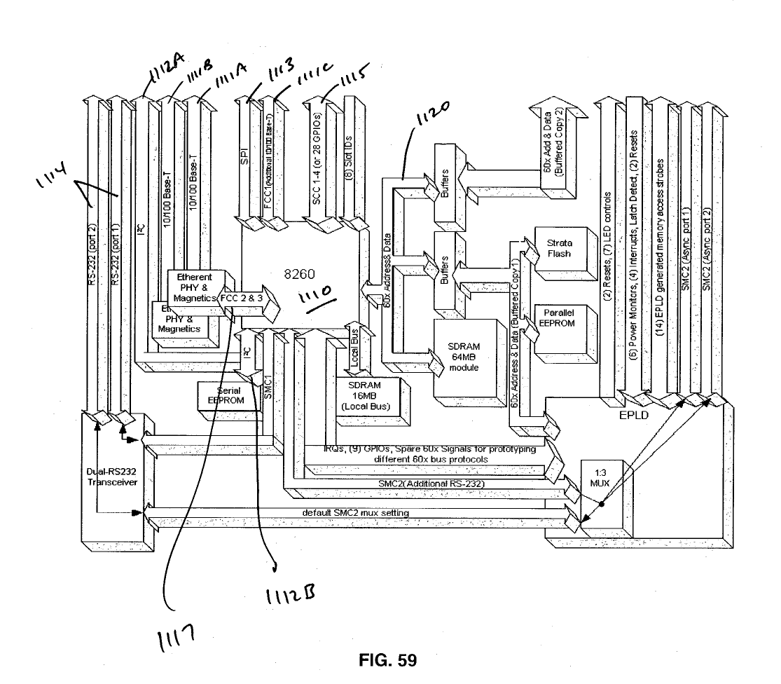

FIG. 59 details the Intelligent Optical Controller 210 architecture.

An IOC 210 resides on a majority of IOS 60 line termination circuit packs. Such a structure leverages the in-house knowledge base of the Motorola PowerPC architecture and provides a flexible platform for system development. I/O emanating from this daughter card takes into account the many communications and control features offered by the Communication Processor Module (CPM) of the 8260 1110. The CPM features exploited by IOC 210 design include (3) built-in 10/100 Base-T Ethernet MACs 1111, I²C 1112, SPI 1113, (2) Serial Management Controllers (SMC) (for RS-232 interfaces 1114), and (4) Serial Communication Controllers (SCC) 1115 (for GPIO or HDLC interfaces).

In addition to the interfaces described above, a subset of the 8260 processor bus is extended to the parent card. Various memory types ranging from dual-ported RAM to PCMCIA Flash cards can be accommodated easily via this interface method.

System specific signals such as Slot ID, reset control, and interrupts are also included as members of the IOC 210 interface. Parent-to-IOC connection is implemented via a 300-pin BERG Meg-Array mezzanine connector. Stacking heights of 5.5 mm and 11.5 mm aid integration to varying line card designs. A 11.5 mm stacking height allows selective component placement underneath an IOC 210.

The hardware platform for the embedded controller resides on a single detachable printed wire board. The interface between the IOC 210 and the parent circuit pack consists of a high density, low profile connector that is keyed for self-alignment.

An IOC 210 contains an embedded processor module with a 32-bit PowerPC memory bus architecture.

The IOC 210 has dual 100 Base-T Ethernet interfaces (FCC2 & FCC3) 1117 for support of a duplex System Node Manager 205 architecture. Each Ethernet port has additional accessibility via header interface located conveniently for CEM or development use.

The IOC 210 allows ability for the parent pack to create an additional 100 Base-T Ethernet port 1111C via the 8260 FCC1 port.

Each Ethernet interface has a unique 6-byte Media Access Controller (MAC) address consisting of three bytes assigned by the IEEE, and 3 bytes that are unique to that instance of the IOC 210 module. The IEEE assigned portion of the MAC address is contained in the first three bytes of the 6-byte construct as shown below:

| | | | | | |
|---|---|---|---|---|---|
| 00 | 05 | A9 | XX | XX | XX |

where XX—any byte in hexadecimal.

The IOC 210 has ability to access a common status and control register interface via a subset of the 8260s 60x parallel bus interface 1120. This common model accommodates up to 64 status and 64 control bits. These registers are separate from the processor such that the processor can be reset without affecting the contents.

The IOC 210 has a serial port interface 1113 consistent with the Motorola Serial Port Interface (SPI port) specification for access to peripherals on the parent circuit pack.

The IOC 210 has a serial port interface 1112A consistent with the I²C specification for access to the hardware calibration and provisioning information that is unique each parent circuit pack. An additional I²C header interface 1112B is located for convenient use during manufacture.

The IOC 210 has a 3 wire serial port that is accessible from the rear panel on every parent circuit pack. This interface supports RS-232 signaling. An additional serial port header interface is located conveniently for CEM or development use.

The IOC has a JTAG controller interface for support of programmable logic firmware updates.

The IOC has a JTAG scan chain interface accessible to the parent pack and header pins located conveniently for use in manufacturing.

### Device Controller Functions

Common

A Device Controller (DC) supports hard reset and software reset.

A hard reset is defined as power-up event. A Device Controller reboots and runs Device Manager (DM) software following a hard reset.

Software reset is defined as behavior resulting from the reboot request from the System Node Manager (SNM). A Device Controller reboots and runs DM software following software reset.

The DM software, which runs on a DC, does not reset any of the hardware devices in its control domain due to software reset (reboot).

The DM interacts with the SNM 205 higher controller in order to support IOS features defined in the SRD (see incorporated Specification Attachment 2—System Requirements Document).

The DM supports bi-directional communication with SNM 205 using the message-based UDP/IP Backplane Interface (BI) (see Specification Attachment 1).

The DC supports software download under SNM 205 control.

Following booting, the DM indicates its presence by sending periodically (once per second) a heartbeat message to both SNMs 205, in-service and out-of-service.

The DM interacts with hardware in its control domain in order to support IOS features defined in the SRD.

The DM software infrastructure (VxWorks and drivers) supports hardware interfaces defined in the Software User's Guide (SWUG) documents (see incorporated Specification Attachment 3—Software User's Guide (SWUG) documents) and device data documentation.

The DM monitors and controls hardware using interfaces defined in the Specification Attachment 3 (SWUGs).

The DM Fault Management software subsystem detects, correlates, and reports failures. Depending on the nature of a reported failure, fault consequent actions result, e.g. LED operation, protection switching, APSD, etc.

The DM detects failures by monitoring hardware devices.

The DM detects failures via interrupt and/or polling and uses these mechanisms, as appropriate.

The DM clears failures using a polling mechanism only.

DM integrates detected failures over time as specified in the SRD. If integration of a failure is not defined in the SRD, then the integration algorithm is dictated by DC hardware and software performance considerations.

DM performs fault correlation to determine which of the detected failures precipitates occurrence of other failures so that only a single, root cause failure is reported to SNM 205.

After fault correlation is completed, DM performs the following fault consequent actions in the order as listed:
1. DC-level time-critical operations (e.g. protection switching, APSD).
2. Failure reporting to SNM 205.
3. LED operations.

The fault consequent actions are autonomous, i.e. not SNM 205 driven.

The DM's Test Management software subsystem facilitates circuit pack level hardware debugging via its hardware access utilities.

The DM provides diagnostic software to support hardware debugging as defined in the Diagnostic Software Requirements (DSR) (see incorporated Specification Attachment 7—Diagnostic Software Requirements).

The DM provides a built-in self-test.

TPM

A TPM 121 application software subsystem is a collection of closely related functionalities that for reason of efficiency are mapped into a single application subsystem. The TPM Device Manager software comprises the following application-level software subsystems: Fault Management (FM), Optical Power Control (OPC), Performance Monitoring (PM), Configuration Management (CM) and Test Management (TM).

The TPM FM monitors hardware for signal and equipment (circuit pack) failures.

The TPM FM detects the following signal failures: Loss of Optical Line Signal (LOLS), Loss of Optical Band Signal (LOBS) and Loss of Optical Control Channel (LOCC) The TPM FM detects equipment failures as recommended in the SWUGs (Specification Attachment 3).

Following detection/clearing, integration and correlation of failures, the associated fault consequent actions result.

The TPM FM supports fault consequent actions specific to this DC in addition to those that are common to all DCs.

The TPM FM is able to execute the following TPM specific fault consequent actions: (1) Automatic Power Shutdown and Automatic Power Restoration (APSD/APR), as defined in the SRD; (2) Selective laser pump power shutdown; (3) Selective Thermo-Electric Cooler (TEC) shutdown and (4) Band Switch Fabric (BOSF) protection switch.

APSD procedure is triggered by the simultaneous presence of LOLS and LOCC failures.

Clearing the LOCC failure triggers the APR procedure.

The TPM OPC software subsystem implements band-level optical power equalization.

The TPM OPC performs band-level optical power equalization using the hardware/software control loop algorithm.

The TPM OPC uses band input power readings and total egress power readings as inputs to the equalization algorithm.

The TPM OPC uses band dedicated VOAs to control band output power.

The TPM OPC adjusts Laser Bias Current (LBC) to control total egress power.

The TPM PM software subsystem allows SNM to obtain PM parameter readings (e.g. LBC, egress power, etc.) and modify PM parameter threshold crossings.

The TPM PM provides SNM with PM parameter readings on demand via the FBI.

The TPM PM autonomously reports to SNM parameter Threshold Crossing Alerts (TCA) via the FBI.

The TPM PM monitors the following parameters for performance purposes: LBC of each laser pump, Total egress power, Ethernet statistics and IP statistics.

The TPM PM utilizes thresholds that constitute decision points for reporting performance parameters. Accordingly, the thresholds should be stored in a way that supports TPM PM modification in a subsequent release of alternative embodiments of the invention.

The TPM CM changes egress power to a value specified in the SNM request. These power values are not configurable parameters in Feature Release 1, but they are likely to be configurable parameters in a subsequent Feature Release.

The TPM CM software subsystem allows SNM to change state of configurable elements (e.g. selector switch position).

The TPM CM modifies state of a BOSF 124 selector switch indicated by the SNM to a position specified in SNM 205 request. This information is provided to TPM 121 by SNM 205 via BI as part of initialization, which follows TPM 121 booting.

The TPM CM modifies IP packet router tables as specified in the SNM request. This information is provided to TPM 121 by SNM 205 via BI as part of initialization, which follows TPM 121 booting.

Optical Switch Fabric Each Optical Switch Fabric 214 employs a band switch and one or more wavelength switches, but the OSF circuit packs 214 used to implement the BOSF and the WOSF 137 are physically identical. The OSF 214 IOC 210 software determines the circuit pack's role as either a BOSF 124 or a WOSF 137 from the pack shelf location (slot ID). The functions of a band switch and a wavelength switch are as follows.

At initialization, the DM accepts commands from SNM (system node manager) 205 to configure its MEMS initial state after the OSF 214 pack boots. All measurements are configured to established hit timing policy at initialization.

After the DM completes initializing it sends the in-service SNM Heartbeat message every second to notify the SNM 205 of the OSF 214 status and OSF 214 pack state.

The BOSF Circuit Pack 124 DM activates the crosspoints upon an in-service SNM 205 request to setup single or multiple port-to-port cross-connections.

The in-service SNM 205 sends the two BOSF 124 and two WOSF 137 Circuit Packs BI messages to configure their service status. One BOSF 124 and one or more WOSF 137 Circuit Packs are configured as the in-service optical switch fabric 214 and the other BOSF 124 and WOSF 137 Circuit Packs are configured as the out-of-service optical switch fabric 214. The OSF 214 DM operates its SERVICE LED to the state corresponding to the configured service status.

The WOSF Circuit Pack 137 DM activates the crosspoints upon an in-service SNM 205 request to setup single or multiple port-to-port cross-connections.

The BOSF Circuit Pack 124 DM deactivates the crosspoints upon an in-service SNM 205 request to tear down single or multiple port-to-port cross-connections.

The WOSF Circuit Pack 137 DM deactivates the crosspoints upon an in-service SNM 205 request to tear down single or multiple port-to-port cross-connections.

Each OSF Circuit Pack 214 DM returns its port-to-port connection map upon an in-service SNM 205 request.

The BOSF Circuit Pack 124 DM monitors its hardware devices via polling/interrupts, translates detected failures to their corresponding faults, transitions the circuit pack state, and operates the faceplate LEDs accordingly. In addition, the DM also reports the occurrence or clearing of alarms, together with the new pack state, to the in-service SNM 205.

The WOSF Circuit Pack 124 DM monitors its hardware devices via polling/interrupts, translates detected failures to their corresponding faults, transitions the circuit pack state, and operates the faceplate LEDs accordingly. In addition, the DM also reports the occurrence or clearing of alarms, together with the new pack state, to the in-service SNM 205.

The BOSF 124 and WOSF 137 Circuit Pack DMs retain the connection configuration after a soft reset initiated by either the DM or the in-service SNM.

The WOSF Circuit Pack 137 DM monitors the optical power level for the wavelengths of its egress ports to the WMX Circuit Packs 136 and determines if there is a loss of signal. A change of optical signal power level status is reported to the in-service SNM 205.

The BOSF Circuit Pack 124 DM monitors the optical power level for the wavelength bands of its egress ports to the TPM 121 and WMX Circuit Packs 136 and determines if there is a loss of signal. A change of optical signal power level status is reported to the in-service SNM 205.

Wavelength Multiplex

In addition to the aforementioned functions of the WOSF 137 DM, the WOSF 137 DM also provides the following functions to control and monitor WMX circuit packs 136.

The WOSF Circuit Pack 137 DM monitors the insertions and removals of up to 8 WMX Circuit Packs, and it reports the WMX Circuit Pack 136 insertion and removal events to the in-service SNM 205.

The WOSF Circuit Pack 137 DM performs WMX Circuit Pack 136 initialization and hardware device provisioning once a new WMX insertion is detected.

The WOSF Circuit Pack DM monitors each of the individual WMX Circuit Pack 136 hardware devices via polling/interrupts, translates detected failures to their corresponding faults, transitions the circuit pack state, and operates the faceplate LEDs accordingly. In addition, the DM also reports the occurrence or clearing of alarms, together with the new pack state, to the in-service SNM 205.

The WOSF Circuit Pack 137 DM monitors the individual wavelength optical power level of the WMX wavelength egress port to the WOSF Circuit Pack 137 and determines if there is a loss of signal. Any change of optical power level status is reported to the in-service SNM.

The WOSF Circuit Pack 137 DM monitors the band optical power level of the WMX band egress to the BOSF 124 and determines if there is a loss of signal at this monitor point. Change of optical signal power level status is reported to the in-service SNM 205.

The WOSF Circuit Pack 137 DM monitors the band optical power level of the WMX band ingress port from the BOSF 124 and determines if there is a loss of signal. Any change of optical signal status is reported to the in-service SNM 205.

The WOSF Circuit Pack 137 DM performs power equalization for each of WMX packs 136 so that the output power level difference among the up to 4 active wavelengths in the same output band to the BOSF 124 is within a predefined range. If the WOSF Circuit Pack DM cannot equalize to within this predefined range, it reports the situation to the in-service SNM.

Optical Wavelength Interface Shelf

The redundant OWCs (Optical Wavelength Controllers) 220 control and monitor the up to 32 OWI (Optical Wavelength Interface) circuit packs 219. The device managing software (DM) running on the in-service OWC circuit pack 220 controls and monitors the OWIs 219 at any snapshot of time. The out-of-service OWC 220 becomes the in-service OWC 220 and takes over the OWI 219 control and monitor functions whenever a failure is detected in the in-service OWC 220.

Determination of the initial in-service OWC 220 is as follows: (1) if no other OWC 220 exists in the same OWI Shelf 70, the existing OWC 220 establishes itself as the in-service OWC 220, (2) if both OWCs 220 exist in the OWI Shelf 70 and both have no alarms, the OWC 220 with the lower slot index (OWC0) establishes itself as the in-service OWC 220, (3) if one OWC 220 has alarms and the other does not, the OWC 220 without alarms establishes itself as the in-service OWC 220, (4) if both OWCs 220 are failed, the OWC 220 with the lower slot index (OWC0) establishes itself as the in-service OWC 220. Note that an OWC 220 service status change, once one OWC 220 is in service and the other out of service can come only from the in-service SNM 205. The functions of the OWC 220 DM are as follows:

DMs on both in-service and out-of-service OWCs 220 report their presence after power up.

The in-service OWC 220 DM reports its role as an in-service OWC 220, together with its pack information, to the in-service SNM 205, and it operates its faceplate SERVICE LED to the in-service state.

After initialization, DMs on both in-service and out-of-service OWCs 220 send Heartbeat messages every second over the internal Ethernet to notify the in-service SNM 205 of their status.

When a new OWI-XP circuit pack 219A is inserted into the OWI shelf 70, the in-service OWC 220 retrieves the circuit pack interface type information and network wavelength (one of the 32 IOS ITU-compliant wavelengths) from the OWI-XP Circuit Pack EEPROM via the I²C bus. The in-service OWC 220 reports insertion/removal event of an OWI-XP Circuit Pack together with the circuit pack location (bay-shelf-slot), interface type, and the network wavelength) to the in-service SNM 205 via a BI message.

When a new OWI-TR circuit pack 219B is inserted into the OWI shelf 70, the in-service OWC retrieves the circuit pack interface type information from the OWI-TR Circuit Pack EEPROM via the I²C bus. The in-service OWC 220 reports insertion/removal event of an OWI-TR pack 219B together with the circuit pack location (bay-shelf-slot) and interface type to the in-service SNM 205 via a BI message.

When a new OWI-λC circuit pack 140 is inserted into the OWI shelf 70, the in-service OWC 220 retrieves the circuit pack interface type information and network wavelength (one of the 32 IOS ITU-compliant wavelengths) from the OWI-λC Circuit Pack EEPROM via the I²C bus. The in-service OWC 220 reports insertion/removal event of an OWI-λC Circuit Pack 140 together with the circuit pack location (bay-shelf-slot), interface type, and the network wavelength) to the in-service SNM 205 via a BI message.

The in-service OWC 220 monitors OWI 219 circuit pack hardware alarms by polling/interrupts, translates detected failures to their corresponding faults, transitions the circuit pack state, and operates the faceplate LEDs accordingly. In addition, the DM also reports the occurrence or clearing of alarms, together with the new pack state, to the in-service SNM 205.

In addition to reporting alerts and alarms autonomously, upon request by the in-service SNM 205, the in-service OWC 220 reads current PM data (e.g., LASER CURRENT, TEC CURRENT, PHOTODIODE CURRENT) from each of the individual OWI packs 219 and reports the data to the in-service SNM 205.

The in-service OWC 220 accepts commands from the in-service SNM 205 to configure a 2.5 Gb/s OWI-XP Circuit Pack into either of 2 modes (2.68 Gb/s and 2.49 Gb/s). The in-service OWC 220 accepts commands from SNM 205 to configure a 10 Gb/s OWI-XP Circuit Pack into one of 3 modes (9.9 Gb/s, 10.3 Gb/s, and 10.7 Gb/s).

When an endpoint HEB configuration is required for 1+1 network protection, the in-service OWC 220 accepts in-service SNM 205 commands to configure the port as a HEB for the working and protection paths, using two adjacent OWI Shelf 70 slots.

When an endpoint TES configuration is required for 1+1 network protection, the in-service OWC 220 accepts in-service SNM 205 commands to configure the port as a TES for the working and protection paths, using two adjacent OWI Shelf 70 slots.

When a 1+1 network protection is released, the in-service OWC 220 returns the involved OWI 219 ports to their default configurations.

The in-service OWC 220 accepts commands from the in-service SNM 205 to configure an OWI-XP 219A or OWI-TRG Circuit Pack 219B with a receive-to-transmit loop toward the CO or an independent receive-to-transmit loop toward the optical switch fabric 214. The OWI-TRP 219B and OWI-λC Circuit Packs 140 have no such loops.

The in-service OWC 220 monitors the optical power levels from signals from both of the redundant optical switch fabrics for each of the OWI packs 219. A transition from signal to loss of signal and vice versa in any monitored signal is reported to the in-service SNM 205.

The in-service OWC 220 monitors the externally incoming signal from CO to each of OWI packs 219. A transition from loss of signal to signal and vice versa is reported to the in-service SNM 205.

The in-service OWC 220 normally selects the signal from the in-service optical switch fabric by configuring the 2×1 switch. If the OWC 220 determines that an LOS condition has occurred on the selected signal with valid power levels on the non-selected signal, it reconfigures the 2×1 switch to the good signal. The in-service OWC 220 immediately reports the selection change of the 2×1 switch to the in-service SNM 205. The in-service OWC 220 performs optical switch fabric selection in a non-revertive manner once side selection occurs due to a failure, reversion to the pre-fault selection is accomplished only by a command from the in-service SNM 205.

The in-service OWC 220 accepts command from the in-service SNM 205 for any or all of the OWI packs 219 it monitors and controls to configure the 2×1 switch to a particular state. The in-service OWC 220 considers a command to configure to the existing selected state as reinforcing.

For a 1+1 network circuit, if the in-service OWC 220 detects LOS on the currently working path with proper optical levels on the protection path, it switches the TES configuration to the protection path and reports this selection change to the in-service SNM 205. The TES selection is non-revertive—reversion to the pre-fault TES selection is accomplished only by a command from the in-service SNM 205.

For a 1+1 network circuit, the in-service OWC 220 accepts a command from the in-service SNM 205 to perform a TES onto the protection path.

The in-service OWC 220 monitors receive and transmit optical signals on the OWI-XP packs 219A, which include Rx and Tx on both the CO and optical switch fabric sides; transition from loss of signal to signal and vice versa is reported to the in-service SNM.

The in-service OWC 220 monitors receive and transmit optical signals on the OWI-TR packs, which includes Rx and Tx on the CO side; transition from loss of signal to signal and vice versa is reported to the in-service SNM 205.

Optical Performance Monitoring

The Optical Performance Monitoring Device Manager (OPMDM) measures the optical power, wavelength registration and OSNR at each tap point.

The OPMDM provides software control for switching to different tap points and scanning among the ensemble of TPM 121 access points.

The OPMDM implements the software control of the optical spectrum analyzer (OSA) device. The control includes the commands that can be processed by the OSA device 850.

The OPMDM supports both peak scan (OSNR, power, and wavelength registration) and spectrum scan.

The OPMDM is transparent to the request mode, whether it is a request for camp-on or background scan. The logic for background scan or camp-on scan is implemented by the in-service SNM.

The OPMDM implements the needed hardware monitoring and fault detection reporting. It implements the pack state machine to correctly reflect the pack state.

The OPMDM sends calibrated measurements (includes tap loss and switch loss) to SNM.

The enabling/disabling of measurement related to various tap points is not done at OPMDM level. This abstraction is handled at SNM level 205.

Optical Test Port

The Optical Test Port Device Manager (OTPDM) is used to set up test port circuit flow for 10 Gbs, 2.5 Gbs and 10 GbE. For pseudorandom data testing, the OTP 218 transmits and/or receives a framed Pseudo Random Bit Stream with a 2²³−1 pattern. This data field is applicable to the two SONET 2.5 Gb/s and the three 10 Gb/s SONET and Ethernet format. The receiver/analyzer provides a Pass/Fail indication to the IOC at the completion of the data analysis. For LMP verification testing, the OTP 218 transmits the LMP message requested by the in-service SNM 205 and verifies reception of the message, if requested.

The circuit flow setup is software selectable, and the test flow is established for circuit troubleshooting and network pre-service testing using the endpoint OWI-XP and OWI-TRG circuit packs that the optical circuit is expected to use.

The OTPDM implements the necessary embedded software modules, module device drivers, module interrupt routines and timers.

The OTPDM implements the needed hardware monitoring and fault detection reporting. It implements the state machine to correctly reflect the pack state.

The OTPDM implements the needed software control for 2.5 Gbs, 10 Gbs and 10 GbE module. The control includes switch selection for signal from in-service or out-of-service WOSF 137, switch selection for signal generation and transmission for 2.5 Gbs or 10 Gbs/GbE, switch selection for signal reception and analysis for 2.5Gbs or 10 Gbs/10 GbE and configuration of 2.5 Gbs/10 Gbs/10 GbE modules.

The OTPDM implements the clock control for 2.5 G/10 G/10 GbE.

### Management Plane SDS

Further reference for the succeeding description is provided to Specification Attachment 5—Management Plane Software Architecture, which is fully and completely incorporated herein as if repeated verbatim.

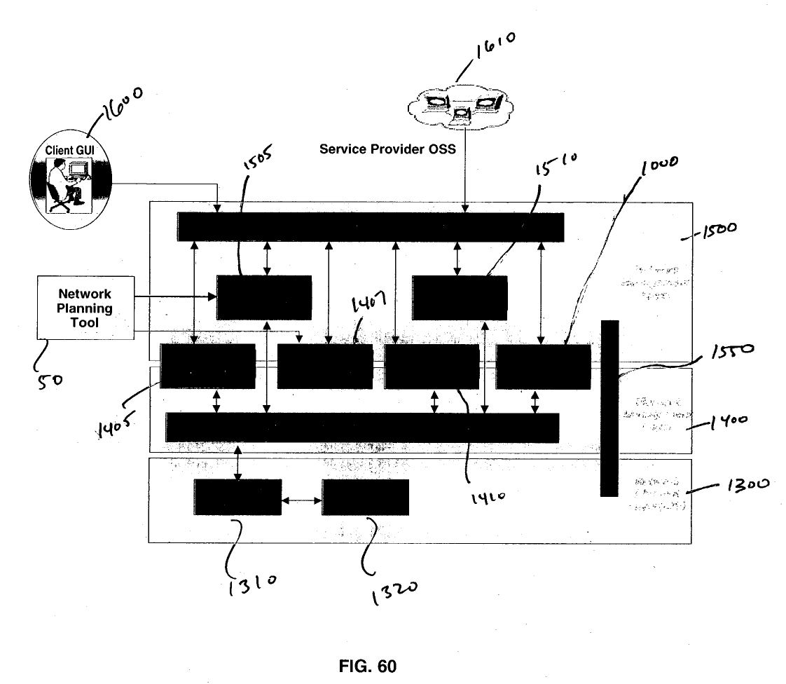

The SDS 204 is a comprehensive suite of management applications based on the Telecommunications Management Network (TMN) model. The overall architecture is depicted in FIG. 60.

The lowest layer, the Network Element Layer 1300, is implemented on the switch itself and provides basic functionality such as self-diagnosis, alarm monitoring and collection, collection of performance data, data conversion and formatting, as well as the agent to the external EMS/NMS system. The embedded agent 1310 is also interfaced to the control point/switch module 1320.

The SDS of the described embodiment supports both layer 2 1400 and 3 1500. Where layer 2 is defined to be the Element Management Layer (EML) 1400 and layer 3 is defined to be the Network Management Layer (NML) 1500.

The functionality provided by the SDS 204 includes configuration manager 1405, connection manager 1407, performance manager 1000, fault manager 1410, topology, accounting manager 1510 and security 1550. These services are provided at both the EMS and NMS layer where applicable. The diagram shows how some components span both the TNM 1299 element 1300 and network 1400 layers.

The software is implemented using Java technology to enable fast development, a friendly user interface, robustness, self-healing, and portability.

Northbound interfaces 1520 provide support for the GUI 1600 as well as other applications and carrier OSSs.

The GUI 1600 is an integrated set of user interfaces. The interfaces are built using Java technology in order to provide an easy to use customer interface as well as portability. The customer can select a manager from a pallet of GUI 1600 views or drill down to a new level by going down a set of views. The GUI 1600 can run cross platform with support for Operating System Software (OSS) 1610 Solaris and Windows 2000/XP.

Security 1550 is provided in several forms. User authentication is provided. Passwords are stored and handled in encrypted form. User access control is provided. The user access is based on user roles. The administrator can define roles and set the permissions of the role.

The SDS supports non-redundant and redundant operational modes. The Redundant mode has warm and hot standby.

### SDS Implementation Technology

SDS Platform

The SDS 204 is a fully distributed set of applications that can be used and configured in many ways.

Hardware Platform

The SDS 204 is designed to use off the shelf industry standard computing platforms. The IOS 60 server platform in an embodiment of the invention is Sun Solaris (Sparc).

The size of the Sun and the number of Suns required vary with network size and required high availability of the SDS 204. The Sun product line is being updated regularly, but in general a minimum of a 2-processor system should be used based on either the UltraSparc II or UltraSparc III processor.

If more processing power is needed then the customer can use multiple workstations or a single workstations with more than 2 processors. Sun supports servers with as many as 64 processes at this time. Of course, for redundancy a minimum of two workstations is required.

The Sun server(s) running Oracle should have a minimum of 2 high-speed SCSI disk drives to ensure adequate performance.

The GUI runs on a PC (Intel) with either Windows 2000 or XP operating system. Solaris is also supported. If Firm requirements are identified other platforms may be supported. A computer with a minimum of 512 MB and the equivalent processing power of a PIII 800 Mhz is recommended for reasonable performance.

Software Platform

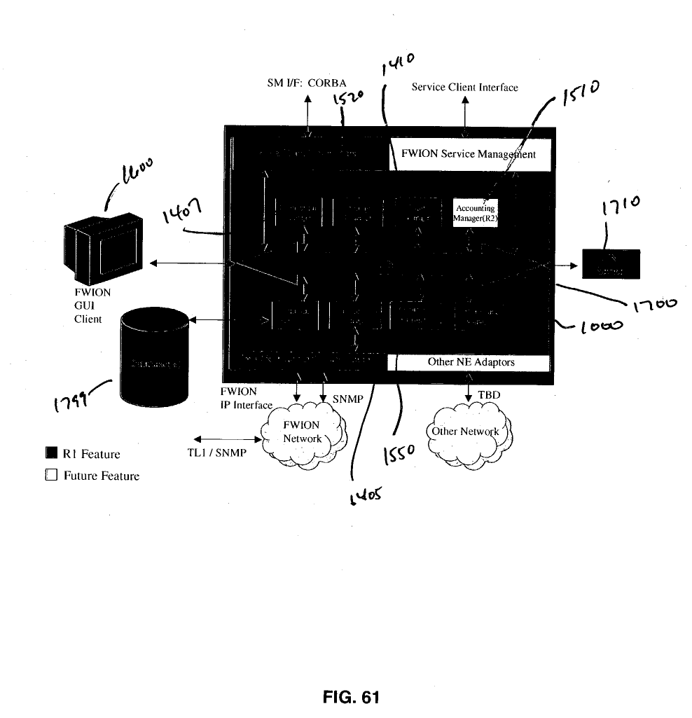

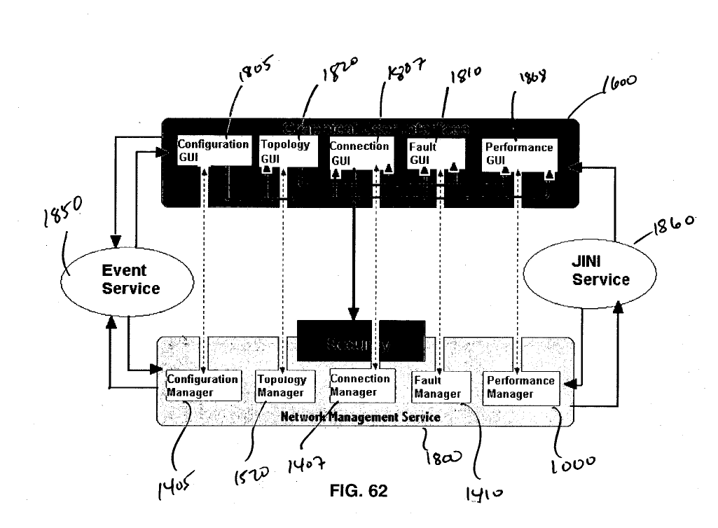

The management system of the present invention is a distributed set of Java components that uses advanced technology to enable efficient and user-friendly management of NEs. Functionally the system provides, as shown in FIG. 61 (with further reference to FIG. 59) a set of services including configuration management 1405, connection management 1407, performance management 1000, topology management 1505, accounting and security 1550. The system is s fully distributed group of Java applications. These applications can be distributed across multiple workstations to allow the SDS 204 to easily scale from a few NEs to hundreds of NEs. An integrated GUI client 1600 is provided as well as a set of interfaces to link the system to the carrier OSS 1610.

The SDS 204 uses the JINI infrastructure 1700 to provide network services, as well as to create spontaneous interactions between programs that use these services. A key component of JINI technology is the JINI Lookup Server 1710. This is the component that allows services to be managed in a dynamic way. The services register with this server. Clients can then find the available services via the lockup server. This allows services to be added or removed from the network in a robust way. Therefore clients are able to rely upon the availability of these services—a failed service is removed from the JINI lookup. The client program downloads a JAVA object from the server and uses this object to talk to the server. This allows the client to talk to the server even though it does not know the details of the server. JINI 1700 allows the building of flexible, dynamic and robust systems, while allowing the components to be built independently.

Each manager is composed of many elements. Each manager is actually composed of several independent managers that share common services and communicate with each other. As shown in FIG. 61, the major managers are configuration 1405, connection 1407, topology 1520, fault 1410, performance 1000, security 1550 and accounting 1510. These managers provide specific functionality and share information via JINI 1700. Data is stored in the database server that uses one or more databases to keep information. The database can be configured in a redundant mode for high availability.

SDS GUI

The SDS 204 is a multi-tier, distributed system. The data tier stores persistent network element information into the Oracle database 1799. The middle tier contains a collection of dynamic JINI services that governs different aspects in the TMN architecture. The presentation tier is a graphical user interface (GUI) 1600 that interacts with the user to perform various network management tasks. The user interface is system and platform independent, and can be run on any machine that supports Java.

In conjunction with middle-tier services, the GUI 1600 dynamically presents users on-line configuration, alarm, and performance information of all managed switches as well as all the connections through them. It interactively provides users all the functionality to manage networks and nodes.

FIG. 62 depicts the dependence of GUI 1600 on the network management services 1800 and the data flow between the components within the GUI application.

General

Context sensitive help is provided to clarify the meaning of GUI selections.

The GUI has full FCAPS capability. The description of FCAPS below provides further specifics of FCAPS functionality.

The GUI client 1600 implements a client data structure to store SDS 204 data for all GUI 1600 components. For example, when the topology manager 1520 starts it retrieves the topology data from the topology GUI client data store 1521, connection data from connection data store and so on.

The client data store is updated in real time via SDS 204 events.

The GUI 1600 has a network dashboard that is the first screen after the login screen. The user can access SDS 204 services from this screen.

The Network Dashboard screen provides network level health as well. Data includes an active alarm summary as well as the number of IOSs 60 in the network.

The Network Dashboard is updated in real time via events.

The Network Dashboard only shows the switches that the user has privileges on.

All window views and pop-up dialogs are consistent in style, appearance, and operation.

All window views and dialogs use scroll bars as needed so the user does not have to resize the window or dialog.

The SDS client runs on JDK 1.3.1 and above.

For operation buttons in a view or dialog in the SDS client, “Ok”/“Cancel” buttons are used. Save”/“Confirm”/“Close” buttons are not allowed.

For operation buttons in a view or dialog in the SDS client, “Create”/“Modify”/“Delete” buttons are used. “Add”/“Edit”/“Remove” buttons are not allowed.

For the buttons on the confirmation message dialog, “Yes”/“No” buttons are used.

The message dialog does not contain any stack trace or programming debug messages.

The title of a view or dialog describes the functionality in clear and concise manner.

The table in a view or dialog supports column reordering. The table does not keep track of column ordering persistently.

All table views in the SDS client can be sorted on key columns.

All table views in the SDS client have the same look-and-feel.

If an operation takes more than 3 seconds to execute, the GUI 1600 brings a pop-up dialog saying the operation is in progress. Furthermore, the GUI 1600 does not block the user from performing other tasks on the GUI 1600.

JINI

Unlike any other SDS 204 components, the GUI 1600 instance is only a client of the JINI community.

When first starting the GUI application, the GUI dynamically discovers middle-tier application services by registering itself to JINI Lookup service 1860 (FIG. 62).

As an SDS service changes its status, such as start, stop or restart, the client automatically gets notified with the updated remote reference of the service. The GUI 1600 application communicates with these Java references to perform operations.

Security

The security manager 1550 is comprised of three core parts: user login, user manager and user access control.

User login authenticates a user based on username and password. It also supports a list of standard features, such as password aging, session tracing, etc.

The user manager performs administrative operations on user accounts, such as add a new user account, modify the user's role, etc.

User access control is the most important part of our security manager. It explicitly enables or disables certain operations based on the current user's role and domains of influence. Three basic role types—administrator, provisional user, and read-only user are predefined.

Dynamically creating new roles is supported in the future release.

Event Service

To present up-to-date information to the end user, the Event Service 1850 is used as the main communication between SDS services and the GUI application 1600.

The event indicates a network management action or system alarm. By receiving events through event service 1850, the GUI 1600 updates the screens incrementally and asynchronously, which eliminates the overhead of going to the SDS 204 service and requesting a new object. For example when a switch cross-connect is created, a trap is sent by the switch embedded software via SNMP. The trap is then received by the SDS configuration service, which translates it into an SDS 204 event. The event is then posted to the Event Service 1850. Finally the GUI client 1600 receives and processes the event and presents it to the user on the screen.

The GUI 1600 correlates SDS 204 events if some events arrive out of order or are missing. For example, if the GUI 1600 receives an EPOC “status change” event for some EPOC object before the “create” event arrives, the GUI 1600 retrieves the EPOC object from the SDS server and presents the user with the updated EPOC information.

High Availability and SDS Service Redundancy

In the case of hot standby, when the master SDS services go down, the GUI 1600 dynamically discovers the new master SDS services (previously Slave SDS Services) without logging out the user.

In the described embodiment, all the SDS clients connect to the same Master SDS services at all times.

### SDS TMN Functions

Fault and Alarm Management

The fault manager 1410 collects faults from the IOS 60.

Alarms can be classified into two types, traffic independent (equipment) and traffic dependent (signal). Traffic independent alarms are caused by failures of circuit packs or circuit pack components or other components such as fan trays within an IOS 60. Any disruptions in user traffic are reported as a traffic dependant fault. Traffic independent failures are detected only by the affected IOS 60. Some circuit pack or component failures cause disruptions in user traffic, which is diagnosed as traffic dependent faults by other IOSs 60 that share part of the user path with the affected IOS 60.

When a single event causes multiple alarms, the SDS receives only a single alarm after the IOS 60 OCP 20 has performed fault correlation.

By default, all the traffic independent alarms are always enabled.

Traffic dependent alarms are enabled once a circuit is setup.

Fault correlation happens at different levels. At the SDS 204 level, only network level alarms are correlated and presented to the user.

The SDS 204 allows the user to perform manual fault isolation by using the test port to transmit test messages. These messages may be one or loopback within the IOS 60, between adjacent IOSs 60, or between remote IOSs 60.

The SDS 204 provides a GUI display 1600 of alarms with the following parameters: Alarm Type, Alarm Severity, Alarm Status, IOS ID, and Time Stamp.

The SDS 204 allows the operator to organize the alarm display based on IOS 60 ID, alarm type, alarm severity, and time stamp. The SDS 204 allows the operator to sort the alarms by various methods such as device origination, time, severity, etc or suppress them at the system, board and port level from the display based on these parameters.

The SDS 204 maintains a history of alarms for a configurable time period and database size that can be displayed upon client request.

The SDS 204 monitors the status of the IOS and generates an alarm if communications connectivity is disrupted.

The SDS 204 allows the operator to suppress alarms either on a severity basis or a card basis.

There are three alarm severities for IOS 60 alarm conditions which are supported by the SDS 204: Critical, Major and Minor.

Configuration Management

(a) Network Element Discovery

The CM 1405 discovers a new unmanaged IOS 60 automatically when the IOS 60 starts up, or when the operator keys in the IP address of the IOS 60.

The SDS 204 operator can remove the IOS 60 from its domain of influence, without affecting IOS 60 functionality.

(b) Inventory

The CM 1405 provides the user with a list of IOSs 60 currently being managed by the CM 1405. The list includes the current status and top-level information for a quick managed network overview.

The user is able to graphically identify the state of the system, boards, and lower level devices for each IOS 60.

The complete up-to-date list of all circuit packs of all IOSs 60 in the managed domain is displayed at a user's request. This list also displays current status and alarm conditions for each circuit pack.

The configuration manager 1405 is capable of detecting and managing new growth to the IOS 60 inventory. Growth includes new I/O cards, new SWF cards, and/or new bays.

All newly inserted cards have the admin status of out-of-service by default. The card is automatically displayed to the user and available for configuration.

Card removal is also supported in the same automatic manner, with the additional requirement that the user takes the card out-of-service first in order to avoid alarms.

Any card insertion or removal action by the operator is relayed to SDS 204 by the OCP 20 after the IOS 60 is put under the management of the SDS 204.

(c) Configuration and Provisioning

The configuration manager 1405 provides for the configuration of the IOS 60 as well as a gateway for the NMS services 1800 to access the IOS 60.

Configuration management includes provisioning, status and control, and IOS 60 installation and upgrade Support.

Point and click configuration enables the user to quickly configure I/O cards, ports, and channels, and place them in service.

The operator can put each card administratively in service or out of service.

The state of the network elements is reflected in color to enable a quick view of the states of the devices. The color reflects the alarm state of the element.

In general, all actions affecting the IOS 60 configuration are reflected in one or more events from the OCP 20 to inform the SDS 204 of the change(s).

Both online and offline configuration of switches are supported. An IOS 60 can be pre-configured via the CM 1405 even before the IOS 60 is connected to the network.

The concept of a profile is supported. The profile concept allows the same configuration to be applied to multiple switches saving the user much time and effort. Validation is done to ascertain that the profile matches the physical inventory before the profile is applied to the IOS 60.

The CM 1405 audits the IOSs 60 in its domain of influence periodically to discover out-of-sync conditions between the CM 1405 database and the physical switch inventory and configuration. Any discrepancy is reported to the user via a color change in the status field of the top-level list of IOSs 60.

One of the key functions of the CM 1405 is to provide access to and isolation from the IOS 60 for the rest of the SDS 204. In other words access to the switch is via the CM 1405. This allows the other SDS 204 components to be more switch-independent.

The CM 1405 supports Custom MIBs and standard MIBs. Standard MIBs include GMPLS, LMP, OSPF, OIF UNI, etc.

The CM 1405 supports IOS 60 software download via FTP protocol to the IOS 60 local memory space. Software can be downloaded to either the downgrade or upgrade areas.

The CM 1405 also supports version control for IOS 60 OCP 20 software. The user can downgrade or upgrade the current IOS software to either previous or new version, respectively.

The CM 1405 supports the APSD capability. The CM 1405 receives the events from the IOS 60 for Link Failure and Link Restored and processes them before sending to other components within the SDS for further processing and display. The CM 1405 also queries the IOSs 60 within the CM 1405 domain for the status of their links. The CM 1405 may configure the IOS 60 to operate any link without control integrity. In this mode, the SDS 204 enables the operator to set the power level of TPM 121 egress amplifiers.

The CM 1405 supports both SNMP (for normal configuration of the IOS) and TCP (for bulk data transfer) protocols to communicate with the IOS 60.

By default, the CM 1405 first tries to communicate with the IOS 60 using SNMP v3, requiring user name, password, and encryption key. If the switch does not support SNMP v3, or the authentication fails, SNMP v2 is used instead, requiring only the community name. To start using SNMP v3 while using SNMP v2, the user needs to provide the required user name, password, and encryption key.

The configuration management 1405 provides step-by-step wizards for ease of data entry, for example, a wizard for creating an OIF-UNI interface.

The Configuration Manager 1405 receives SDS events derived from SNMP traps, and updates CM 1405 screens in real-time.

Accounting Management

Accounting management is supported through accounting manager 1510.

Performance Management

The performance manager 1000 does processing related to the performance of the network element as well as the network. Specific functionality includes performance monitoring, performance management control and performance analysis.

In this implementation emphasis is on optical monitoring. The IOS 60 provides two performance management features: (1) fast, low resolution power measurement via pin diodes and (2) slower, high resolution optical measurements via the OPM.

The SDS 204 utilizes SNMP and IP data transfer modes to support these features.

For fast, low-resolution power measurement, the monitored parameters include band and DWDM power level on the card level. The SDS 204 sends request to IOS 60 through SNMP. These requests may specify measurements for any combination of tap and circuit points and may specify one time or periodic measurements. In response to a SDS 204 request, the IOS 60 send the requested data to the SDS 204.

The SDS 204 receives fast power measurements from the IOS 60 and generates GUI 1600 displays and reports according to the programmed interval and accumulation period. The reporting rate is configurable parameter with a default value of 5 seconds to provide quasi real-time updates.

The IOS 60 reports the dropout of optical power below low thresholds and degradation of insertion loss between an input and corresponding output port through SNMP traps to the SDS 204.

For the TPM circuit pack 121, the other measured parameters supported by the SDS 204 include laser current, backface current, laser temperature and TEC current.

For slower, narrowband optical measurements, the measured parameters include variables on the channel level: wavelength registration, signal power, OSNR, and power spectrum. The SDS 204 supports two scanning mode: camp-on and background. In either mode, SDS 204 passively receives the data through IP data transfer.

In the camp-on mode the reading of each monitored access point gets updated every 5 seconds, this mode is used for real-time field troubleshooting purpose. In the background mode to scan of all equipped access points occurs with a 15 minutes cycle time.

The SDS 204 activates and deactivates performance measurements at each tap point and provides the following options: (1) round robin of all measurements at all measurement points with a specified interval between measurement sets; (2) round robin of selected measurements at all measurement points with a specified interval between measurement sets; (3) round robin of selected measurements at selected measurement points with a specified interval between measurement sets; and (4) one time selected measurements at selected measurement points (in support of diagnostic troubleshooting)

The SDS 204 can remove the camp-on condition from the access point(s).

Since the IOS 60 can only support five camp-on active requests, the SDS 204 responds with a message that says “OPM not available due to too many simultaneous camp-ons—try again later” to the GUI 1600 client when the active camp-on requests exceed five.

The SDS 204 can modify the scan cycle to revert to the other camp-ons that are still active, or if no others are still active, reversion is to the background scan.

The SDS 204 can report cycle information, the sum of the number of cycles consumed by camp-ons plus the number of cycles consumed by background scans. This information is supplied by the IOS 60.

In addition to measuring the optical parameters at the interface level, the user can select an end-to-end connection and view the measurements across it in an automated way

An archiving feature is provided to allow the user to store data that is of interest. The user can later retrieve this data or the SDS 204 can use it for historical trending in the future.

Performance management is supported via the OPM 216 function in the IOS 60. The SDS 204 software supports single or dual OPMs 216 using a combination of background and camp on measurements. When the IOS 60 is equipped with two OPMs 216, the SDS 204 can use one for background monitoring and the other for camp-on. Alternately, both are useable for background scan or both are usable for camp-on on a load-sharing basis.

Security Management

(a) User Security

User authentication ensures that only authorized users can log into the SDS 204.

The SDS Security Manager 1550 supports the following three user classes. Only specified privileges for the class are allowed, all others are denied:

1. Read-Only Class—Users assigned to this class can only inspect resources assigned to that specific user (meaning assigned domain). The user is allowed to change only that user's password. No other privilege is available to this user.

2. Provision Class—Users assigned to this class can make any changes on resources assigned to that specific user (meaning assigned domain). The user does not have any privilege that is specifically reserved for the administrator. The user is allowed to change only that user's password.

3. Administration Class—There is one and only one administrator in this class.

The administrator has all privileges including managing resources and user administration.

The administrator has privileges over the full domain. The administrator is always able to login regardless of the number of active sessions. Specific privileges that are reserved for the administrator class consists of the following: (a) user account administration including assigning domains of influence; (b) network view creation and deletion; (c) manually adding or removing an NE from the SDS; and (d) manually adding or deleting an NE from a network view.

The SDS Security Manager 1550 creates the following profile for each user:
(a) User Id—minimum of 6 characters, case insensitive composed of any combination of alphanumeric and special characters.
(b) User Password—minimum of 6 characters, case sensitive, composed of any combination of alphanumeric and special characters except that one character must be a special character.
(c) User Class—Read-Only or Provision Class.
(d) Assigned Resources—None By Default.
(e) Inactivity Session Timeout—60 minutes By Default (Min: 1 min, Max: 24 hrs).
(f) Password Expiration Period—6 months By Default (Min: 1 day, Max: 1 year).
(g) Account Expiration Period—Never (Min: 1 day).
(h) Maximum number of consecutive unsuccessful attempts before account is locked—3 default (Min: 1, Max: 10).

The SDS supports multiple users of the same class.

User access control restricts users to their domains of influence. Domain of Influence can be considered as resources that to which users have access. Users permissions are only valid within their Domain of Influence. The domain of influence consists of network levels and network elements as defined in the SRD (Specification Attachment 2).

The SDS Security Manager 1550 creates a factory default user of Administrator class called “administrator” with a default password “changeit”.

The SDS Security Manager 1550 prompts the user to change password on the first login or after the password expired.

The SDS Security Manager 1550 does not transmit the user name and password in clear form.

The SDS Security Manager 1550 disables a user account if login attempts on the user id exceed the configured maximum number of attempts. The account is disabled for a period of 24 hours or until the Administrator re-enables it.

The SDS Security Manager 1550 provides a list of active user sessions to the administrator, and the administrator can terminate these sessions.

SDS Security Manager 1550 prompts for a password if the user session becomes inactive for the configured Inactivity Session Timeout interval.

Services Security

Services authentication and encryption are supported using SSL. Services encryption is 64 bit DES. SDS services have an option to disable secured transmission.

Topology Management

The SDS 204 provides a topological view of a network with recursive subnets through topology manager 1520. This view allows the user to quickly determine the way NEs in the network are currently connected. The user can use this map to drill down to specific views of the network or an NE.

The SDS 204 also provides the option of a flat view of a network.

The SDS 204 supports dynamic topology discovery including adding a switch to network, configuring new links between two IOSs 60, removing existing links, inserting cards to switches, removing cards from switches, and related status changes for switches, cards, links and ports.

The SDS GUI 1600 dynamically updates when network topology changes.

The topology can be entered manually or auto discovered. Auto discovery depends on LMP (Link Management Protocol) and OSPF at the control plane to provide neighbor information to the SDS 204 by sending link status messages from the OCP 20 as links are established and shut down. These messages Include the following parameters for the local and remote IOSs 60: IP address/interface number, Interface ID, TE Link ID.

The SDS 204 can validate these auto discovery messages by comparing the link parameters provided by adjacent IOSs 60.

If the SDS 204 discovers a new IOS 60 as a neighbor of an existing IOS 60, it then queries this IOS 60 to determine its local configuration. Note this has low probability because the SDS 204 must establish SNMPv3 authentication parameters before accessing any IOS 60 data. Thus, it probably knows about any IOS 60 within its domain.

The SDS 204 provides a GUI 1600 display of the network topology with the option to display the physical topology or the logical topology. The display is be hierarchical such that client may limit the display to a subnet.

The SDS 204 supports physical links related to two ports with fiber connecting them between different IOSs 60.

Based on the physical link, the logical link concept is also supported. A logical link is a band path or a bundle of multiple band paths on the same route. It is also called a Traffic Engineering (TE) link.

The SDS 204 supports topology XML import and export functionalities.

Topological network information is stored in the SDS database 1799.

The SDS 204 provides network level Inventory of IOSs 69 via the GUI 1600.

Connection Management

The connection manager 1407 provides methods to create new connections, delete connections, and view existing connections. The connection manager supports simple cross connects as well as end-to-end connections traversing the entire network.

(a) General

The types of connections supported include Provisioned Optical Circuits (POC), Endpoint Provisioned Optical Circuits (EPOC), Route Provisioned Optical Circuits (RPOC) and Switched Optical Circuits (SOC).

The SDS 204 validates all circuit requests for POCs, RPOCs and EPOCs. If the parameters are out of range, the SDS 204 rejects the request and indicates the out-of-range parameter to the user.

The SDS 204 allows on demand teardown of all circuit types supported.

The SDS 204 filters out unavailable ports and wavelength channels and presents available ports, wavelength channels to the user for EPOC, RPOC and POC setup.

The SDS 204 supports pre-service testing on provisioned connection path and link verification using the optional test port.

The SDS 204 supports the display of provisioned connection paths for all supported connection types. The operational statuses of the provisioned circuits are updated on the GUI as the status changes.

The SDS 204 notifies the NPT 50 when any network topology, including IOS, physical link and logical link, as well as associated properties, and any type of optical circuit change including cross connects.

(b) Optical Circuit Setup

The SDS 204 allows the user to create/remove cross connects on a single IOS 60.

The SDS 204 passes POC and RPOC route information to OCP 20 to setup the connection path. This information includes any wavelength conversion. The SDS 204 only sends the request to the start IOS 60 node for POC and RPOC setup.

The SDS 204 requires the user to specify the exact route for basic service level POC.

The SDS 204 supports only the basic service level for the POC. If the path later fails the user is notified via the connection status.

The SDS 204 uses endpoints specified by the user and the services of the NPT software to route the connection for RPOC.

The SDS 204 supports basic, 1+1 and 1:1 service level for RPOC.

The user must specify the service level for RPOC.

The OCP 20 switches over to the protection path for RPOC 1+1 and 1:1 service level if the working path fails.

When the SDS 204 receives an event from the OCP 20 indicating the connection path switch over for the 1+1 or 1:1 RPOC, the SDS 204 starts a wait-timer with specified time duration. If the OCP 20 did not repair the failed connection path before the wait-timer expires, the SDS uses NPT 50 software to generate a new connection path complying with the diversity role (link, node) of original path, and requests OCP 20 to setup as a new protection path.

The SDS 204 supports EPOC and SOC basic, low priority, auto-restore, 1+1, and 1:1 service levels for both single circuit and group circuit requests.

The OCP 20 routes SOC and EPOC connections for supported service levels.

The SDS 204 specifies the endpoints of an EPOC and only sends the request to the start IOS node for EPOC setup.

(c) Band Management

The SDS 204 supports manually provisioning (create/remove) static bands over a network of IOSs 60. The SDS 204 notifies the NPT 50 when the band is created or removed manually.

The SDS 204 uses NPT 50 software to get network band and logical link assignments by passing the network topology and circuit information of all supported types to the NPT 50 software. Then the SDS 204 configures the logical links and band paths.

The SDS 204 supports provisioning band paths by specifying two IOS 60 endpoints and routes. The SDS 204 configures one of the endpoints on the IOS 60. The OCP 20 then uses signaling to set up the bands. The end-to-end wavelengths must be the same along the bands. The SDS 204 notifies the user if the OCP 20 fails to set up the bands and fails the request.

The SDS 204 does not support dynamic creation of logical links and bands—the bands are not created in response to a call setup request.

The SDS 204 allows the user to select a particular band for RPOC setup between the same two IOS 60 end points. If the NPT 50 software can't find routes for all selected wavelengths, the SDS 204 rejects the request and displays a proper message to the user.

The SDS 204 supports setting up multiple connection paths for EPOC and RPOC if the endpoints are the same IOSs 60 and the same band is used. A maximum of four connections are allowed.

The SDS 204 supports provisioning Band Switch Cross Connects on a single IOS 60.

The SDS 204 only allows the user to remove the band when there are no optical circuits on it.

(d) Logical Link Management

A logical link is bi-directional. Its admin status can be in-service or out-of-service.

The SDS 204 supports setting a logical link on top of band path(s). The SDS sends the request along with band path(s) information to the start IOS 60 to setup a logical link. The OCP 20 uses signaling to setup the logical link and activates the logical link by setting admin status to in-service.

The SDS 204 allows the user to change the admin status of a logical link.

The SDS 204 allows the user to add new band path(s) to an existing logical link without affecting the service. The new band path(s) must be on top of the same DWDM physical links on which the logical link is built.

The SDS 204 allows the user to modify logical link parameters such as logical link cost.

The SDS 204 supports displaying a version of the network graph showing IOS 60 nodes and logical links.

Wavelength Conversion

The SDS 204 supports wavelength conversion only at the source IOSs 60. The NPT 50 software decides if conversion is needed and selects the wavelength.

### Networking and Protocols

The SDS 204 easily integrates into a diverse management plane. The management software is designed to work in an all embodiments of the invention as well as a mixed management and switch environment. The Carrier can use their own OSS and integrate the NMS/EMS of the invention in their system to manage the hardware.

IOS Interfaces

The interface to the IOS 60 is via SNMP was well as custom interfaces. A custom interface may be provided for use by the SDS 204 to allow greater flexibility and efficiency than SNMP provides alone. The SNMP interface is an industry standard interface that allows integration with other network management tools. SNMP security is provided when used in the V3 mode. Additionally TLI is provided to interface to existing NMS and carrier systems.

SNMP

SNMP supports V1, V2C, and V3 standards.

The IOS 60 allows V1 and V2c access to be disabled and enabled via the serial port CLI only. By default they are enabled.

SNMP can use a Custom MIB when industry standard MIBS are not available.

The SNMP Agent provides two types of communication to the IOS 60 when using V3: (1) communication with authentication but without privacy (AuthNoPriv): communication is restricted. Access is granted upon authentication. Message not encrypted; and (2) communication with authentication and privacy (AuthPriv): communication is secured. Access is granted upon authentication, and message is encrypted.

The SNMP Agent in V3 mode does authentication using MD5 or SHA. MD5 or SHA is specified when the V3 user account is created on the IOS 60.

The SNMP agent in V3 mode uses CBC-DES for encrypting communication messages.

The SDS 204 uses a single V3 username, password and key to manage an NE. This account has full access to the IOS 60.

The V3 user name, password, and key is stored on the switch and modified via serial port only.

TLI

The TLI command interface is available via a TCP/IP connection or through the CLI via the serial port or telnet.

Multiple users can access the TLI interface through TCP/IP at one time.

The TLI interface provides username/password security.

The TLI interface provides the ability to control the same MIB data as SNMP. All fields in every supported MIB can be accessed through TLI.

The TLI command set of the present invention is based on the data structure of the SNMP MIBs. Users are allowed to get/set a scalar field, get/set a field in a table entry, create/delete table entries, and retrieve an entire table at once.

Events are transmitted to all TLI users asynchronously. The events provide the same information as the SNMP traps defined in the MIBs.

(a) TCP Control TCP Control of the present invention is used to optimize data transfer between the SDS 204 and the IOS 60. The TCP Control is an interface via a TCP/IP socket that allows the SDS 204 to get or set a large amount of IOS 60 data at one time. The TCP Control provides the ability to get/set a view or a portion of a table in a fast and optimal way. The PTC provides security to prevent unauthorized access to the IOS.

SDS Interfaces

The SDS 204 provides a rich set of interfaces to the carrier OSS. Interfaces include XML, SNMP, TLI and CORBA. A preferable embodiment supports Corba. These interfaces allow the carrier to integrate the SDS 204 with their systems in order to do end-to-end provisioning as well as unify event information. Third party services and business layer applications can also be easily integrated into the SDS 204 via this interface.

(b) Corba

This embodiment supports provisioning only. The IDL is compliant with Connection and Service Management Information Model Corba IDL Solution Set V1.5-TMF807.

Since the carrier interface is a machine-to-machine interface, no GUI 1600 display is involved.

Based on TMF807 standard, the current release supports the concepts of Termination, AdministratedObject, ManagedObject, Link, Connection and Subnetwork.

Termination represents the points at which a subnetwork offers the ability to create connections. Termination has the concepts of containment structure, naming, role, and mapping.

AdministeredObject supports administrative states, operational states, and change events on these states.

ManagedObject is an interface for the objects that can be created, activated or removed. It implements the operations that change the object's life cycle state (such as activation). It also implements identification, naming, idle version control and user labeling. ManagedObject generates life-cycle events.

Link represents the connectivity between subnetworks.

A sub network is for managing sets of connections and/or other derived connection types.

Connection represents the ability to transfer data between terminations according to some desired behavior.

By default, the Corba layer assumes the connection type is EPOC. Proprietary extensions need to be made to the IDL to support other connection types.

### SDS System Management

Database

The SDS 204 uses Oracle as its database 1799. The Oracle database 1799 is well proven and widely deployed in the industry. It supports replication that is required in order to have a high availability SDS 204.

The SDS 204 uses the Oracle replication feature to maintain a stand-by database to provide fail-over protection. The databases must be on separate workstations.

The SDS 204 provides the ability to enable/disable the replication feature.

The SDS 204 provides the ability to either automatically or manually switch from the master to the standby database.

The SDS Database 1799 provides the ability to store and retrieve data for all NMS components.

SDS Deployment Modes, Redundancy and Recovery

The SDS 204 is a fully distributed set of applications that can be used and configured in many ways.

Single Instance on Single Workstation

In the described embodiment, all applications run on a single Sun Solaris server managing a single network. The database 1799 is non-redundant. However, services can be restarted automatically in the event of a software failure. The main limitation of this deployment mode is that the SDS 204 is not protected against hardware failure or database failure. It will be appreciated that alternative configurations may be supported as necessitated.

The GUI 1600 can be distributed anywhere on the network and multiple GUIs are supported as well.

Single Instance on Multiple Workstations (Load Sharing)

Referring to FIG. 62, this is the case where a single instance running on multiple servers manages a network 2000.

Database redundancy is supported so that data can be protected. If the master database cannot be accessed the slave database is used by the SDS database application.

If Sun 1 hardware were to fail, the services on Sun 1 2001 would be started on Sun 2 automatically and the standby database on Sun 2 would be used.

This deployment provides protection against software, database and hardware failure.

The limitation of this deployment mode is that some time is required to bring up the services on Sun 2. During this time the SDS 204 would be unavailable to the user.

Warm Standby

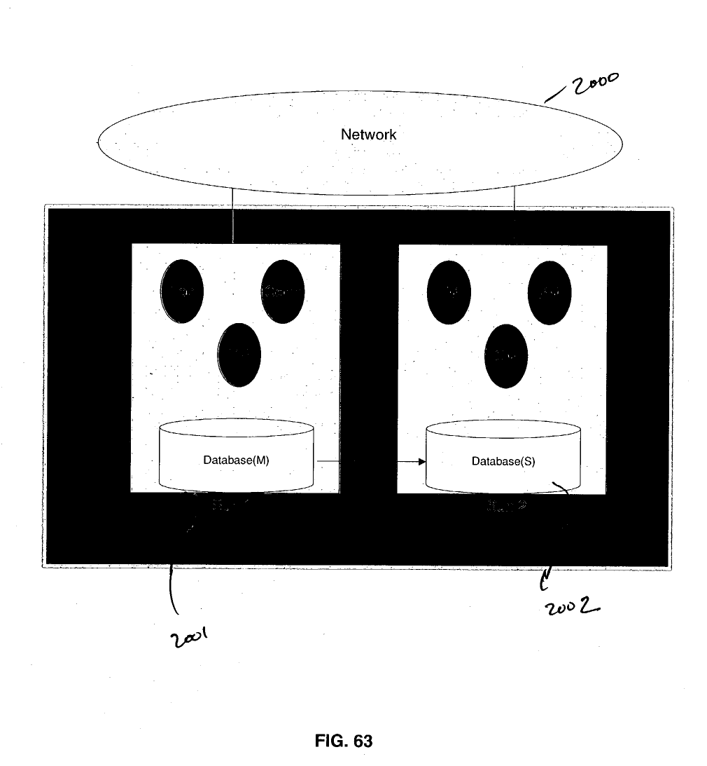

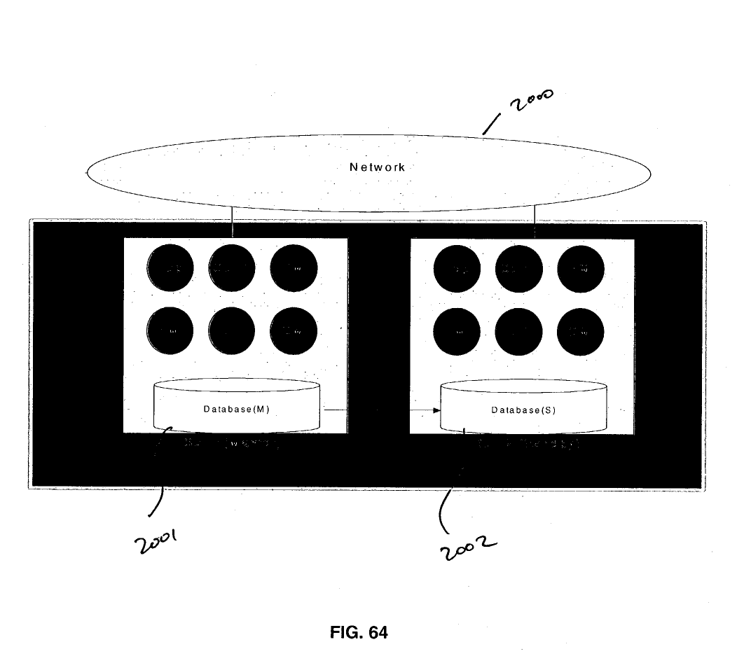

Referring to FIG. 63, standby is the case where there are two SDS 204 instances managing the same network. One instance is the master the other is a standby. Each instance can run on one or more hardware servers. The switchover requires user intervention.

Normally only the master services are running and managing the network.

The data is mirrored from the master to the standby instance using standard database methods.

In the event of a failure on the master instance the standby instance becomes the master.

In the case of warm standby the administrator starts the slave instance after the failure of the master instance. There is therefore an interruption of SDS 204 availability during this manual startup period.

The time required to bring up the standby instance is less than 15 minutes.

The clients must be restarted to connect to the new master instance.

The IOS 60 must be configured to send events to both the slave and master instance of the SDS 204.

Hot Standby

Hot standby is the case where there are two SDS instances managing the same network. One instance is the master the other is a standby. Only the master is used. In the case of failure the standby assumes the master role. The switchover is automatic.

The data is mirrored from the master to the slave instance using standard database methods. They are not used concurrently.

The slave instance is running all the time—there is no requirement for the administrator to take action to switch from the master to slave instance.

The master and slave instances are aware of each other from messages being passed between them. In the event that the master fails the standby assumes the master role.

The switchover time is 2 minutes from failure until the standby instance becomes the master.

The clients are informed of the switchover then reconnect to the new server instance automatically.

To enhance the capability to quickly resolve faults in the hot standby of SDS 204 redundancy, it is highly recommended that each server have at least 2 network interfaces. The additional interfaces are used to form a private network between servers.

The IOS 60 must be configured to send events to both the slave and master instance of the SDS 60.

SDS Installation

The SDS 204 is installed using a GUI based product. The GUI based install program Supports both client and server installations. The Installation program handles the license key management. User data from the previous version is preserved. The Install program verifies that the version of Oracle is correct and does any required update to the database schema.

### IOS Command Line Interface

The IOS 60 supports a Command Line Interface (CLI). The CLI provides basic element management functionality to the user.

Two modes are supported—Cisco-like and TLI. If desired, the user can switch back and forth between the two modes.

Functional capability includes configuration management, fault management, performance management and connection management.

Multiple instances, maximum of 6, are supported via telnet or the serial port. Only one serial port instance is supported. Telnet is activated until after the CLI and application software are hilly initialized.

All CLI users are authenticated via UserID and password.

Three types of users accounts are supported: readonly, readwrite, and admin. The passwords are set to a default value.

There is at most one active local session and five telnet sessions.

The admin user can only login via the serial port.

Only one active CLI user has readwrite permissions.

The admin user can force the logout of any other current user.

Only those commands for which a user has privileges are accessible.

The CLI supports only element management capabilities. The CLI supports a batch mode. The CLI automatically times out the user session after a specified period has elapsed. The default time out period is 5 minutes with the value programmable by the admin user up to 60 minutes maximum.

Security for the batchmode is based on origination IP address and a password that is enabled on the IOS 60.

The IOS 60 generates an SNMP trap for CLI user login, user logout, and user login failure. The SDS 204 posts these events to the Fault Manager (FM) 1410.

### Network Planning Tool

Further reference for the succeeding description is provided to Specification Attachment 6 Network Planning Tool Architecture, which is fully and completely incorporated herein as if repeated verbatim.

The Network Planning Tool (NPT) 50 provides features to support planning of a service provider network for both the short term and long-term time horizons. It supports both the craft at the SDS 204 console managing the on-line network as well as planners that are addressing longer-tern issues and most likely located away from the SDS 204. The use of the NPT 50 features and the NPT 50 specifications are described below.

NPT Overview

The NPT 50 may be used by the craft in the Short Term Design (On Demand) mode to set Up Routed POCs (RPOCs). In this mode, the NPT 50 uses the current network topology, switch configuration (including band assignments), and circuit assignments to assign routes to new circuit requests. In this case, the circuit demands are known and the assignments are downloaded to the IOSs 60 in the operational network. The circuit requests may be single circuit request or multiple circuit requests, may be single circuit or group request, and have any service level (basic, protection, auto-restoration, low priority). In specifying the current network topology, the craft may be adding new circuit packs. In this case, the craft may request the NPT 50 to pick the transponder wavelength or this could be provided as input to the NPT 50.

The time horizon for implementing the download of the route is immediate. It may be performed with or without craft review.

The NPT 50 also supports the service provider network planning staff that focus on enhancing the network to meet circuit demands based on expected future orders and marketing projections. As part of their activities, they determine whether the network should be enhanced by modifying the band assignments or also by upgrading the network capacity. For example the network capacity may have to be upgraded by: increasing IOS capacity at existing sites, introducing new IOSs, and laying additional fibers between existing sites or connecting new sites to the network

The time frame for implementing the resulting plans varies. If only the band assignments need to be updated, then it can be done quickly. However, it new equipment and/or fibers are required, then the implementation time may range from months to years.

In performing these activities, planning analysts use the existing network topology, configuration, and circuit loading as a starting point and then enter via the GUI 1600 the IOS 60 and fiber enhancements as well as the projected circuit requirements. Projected requirements include expected services such as bandwidth on demand. Typically the requirements are specified over a multi-period the horizon, e.g., yearly over a five-year period.

The planning analysts then invoke the NPT 50 Analysis mode to determine how well the enhanced network satisfies the projected demands. They then modify the network via the GUI 1600 to alleviate bottlenecks or reduce capacity of underutilized components. Also, they invoke the NPT 50 Failure Analysis mode to determine whether the network performance is sufficiently robust in the presence of failure conditions. Because of the uncertainty of the circuit demands over the longer planning period, the network planning analysts typically perform a sensitivity analysis before deciding whether/how the network should be upgraded.

The NPT 50 also supports a Re-optimization mode in alternative embodiments. This feature enables the craft to operate the network in a more efficient manner. For example, after the network has been operated over a period, it may be possible to re-route circuits over short paths or to even out the load on the network because new capacity has been added. In the Re-optimization mode, the NPT 50 generates the new routes to the SDS 204 for download to the IOSs 60 in the operational network. Typically the re-optimization is done off-line because it may be computational intensive. Upon completion and review, it is downloaded to the SDS 204 for implementation. The download identifies the circuits to be re-routed, the new route (it may only be partial re-routed), and the sequence for performing the re-routing.

In future releases, the NPT 50 Design Mode is available to support the longer term planning activities as an enhancement to the Analysis and Failure Analysis modes described above. In the design mode, the NPT 50 automatically determines new fiber links and incremental switching capacity. This requires an integer linear programming capability, or equivalent, that needs further algorithm development and evaluation.

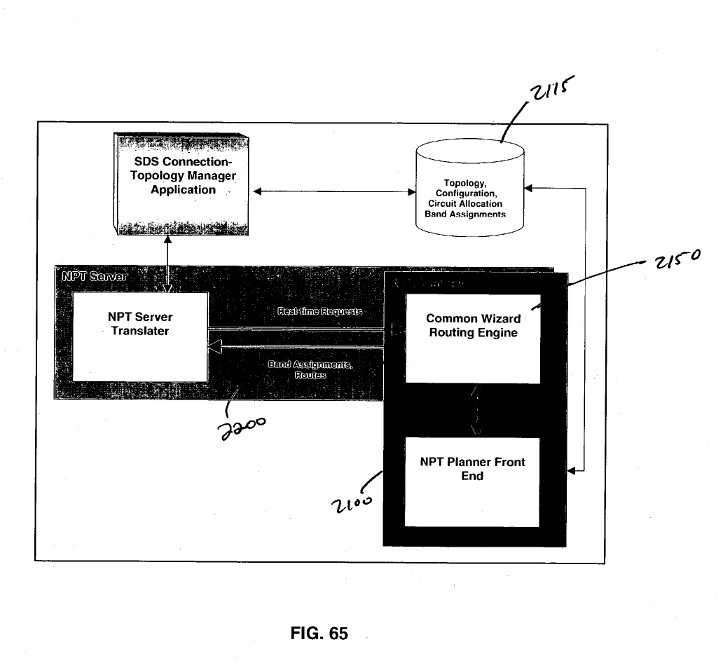

NPT Specifications The NPT 50 includes the NPT Planner 2100 and NPT Server 2200 that share a common Wizard Routing Engine (WRE) 2150 as depicted in FIG. 65.

The NPT Server 2200 operates as part of the on-line SDS 204 and generates routes for Routed POCs. It generates routes for single circuit requests and group circuit requests for all service levels.

The NPT Server 2200 operates in the NPT Short Term Design (On Demand) mode using the current network topology, configuration, circuit assignments, and band assignments. It receives the inputs and generates the outputs listed in Table 14. When ready to establish new RPOCs, the craft enters the new circuit demands and requests the NPT server 2200 to generate the new routes.

TABLE 14

| Inputs | | Outputs | |
|---|---|---|---|
| Network State | Topology | New Circuit | Routes |
| | Configuration | Assignment | Band Cross- |
| | Band Assignments | | connects |
| | Circuit Assignments | | Wavelength Cross- |
| New Demands | Number of Circuits, | | connects |
| | Endpoints | | Source Wavelength |
| | Service Levels | | Converter |
| | Transponder | | Intermediate |
| | Wavelength (opt.) | | Wavelength |
| | | | Converter |
| | | | Transponder |
| | | | Wavelength (opt.) |
| | | Band | Endpoints and |
| | | Assignments | Intermediate IOSs, |
| | | | Bands, WMXs |

In the Short Term design mode, the wavelength of new OWI circuit packs 219 may be provided as input to the NPT 50 or the NPT 50 may determine an optimal wavelength.

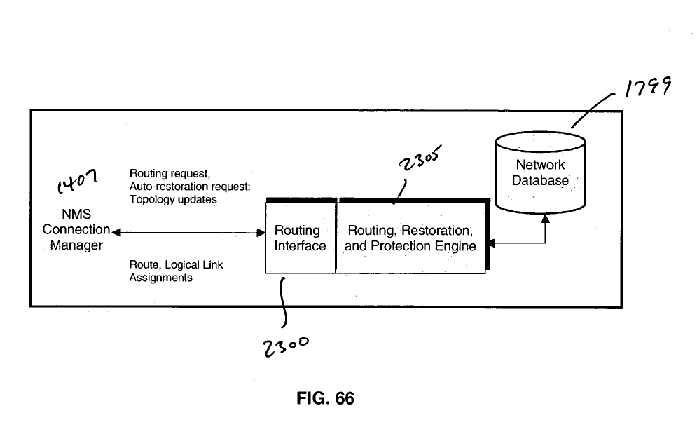

The NPT Server Routing Interface 2300, depicted in FIG. 66, provides the interconnection between the on-line SDS Connection Manager 1407 and the NPT Common Routing Engine 2305. It receives network topology and configuration updates as well as the specific circuit request from the SDS 204. In response, it forwards the R2P engine results to the SDS 204.

In support of the NPT Server 2200, the WRE generates routes for single or multiple circuit requests. The routes identify the sequence of IOSs 60 and the logical links comprising the route. For circuits having the low priority, 1+1, or 1:1 protection service levels, the WRE generates routes with protection paths. It also determines when wavelength conversion should be used. Wavelength conversion is performed only at the source in one embodiment of the invention.

The NPT Server 2200 also generates new band assignments upon request of the craft when a circuit request is blocked with the existing band assignments. After the new band assignment is approved by the craft and downloaded to the operational network, the NPT server 2200 generates the route for the circuit.

The NPT Planner 2100 operates off-line of the SDS 204 with common Wizard Routing Engine 2150 to support the longer term planning activities of the service provider. It supports the planning for all types of optical circuits including bandwidth on demand. In this mode the circuit demands may be based on known demands, customer orders or projections of circuit requests based on market demands. Requirements for bandwidth on demand are included in the latter category. The NPT Planner 2100 exports new band assignments to the SDS 204 for download to the IOSs 60 in the operational network.

The NPT Planner 2100 operates in the Analysis mode to perform routing, wavelength assignment, and band assignment enabling the service provider to assess the capability of its network to accommodate known and/or projected circuit demands. In this mode, the NPT 50 enables the user to modify the network topology and capacity as well as modify the IOS 60 configuration in order to meet these demands. The input and output parameters for the Analysis mode are listed in Table 15.

TABLE 15

| Inputs | | Outputs | |
|---|---|---|---|
| Network | Topology | Circuit | Same as Short Term |
| State | Configuration | Assignments | Design mode |
| | Band Assignments | Band | Same as Short Term |
| | Circuit Assignments | Assignments | Design mode |
| | | Statistics | Blocking |
| | | | Link Utilization |
| | | | Demand Satisfaction |
| New | Number of Circuits | Changes | Topology Changes |
| Demands | Endpoints | | Fiber Changes |
| | Service Levels | | IOS Changes |
| | Transponder | | |
| | Wavelength (opt.) | | |
| Network | New fibers | | |
| Changes | Additional IOSs | | |
| | IOS capacity | | |
| | increases | | |

The NPT Planner 2100 operates in the Failure Analysis to assess the capability of its network to recover from link and switch failure conditions. In this mode, the NPT 50 enables the user to specify link and switch failure conditions and it determines the circuits that can be maintained. The input and output parameters for the Analysis mode are listed in Table 16.

TABLE 16

| Inputs | | Outputs | |
|---|---|---|---|
| Network State | Same as Analysis | Statistics | % of circuits that |
| | mode | | can be re-routed |
| Failure Scenario | Failed links and/or | | New routes |
| | Failed IOSs | | |

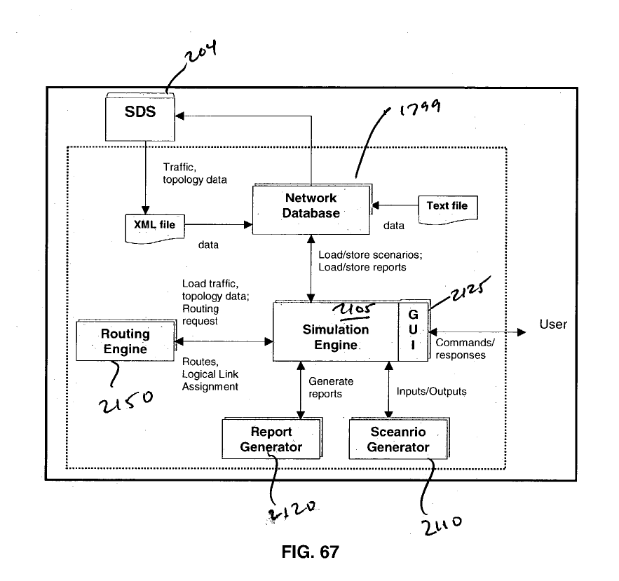

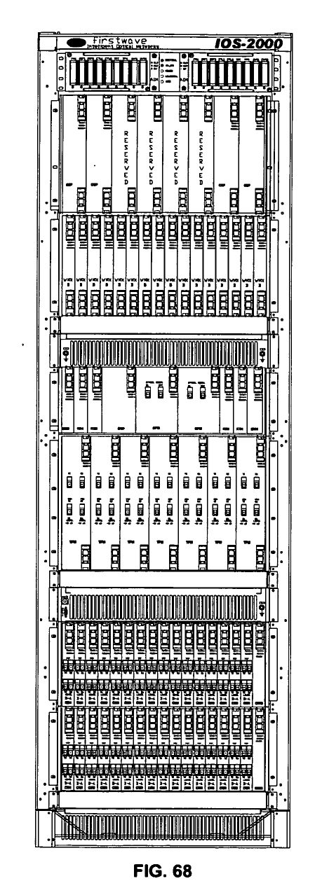

The NPT Planner 2100 functional architecture consists of Simulation Engine 2105, Scenario Generator 2110, Network Database 2115, Report Generator 2120, and GUI 2125 in addition to the common Wizard Routing Engine (WRE) 2150 as shown in FIG. 67.

The NPT Planner Scenario Generator 2110 prepares traffic, topology, and IOS 60 configuration data input over possibly multiple time periods. Data may be obtained from an external text file (e.g., a Microsoft Excel file) or from the NPT Server 2200, i.e., current network data.

The NPT Planner Simulation Engine 2105 controls execution of the planning tool by invoking the Wizard Routing Engine (WRE) 2150 in response to individual circuit requests or failure events. It also manages the data flow between the Network Database 2115, Scenario Generator 2110, and Report Generator 2120.

The NPT Planner Database 2115 stores model inputs and outputs. The SDS 204 exports network state data (current configuration, topology, circuit assignment, and band assignment) to the database and imports network configuration data (band assignments).

The NPT Report Generator 2120 displays or produces printouts of the NPT 50 results possibly over multiple time periods. These results consist of number of circuit requests that can be satisfied, routes used by each circuit, circuits that can be restored after failure, and equipment needed to satisfy the requirements.

The NPT GUI 2125 has the same “look and feel” as the SDS GUI 1600 and provides user interface for entry of data and display of results. It provides the same easy to use features specified above for the SDS GUI including on-line help.

The NPT Planner 2100 also operates in the Short Term Design mode as does the NPT Server 2200. This is a degenerate case of the Analysis mode.

The NPT Planner 2100 and Server 2200 are implemented using separate instances of the common WRE 2150 such that the longer term planning does not interfere with the NMS assignment of RPOCs.

The NPT Planner 2100 operates in a Network Re-optimization mode. In this mode, the NPT 50 analyzes the current circuit routes and band assignments and generates improved routes, e.g., shorter routes, load balanced routes, and possibly new band assignments. These results are exported to the NPT Server 2200 for downloading to the IOSs 60 in the operational network.

In support of the NPT Planner 2100, the WRE 2150 generates routes for single or multiple circuit requests and introduces wavelength conversion and/or modified band assignments as necessary in accordance with the IOS 60 engineering rules. For circuits having the 1+1, or 1:1 protection service levels, it generates routes with protection paths.

The NPT Planner 2100 operates in the Long Term Design Mode to perform network and switch sizing in conjunction with routing, wavelength assignment, and band assignment. It enables the service provider to assess the capability of its network to accommodate projected circuit demands. In this mode, the NPT 50 automatically generates enhancements to the network and switch capacity such that the switch and fiber costs are minimized using a heuristic algorithm. However, it still allows the user to modify the network topology and capacity as well as modify the IOS 60 configuration. The input and output parameters for the Analysis mode are listed in Table 17.

TABLE 17

| Inputs | | Outputs | |
|---|---|---|---|
| Network | Topology | Circuit | |
| State | Configuration | Assignments | |
| | Band Assignments | | |
| | Circuit | | |
| | Assignments | | |
| New | Number of | Band | |
| Demands | Circuits, | Assignments | |
| | Endpoints | | |
| | Service Levels | | |
| | Transponder | | |
| | Wavelength | | |
| | (opt.) | | |
| Costs | Link Costs | New Fiber | Endpoints |
| | | Links | Number of fibers |
| | Switch Costs | Switch | TPMs, WMXs |
| | | Capacity | Wavelength Fabrics |
| | | | Transponders |

The NPT Server 2200 generates new routes for RPOCs with the Auto-Restoration service level.

### IOS Physical Design

Further reference for the succeeding description is provided to Specification Attachment 4—Physical Design Architecture, which is fully and completely incorporated herein, as if repeated verbatim.

The IOS 60 physical design is Telcordia compliant in an embodiment of the invention. All designs and specifications meet the Specifications set forth in the Telcordia GR specifications.

Equipment Frame

The equipment is mounted in an EIA Seismic frame with a maximum enclosure height of 2134 mm (7 ft), a width of 660 mm (2 ft, 2 in) and a depth of 600 mm (2 ft).

Frameworks are welded construction. Items that do not provide mechanical strength, such as panels and doors may be fastened by other means. The frames can withstand the static load test of GR-63-Core with less than a 5-mm permanent deformation. At any time the peak deflection of the frame shall not exceed 50-mm measured from the top of the bay.

Equipment and shelves are fastened to the equipment frame by means of M5 screws or larger with a minimum engagement of three threads. The mounting pitch for all equipment fastened to an equipment frame is on centers of 25 mm.

No part of the framework extends beyond the nominal height, width or depth dimensions.

The Circuit Pack Plug-Ins, Power/Alarm Panel & DCMs are accessible for removal or installation without removing any other framework components, including doors and trim panels.

Access is provided to permit Electrical or Optical Cabling from the top or bottom of the framework.

Equipment frames are capable of supporting and providing a fastening arrangement for all CDSs (Cable Distribution Systems). The design of the interface between the frame and the CDSs permit the insertion or removal of a frame from an equipment line-up. To permit this a minimum clearance of 10mm (0.39in) is provided between the top of the frames and the bottom of the CDSs.

An anchoring area is provided in the base of the framework for attachment to the building floor or a raised floor. (See Telcordia GR-63-Core for Anchoring details)

Orderable Configurations

Table 18 sets forth orderable configurations in embodiments of the invention.

TABLE 18

| | | Simplex | | | | Redundant | | | |
|---|---|---|---|---|---|---|---|---|---|
| | | Add/Drop | | | | Add/Drop | | | |
| Orderable Configurations IOS-2000 | | 32 | 64 | 96 | 128 | 32 | 64 | 96 | 128 |
| Number of Network Frames | | 1 | 2 | 2 | 3 | 1 | 2 | 2 | 3 |
| Switch Shelf Assemblies | | 1 | 1 | 1 | 2 | 1 | 1 | 1 | 2 |
| OSF | OSF (Wavelength Optical Switch Fabric) | 1 | 2 | 3 | 4 | 2 | 4 | 6 | 8 |
| | OSF (Band Optical Switch Fabric) | 1 | 1 | 1 | 1 | 2 | 2 | 2 | 2 |
| TPM Shelf Assembly | | 1 | 1 | 1 | 1 | 1 | 1 | 1 | 1 |
| TPM | TPM (Transport Module) | 7 | 6 | 5 | 4 | 7 | 6 | 5 | 4 |
| WMX Shelf Assembly | | 1 | 2 | 3 | 4 | 1 | 2 | 3 | 4 |
| WMX | WMX (Wavelength Mux/Demux) | 8 | 16 | 24 | 32 | 16 | 32 | 48 | 64 |
| Controller Shelf Assemblies | | | | | | | | | |
| SNM | SNM (System Node Manager) | 1 | 1 | 1 | 1 | 2 | 2 | 2 | 2 |
| ETH | ETH (Ethernet Switch) | 2 | 2 | 2 | 2 | 4 | 4 | 4 | 4 |
| OPM** | OPM (Optical Performance Monitor) | 1 | 1 | 1 | 1 | 1 | 1 | 1 | 1 |
| OTP*** | OTP(Optical Test Port) | 1 | 1 | 1 | 1 | 1 | 1 | 1 | 1 |
| Fan Tray Assemblies | | 3 | 6 | 6 | 8 | 3 | 6 | 6 | 8 |
| Air Intake/Heat Baffle Assembly | | 3 | 6 | 6 | 8 | 3 | 6 | 6 | 8 |
| OWI Shelf Assemblies | | 1 | 2 | 3 | 4 | 1 | 2 | 3 | 4 |
| OWI * | OWI (Optical Wavelength Interface) | 32 | 64 | 96 | 128 | 32 | 64 | 96 | 128 |
| OWC | OWC (Optical Wavelength Controller) | 1 | 2 | 3 | 4 | 2 | 4 | 6 | 8 |

* OWI (Various Configurations Available ie. 10 G/2.5 G/1550/1310), TRG, TRP, λC
**OPM (Available Option for 2nd OPM
***TPM (Multirate 10 G/2.5 G)

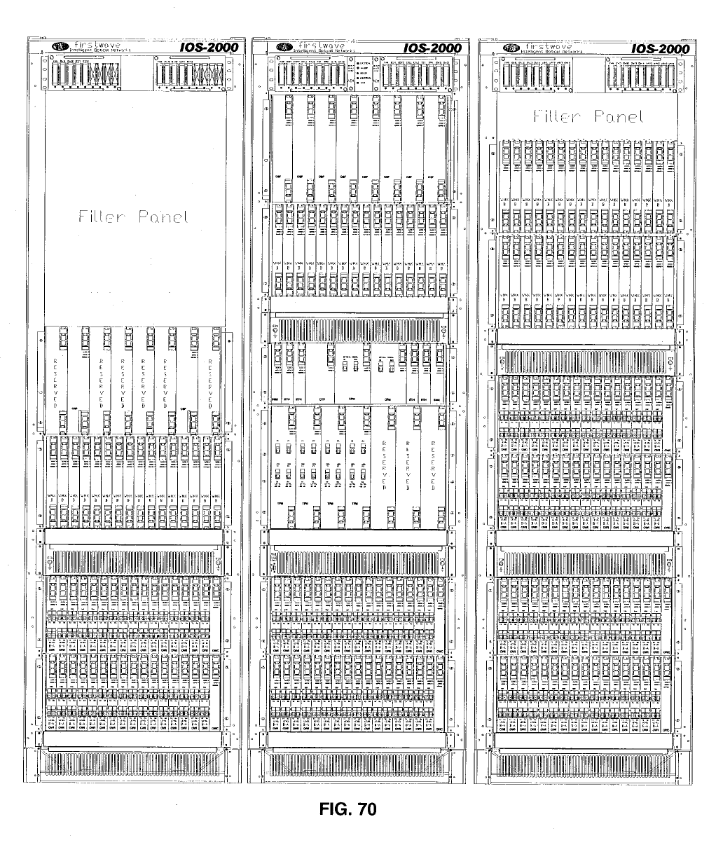

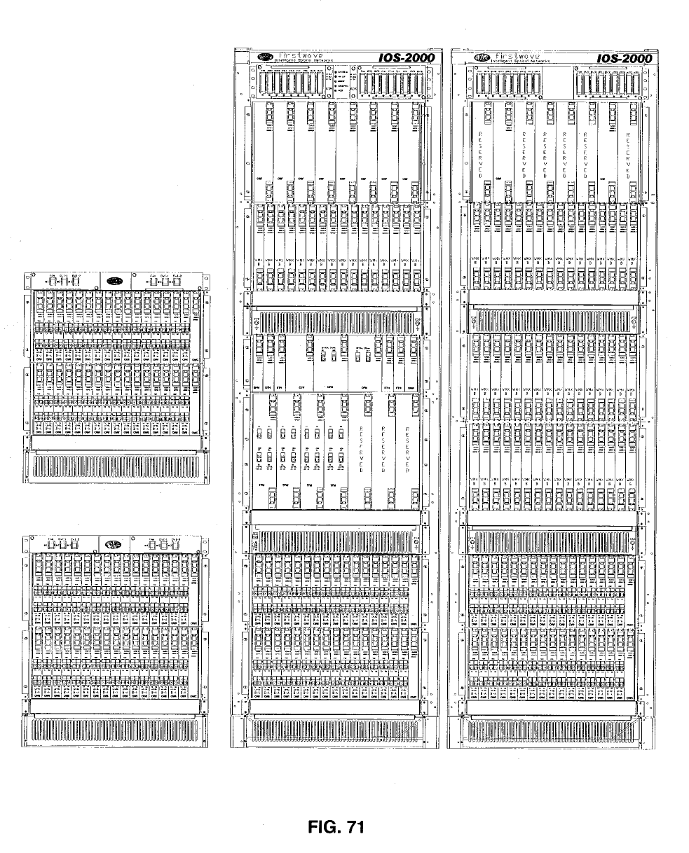

FIG. 68 shows 32 Add/Drop-7 Fiber Single Bay Configuration. FIG. 69 shows 96 Add/Drop-5 Fiber Two Bay Configuration. FIG. 70 shows 128 Add/Drop-4 Fiber 3-Bay Configuration. FIG. 71 shows 128 Add/Drop-4 Fiber 2-Bay Configuration With (2) Remote OWI Shelf Assemblies.

Equipment Shelves and Sub-Assemblies

Shelf Designs are compatible with Seismic, Newton and ETSI Bay styles. Shelving is 23″ Telcom Rack-mountable and does not support a 19″ Telcom Rack.

For ESD protective measures during maintenance, all equipment assemblies are fitted with clearly labeled jacks or similar devices for the grounding of wrist straps. Provisions are made for grounding at both the front and the rear of the unit.

All card guides extend close to the front of the shelves and incorporate a tapered lead-in to facilitate circuit pack insertion.

All faceplates have appropriate EMC/EMI treatment. Typically, conductive foam gasket or Beryllium copper gasket may be used to seal gaps between faceplates.

Dummy faceplates are utilized to fill any un-equipped circuit pack locations. These dummy faceplates channel the airflow so that proper pressure can be maintained within a given shelf assembly.

All back-planes and circuit pack plug-ins have appropriate guide pins to facilitate circuit pack insertion as well as proper alignment. Furthermore, all circuit pack plug-ins have circuit pack and/or backplane keying to protect against improper circuit pack slot insertion.

The IOS Shelf Assembles are summarized in Table 19.

TABLE 19
IOS-2000 SHELF ASSEMBLIES

| SHELF | | EIA | SHELF HEIGHT | |
|---|---|---|---|---|
| NAME | FUNCTION | TYPE | MM | IN |
| OWI | Optical Wavelength Interface | 5U | 221.23 | 8.710 |
| TPM | Transport Module | 8U | 354.58 | 13.960 |
| WMX | Wavelength Mux/Demux | 6U | 265.68 | 10.460 |
| CTRL | Controller | 4U | 176.78 | 6.960 |
| OSF | Optical Switch Fabric | 7U | 310.13 | 12.210 |
| ALM | Power/Alarm Panel | 2U | 88.90 | 3.500 |

Backplanes

(a) Optical Backplane

Due to the intensity of the fiber management for this system an optical backplane is utilized to manage the interconnection between each circuit pack. The IOS 60 utilizes a FlexPlane design by Molex.

For high fiber Count interconnects in back-planes and cross-connect systems, the FlexPlane's high density routing on a flexible, flame-resistant substrate provides a manageable means of fiber r outing from card-to-card or shelf-to-shelf. A variety of interconnects including blind mating MT and MTP based connectors connect the optical flex circuits to individual cards in a shelf.

Available in any routing scheme, fiber can be routed point-to-point, in a shuffle, or in a logical pattern. Direct or fusion-spliced terminations are available. Non-fusion splice lead lengths are available up to 2 meters. Molex provides a variety of FlexPlane interconnect options including: MT, MTP, MT-RJ, SMC, LC, FC, ST, SC, MU, up to 12 fiber Back-plane MTP (BMTP), and up to 96 fiber High Density Back-plane MT (HBMT).

Packaging alternatives include standard bare flexible substrate, sandwiched in FR-4 or custom laminating. Each FlexPlane circuit can be fully tested down to per port insertion loss and return loss.

(b) High Density Optical Backplane Connectors:

IOS 60 HBMT Connectors allow a maximum of 96 fibers of interconnectivity per connector. Ribbon fiber assemblies utilize up to 24 fibers per MTP. The HBMTP Interconnection Scheme is described below.

IOS Molex Connectors

Referring to Table 20 below, IOS 60 molex connectors in the present invention include the following properties: (1) High density up to 96 fibers in 1.6 inch by 0.62 inch by 2.1 inch; (2) Small footprint increases board real-estate; (3) Mechanical float on either the daughter-card or motherboard side in the X, Y, and Z axis; (4) Allows for card cage tolerances; (5) Rivet or screw mounting; and (6) Uses MT ferrule as the optical interface: 2, 4, 8, 12, 24 fiber version, single mode.

TABLE 20

| Characteristics | Units | Min | AVG | MAX | Comments |
|---|---|---|---|---|---|
| Insertion Loss | | | | | |
| 9/125 uM Sngle- | dB | | 0.35 | 0.75 | |
| Mode Fiber | | | | | |
| Enhanced 9/125 | dB | | 0.14 | 0.45 | |
| uM SingleMode | | | | | |
| Return Loss | dB | | | <60 | |
| (SingleMode) | | | | | |
| Temperature Range | ° C. | −40 | | 80 | Angle Polish |
| Durability | dB | | | <0.2 | 40 Cycles, 0.05 dB |
| | | | | | Max Change |
| | | | | | 1000 mate/un-mate |
| | | | | | cycles |

Electrical Backplane

The IOS 60 utilizes a Molex VHDM connector system.

Equipment Loading

The Floor Loading is 735 kg/m² (150.6 lb/ft²). The Equipment Loading is 560 kg/m² (114.7 lb/ft²). The CDS and Lighting Fixture Loading is 125 kg/m² (25.6 lb/ft²). The Transient Load is 50 kg/m² (10.2 lb/ft²).

Floor Mounting: The frames are leveled and plumbed to compensate for variations in floor flatness. Devices for leveling the frame may include, but are not limited to wedges, shims and leveling screws.

Dispersion Compensation Modules

There is (1) DCM (Dispersion Compensating Module) per TPM (DWDM Fiber Link) per IOS-2000 System Bay. A maximum of (7) DCM modules are necessary for a 32-Add/Drop 7-Fiber Terminal. The DCMs (Dispersion Compensating Modules) reside only in the IOS System Bay 62. The DCMs are located on the side of each OWI, TPM, WMX, & OSF shelf assemblies. Fiber Management raceways are utilized to control the Input/Output DCM fibers. All DCMs are LC/APC terminated and connect to BLCs (Backplane LC/APC-Adapters) located on each TPM (Transport Module) backplane slot.

(a) DCM Installation & Removal

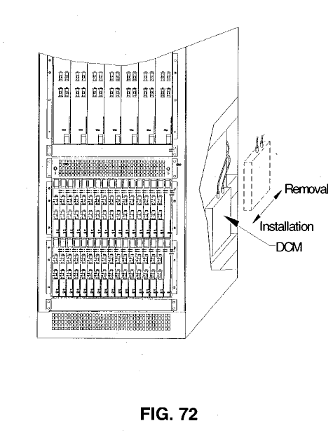

Referring to FIG. 72, DCM Installation requires attaching a DCM module to the side of a shelf. Fixing material is mounted to the shelf unit at the factory so no additional hardware is required. All DCM installations or removals may occur while the product is in service. No traffic degradation occurs on any other fiber during DCM installation or removal. The DCM module slides in and out of a channel and is fastened on the side of each shelf unit.

Circuit Pack Keying

All plug-in modules have a mechanism for keying to prevent improper circuit pack insertion and possible damage. The keying mechanism is to be in the form of either a latch-interlocking device or-back-plane alignment keys.

Circuit Packs

Circuit Pack Coding Table

Table 21 provides circuit pack coding information:

TABLE 21

| | | | | | | Visual Indications | | |
|---|---|---|---|---|---|---|---|---|
| Circuit | Functional | Electrical | Connector | | Latch | Alarm | Active | Service |
| Pack | Name | Connector | Faceplate | Backplane | Config | (RED) | (Green) | (Green/Yellow) |
| OSF | Optical Switch Fabric | VHDM | n/a | BLC/HBMT | Top/Bot | X | X | X |
| WMX | Wavelength Mux/Demux | VHDM | n/a | BLC/HBMT | Top/Bot | X | X | X |
| SNM | System Node Manager | VHDM | n/a | n/a | Top | X | X | X |
| ETH | Ethernet Controller | VHDM | n/a | n/a | Top | X | X | X |
| OPM | Optical Performance Monitor | VHDM | (2) SC/APC | HBMT | Top | X | X | |
| OWC | Optical Wavelength Controller | VHDM | n/a | n/a | Top | X | X | X |
| OWI-XP | Optical Wavelength Interface | VHDM | (2) SC/APC | BLC/HBMT | Top | X | X | X |
| TPM | Transport Module | VHDM | (4) SC/APC | BLC/HBMT | Top/Bot | X | X | |
| OWI-λC | Lambda Converter | VHDM | n/a | BLC/HBMT | Top | X | X | |
| OTP | Optical Test Port | VHDM | n/a | HBMT | Top | X | X | |
| OWI-TRG | Transmit Amplified | VHDM | (2) SC/APC | BLC/HBMT | Top | X | X | |
| OWI-TRP | Transmit Passive | VHDM | (2) SC/APC | BLC/HBMT | Top | X | X | |

Circuit Pack Physical Attributes

Table 22 provides circuit pack physical attributes:

TABLE 22
CIRCUIT PACK PHYSICAL ATTRIBUTE

| | | | | | | CIRCUIT PACK | | | | | | COMPONENT | | WIRING | |
|---|---|---|---|---|---|---|---|---|---|---|---|---|---|---|---|
| | | FACEPLATE | | | | PWB PACK | | PWB PACK | | | | SIDE USABLE | | SIDE | |
| PACK | EIA | NOM. WIDTH | | ACT. WIDTH | | HEIGHT | | DEPTH | | PWB THICK | | HEIGHT | | USABLE | |
| NAME | TYPE | MM | IN | MM | IN | MM | IN | MM | IN | MM | IN | MM | IN | MM | IN |
| SNM | 4U | 37.00 | 1.457 | 36.70 | 1.445 | 144.45 | 5.687 | 400.00 | 15.748 | 2.54 | 0.100 | 30.23 | 1.190 | 3.93 | 0.155 |
| ETH | 4U | 37.00 | 1.457 | 36.70 | 1.445 | 144.45 | 5.687 | 400.00 | 15.748 | 2.54 | 0.100 | 30.23 | 1.190 | 3.93 | 0.155 |
| OPM | 4U | 101.60 | 4.000 | 101.30 | 3.988 | 144.45 | 5.687 | 400.00 | 15.748 | 2.54 | 0.100 | 94.83 | 3.733 | 3.93 | 0.155 |
| OTP | 4U | 101.60 | 4.000 | 101.30 | 3.988 | 144.45 | 5.687 | 400.00 | 15.748 | 2.54 | 0.100 | 94.83 | 3.733 | 3.93 | 0.155 |
| OWI-XP | 5U | 31.08 | 1.224 | 30.78 | 1.212 | 188.90 | 7.437 | 400.00 | 15.748 | 2.54 | 0.100 | 24.31 | 0.957 | 3.93 | 0.155 |
| OWI-TRG | 5U | 31.08 | 1.224 | 30.78 | 1.212 | 188.90 | 7.437 | 400.00 | 15.748 | 2.54 | 0.100 | 24.31 | 0.957 | 3.93 | 0.155 |
| OWI-TRP | 5U | 31.08 | 1.224 | 30.78 | 1.212 | 188.90 | 7.437 | 400.00 | 15.748 | 2.54 | 0.100 | 24.31 | 0.957 | 3.93 | 0.155 |
| OWI-λC | 5U | 31.08 | 1.224 | 30.78 | 1.212 | 188.90 | 7.437 | 400.00 | 15.748 | 2.54 | 0.100 | 24.31 | 0.957 | 3.93 | 0.155 |
| OWC | 5U | 31.08 | 1.224 | 30.78 | 1.212 | 188.90 | 7.437 | 400.00 | 15.748 | 2.54 | 0.100 | 24.31 | 0.957 | 3.93 | 0.155 |
| WMX | 6U | 33.02 | 1.300 | 32.72 | 1.288 | 233.35 | 9.187 | 400.00 | 15.748 | 2.54 | 0.100 | 26.25 | 1.033 | 3.93 | 0.155 |
| OSF | 7U | 66.04 | 2.600 | 65.74 | 2.588 | 277.80 | 10.937 | 400.00 | 15.748 | 2.54 | 0.100 | 59.27 | 2.333 | 3.93 | 0.155 |
| TPM | 8U | 75.47 | 2.971 | 75.17 | 2.959 | 322.25 | 12.687 | 400.00 | 15.748 | 2.54 | 0.100 | 68.70 | 2.705 | 3.93 | 0.155 |

### TPM (Transport Module)

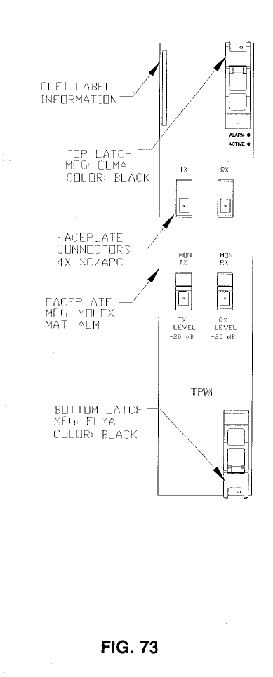

Referring to FIG. 73 a physical rendering of the TPM 121 is shown.

Properties

Material: Aluminum

Size: 8U×2.971″ (75.47 mm)

Latch Configuration: Top/Bottom—Source: Elma Electronics

Visual Indications: (1) Red LED for Alarm, (1) Green LED for Active,

Optical Connections: (4) SC/UPC (Input, Output, Mon In, Mon Out)

Label: CLEI, Common Language Equipment Identifier

Electrical Backplane Connections

Electrical I/O: Molex VHDM Connector System

Optical Backplane Connections

Molex HBMT Connector Housing #1:

MT #1 No Connect

MT #2 2 Fibers To OPM1

MT #3 8 Fibers From Band OSF (BOSF0)

MT #4 8 Fibers To Band OSF (BOSF0)

Molex HBMT Connector Housing #2:

MT #1 No Connect

MT #2 2 Fibers To OPM2

MT #3 8 Fibers From Band OSF (BOSF1)

MT #4 8 Fibers To Band OSF (BOSF1)

Backplane BLC Adapter Housings

BLC/APC #1 to DCM (Dispersion Compensating Module Input)

BLC/APC #2 from DCM (Dispersion Compensating Module Output)

### OPM (Optical Performance Monitor)

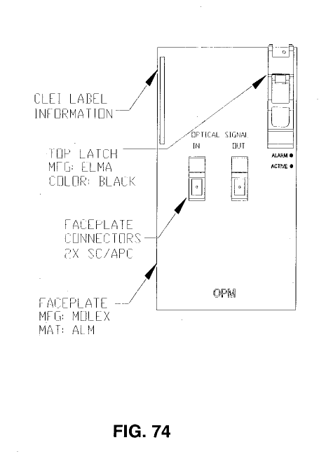

Referring to FIG. 74, a physical rendering of OPM 216 is shown.

Properties

Material: Aluminum

Size: 4U×4″ (101.6 mm)

Latch Configuration: Top—Source: Elma Electronics

Visual Indications: (1) Red LED for Alarm, (1) Green LED for Active,

Optical Connections: (2) SC/UPC (OPTICAL SIGNAL IN, OUT)

Label: CLEI, Common Language Equipment Identifier

Electrical Backplane Connections

Electrical I/O: Molex VHDM Connector System

Optical Backplane Connections

Molex HBMT Connector Housing #1:

MT #1 No Connection

MT #2 6 Fibers From TPM5-TPM7

MT #3 8 Fibers From TPM1-TPM4

MT #4 No Connection

### OSF (Optical Switch Fabric) (WOSF VERSION)

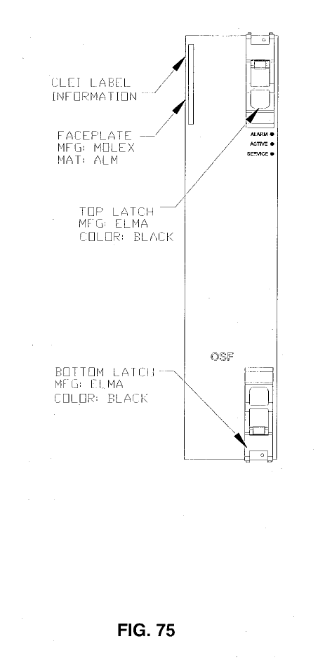

Referring to FIG. 75, a physical rendering of OSF 214 (WOSF 137 version) is shown.

Properties

Material: Aluminum

Size: 7U×2.600 (66.04 mm)

Latch Configuration: Top/Bottom—Source: Elma Electronics

Visual Indications: (1) Red LED for Alarm, (1) Green LED for Active, (1) Green/Yellow LED for Service

Optical Connections: None

Label: CLEI, Common Language Equipment Identifier

Electrical Backplane Connections

Electrical I/O: Molex VHDM Connector System

Optical Backplane Connections

Molex HBMT Connector Housing #1:

MT #1 16 Fiber To/From WMXPA-PB

MT #2 16 Fiber To/From WMXPC-PD

MT #3 16 Fiber To/From WMXPE-PF

MT #4 16 Fiber To/From WMXPG-PH

NOTE: P=SIDE (0 OR 1)

Molex HBMT Connector Housing #2:

MT #1 16 Fiber To/From OWI1-OWI8

MT #2 16 Fiber To/From OWI9-OWI16

MT #3 16 Fiber To/From OWI17-OWI24

MT #4 16 Fiber To/From OWI25-OWI32

Backplane BLC Adapter Housings

BLC/APC #1 To OTP (Optical Test Port)

BLC/APC #2 From OTP (Optical Test Port)

### OSF (Optical Switch Fabric) (BOSF VERSION)

Optical Backplane Connections

Molex HBMT Connector Housing #1:

MT #1 16 Fiber To/From TPM 1

MT #2 16 Fiber To/From TPM 2

MT #3 16 Fiber To/From TPM 3

MT #4 16 Fiber To/From TPM 4

Molex HBMT Connector Housing #2:

MT #1 16 Fiber To/From TPM 5/16 Fiber To/From WMXPA-PH

MT #2 16 Fiber To/From TPM 6/16 Fiber To/From WMX PA-PH

MT #3 16 Fiber To/From TPM 7/16 Fiber To/From WMX PA-PH

MT #4 16 Fiber To/From WMX PA-PH

P=SIDE (0 OR 1)

Backplane BLC Adapter Housings

BLC/APC #1 To OTP (Optical Test Port)

BLC/APC #2 From OTP (Optical Test Port)

### OTP (Optical Test Port)

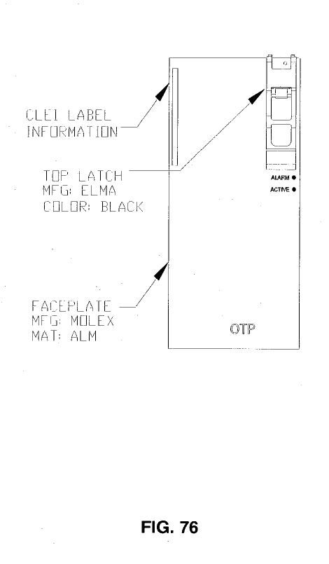

Referring to FIG. 76, a physical rendering of OTP 218 is shown.

Properties

Material: Aluminum

Size: 4U×4″ (101.6 mm)

Latch Configuration: Top—Source: Elma Electronics

Visual Indications: (1) Red LED for Alarm, (1) Green LED for Active,

Optical Connections: None

Label: CLEI, Common Language Equipment Identifier

Electrical Backplane Connections

Electrical I/O: Molex VHDM Connector System

Optical Backplane Connections

Molex HBMT Connector Housing #1:

MT #1 6 Fibers To/From WOSF0A-WOSF0C

MT #2 2 Fibers To/From WOSF0D

MT #3 6 Fibers To/From WOSF1A-WOSF1C

MT #4 2 Fibers To/From WOSF1D

### SNM (System Node Manager)

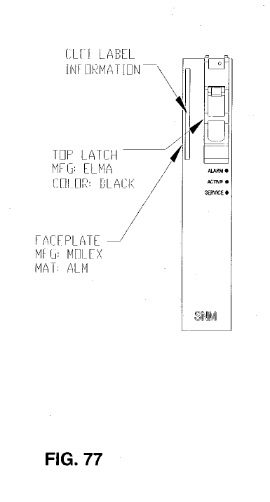

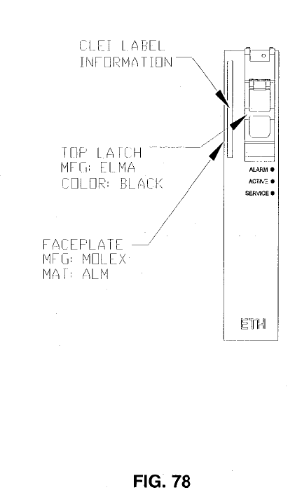

Referring to FIG. 77, a physical rendering of SNM 205 is shown.

Properties

Material: Aluminum

Size: 4U×1.457″ (37 mm)

Latch Configuration: Top—Source: Elma Electronics

Visual Indications: (1) Red LED for Alarm, (1) Green LED for Active, (1) Green/Yellow LED for Service

Optical Connections: None

Label: CLEI, Common Language Equipment Identifier

Electrical Backplane Connections

Electrical I/O: Molex VHDM Connector System

### ETH (Ethernet Switch)

Referring to FIG. 78, a physical rendering of Ethernet Switch 222 is shown.

Properties

Material: Aluminum

Size: 4U×1.457″ (37 mm)

Latch Configuration: Top—Source: Elma Electronics

Visual Indications: (1) Red LED for Alarm, (1) Green LED for Active, (1) Green/Yellow LED for Service

Optical Connections: None

Label: CLEI, Common Language Equipment Identifier

Electrical Backplane Connections

Electrical I/O: Molex VHDM Connector System

### OWC (Optical Wavelength Controller)

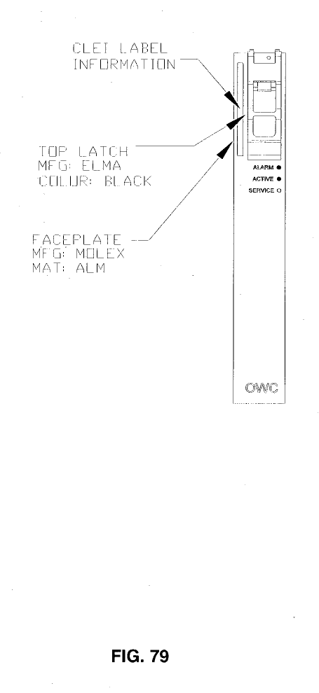

Referring to FIG. 79, a physical rendering of OWC 220 is shown.

Properties

Material: Aluminum

Size: 5U×1.224″ (31.08 mm)

Latch Configuration: Top—Source: Elma Electronics

Visual Indications: (1) Red LED for Alarm, (1) Green LED for Active, (1) Green/Yellow for Service

Optical Connections: None

Label: CLEI, Common Language Equipment Identifier

Electrical Backplane Connections

Electrical I/O: Molex VHDM Connector System

OWI-λC (Wavelength Lambda Converter)

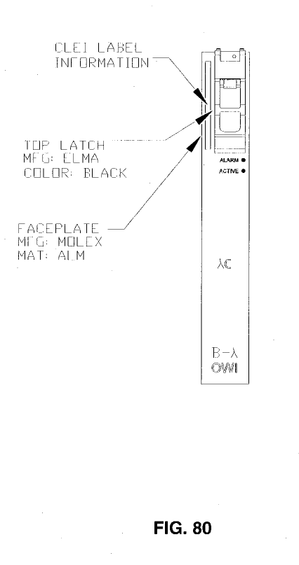

Referring to FIG. 80, a physical rendering of wavelength λ converter 140 is shown.

Material: Aluminum

Size: 5U×1.224″ (31.08 mm)

Properties

Latch Configuration: Top—Source: Elma Electronics

Visual Indications: (1) Red LED for Alarm, (1) Green LED for Active

Optical Connections: None

Label: CLEI, Common Language Equipment Identifier

B-λ=Band-Wavelength

Electrical Backplane Connections

Electrical I/O: Molex VHDM Connector System

Optical Backplane Connections

Molex HBMT Connector Housing:

MT #1 To/From Adjacent OWI

MT #2 To/From WOSF0Y

MT #3 To/From WOSF1Y

MT #4 Not Used

Y=A, B, C, D

### OWI-TRG (Transmit Gain)

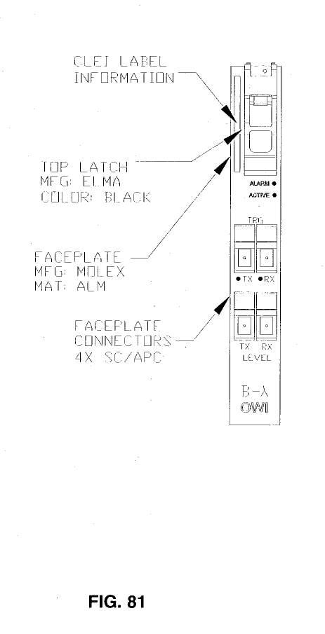

Referring to FIG. 81, a physical rendering of OWI-TRG is shown.

Properties

Material: Aluminum

Size: 5U×1.224″ (31.08mm)

Latch Configuration: Top—Source: Elma Electronics

Visual Indications: (1) Red LED for Alarm, (1) Green LED for Active, (2) Green/Yellow LED or LOS

Optical Connections: (4) SC/UPC (TX, RX, Level TX, RX)

Label: CLEI, Common Language Equipment Identifier

Laser Safety Warning Label (Location—TBD)

B-λ=See Table: 2.5.9-1 Band-Wavelength Matrix

See Table: 2.5.12-1 for Optical Interconnections

Electrical Backplane Connections

Electrical I/O: Molex VHDM Connector System

Optical Backplane Connections

Molex HBMT Connector Housing:

MT #1 To/From Adjacent OWI

MT #2 To/From WOSF0Y

MT #3 To/From WOSF1Y

MT #4 Not Used

Y=A, B, C, D

### OWI-TRP (Transparent Passive)

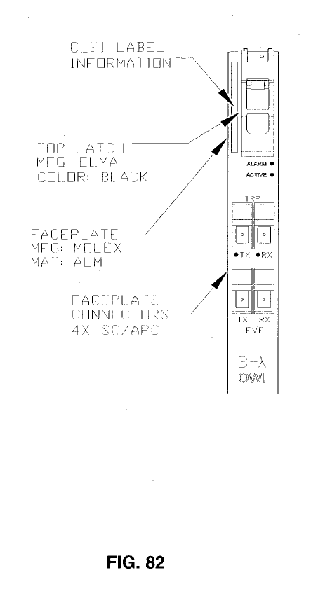

Referring to FIG. 82, a physical rendering of OWI-TRP is shown.

Properties

Material: Aluminum

Size: 5U×1.224″ (31.08 mm)

Latch Configuration: Top—Source: Elma Electronics

Visual Indications: (1) Red LED for Alarm, (1) Green LED for Active, (2) Green/Yellow LED or LOS

Optical Connections: (4) SC/UPC (TX, RX, Level TX, RX)

Label: CLEI, Common Language Equipment Identifier

Laser Safety Warning Label (Location-TBD)

B-λ=See Table: 2.5.9-1 Band-Wavelength Matrix

See Table: 2.5.12-1 for Optical Interconnections

Electrical Backplane Connections

Electrical I/O: Molex VHDM Connector System

Optical Backplane Connections

Molex HBMT Connector Housing:

MT #1 To/From Adjacent OWI

MT #2 To/From WOSF1Y

MT #3 To/From WOSF0Y

MT #4 Not Used

Y=A, B, C, D

OWI-XP (Optical Wavelength Interface Transponder)

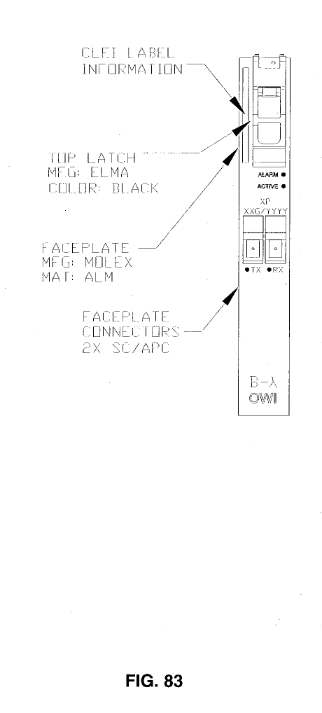

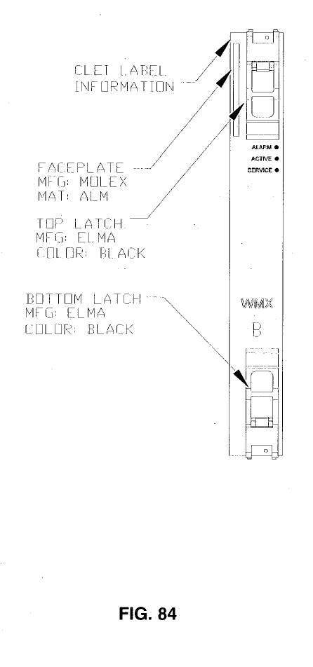

Referring to FIG. 83, a physical rendering of OWI-XP 219A is shown.

Properties

Material: Aluminum

Size: 5U×1.224″ (31.08 mm)

Latch Configuration: Top—Source: Elma Electronics

Visual Indications: (1) Red LED for Alarm, (1) Green LED for Active, (2) Green/Yellow LEDs for Input/Output Optical Signal Out of Range

Optical Connections: None

Label: CLEI, Common Language Equipment Identifier

Laser Safety Warning Label (Location-TBD)

XXG/YYYY=2.5 G or 10 G/1550 or 1310

B-λ=Band-Wavelength

Electrical Backplane Connections

Electrical I/O: Molex VHDM Connector System

Optical Backplane Connections

Molex HBMT Connector Housing:

MT #1 To/From Adjacent OWI

MT #2 To/From WOSF0Y

MT #3 To/From WOSF1Y

MT #4 Not Used

Y=A, B, C, D

WMX (Wavelength Mux/Demux Circuit Pack)

Referring to FIG. 83, a WMX 136 (mux 139/demux 135) is shown

Properties

Material: Aluminum

Size: 6U×1.300″ (32.72 mm)

Latch Configuration: Top—Source: Elma Electronics

Visual Indications: (1) Red LED for Alarm, (1) Green LED for Active, (1) Green/Yellow LED for Service

Optical Connections: None

Label: CLEI, Common Language Equipment Identifier

(B)—Designates Required Band

Electrical Backplane Connections

Electrical I/O: Molex VHDM Connector System

Optical Backplane Connections

Molex HBMT Connector Housing:

MT #1 Not Used

MT #2 4-Fiber To WOSFPY

MT #3 4-Fiber From WOSFPY

MT #4 Not Used

Backplane BLC Adapter Housings

BLC/APC #1 to BOSF

BLC/APC #2 from BOSF

IOS Shelf Assemblies

### WMX (Wavelength Mux/Demux) Shelf Assembly

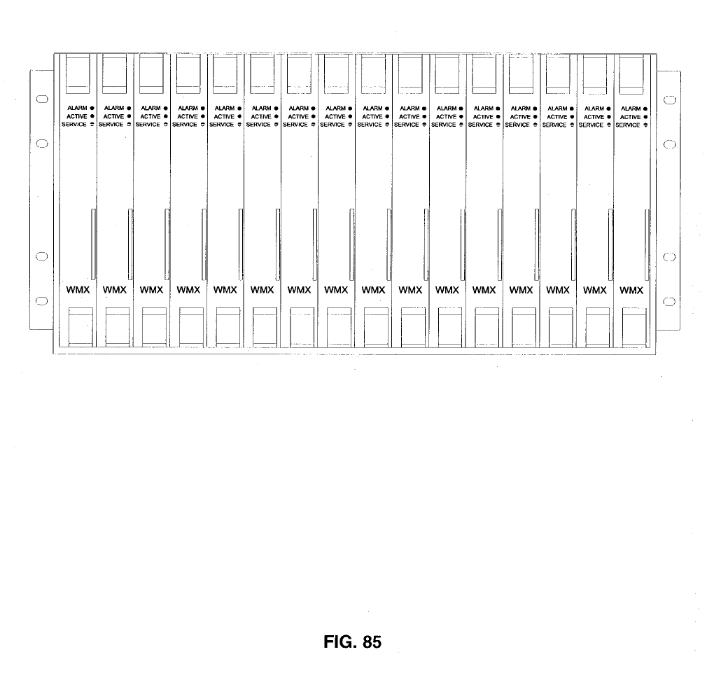

Referring to FIG. 85, a physical rendering of WMX Shelf Assembly 100 is shown.

Slot Identification

Slots are numbered from left to right (Slot1-Slot17).

### WMX Identification

WMX Circuit Packs on Side 0 are identified by: (WMX 0A,0B,0C,0D,0E,0F,0G,0H).

WMX Circuit Packs on Side 1 are identified by: (WMX 1A,1B,1C,1D,1E,1F,1G,1H).

WMX0A resides in Slot 1 and its backup circuit pack WMX1A resides in Slot 9.

### OWI (Optical Wavelength Interface) Shelf Assembly

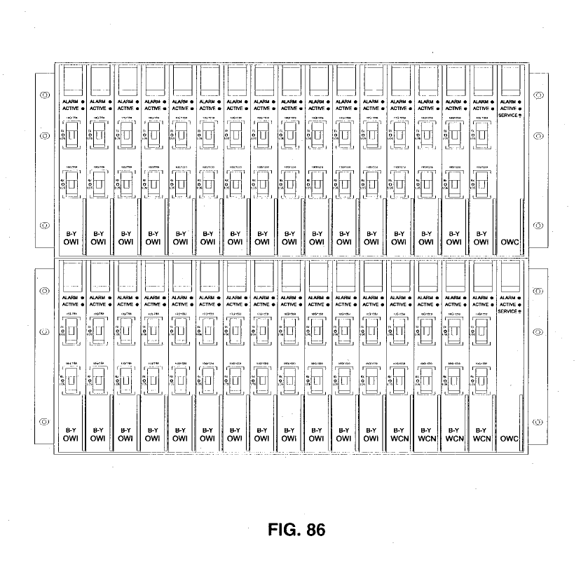

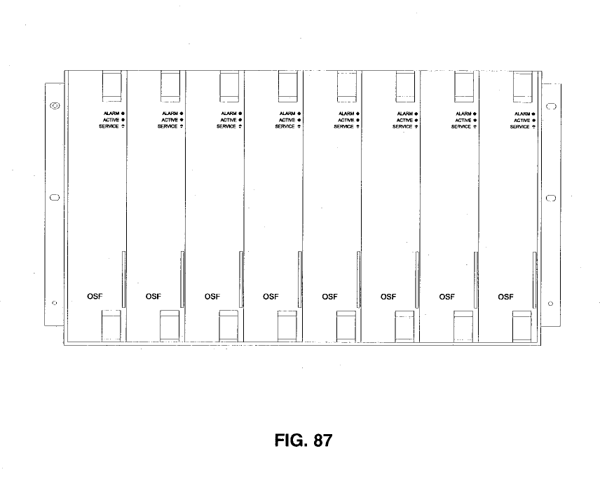

Referring to FIG. 86, a physical rendering of OWI Shelf Assembly 70 is shown.

Shelf Identification

OWI Shelf assembly consists of (2) Shelf Assemblies.

Shelf Assembly #1 is the lower and Shelf Assembly #2 is the upper.

Slot Identification

Slots are numbered from left to right (Slot1-Slot17) per Upper/Lower Shelf Assembly.

OWI Identification

OWI Circuit Packs in the Lower Shelf Assembly are labeled (OWI1-OWI16, OWC 0).

OWI Circuit Packs in the Upper Shelf Assembly are labeled (OWI17-OW132, OWC 1).

### OSF (Optical Switch Fabric) Shelf Assembly

Referring to FIG. 87, a physical rendering of OSF Shelf Assembly 110 is shown.

Slot Identification

Slots are numbered from left to right (Slot1-Slot8).

OSF Identification

OSF Circuit Packs are labeled (BOSF0, WOSF0A, WOSF0B, WOSF0C) Slots 1-4 and (WOSF1C, WOSF1B, WOSF1A, BOSF1) Slots 5-8.

BOSF0 is located in Slot 1 and BOSF1 is located in Slot 8.

### TPM (Transport Module) Shelf Assembly

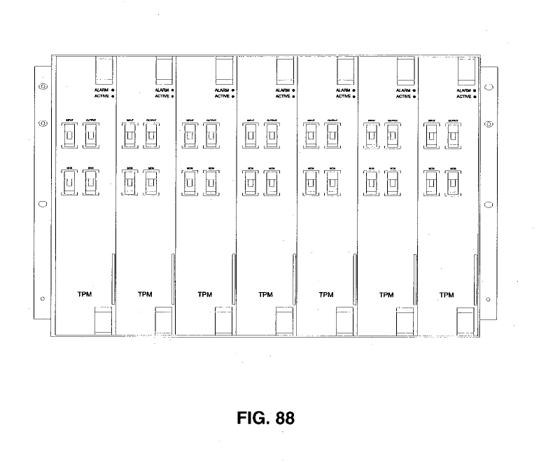

Referring to FIG. 88, a TPM Shelf Assembly 80 is shown.

Slot Identification

Slots are numbered from left to right (Slot1-Slot7).

TPM Identification

TPM Circuit Packs are labeled (TPM1, TPM2, TPM3, TPM4, TPM5, TPM6, TPM7).

### CTRL (Controller) Shelf Assembly

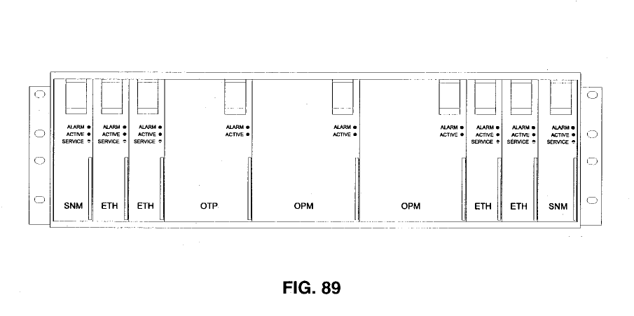

Referring to FIG. 89, a Control Shelf Assembly 90 is shown.

Slot Identification

Slots are numbered from left to right (Slot1-Slot9).

Circuit Pack Identification

Labeling as follows: SNM0, ETH0A, ETH0B, OTP, OPM1, OPM2, ETH1B, ETH1A, SNM1.

ETH0A resides in Slot #2 and ETH1A resides in Slot #8.

IOS Miscellaneous Assemblies

### Smart Fan Tray Assembly

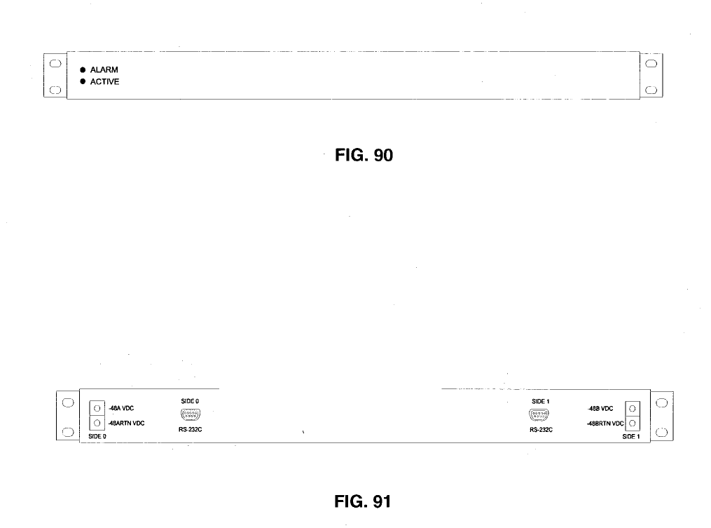

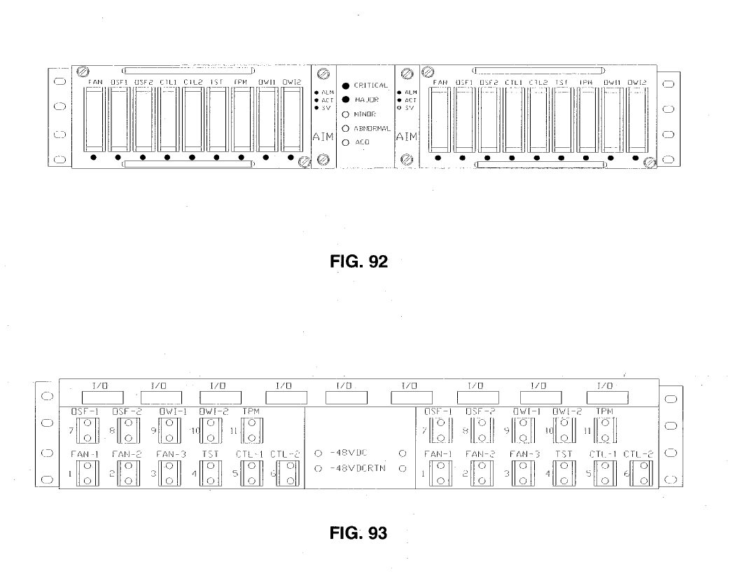

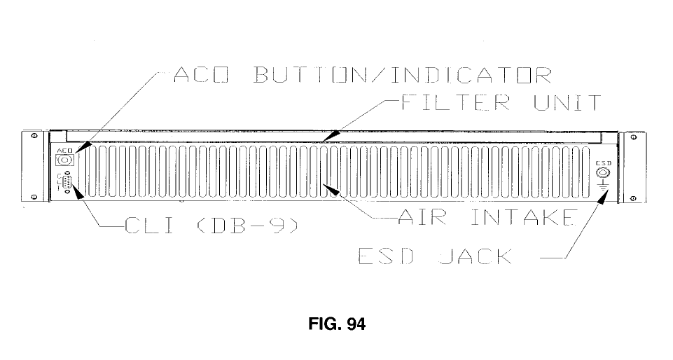

FIG. 90 shows the Smart Fan Tray Assembly (Front) and FIG. 91 shows the Smart Fan Tray Assembly (Rear).

Fan/Baffle Arrangement

All fan tray assemblies are fitted with suitable filters to remove particulate matter greater than 2 microns in size.

Fan Filters have a minimum fire rating of Underwriters Laboratories (UL) Class 2.

All equipment fan filters have a minimum dust arrestance of 80%.

The IOS 60 provides a method to determine equipment fan filter replacement schedules.

Fan Tray Assemblies are equipped with Dual −48 V DC Inputs.

### Smart Fan Tray Control

Each fan tray is controlled locally by two fan control IOCs 210 that reside in the equipment shelves that the fan shelf cools. These fan control IOCs 210 have device control functions associated with the circuit packs with which they are associated, but fan control is an added responsibility for them. The interface between these IOCs 210 and the fan tray is RS232, and the fan tray can accept speed and status commands from either IOC 210. The fan tray provides a command response to both IOCs 210. The data that the fan tray collects and sends to the IOCs 210 are: (1) fan speed; (2) temperature on temperature sensors inside fan tray; and (3) alarm conditions.

The fan tray does not send the alarm conditions autonomously. The associated tan control IOCs 210 poll for status from each fan tray every 15 seconds. It is the responsibility of the associated fan control IOC 210 to monitor the shelf temperature by reading the thermal devices on specific shelf circuit packs. From this information, the fan control IOC determines the required fan speed set point for the fan shelf and communicates it to the fan tray over the link. If the IOC 210 decides that the fan tray should be in alarm condition, it can send a command to the fan tray telling it to turn on its red ALARM LED and turn off its green ACTIVE LED. If the IOC 210 decides that the fan tray is no longer in an alarm condition, it can send a command to the fan tray telling it to turn off its ALARM LED and turn on its ACTIVE LED.

The fan control IOCs 210 are the ones that can communicate with the fan tray. The redundant OWCs 220 communicate with the fan tray that cools the OWI Shelf 70. For the TPM shelf 80, the first two slots are assigned as the redundant controllers for the fan tray that cools the TPM 80 and CONTROL 90 Shelves. The redundant WOSFs 137 are responsible for controlling the fan tray that cools the corresponding WMX shelf 100.

### Power/Alarm Interface Panel

FIG. 92 shows Power Distribution Panel (Front) and FIG. 93 shows Power Distribution Panel (Rear).

Power Panel Assembly accepts Dual (−36 to −72 VDC) power inputs. The Distribution operates without any performance degradation or physical deterioration when subjected to DC faults specified in Telcordia GR-1089-Core, Section 9.10.3.

### Air Intake-Baffle Assembly With CLI/ACO

FIG. 94 shows Air-Intake-Baffle Assembly With CLI/ACO

The Air-Intake-Baffle Assembly is 3.0″ (76.20 mm) tall. It houses the CLI (Craft Interface), ACO (Alarm Cut off switch & Indication) and an ESD jack for the purpose of locating these functions at a user-friendly level. It is preferable that this unit is placed approximately 30″ from high from the floor. The Standard location for the CLI and ACO would be on the Display panel but due to necessary human interaction it is preferred at a lower level. All other baffle assemblies contain only ESD jacks.

Cabling

All Optical Cables are routed independent of electrical cables.

Intra-System Cabling/Intra-Office Cabling

All working signal cables are routed on separate physical paths from the redundant side cables within the given system. All power cables are routed separately for each respective A and B power systems within the unit. All cables are uniquely identified.

All routing of cables are made from either side of the framework. Appropriate radii or bend limiting devices is utilized to maintain appropriate fiber management.

All battery or electrical termination fields are isolated and have appropriate safety covers in case of accidental contact.

Maintenance Access to Removable Modules

The IOS 60 incorporates a Front Access Design. This front access design is such that all operations and routine maintenance activities can be performed with access only to the front of the equipment. Access for the rear of the unit is required only when a major hardware upgrade is needed or a critical problem with the system.

ESD jacks are located on the front and rear on IOS 60 framework to facilitate proper Electrostatic Grounding for diagnostics and maintenance activities requiring rear access.

### Fiber Management

Fiber Management for the IOS 60 is managed by fiber raceway's, bend limiting devices, Optical Backplanes & ruggedized intra-bay high density Optical cables.

Fiber Connectors and Optical Termination Fields

All fiber pigtails are Type 1 per Telcordia GR-326-CORE, “Generic Requirements for Single Mode Optical Connectors and Jumper Assemblies”.

All fiber jacket and buffer material meet the flammability requirements of GR-63-Core.

Cables Serviceability

All cables within the IOS 60 are accessible in a fashion that one cable's need to be serviced does not affect any other cable assembly. (Does not require taking another cable or assembly out of service). This is for all optical, electrical and power cable assemblies used in the IOS 60.

### Power and Heat Release

The IOS 60 is cooled through forced convection. Multiple fan trays and baffle assemblies are utilized to control airflow and temperature variations in accordance with Telcordia GR-63-Core.

Power/Current dissipation estimates are set forth in Table 23:

TABLE 23
POWER/CURRENT DISSIPATION ESTIMATES

| | | POWER | CURRENT | | |
|---|---|---|---|---|---|
| MODULE | | (W) | @72 VDC | @48 VDC | @36 VDC |
| SNM | SYSTEM NODE MANAGER | 20.00 | 0.28 | 0.42 | 0.56 |
| ETH | ETHERNET SWITCH | 15.00 | 0.21 | 0.31 | 0.42 |
| OTP | OPTICAL TEST PORT | 30.00 | 0.42 | 0.63 | 0.83 |
| OPM | OPTICAL PERFORMANCE MONITOR | 25.00 | 0.35 | 0.52 | 0.69 |
| WMX | WAVELENGTH MUX/DEMUX | 20.00 | 0.28 | 0.42 | 0.56 |
| OSF | OPTICAL SWITCH FABRIC | 40.00 | 0.56 | 0.83 | 1.11 |
| TPM | TRANSPORT MODULE | 65.00 | 0.90 | 1.35 | 1.81 |
| OWI | OPTICAL WAVELENGTH INTERFACE | 32.00 | 0.44 | 0.67 | 0.89 |
| TRG | TRANSMIT GAIN | TBD | TBD | TBD | TBD |
| TRP | TRANSMIT PASSIVE | TBD | TBD | TBD | TBD |
| λc | LAMBDA CONVERTOR | TBD | TBD | TBD | TBD |
| OWC | OTPICAL WAVELENGTH CONTROLLER | 15.00 | 0.21 | 0.31 | 0.42 |
| ALM | POWER/ALARM MODULE | 50.00 | 0.69 | 1.04 | 1.39 |
| FAN | SMART FAN MODULE | 45.00 | 0.63 | 0.94 | 1.25 |

The power/current estimates for System Bay 62/Growth Bay 64 (32-Add/Drop configuration) are set forth in Table 24:

TABLE 24
32 ADD/DROP SYSTEM BAY

| | | | | TOTAL | CURRENT | | |
|---|---|---|---|---|---|---|---|
| | | | POWER | POWER | −72 VDC | −48 VDC | −36 VDC |
| SHELF | ITEM | QTY | (W) | (W) | (A) | (A) | (A) |
| POWER DISTRIBUTION | POW | 1 | 50 | 50 | 0.69 | 1.04 | 1.39 |
| OSF SHELF | OSF | 4 | 40 | 160 | 2.22 | 3.33 | 4.44 |
| WMX SHELF | WMX | 16 | 20 | 320 | 4.44 | 6.67 | 8.89 |
| FAN SHELF 3 | FAN | 1 | 45 | 45 | 0.63 | 0.94 | 1.25 |
| CTRL SHELF | SNM | 2 | 20 | 40 | 0.56 | 0.83 | 1.11 |
| | ETH | 4 | 15 | 60 | 0.83 | 1.25 | 1.67 |
| | AIM | 2 | 15 | 30 | 0.42 | 0.63 | 0.83 |
| | OTP | 1 | 30 | 30 | 0.42 | 0.63 | 0.83 |
| | OPM | 2 | 25 | 50 | 0.69 | 1.04 | 1.39 |
| | | | TOTAL | 210 | 2.92 | 4.38 | 5.83 |
| TPM SHELF | TPM | 7 | 65 | 455 | 6.32 | 9.48 | 12.64 |
| FAN SHELF 2 | FAN | 1 | 45 | 45 | 0.63 | 0.94 | 1.25 |
| OWI SHELF | OWI | 32 | 26 | 832 | 11.56 | 17.33 | 23.11 |
| | OWC | 2 | 15 | 30 | 0.42 | 0.63 | 0.83 |
| | | | TOTAL | 862 | 11.97 | 17.96 | 23.94 |
| FAN SHELF 1 | FAN | 1 | 45 | 45 | 0.63 | 0.94 | 1.25 |
| | | | BAY TOTAL | 2192 | 30.44 | 45.67 | 60.89 |

The power/current estimates for System Bay 62/Growth Bay 64 (96-Add/Drop configuration) are set forth in Table 25:

TABLE 25

| | | | | TOTAL | CURRENT | | |
|---|---|---|---|---|---|---|---|
| | | | POWER | POWER | −72 VDC | −48 VDC | −36 VDC |
| SHELF | ITEM | QTY | (W) | (W) | (A) | (A) | (A) |

96 ADD/DROP SYSTEM BAY

| | | | | | | | |
|---|---|---|---|---|---|---|---|
| POWER DISTRIBUTION | POW | 1 | 50 | 50 | 0.69 | 1.04 | 1.39 |
| OSF SHELF | OSF | 8 | 40 | 320 | 4.44 | 6.67 | 8.89 |
| WMX SHELF | WMX | 16 | 20 | 320 | 4.44 | 6.67 | 8.89 |
| FAN SHELF 3 | FAN | 1 | 45 | 45 | 0.63 | 0.94 | 1.25 |
| CTRL SHELF | SNM | 2 | 20 | 40 | 0.56 | 0.83 | 1.11 |
| | ETH | 4 | 15 | 60 | 0.83 | 1.25 | 1.67 |
| | AIM | 2 | 15 | 30 | 0.42 | 0.63 | 0.83 |
| | OTP | 1 | 30 | 30 | 0.42 | 0.63 | 0.83 |
| | OPM | 2 | 25 | 50 | 0.69 | 1.04 | 1.39 |
| | | | TOTAL | 210 | 2.92 | 4.38 | 5.83 |
| TPM SHELF | TPM | 5 | 65 | 325 | 4.51 | 6.77 | 9.03 |
| FAN SHELF 2 | FAN | 1 | 45 | 45 | 0.63 | 0.94 | 1.25 |
| OWI SHELF | OWI | 32 | 26 | 832 | 11.56 | 17.33 | 23.11 |
| | OWC | 2 | 15 | 30 | 0.42 | 0.63 | 0.83 |
| | | | TOTAL | 862 | 11.97 | 17.96 | 23.94 |
| FAN SHELF 1 | FAN | 1 | 45 | 45 | 0.63 | 0.94 | 1.25 |
| | | | BAY TOTAL | 2222 | 30.86 | 46.29 | 61.72 |

96 ADD/DROP GROWTH BAY

| | | | | | | | |
|---|---|---|---|---|---|---|---|
| POWER DISTRIBUTION | POW | 1 | 50 | 50 | 0.69 | 1.04 | 1.39 |
| WMX SHELF | WMX | 16 | 20 | 320 | 4.44 | 6.67 | 8.89 |
| WMX SHELF | WMX | 16 | 20 | 320 | 4.44 | 6.67 | 8.89 |
| FAN SHELF 2 | FAN | 1 | 45 | 45 | 0.63 | 0.94 | 1.25 |
| OWI SHELF | OWI | 32 | 26 | 832 | 11.56 | 17.33 | 23.11 |
| | OWC | 2 | 15 | 30 | 0.42 | 0.63 | 0.83 |
| | | | TOTAL | 862 | 11.97 | 17.96 | 23.94 |
| FAN SHELF 2 | FAN | 1 | 45 | 45 | 0.63 | 0.94 | 1.25 |
| OWI SHELF | OWI | 32 | 26 | 832 | 11.56 | 17.33 | 23.11 |

The power/current estimates for System Bay 620/Growth Bay 64 (128-Add/Drop configuration) are set forth in Table 26:

TABLE 26

| | | | | TOTAL | CURRENT | | |
|---|---|---|---|---|---|---|---|
| | | | POWER | POWER | −72 VDC | −48 VDC | −36 VDC |
| SHELF | ITEM | QTY | (W) | (W) | (A) | (A) | (A) |

128 ADD/DROP SYSTEM BAY

| | | | | | | | |
|---|---|---|---|---|---|---|---|
| POWER DISTRIBUTION | POW | 1 | 50 | 50 | 0.69 | 1.04 | 1.39 |
| OSF SHELF | OSF | 8 | 40 | 320 | 4.44 | 6.67 | 8.89 |
| WMX SHELF | WMX | 16 | 20 | 320 | 4.44 | 6.67 | 8.89 |
| FAN SHELF 3 | FAN | 1 | 45 | 45 | 0.63 | 0.94 | 1.25 |
| CTRL SHELF | SNM | 2 | 20 | 40 | 0.56 | 0.83 | 1.11 |
| | ETH | 4 | 15 | 60 | 0.83 | 1.25 | 1.67 |
| | AIM | 2 | 15 | 30 | 0.42 | 0.63 | 0.83 |
| | OTP | 1 | 30 | 30 | 0.42 | 0.63 | 0.83 |
| | OPM | 2 | 25 | 50 | 0.69 | 1.04 | 1.39 |
| | | | TOTAL | 210 | 2.92 | 4.38 | 5.83 |
| TPM SHELF | TPM | 4 | 65 | 260 | 3.61 | 5.42 | 7.22 |
| FAN SHELF 2 | FAN | 1 | 45 | 45 | 0.63 | 0.94 | 1.25 |
| OWI SHELF | OWI | 32 | 26 | 832 | 11.56 | 17.33 | 23.11 |
| | OWC | 2 | 15 | 30 | 0.42 | 0.63 | 0.83 |
| | | | TOTAL | 862 | 11.97 | 17.96 | 23.94 |
| FAN SHELF 1 | FAN | 1 | 45 | 45 | 0.63 | 0.94 | 1.25 |
| | | | BAY TOTAL | 2157 | 29.96 | 44.94 | 59.92 |

128 ADD/DROP GROWTH BAY #1

| | | | | | | | |
|---|---|---|---|---|---|---|---|
| POWER DISTRIBUTION | POW | 1 | 50 | 50 | 0.69 | 1.04 | 1.39 |
| WMX SHELF | WMX | 16 | 20 | 320 | 4.44 | 6.67 | 8.89 |
| WMX SHELF | WMX | 16 | 20 | 320 | 4.44 | 6.67 | 8.89 |
| FAN SHELF 2 | FAN | 1 | 45 | 45 | 0.63 | 0.94 | 1.25 |
| OWI SHELF | OWI | 32 | 26 | 832 | 11.56 | 17.33 | 23.11 |
| | OWC | 2 | 15 | 30 | 0.42 | 0.63 | 0.83 |
| | | | TOTAL | 862 | 11.97 | 17.96 | 23.94 |
| FAN SHELF 2 | FAN | 1 | 45 | 45 | 0.63 | 0.94 | 1.25 |
| OWI SHELF | OWI | 32 | 26 | 832 | 11.56 | 17.33 | 23.11 |
| | OWC | 2 | 15 | 30 | 0.42 | 0.63 | 0.83 |
| | | | TOTAL | 862 | 11.97 | 17.96 | 23.94 |
| FAN SHELF 1 | FAN | 1 | 45 | 45 | 0.63 | 0.94 | 1.25 |
| | | | BAY TOTAL | 2549 | 35.40 | 53.10 | 70.81 |

128 ADD/DROP GROWTH BAY #2

| | | | | | | | |
|---|---|---|---|---|---|---|---|
| POWER DISTRIBUTION | POW | 1 | 50 | 50 | 0.69 | 1.04 | 1.39 |
| OSF SHELF | OSF | 2 | 40 | 80 | 1.11 | 1.67 | 2.22 |
| WMX SHELF | WMX | 16 | 20 | 320 | 4.44 | 6.67 | 8.89 |
| FAN SHELF 2 | FAN | 1 | 45 | 45 | 0.63 | 0.94 | 1.25 |
| OWI SHELF | OWI | 32 | 26 | 832 | 11.56 | 17.33 | 23.11 |
| | OWC | 2 | 15 | 30 | 0.42 | 0.63 | 0.83 |
| | | | TOTAL | 862 | 11.97 | 17.96 | 23.94 |
| FAN SHELF 1 | FAN | 1 | 45 | 45 | 0.63 | 0.94 | 1.25 |
| | | | BAY TOTAL | 1402 | 19.47 | 29.21 | 38.94 |

| | | | | |
|---|---|---|---|---|
| 3-BAY TOTAL POWER | 6108 | 84.83 | 127.25 | 169.67 |

The power/Current estimates for System Bay 620/Growth Bay 64 (128-Add/Drop configuration (2) Remote OWI Shelves) are set forth in Table 27:

TABLE 27

| | | | | TOTAL | CURRENT | | |
|---|---|---|---|---|---|---|---|
| | | | POWER | POWER | −72 VDC | −48 VDC | −36 VDC |
| SHELF | ITEM | QTY | (W) | (W) | (A) | (A) | (A) |

128 ADD/DROP SYSTEM BAY

| | | | | | | | |
|---|---|---|---|---|---|---|---|
| POWER DISTRIBUTION | POW | 1 | 50 | 50 | 0.69 | 1.04 | 1.39 |
| OSF SHELF | OSF | 8 | 40 | 320 | 4.44 | 6.67 | 8.89 |
| WMX SHELF | WMX | 16 | 20 | 320 | 4.44 | 6.67 | 8.89 |
| FAN SHELF 3 | FAN | 1 | 45 | 45 | 0.63 | 0.94 | 1.25 |
| CTRL SHELF | SNM | 2 | 20 | 40 | 0.56 | 0.83 | 1.11 |
| | ETH | 4 | 15 | 60 | 0.83 | 1.25 | 1.67 |
| | AIM | 2 | 15 | 30 | 0.42 | 0.63 | 0.83 |
| | OTP | 1 | 30 | 30 | 0.42 | 0.63 | 0.83 |
| | OPM | 2 | 25 | 50 | 0.69 | 1.04 | 1.39 |
| | | | TOTAL | 210 | 2.92 | 4.38 | 5.83 |
| TPM SHELF | TPM | 4 | 65 | 260 | 3.61 | 5.42 | 7.22 |
| FAN SHELF 2 | FAN | 1 | 45 | 45 | 0.63 | 0.94 | 1.25 |
| OWI SHELF | OWI | 32 | 26 | 832 | 11.56 | 17.33 | 23.11 |
| | OWC | 2 | 15 | 30 | 0.42 | 0.63 | 0.83 |
| | | | TOTAL | 862 | 11.97 | 17.96 | 23.94 |
| FAN SHELF 1 | FAN | 1 | 45 | 45 | 0.63 | 0.94 | 1.25 |
| | | | BAY TOTAL | 2157 | 29.96 | 44.94 | 59.92 |

128 ADD/DROP GROWTH BAY

| | | | | | | | |
|---|---|---|---|---|---|---|---|
| POWER DISTRIBUTION | POW | 1 | 50 | 50 | 0.69 | 1.04 | 1.39 |
| OSF SHELF | OSF | 2 | 40 | 80 | 1.11 | 1.67 | 2.22 |
| WMX SHELF | WMX | 16 | 20 | 320 | 4.44 | 6.67 | 8.89 |
| FAN SHELF 2 | FAN | 1 | 45 | 45 | 0.63 | 0.94 | 1.25 |
| WMX SHELF | WMX | 16 | 20 | 320 | 4.44 | 6.67 | 8.89 |
| WMX SHELF | WMX | 16 | 20 | 320 | 4.44 | 6.67 | 8.89 |
| FAN SHELF 2 | FAN | 1 | 45 | 45 | 0.63 | 0.94 | 1.25 |
| OWI SHELF | OWI | 32 | 26 | 832 | 11.56 | 17.33 | 23.11 |
| | OWC | 2 | 15 | 30 | 0.42 | 0.63 | 0.83 |
| | | | TOTAL | 862 | 11.97 | 17.96 | 23.94 |
| FAN SHELF 1 | FAN | 1 | 45 | 45 | 0.63 | 0.94 | 1.25 |
| | | | BAY TOTAL | 2087 | 28.99 | 43.48 | 57.97 |

| | | | | |
|---|---|---|---|---|
| 2-BAY TOTAL POWER | 4244 | 58.94 | 88.42 | 117.89 |

REMOTE OWI #1

| | | | | | | | |
|---|---|---|---|---|---|---|---|
| POWER DISTRIBUTION | POW | 1 | 50 | 50 | 0.69 | 1.04 | 1.39 |
| OWI SHELF | OWI | 32 | 26 | 832 | 11.56 | 17.33 | 23.11 |
| | OWC | 2 | 15 | 30 | 0.42 | 0.63 | 0.83 |
| | | | TOTAL | 862 | 11.97 | 17.96 | 23.94 |
| FAN SHELF 1 | FAN | 1 | 45 | 45 | 0.63 | 0.94 | 1.25 |

| | | | | |
|---|---|---|---|---|
| REMOTE OWI POWER | 957 | 13.29 | 19.94 | 26.58 |

REMOTE OWI #2

| | | | | | | | |
|---|---|---|---|---|---|---|---|
| POWER DISTRIBUTION | POW | 1 | 50 | 50 | 0.69 | 1.04 | 1.39 |
| OWI SHELF | OWI | 32 | 26 | 832 | 11.56 | 17.33 | 23.11 |
| | OWC | 2 | 15 | 30 | 0.42 | 0.63 | 0.83 |

### Environmental Specification

The requirements set forth by Telcordia for all environmental, shock and vibration requirements as well as Temperature, Humidity and Noise specifications are described below.

### Normal Operating Conditions

Table 28 provides the normal operating temperature and humidity levels and short term operating temperature/humidity levels in which network equipment operates.

Operating Life Performance

The equipment sustains no damage or deterioration of functional performance during its operating life when operating within Table 28 requirements.

TABLE 28

| Conditions | Limits |
|---|---|
| Temperature | |
| 1. Operating | 1. 5° C. to 40° C. (41° F. to 104° F.) |
| 2. Short Term (Normal | 2. −5° C. to 50° C. (23° F. to 122° F.) |
| Operating Conditions) | |
| Rate of Temperature Change | 30° C./hr (54 F./hr) |
| Relative Humidity | |
| 1. Operating | 1. 5% to 85% |
| 2. Short Term (Normal | 2. 5% to 90% (but not to exceed |
| Operating Conditions) | 0.024 kg-water/kg of dry air) |

Note: Ambient refers to conditions at a location 1.5 m (59 in) above the floor and 400 mm (15.8 in) in front of the equipment.

Heat Dissipation

Table 29 sets forth the heat dissipation specifications:

TABLE 29

| | |
|---|---|
| Individual Frame | |
| Natural Convection | 1450 W/m² (134.7 W/ft²) |
| Forced Convection | 1950 W/m² (181.2 W/ft²) |
| Shelf | |
| Natural Convection | 225 W/m² per meter (20.9 W/ft² of vertical frame |
| | space the equipment uses) |
| Forced Convection | 300 W/m² per meter (27.9 W/ft² of vertical frame |
| | space the equipment uses) |

### Non-Operating Temperature and Humidity

Table 30 sets forth non-operating temperature and humidity specifications:

TABLE 30

| Conditions | Limits |
|---|---|
| Temperature | |
| Non - Operating | −40° C. to 60° C. (41° F. to 104° F.) |
| Rate of Temperature Change | 30° C./hr (54 F./hr) |
| Relative Humidity | |
| Non-Operating | 10% to 95% |

### Component Reliability

Component long-term use in the Telecomm environment requires that it satisfy these reliability specifications.

The component initial failure rate is the average failure rate during the first year of its use in the Telecom Environment and includes all the infant mortality and learning curve effects. The component initial failure rate can be significantly improved by implementing a reliability growth process during its design and development and a 100% burn-in and screening process during manufacture.

The component long-term failure rate is the steady state failure rate over its useful life and does not include the first year effects. Useful life is measured by an end-of-life or lifetime value that is defined to be the time at which the median population is expected to fail.

These reliability specifications are realized when the components are used in systems that are deployed in the field at normal operating conditions in controlled environments (typically 40° C. case temperature and nominal electrical load). The long-term failure rate is defined as the random failure rate for 60% confidence level derived from the accelerated reliability test.

Dissimilar Metals: Components selection ensures that no galvanic corrosion occurs when dissimilar metals are used in its construction.

Fungus Resistance: Exposed polymeric materials used in the component construction are not to support fungi growth as per ASTM-G21. A rating of zero is required.

Toxicity: All materials with which personnel may come in contact are non-toxic, and do not present any environmental hazards as defined by applicable federal or state laws and regulations or current industry standards.

### NEBS Level 3 Compliance

The detailed safety and compliance specifications needed to satisfy NEBS Level 3 requirements are detailed as follows:

Fire Resistance: Materials, components and interconnect wire and cable sewed within the equipment assemblies meet the requirements of ANSI-T1.307.1990 (Fire Resistance Criteria—Part 1: Ignitability Requirements for Equipment Assemblies and Fire Spread Requirements for Interconnection Wire and Cable Distribution Assemblies.

All Mechanical Elements including circuit boards and backplanes have an oxygen index of 28% or greater as determined by ASTM Standard D 2863-77. All materials used to construct the product must meet ANSI T1-307—Telecommunications Fire Resistance Criteria—Ignitability Requirements for Equipment Assemblies and Fire Spread Requirements for Wire and Cable. Plastic materials, fiber pigtails, and fiber connectors do not sustain combustion when an open flame source is removed. These materials have a rating of UL-94V-1 or better when tested in accordance to the Vertical Burning Test for Classifying Material, Underwriters Laboratories Publication UL94, Tests for Flammability of Plastic Materials for Parts in Devices and Appliances. Test procedure per ANSI-T1.307—Needle Flame Test must be used to demonstrate compliance. Manufactures must also be requested to provide material samples and of appropriate size to verify flammability compliance.

Handling & Transportation: The product won't sustain any physical damage or deterioration in functional performance after the packaged product has been exposed to Category A Packaged Equipment Shock Criteria per Telcordia GR-63-Core.

The product won't sustain any physical damage or deterioration in functionality after the unit has been subjected to Unpackaged Equipment Shock Criteria per Telcordia GR-63-Core.

The product won't sustain any physical damage or deterioration in functionality after the product has been subjected to the Transportation Vibration Criteria per Telcordia GR-63-Core.

Earthquake & Office Vibration: The equipment conforms to Zone IV earthquake requirements and Office Vibrations as per Telcordia GR-63-Core.

Airborne Contaminants: The product meets all specifications and suffers no physical or mechanical damage after exposure to the airborne contaminant environment per Telcordia GR-63-Core and tested in accordance with Gaseous Contaminants Test Method. If the product does not contain silver then the exposure to airborne contaminants occurs while the component is non-operational. However, if the product contains silver the product must be operational during the exposure.

Acoustic Noise: Equipment won't produce sound levels above the limits shown in Table 31 when installed in network facilities.

TABLE 31

| Equipment | Sound Level (dBA) |
|---|---|
| An individual equipment frame that may | 65 |
| be located in a lineup with other equipment. | |

Electrostatic Discharge: All circuit packs within the telecommunications equipment are tested for susceptibility to ESD. All testing methods and requirements are per GR-78-Core (Circuit Pack ESD Test Methods and Requirements & ESD Warning Label Requirements).

Electromagnetic Interference: The equipment and cabling conforms to the electromagnetic compatibility criteria in Telcordia GR-1089-Core, Issue 2, December, 1997. (Electromagnetic Compatibility and Electrical Safety—Generic Criteria for Network Telecommunications Equipment). All equipment complies with FCC Rules, Part 15, Sub-part J, Class A.

### Installation and Operations/Maintenance

This section addresses IOS 60 and management software specifications that are specifically focused on the installation and maintenance environments. Installation activities on CO or NOC equipment may be either in service or out of service and could reside in in-service. Examples of these activities include IOS 60 node installation, Growth Bay 64 installation, and software upgrade. Service provider craft typically perform maintenance activities, such as replacing failed circuit packs or adding circuit packs to provision new paths. Certain of these installation, operations, and maintenance capabilities also extend into other environments, such as manufacturing Factory System Test.

### Basic Capabilities

All replaceable modules are hot swappable and capable of complete replacement and return to service within minutes after the new unit is available at the IOS site. Neither IOS operation nor service on existing circuits is affected by a card insertion or removal in an out-of-service entity in the installation and maintenance environment.

All replaceable modules are accessable for removal and insertion from the front of the IOS bays, without removing any other framework components, with insertion and removal forces that are compliant with Telcordia guidelines and reasonable customer expectation.

Dispersion Compensation Modules (DCMs) are accessable for removal and insertion from the rear of the IOS System Bay 62 without removing any other framework components with insertion and removal forces that are compliant with Telcordia guidelines and reasonable customer expectation.

Built-in test capabilities, such as in-service and out-of-service diagnostics and in-service and out-of-service routine exercises are available for all IOS 60 subsystems and circuit packs.

Fiber loop assemblies are used to provide individual rigid loops for TPM circuit pack 121 to loop the transmit and receive SC connectors without the use of line build out networks or external fiber.

Fiber loop assemblies are used to provide individual rigid loops for OWI (XP or TR) circuit pack 219 to loop the transmit and receive SC connectors without the use of line build out networks or external fiber.

All removable modules are designed for safe removal with a faceplate tab. Keying prevents improper insertion of a module into a slot and prevents backplane or connector damage in the event an attempt is made to insert the wrong circuit pack into a slot.

System Node Managers 205 provide removable flash media to facilitate the establishment of software and database in the installation environment.

### Installation

Installation testing of an IOS 60 does not rely on the availability of the SDS 204. The IOS 60 installation testing requires only an installer-provided laptop PC accessing the CLI and/or external IP network ports, as appropriate. The Installation Test Software executing on the laptop provides all configuration changes, diagnostics, and exercising required to pronounce the IOS Optical Control Plane 20 ready for connection to the SDS 204 and OCN and ready for service.

Installation testing of an IOS 60 does not rely on the availability of fibering, optical signals, or patch panel facilities at the customer Central Office. Instead, local loops on IOS 60 circuit packs, an optical source of signal, and an optical power measurement device are sufficient to perform all IOS Data Plane 10 installation testing required to pronounce the IOS Data Plane 10 ready for service.

In-service IOS 60 installation activities, such as capacity growth or software upgrade or rollback are normally permitted only if there are no alarms in the IOS 60. Special procedures exist for the handful of extraordinary cases that are permitted in violation of this policy.

Addition of a Growth Bay 64 (wired equipment and circuit packs) to an in-service IOS System Bay 62 or bay complex relies on testable and verifiable connections to the out-of-service optical switch fabric only, and this addition does not affect existing service or IOS 60 operations.

IOS Optical Switching Fabric Capacity Expansion through OSF 214 and possibly WMX circuit pack addition is accomplished on the out-of-service optical switching fabric, and this capacity expansion does not affect existing service or IOS N000 operations.

IOS 60 integrated DWDM Capacity Expansion through TPM 121 and circuit pack addition does not affect existing service or IOS 60 operations.

IOS 60 OWI Capacity Expansion or provisioning through XP 219, TR 219B, λCON 140, and WMX circuit pack 136 addition does not affect existing service or IOS 60 operations.

Software download through an external IP port or through the CLI does not affect IOS 60 operations and does not cause interruption to existing service.

Database download or upload through an external IP port or through the CLI does not affect IOS 60 operations and does not cause interruption to existing service.

Software upgrade and rollback does not cause interruption to existing service and requires an operations blanking interval of less than 1 minute.

During both in-service and out-of-service installation activities, the IOS 60 responds to configuration commands from the SDS 204 or CLI, including commands to change the service status of the optical switching fabric.

During both in-service and out-of-service installation activities, the IOS 60 responds to alarm suppression and enablement commands from the SDS 204 or CLI.

During any IOS 60 installation operation, such as capacity expansion or software retrofit, the operation is reversible in-service by reverting to the configuration and database that pertained prior to the operation. This reverting does not affect service on the IOS 60.

Access for insertion or changeout of DCMs is available from the rear of the IOS 60 bays with negligible risk of impacting existing service or operations on the IOS 60.

### Maintenance and Operations

Equipment and circuit provisioning operations are normally permitted only if there are no alarms in the IOS 60. Special procedures exist for the handful of extraordinary cases that are permitted in violation of this policy.

Equipment provisioning operations on an in-service IOS 60 requires only insertion of appropriate circuit packs and execution of appropriate diagnostics using only built-in IOS 60 capabilities. Craft validation of inserted IOS 60 equipment or circuit packs does not rely on the availability of fibering, optical signals, or patch panel facilities at the customer Central Office.

Network pre-service testing may take place during the circuit provisioning operation using an OTP 218 under control of the SDS 204. Additionally, intra-office data link testing, under control of the CO craft, may take place using the OWI CO hairpin loop, established by the SDS 204 or CLI, together with a CO optical test set. Network pre-service testing and CO intraoffice link testing are completely independent.

Redundant IOS 60 circuit packs are normally replaced only when the SERVICE LED indicates the circuit pack is out-of-service (yellow). Special procedures exist for the handful of extraordinary cases that are permitted in violation of this policy. Replacement of a redundant out-of-service circuit pack does not affect service or operations on the IOS 60.

Replacement of a simplex IOS Data Plane circuit 10 packs does, of course, lose the service it is supporting unless the service is rerouted or protected (e.g. 1+1) at the network level. Insertion or removal of such a pack affects no Data Plane service unassociated with service through the added or removed circuit pack.

Access for insertion or changeout of DCMs is available from the rear of the IOS 60 bays with negligible risk of impacting existing service or operations on the IOS 60.

### Traffic Scenarios

Purpose

The purpose of the subsequent description is to quantify the packet traffic load on an IOS 60 using an Optical Control Network. The traffic scenarios presented in this analysis is based on the maximum loading introduced by the Optical Performance Measurement pack.

Architecture

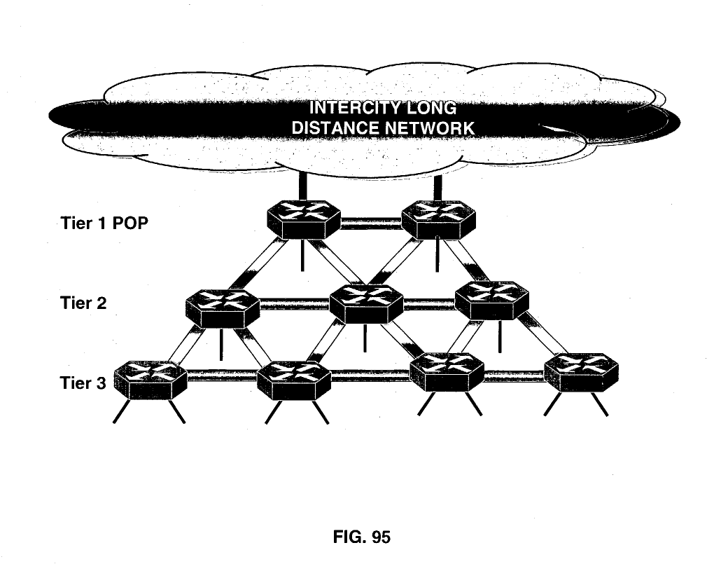

FIG. 95 depicts the tiered network architecture that is representative of the environments where the IOS 60 is deployed. As shown in FIG. 95, the network consists of Tier 1, 2, and 3 Points of Presence. Tier 1 provides the interconnection of this network with the inter-city long distance network while Tier 3 provides the interconnection with access networks such as DSL, cable, and large enterprise network sites. Tier 2 is an intermediate node that provides both access and transit services.

The circuit traffic pattern in these networks is “hubbed” with most of the circuits originated and terminated at the Tier 1. This results in a large transit traffic flow at the Tier 2 IOSs.

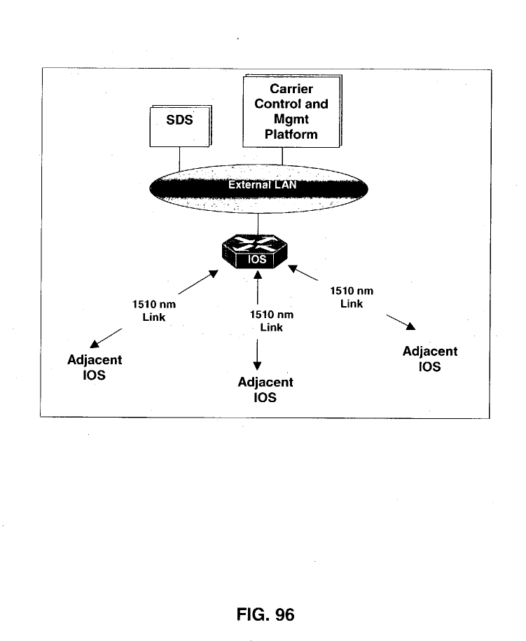

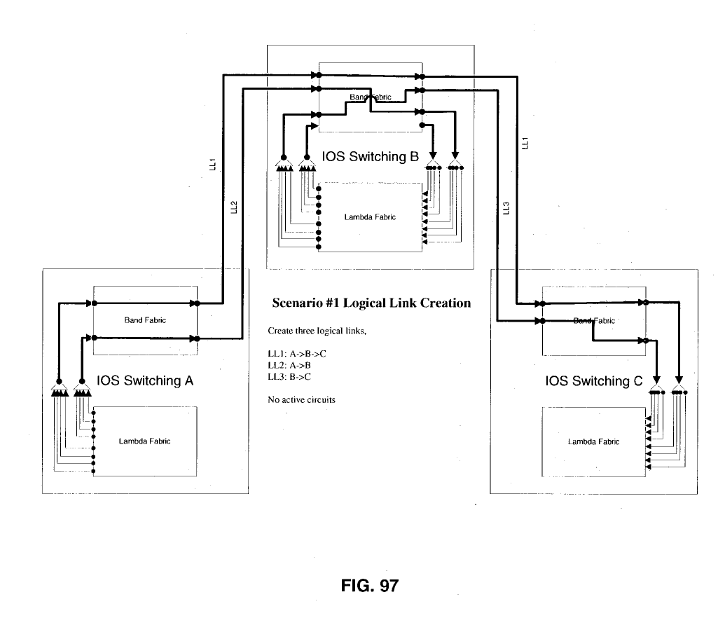

FIG. 96 depicts the architecture for an IOS Tier 1 that is co-located with the SDS 204. There may also be a carrier platform co-located with the IOS. The SDS is interconnected to adjacent IOS 60 by the 1510 nm Optical Control Network.

With the IOS 60 and SDS 204 co-located, the management traffic has a “hubbed” traffic pattern where all SDS traffic will pass through this switch. Therefore, this likely leads to a worst-case management traffic loading.

Also as shown in FIG. 96, there may be a Carrier Control and Management Platform also co-located with this IOS 60. It could introduce an arbitrary load on the 1510 Optical Control Network for GMPLS control of TDM or label LSPs as well as some administrative traffic. This could easily dominate all other traffic, but it is not addressed in this initial analysis.

Although not shown in FIG. 96, the IOS 60 would be connected to a Carrier Data Platform. Based on the most recent information from OIF, it would have a transponder interface with the IOS. However, it would not generate traffic on the OCN.

Traffic Scenario

The traffic loading on Tier 1, 2, and 3 IOSs and their OCC links is presented in the following tables 33-35. The traffic modeled consists of: GMPLS signaling messages for circuit set up that may be originating, terminating, or transiting the IOS; SNMP trap messages that the IOS sends to the SDS indicating that a new circuit is being set up; OPM messages requesting and receiving the OPM data; and LMP heartbeat messages.

Assumptions

The analysis of the traffic scenarios is based on the following assumptions: SDS is co-located with a Tier 1 IOS; call request rate assumes the basic service level; management traffic may be routed to the SDS without traversing a peer node, i.e., management traffic from Tier 2 IOS goes directly to the IOS co-located with the SDS and Tier 3 IOSs send their management traffic directly to a Tier 2 IOS that forwards it to the Tier 1 IOS co-located with the SDS; only SOCs are modeled; messages associated with call release are ignored. The scenarios model the circuit set up so release will occur later; signaling messages have a hubbed traffic pattern since the circuit traffic is mostly between the access nodes and the hub nodes rather than between access nodes; management messages have hubbed traffic pattern since the SDS is co-located with the switch being analyzed; circuit OSPF traffic LSAs announcing changes in link utilization are transmitted at the maximum rate—once every five seconds; circuit OSPF router LSAs announcing changes in topology are ignored; and crankback corresponding to circuit setup retries is not modeled.

Parameters

The parameters used in the traffic analysis are listed in the following Table 32.

TABLE 32

| Parameter | Value | Comment |
|---|---|---|
| Number of Network Nodes = | 26 | |
| Number of Tier 1 Nodes | 2 | |
| Number of Tier 2 Nodes | 8 | |
| Number of Tier 3 Nodes | 16 | |
| Number of Adjacent IOS = | 3 | |
| Tier 1 Call Request Rate = | 4 | request/second/IOS |
| Tier 2 Call Request Rate = | 2 | |
| Tier 1 Call Request Rate = | 1 | |
| Tier 1 Transit Traffic Factor = | 20% | |
| Tier 2 Transit Traffic Factor = | 300% | |
| Tier 3 Transit Traffic Factor = | 20% | |
| Average Path Length = | 4 | Used for crankback only |
| OSPF Advertisement Update | 5 | seconds |
| Interval = | | |
| LMP Heartbeat Interval | 0.5 | seconds |
| OPM Performance Reporting | 1 | Seconds (camp-on) |
| Interval = | | |
| OPM Data Size per Measurement | 16000 | Bytes |
| OPM Measurements per Cycle = | 14 | Number of Tap Points |
| Crankbank % = | 10% | |

Results

Tables 33-35 present the traffic loadings for IOSs 60 located, respectively, at Tier 1, 2, and 3 sites under the case when all IOS 60 are camped on to five tap points. This maximizes the OPM 216 traffic. Since the SDS 204 is co-located with a tier 1 IOS 60, all OPM 216 traffic will flow through that IOS 60. This results in a worst-case traffic flow of approximately 3.5 Mbps through this IOS 60 with the flow on each of the IOS 60 links approximately ⅓ of this rate.

The traffic associated with the OPM 216 dominates the signaling, routing, and link management traffic. Furthermore, the estimated rate of 3.5 Mbps is sufficiently large that a dedicated processor to accommodate the packet switching function is required. Otherwise any function that is co-resident with the packet switching function would suffer significant performance degradation.

Changing the circuit request rate or modeling other services (such as auto-restoration) could perform additional sensitivity analyses. While these analyses could provide interesting results concerning the traffic pattern in the network, they will not generate traffic nearly as large as the OPM scenario described above.

TABLE 33
Traffic Parameters

| | | |
|---|---|---|
| Number of Network Nodes = | 26 | |
| Number of Tier 1 Nodes | 2 | |
| Number of Tier 2 Nodes | 8 | |
| Number of Tier 3 Nodes | 16 | |
| Number of Adjascent IOS = | 3 | |
| Tier 1 Call Request Rate = | 4 | request/second/IOS |
| Tier 2 Call Request Rate = | 2 | |
| Tier 1 Call Request Rate = | 1 | |
| Tier 1Transit Traffic Factor = | 20% | |
| Tier 2 Transit Traffic Factor = | 300% | |
| Tier 3 Transit Traffic Factor = | 20% | |
| Average Path Length = | 4 | Used for crankback only |
| OSPF Advertisement Update Interval = | 5 | seconds |
| LMP Heartbeat Interval | 0.5 | seconds |
| OPM Performance Reporting Interval = | 5 | seconds |
| OPM Data Size per Measurement | 16000 | Bytes |
| OPM Measurements per Cycle = | 5 | Number of Tap Points |
| Crankbank % = | 10% | |

| | | | | | | | | | | | Link |
|---|---|---|---|---|---|---|---|---|---|---|---|
| | | | | Mes- | Message | Message | | | Packet | Data | Data |
| | | | Event | sages/ | Rate | Length | Packet | Packet | Overhead | Rate | Rate |
| Tier 1 | | | Rate | Event | (msg/sec) | (bytes) | Length | Rate | (bytes) | (kbps) | (kbps) |
| Traffic Classes | | | | | | | | | | | |
| Signaling Set Up | | | | | | | | | | | |
| GMPLS | Originated | | 4 | 3 | 12.00 | 500 | | | 40 | 51.84 | 17.28 |
| | Terminated | | 4 | 3 | 12.00 | 500 | | | 40 | 51.84 | 17.28 |
| | Transit | | 0.8 | 6 | 4.80 | 500 | | | 40 | 20.74 | 6.91 |
| | | Sum = | 8.8 | | | | | | | | |
| Management | | | | | | | | | | | |
| SNMP | Connection | Originated | 4 | 1 | 4.00 | 100 | | | 28 | 4.10 | |
| | | Terminated | 4 | 1 | 4.00 | 100 | | | 28 | 4.10 | |
| | | All Others | 124 | 1 | 124.00 | 100 | | | 28 | 126.98 | 42.33 |
| | Configuration | TBD | | | | | | | | | |
| | Fault | TBD | | | | | | | | | |
| OPM | Local Performance Tx | | 0.200 | 1 | 0.20 | 80000 | 512 | 31.3 | 40 | 138.00 | |
| | Local Performance Rx | | 0.200 | 1 | 0.20 | 20 | | 31.3 | 40 | 15.00 | |
| | Transit Performance Tx | | 0.200 | 25 | 5.00 | 80000 | 512 | 781.3 | 40 | 3450.00 | 1150.00 |
| | Transit Performance Rx | | 0.200 | 25 | 5.00 | 20 | | 781.3 | 40 | 375.00 | 125.00 |
| SDS <-> SDS Backup | | | | | | | | | | | |
| Carrier - Not Curently Required | | | | | | | | | | | |
| | Transmitted | TBD | | | | | | | | | |
| | Received | TBD | | | | | | | | | |
| | Transit | TBD | | | | | | | | | |
| | | | | | | | | Totals = | | 4237.58 | 1358.80 |
| OSPF Advertisements | | | | | | | | | | | |
| | Transmitted | Link | 0.200 | 3 | 0.60 | 152 | | | 20 | 0.83 | 0.28 |
| | Received | Link | 0.200 | 0.60 | 0.12 | 152 | | | 20 | 0.17 | 0.06 |
| LMP Heartbeat | | | | | | | | | | | |
| | Transmitted | | 2 | 1 | 2.00 | 32 | | | 20 | 0.83 | 0.28 |
| | Received | | 2 | 1 | 2.00 | 32 | | | 20 | 0.83 | 0.28 |

TABLE 34
Traffic Parameters

| | | |
|---|---|---|
| Number of Network Nodes = | 26 | |
| Number of Tier 1 Nodes | 2 | |
| Number of Tier 2 Nodes | 8 | |
| Number of Tier 3 Nodes | 16 | |
| Number of Adjascent IOS = | 3 | |
| Tier 1 Call Request Rate = | 4 | request/second/IOS |
| Tier 2 Call Request Rate = | 2 | |
| Tier 1 Call Request Rate = | 1 | |
| Tier 1 Transit Traffic Factor = | 0.2 | |
| Tier 2 Transit Traffic Factor = | 3 | |
| Tier 3 Transit Traffic Factor = | 0.2 | |
| Average Path Length = | 4 | Used for Crankback only |
| OSPF Advertisement Update Interval = | 5 | seconds |
| LMP Heartbeat Interval | 0.5 | seconds |
| OPM Performance Reporting Interval = | 5 | seconds |
| OPM Data Size per Measurement | 16000 | Bytes |
| OPM Measurements per Cycle = | 5 | Number of Tap Points |
| Crankbank % = | 0.1 | |

| | | | | | | | | | | | Link |
|---|---|---|---|---|---|---|---|---|---|---|---|
| | | | | Mes- | Message | Message | | | Packet | Data | Data |
| | | | Event | sages/ | Rate | Length | Packet | Packet | Overhead | Rate | Rate |
| Tier 2 | | | Rate | Event | (msg/sec) | (bytes) | Length | Rate | (bytes) | (kbps) | (kbps) |
| Traffic Classes | | | | | | | | | | | |
| Signaling Set Up | | | | | | | | | | | |
| GMPLS | Originated | | 2 | 3 | 6.00 | 500 | | | 40 | 25.92 | 8.64 |
| | Terminated | | 2 | 3 | 6.00 | 500 | | | 40 | 25.92 | 8.64 |
| | Transit | | 6 | 6 | 36.00 | 500 | | | 40 | 155.52 | 51.84 |
| | | Sum = | 10 | | | | | | | | |
| Management | | | | | | | | | | | |
| SNMP | Connection | Originated | 4 | 1 | 4.00 | 100 | | | 28 | 4.10 | 1.37 |
| | | Terminated | 4 | 1 | 4.00 | 100 | | | 28 | 4.10 | 1.37 |
| | | All Others | 4.4 | 2 | 8.80 | 100 | | | 28 | 9.01 | 3.00 |
| | Configuration | TBD | | | | | | | | | |
| | Fault | RBD | | | | | | | | | |
| OPM | Local Performance Tx | | 0.200 | 1 | 0.20 | 80000 | 512 | 31.3 | 40 | 138.00 | 17.25 |
| | Local Performance Rx | | 0.200 | 1 | 0.20 | 20 | | 31.3 | 40 | 15.00 | 1.88 |
| | Transit Performance Tx | | 0.200 | 4 | 0.80 | 80000 | 512 | 125.0 | 40 | 552.00 | 184.00 |
| | Transit Performance Rx | | 0.200 | 4 | 0.80 | 20 | | 125.0 | 40 | 60.00 | 20.00 |
| SDS <-> SDS Backup | | | | | | | | | | | |
| Carrier - Not Curently Required | | | | | | | | | | | |
| | Transmitted | TBD | | | | | | | | | |
| | Received | TBD | | | | | | | | | |
| | Transit | TBD | | | | | | | | | |
| | | | | | | | | Totals = | | 989.56 | 297.98 |
| OSPF Advertisements | | | | | | | | | | | |
| | Transmitted | Link | 0.200 | 3 | 0.60 | 152 | | | 20 | 0.83 | 0.28 |
| | Received | Link | 0.200 | 0.60 | 0.12 | 152 | | | 20 | 0.17 | 0.06 |
| LMP Heartbeat | | | | | | | | | | | |
| | Transmitted | | 2 | 1 | 2.00 | 32 | | | 20 | 0.83 | 0.28 |
| | Received | | 2 | 1 | 2.00 | 32 | | | 20 | 0.83 | 0.28 |

TABLE 35
Traffic Parameters

| | | |
|---|---|---|
| Number of Network Nodes = | 26 | |
| Number of Tier 1 Nodes | 2 | |
| Number of Tier 2 Nodes | 8 | |
| Number of Tier 3 Nodes | 16 | |
| Number of Adjascent IOS = | 3 | |
| Tier 1 Call Request Rate = | 4 | request/second/IOS |
| Tier 2 Call Request Rate = | 2 | |
| Tier 1 Call Request Rate = | 1 | |
| Tier 1 Transit Traffic Factor = | 0.2 | |
| Tier 2 Transit Traffic Factor = | 3 | |
| Tier 3 Transit Traffic Factor = | 0.2 | |
| Average Path Length = | 4 | Used for crankback ony |
| OSPF Advertisement Update Interval = | 5 | seconds |
| LMP Heartbeat Interval | 0.5 | seconds |
| OPM Performance Reporting Interval = | 5 | seconds |
| OPM Data Size per Measurement | 16000 | Bytes |
| OPM Measurements per Cycle = | 5 | Number of Tap Points |
| Crankbank % = | 0.1 | |

| | | | | | | | | | | | Link |
|---|---|---|---|---|---|---|---|---|---|---|---|
| | | | | Mes- | Message | Message | | | Packet | Data | Data |
| | | | Event | sages/ | Rate | Length | Packet | Packet | Overhead | Rate | Rate |
| Tier 3 | | | Rate | Event | (msg/sec) | (bytes) | Length | Rate | (bytes) | (kbps) | (kbps) |
| Traffic Classes | | | | | | | | | | | |
| Signaling Set Up | | | | | | | | | | | |
| GMPLS | Originated | | 1 | 3 | 3.00 | 500 | | | 40 | 12.96 | 4.32 |
| | Terminated | | 1 | 3 | 3.00 | 500 | | | 40 | 12.96 | 4.32 |
| | Transit | | 0.2 | 6 | 1.20 | 500 | | | 40 | 5.18 | 1.73 |
| | | Sum = | 2.2 | | | | | | | | |
| Management | | | | | | | | | | | |
| SNMP | Connection | Originated | 1 | 1 | 1.00 | 100 | | | 28 | 1.02 | 0.34 |
| | | Terminated | 1 | 1 | 1.00 | 100 | | | 28 | 1.02 | 0.34 |
| | | All Others | 0.2 | 1 | 0.20 | 100 | | | 28 | 0.20 | 0.07 |
| | Configuration | TBD | | | | | | | | | |
| | Fault | TBD | | | | | | | | | |
| OPM | Local Performance Tx | | 0.200 | 1 | 0.200 | 80000 | 512 | 31.3 | 40 | 138.000 | 17.250 |
| | Local Performance Rx | | 0.200 | 1 | 0.200 | 20 | | 31.3 | 40 | 15.000 | 1.875 |
| | Transit Performance Tx | | 0.200 | 0 | 0.00 | 80000 | 512 | 0.0 | 40 | 0.00 | 0.00 |
| | Transit Performance Rx | | 0.200 | 0 | 0.00 | 20 | | 0.0 | 40 | 0.00 | 0.00 |
| SDS <-> SDS Backup | | | | | | | | | | | |
| Carrier - Not Curently Required | | | | | | | | | | | |
| | Transmitted | TBD | | | | | | | | | |
| | Received | TBD | | | | | | | | | |
| | Transit | TBD | | | | | | | | | |
| | | | | | | | | Totals = | | 186.36 | 30.24 |
| OSPF Advertisements | | | | | | | | | | | |
| | Transmitted | Link | 0.200 | 3 | 0.60 | 152 | | | 20 | 0.83 | 0.28 |
| | Received | Link | 0.200 | 0.60 | 0.12 | 152 | | | 20 | 0.17 | 0.06 |
| LMP Heartbeat | | | | | | | | | | | |
| | Transmitted | | 2 | 1 | 2.00 | 32 | | | 20 | 0.83 | 0.28 |
| | Received | | 2 | 1 | 2.00 | 32 | | | 20 | 0.83 | 0.28 |

### Circuit Routing Scenarios

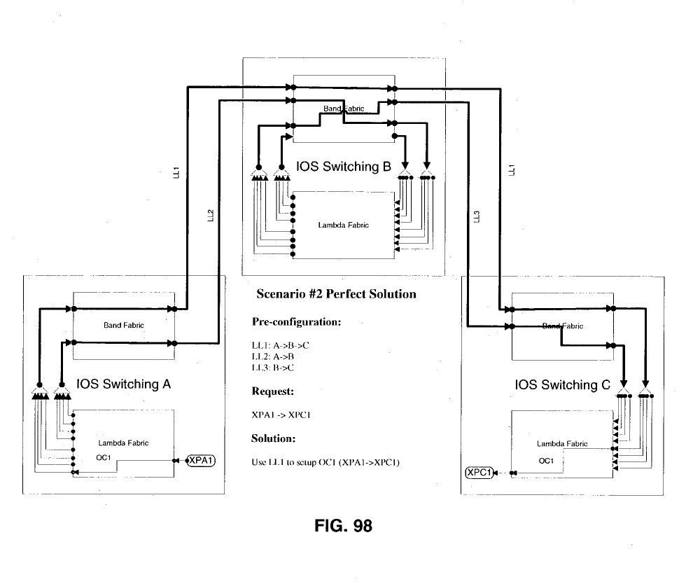

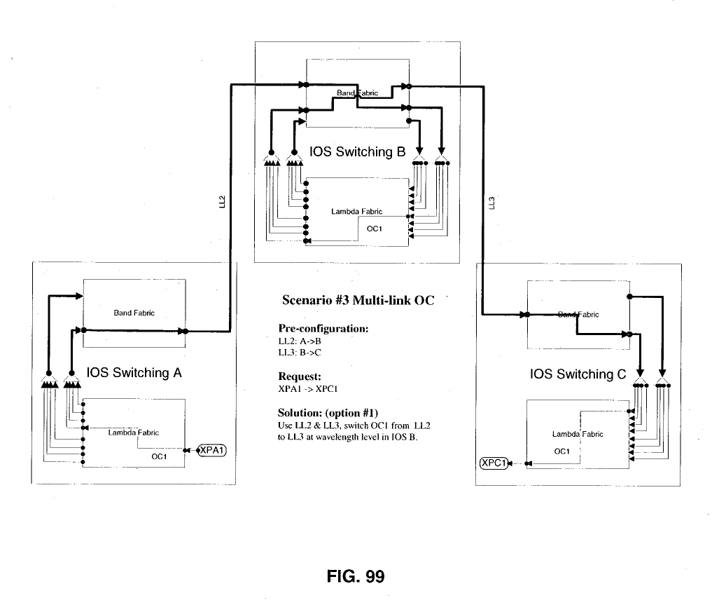

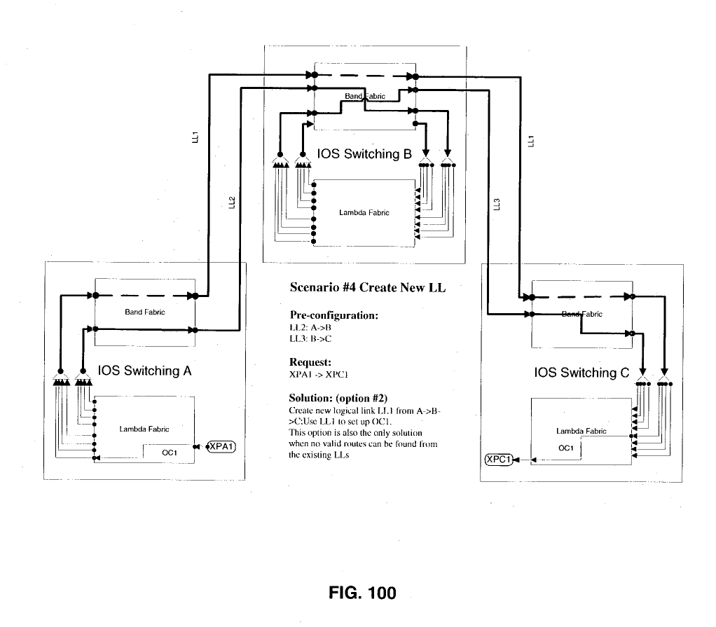

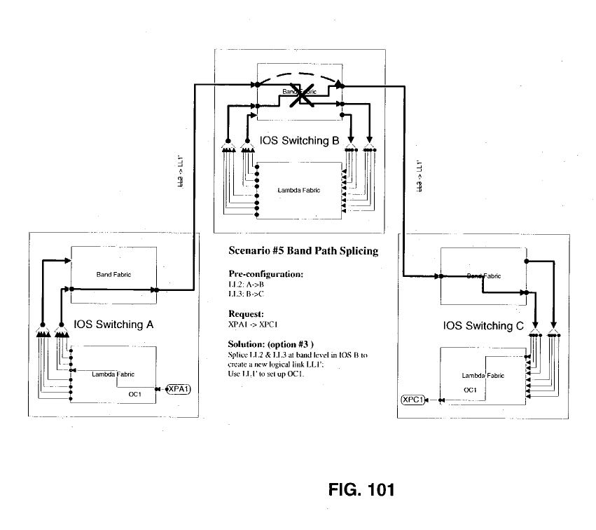

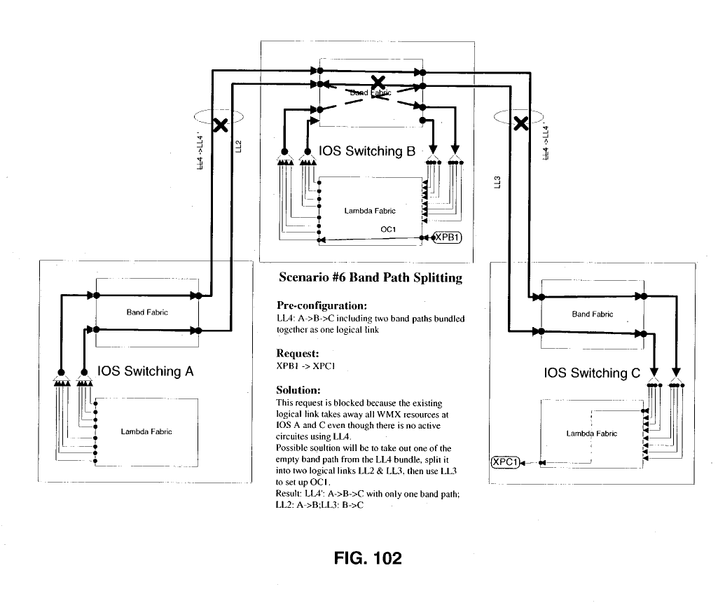

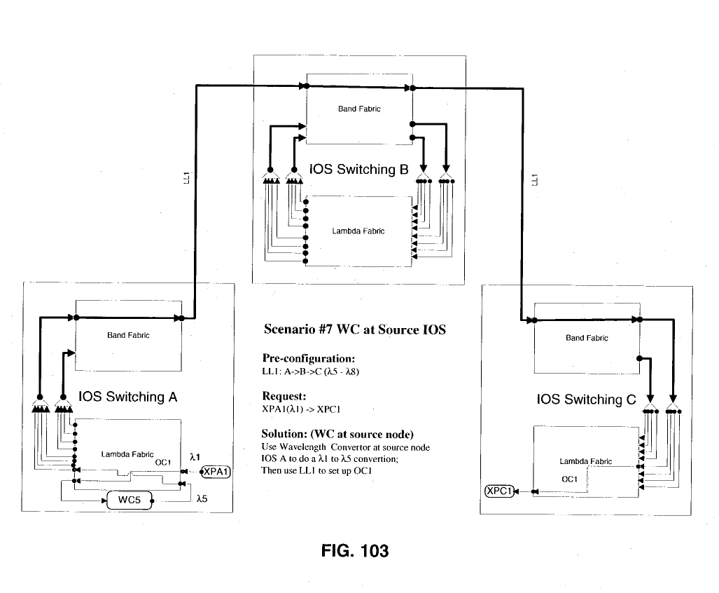

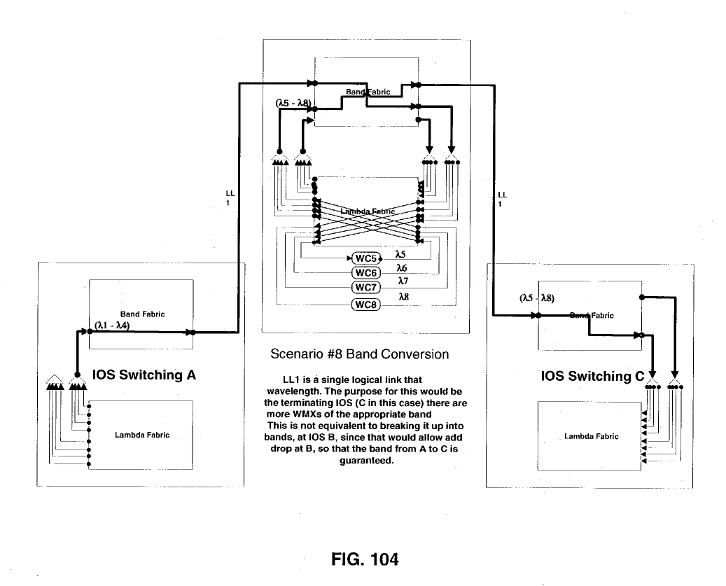

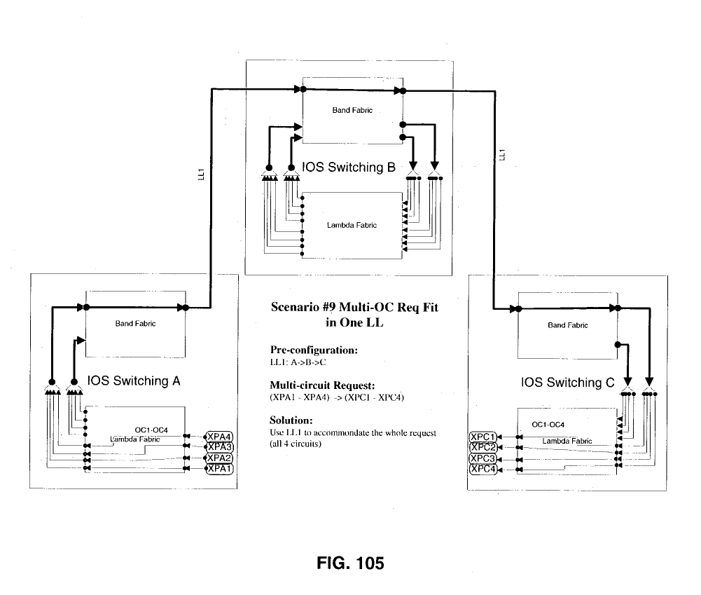

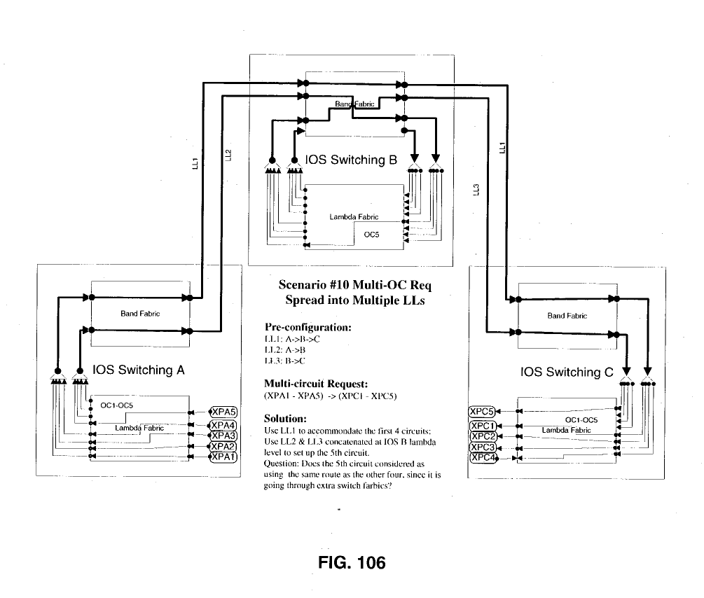

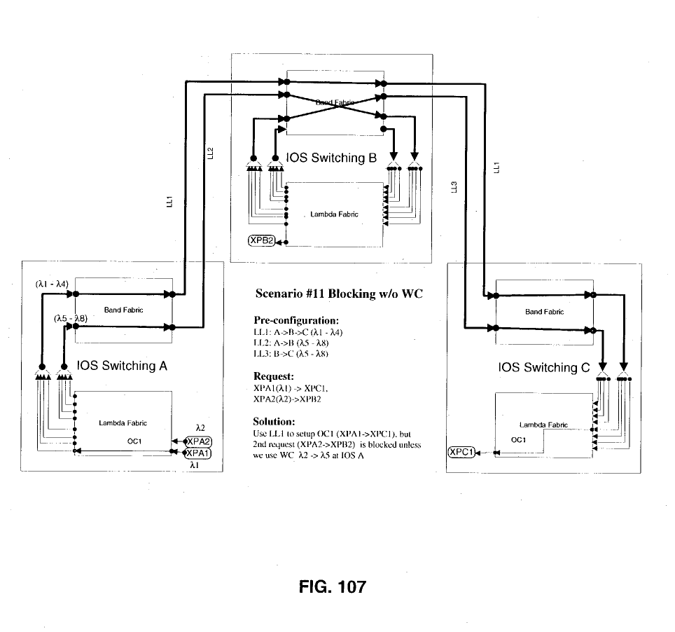

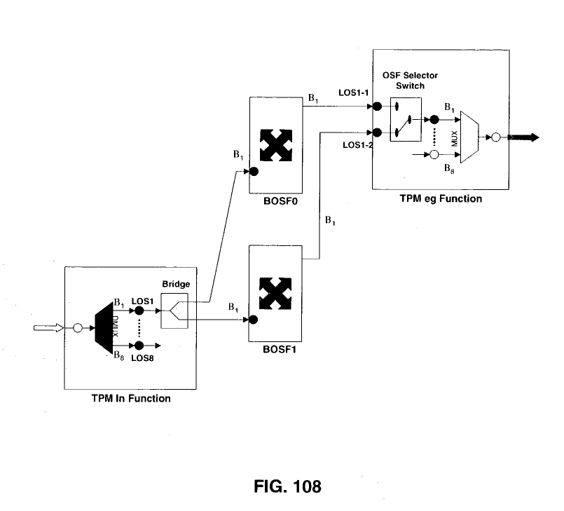

FIGS. 97-107 set forth a set of exemplary circuit routing scenarios (1-11 respectively). Each Figure indicates the scenario conditions and depicts the circuit routing under those conditions.

### Alarm Scenarios

Intra-Node Fault Isolation

FIGS. 108-111 capture exemplary scenarios of intra-node fault isolation. The diagrams show different failures that happen at the band path level as well as wavelength paths.

Fault at TPM Pack

FIG. 108 shows a band path switched between TPM modules 121. A failure within the TPM circuit pack 121 causes loss of signal. All the Tap points in the system, marked in red color, detect the LOS. The input TPM 121 correlates the alarms from the different tap points within the pack and report one alarm to the SNM 205, reporting the pack failure. The Egress TPM also detects the LOS, set the switch fabric selector to backup switch fabric and report the failure to the SNM 205. The SNM 205 correlates the different failures and report one alarm on the input TPM. SNM 205 also informs the output TPM 121 to set the set switch fabric selector to the previous state.

Band Optical Switch Fabric Failure

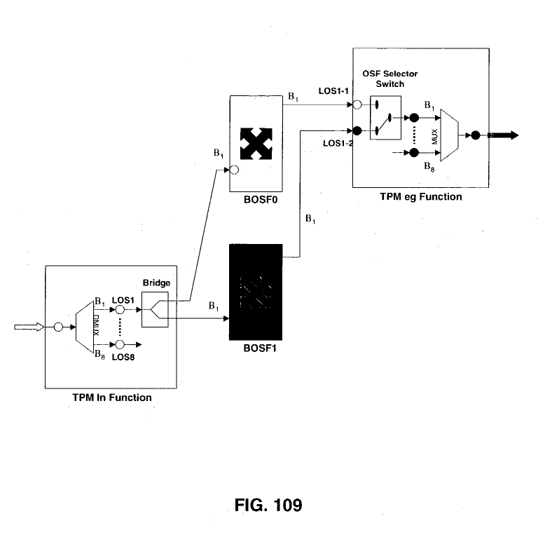

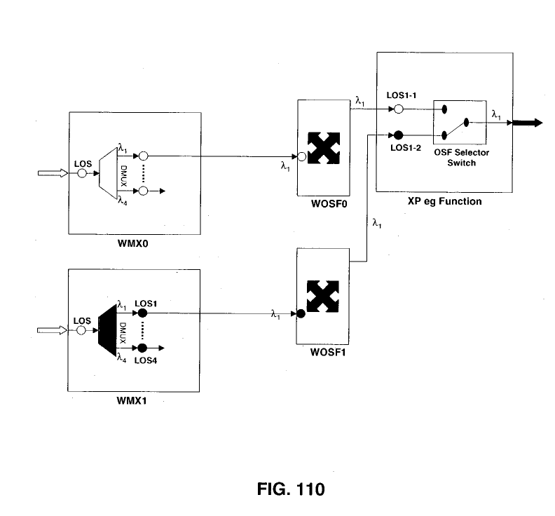

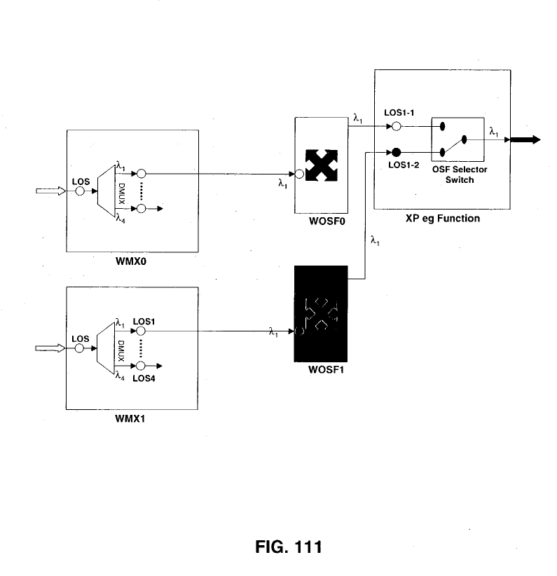

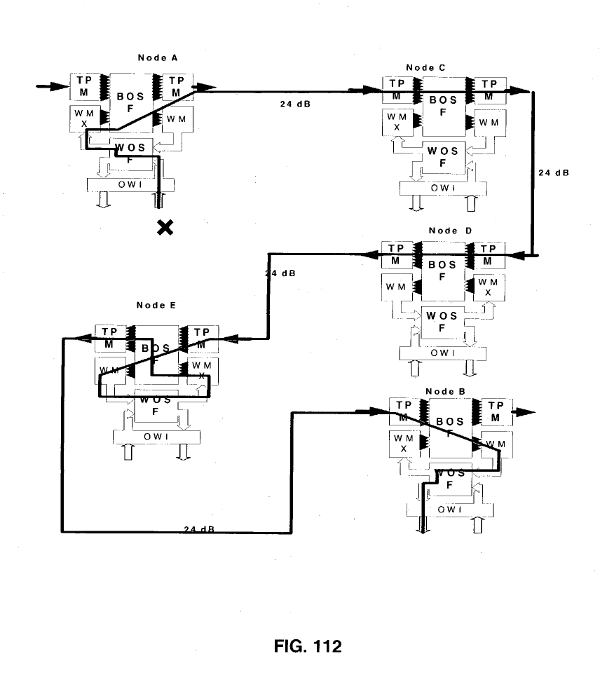

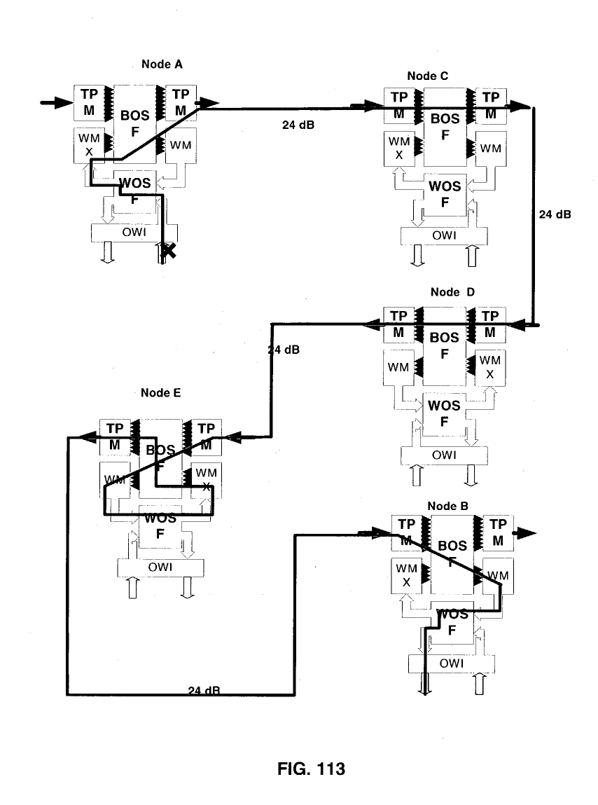

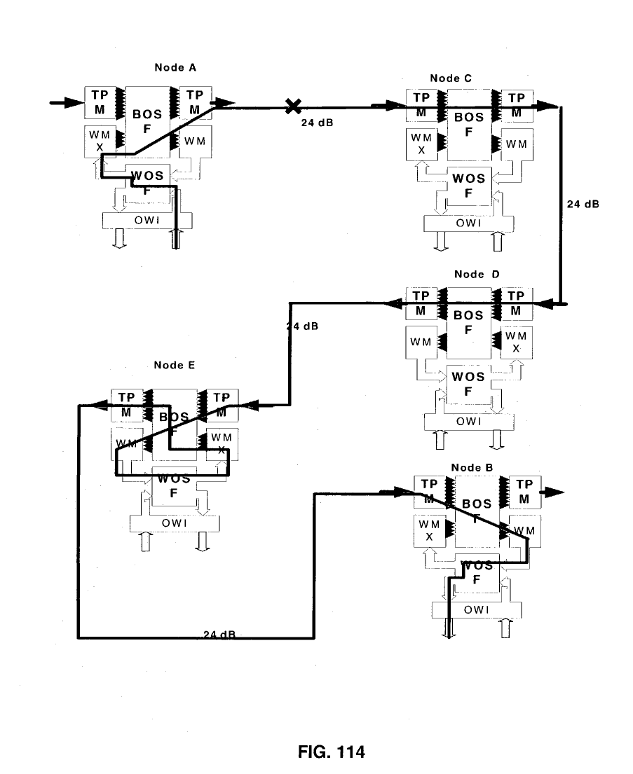

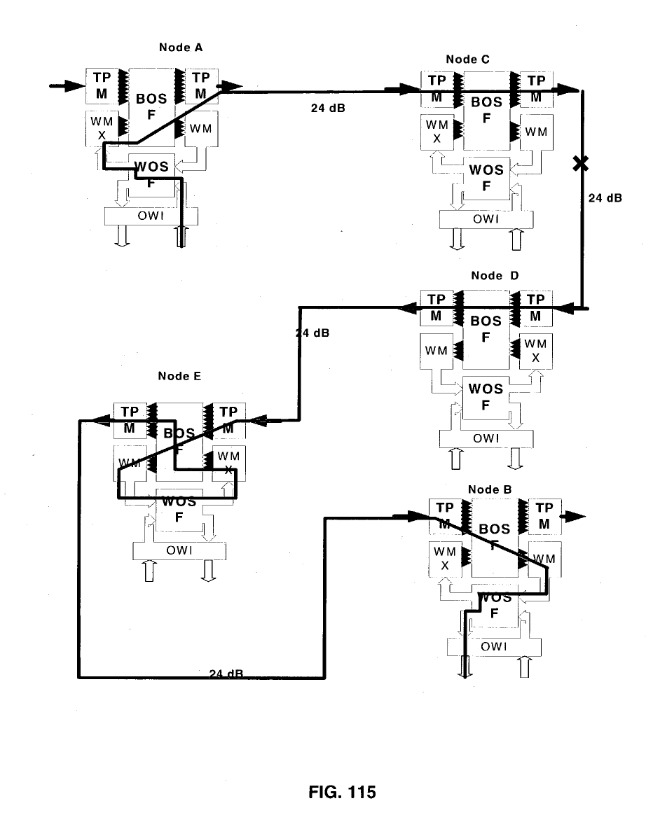

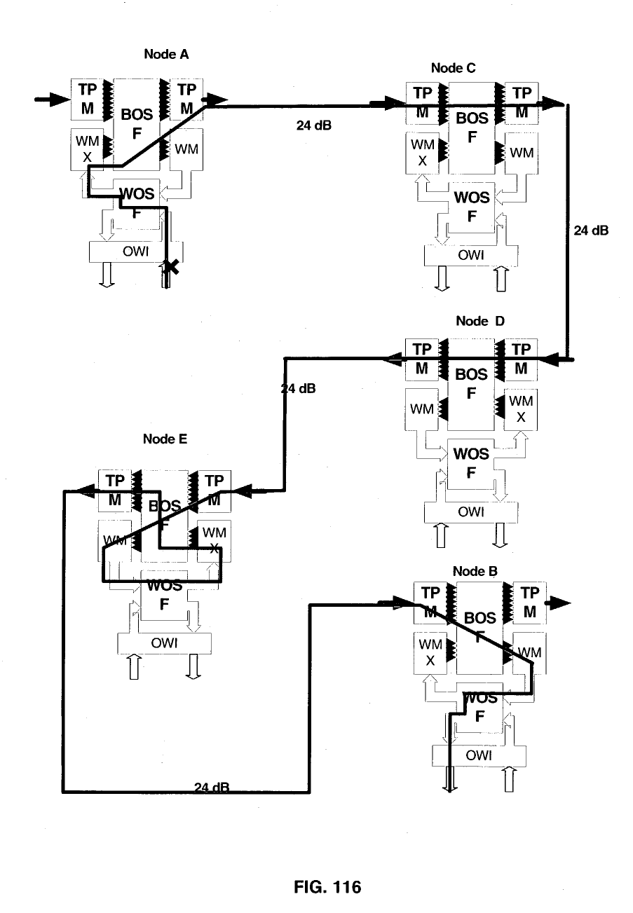

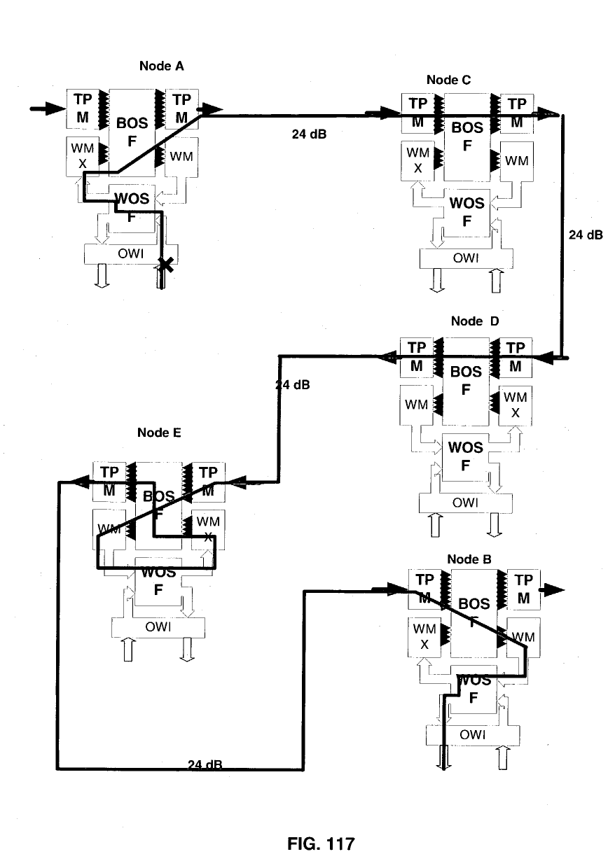

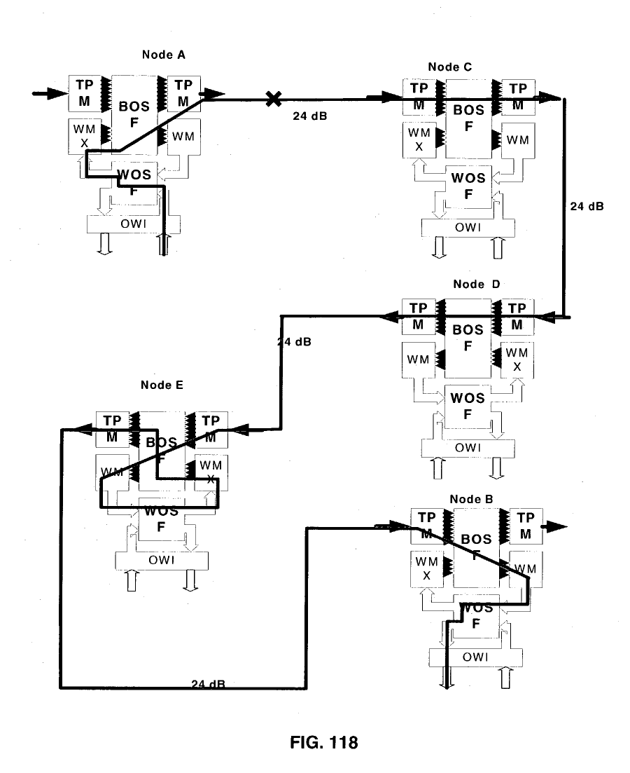

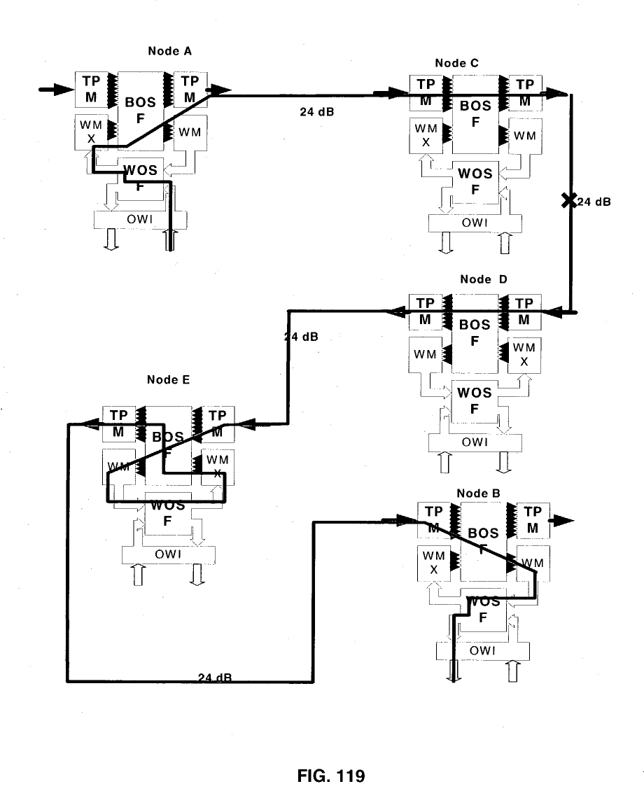

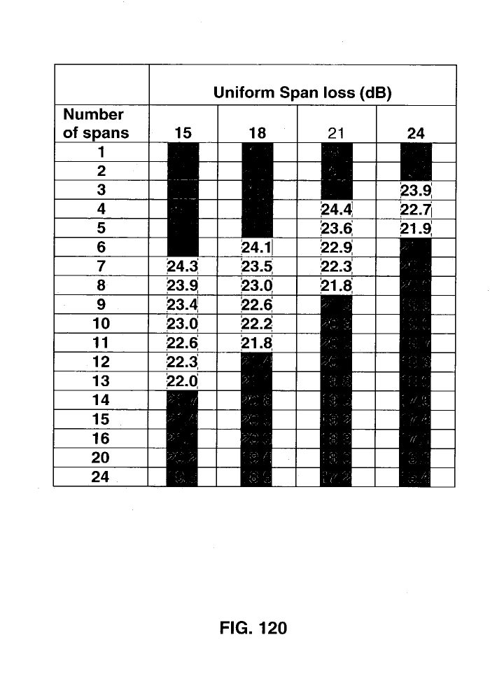

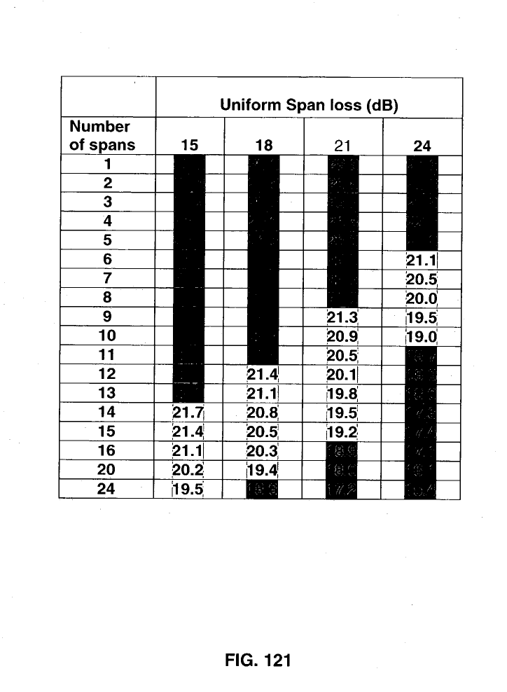

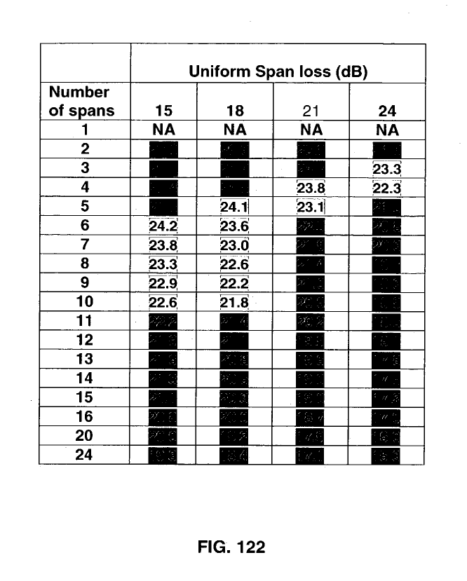

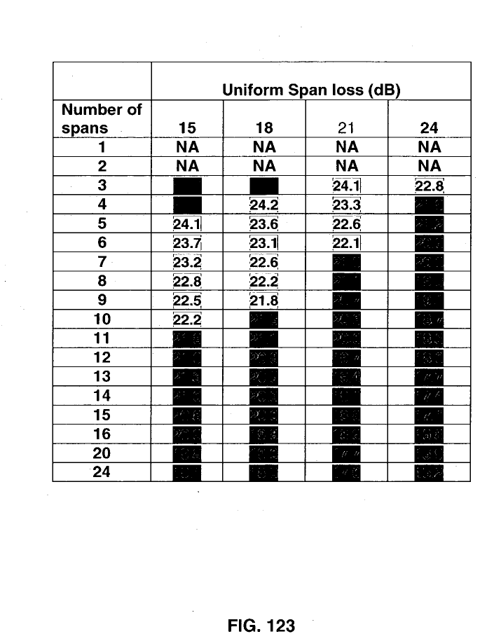

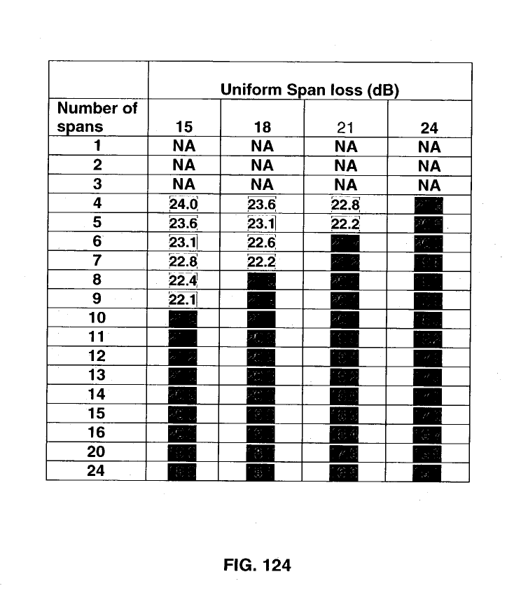

FIG. 109 shows a band path switched between TPM modules 121. A failure happened at the in-service switch fabric (BOSF1). If the whole switch fabric failed, all the TPM 121 detects a LOS at the input from the fabric and set the OSF selector to the redundant fabric. If only a few MEMS failed, the few affected TPMs 121 detect LOS and switch to the backup switch fabric.

FIG. 109 shows the case of the whole switch fabric failure. All the Tap points in the system, marked in red color, detect the LOS. The egress TPM correlates the alarms from the different tap points within the pack and set the switch fabric selector to the out-of-service switch fabric and report an alarm to the SNM 205. The SNM 205 correlates the different failures and report the failure of the switch fabric.

The default condition is for all circuit packs to switch to BOSF0. In case some circuit packs have no active circuits and have not switched over, the SNM 205 initiates their switch over to BOSF0.

Failure at the DMUX of a WMX Pack

FIG. 110 shows a single wavelength path across the wavelength switch fabric. A failure within the input of the WMX circuit pack 136 causes loss of signal. All the Tap points in the system, marked in red color, detect the LOS. The WOSF 137 IOC 210 correlates the alarms from the different tap points within the pack and reports one alarm to the SNM 205, reporting the WMX1 pack failure. The Shelf Controller IOC for the Transponder pack correlates the alarms from the different tap points within the pack and set the switch fabric selector to the out-of-service switch fabric and report an alarm to the SNM 205. The SNM 205 correlates the different failures and report one alarm on the input WMX 136.

In the default case, the SNM 205 also informs the Shelf Controller IOC to set all the Transponder switch fabric selectors to the current out-of-service switch fabric in case some packs have not performed the switchover.

Wavelength Optical Switch Fabric Failure

FIG. 111 shows a single wavelength path across the wavelength switch fabric. A failure happened at the in-service switch fabric (WOSF1). If the whole switch fabric failed, all the Transponders and WMXs 136 attached to the switch fabric detect a LOS at the input from the fabric and set the OSF selector to the redundant fabric. If only a few MEMS failed, the few affected Transponders/WMXs detect LOS and switch to the backup switch fabric.

FIG. 110 shows the case of the whole switch fabric failure. All of the tap points in the system, marked in red color, detect the LOS. The Shelf Controller IOC for the Transponder pack correlates the alarms from the different tap points within the pack and set the switch fabric selector to the out-of-service switch fabric and report an alarm to the SNM 205. The SNM 205 correlates the different failures and report the failure of the switch fabric.

In the default case, the SNM 205 also initiates switch over of all the circuits to the out-of-service fabric.

Inter-Node Fault Isolation

FIGS. 112-119 capture exemplary scenarios of inter-node fault isolation. In all of the cases there is an optical circuit setup from the Node A to B. The optical circuit is setup via a band path setup-traversing Node A to Node E and a band path setup traversing Node E to Node B.

Failure at Input Outside Node A

Referring to FIG. 112:
1. Circuits are setup and are carrying user traffic. Alarms are enabled on all the Nodes.
2. Node A isolates the failure and reports an alarm at the input.
3. Node A uses LMP ChannelStatus Message to deactivate the circuit at the downstream Nodes.
4. Nodes C & D detect loss of light if this was the only circuit in the band, else they won't notice any change.
5. Nodes E and B are able to detect loss of light at the individual circuit.
6. Nodes C, D, E, & B use LMP fault isolation, and conclude that they do not need to report any alarm.

Failure Inside of Node A

Referring to FIG. 113:
1. Circuits are setup and are carrying user traffic. Alarms are enabled on all the Nodes.
2. Node A isolates the failure and reports an alarm for the hardware failure.
3. Node A uses LMP ChannelStatus Message to deactivate the circuit at the downstream Nodes.
4. Nodes C & detect loss of light if this was the only circuit in the band, else they won't notice any change.
5. Nodes E and B are able to detect loss of light at the individual circuit.
6. Nodes C, D, E, & B use LMP fault isolation, and conclude that they do not need to report any alarm.

Fiber Cut Between Nodes A and C

Referring to FIG. 114:
1. Circuits are setup and are carrying user traffic. Alarms are enabled on all the Nodes.
2. Node A and C enters APSD and isolates the failure. Reports an alarm to the SDS.
3. Node C uses LMP ChannelStatus Message to deactivate the circuit at the downstream Nodes.
4. Node D detects loss of light at the Band Level.
5. Nodes E and B are able to detect loss of light at the individual circuit.
6. Nodes D, E, & B use LMP fault isolation, and conclude that they do not need to report any alarm.
7. Node A & E use LMP fault isolation on the logical link (setup on top of the band path) and declare the failure of the logical link.

Fiber Cut Between Nodes C and D

Referring to FIG. 115:
1. Circuits are setup and are carrying user traffic. Alarms are enabled on all the Nodes.
2. Node C and D enters APSD and isolates the failure. Reports an alarm to the SDS.
3. Node D uses LMP ChannelStatus Message to deactivate the circuit at the downstream Nodes.
4. Nodes E and B are able to detect loss of light at the individual circuit.
5. Nodes E, & B use LMP fault isolation, and conclude that they do not need to report any alarm.
6. Node A learns failure in band path via signaling.

Failure at Input Outside Node A—No User Traffic

Referring to FIG. 116:
1. Circuits arc setup.
2. Node A isolates the failure and reports an alarm at the input.
3. The circuit was never active at Nodes C, D, and E & B. So they don't report any alarm.

Failure Inside of Node A—No User Traffic

Referring to FIG. 117:
1. Circuits are setup.
2. Node A isolates the failure and reports an alarm for the hardware failure.
3. The circuit was never active at Nodes C, D, E & B. So they don't report any alarm.

Fiber Cut Between Node A and C—No User Traffic

Referring to FIG. 118:
1. Circuits are setup.
2. Node A and C enters APSD and isolates the failure. Reports an alarm to the SDS.
3. Node C uses LMP ChannelStatus Message to deactivate the active circuit at the downstream Nodes.
4. Node D detects loss of light at the Band Level.
5. Nodes E and B detect loss of light at the individual active circuit.
6. Nodes D, E, & B use LMP fault isolation, and concludes that it doesn't need to report any alarm.

Fiber Cut Between Node C and D—No User Traffic

Referring to FIG. 119:
1. Circuits are setup.
2. Node C and D enters APSD and isolates the failure. Reports an alarm to the SDS.
3. Node D uses LMP ChannelStatus Message to deactivate the circuit at the downstream Nodes.
4. Nodes E and B detect loss of light at the individual active circuit.
5. Nodes E, & B use LMP fault isolation, and conclude that there is no need to report any alarm.
6. Node A learns failure in band path via signaling.

### IOS Engineering Rules Details

Multiple factors influence the rules for engineering networks with IOS 60 nodes with bit rates up to 10 Gb/s. Among these factors are (1) the actual bit rates under the wavelengths, (2) the number of spans from wavelength insertion to drop, (3) the type of fiber and the transmission loss of each span, (4) the power per wavelength at the egress point of each node, (5) the degree of compensation for chromatic and polarization mode dispersion, (6) the rise and fall time characteristics of the insertion transmitter, (7) the sensitivity and regeneration performance of the drop receiver, (8) the difference between the hottest and coldest wavelengths on the optical line, (9) the target bit error rate, (10) the presence or absence of O-E-O functions (e.g. wavelength conversion) in the end-to-end circuit, (11) the signal coding characteristics (e.g. FEC, which flattens spectral densities and eliminates long strings of zeros), and (12) the insertion loss and gain characteristics and the noise factor at each of the circuit nodes.

In addition, networks normally contain special degradations for which the engineering rules must account in order to achieve the bit error rate specified. Among these special degradations are (1) legacy fiber with higher loss, (2) multiple splices of highly variable quality, (3) multiple connectors and patch panels of variable quality, (4) in-line amplifiers with variable insertion gain, and (5) multiple span-by-span fiber types (e.g. Standard Single Mode fiber of various types and characteristics concatenated with various types of non-dispersion-shifted fiber of various vintages and vendors. Dispersion Shifted fibers are not covered by the engineering rules.)

Networks normally require consultation for network layout for various reason, including (1) spans are never uniform, (2) there are always special degradations to account for in networks, (3) characterization of the fiber spans is often inaccurate, and (4) there are always combinations of a larger number of short spans and occasional long spans that fall outside the engineering rules.

In an embodiment of the present invention, implemented with an IOS 60, with up to 32 wavelengths, the engineering rules have the following general assumptions and characteristics:
1. The primary engineering rules are for optical lines that include at least one 10 Gb/s wavelength, since customers normally cannot say with certainty that they require no 10 Gb/s wavelengths over the provisioning lifetime of the optical line. No bit rates exceeding 10 Gb/s are covered by the engineering rules.
2. A secondary set of engineering rules is also available for optical lines that include a maximum bit rate of 2.5 Gb/s for all wavelengths provisioned over the lifetime of the optical line. Use of this secondary set of engineering rules is for special applications only, since no guaranteed BER performance can be made for a subsequent addition of a 10 Gb/s wavelength to the optical line that is engineered with the secondary rules.
3. The primary engineering rules assume the presence of a Dispersion Compensation Module (DCM) in the egress optical amplifier interstage at every node, with a DCM code appropriate for the compensation of next-span chromatic dispersion, including the specific fiber type, span length, and special degradations. The engineering rules assume that the DCM, while a compromise compensator, provides sufficient matched chromatic dispersion compensation that the resulting optical circuit is noise limited. If a DCM must be added or changed for any reason, a service interruption generally occurs for that optical line while the DCM is added or changed.
4. The IOS engineering rules are specified to guarantee a BER performance of 10¹² error/bit or better in the worst case. This is a no-quibble guarantee: there are no assumptions made about signal coding, and the guarantee holds with no FEC on the data signal; if one chooses to utilize FEC, the BER performance is better than the guaranteed 10 exp (−12) errors per bit.
5. The primary engineering rules assume the IOS OWI ITU-compliant XP transmitter and receiver. The transmitter is engineered to provide excellent rise and fall times and characteristics and a certain optical signal level on the optical line. The receiver is engineered to provide excellent signal regeneration characteristics at the worst-case low received power levels and with 10⁻¹² errors per bit guaranteed with the specific OSNR levels that the engineering rules specify. The characteristics of these transmitters and receivers are specified in the engineering rules documentation, including specifications on bit rate, minimum and maximum power levels, and wavelength purity, and the engineering rules guarantee 10⁻¹² errors per bit only for transmitters and receivers that meet those specifications. In particular, transmitters and receivers that utilize the transparent (TRP and TRG) access to the network are not certified to meet a specific error performance within the engineering rules.
6. The MP 30 and OCP 20 maintains an OSNR characterization table of the receive signals at all IOS DWDM node receive points in the network.
7. The MP 30 and OCP 20 utilize the OSNR characterization table to guarantee that the new wavelength provisioning meets the 10⁻¹² errors/bit IOS BER guarantee for each provisioned circuit.
8. The OCP 20 establishes the set point for each TPM 121 by broadcasting to them the number of wavelengths that physically reside in each of the DWDM bands. Since end customer light may or may not be present on the fiber at the completion of the provisioning operation, the OCP 20 exits the provisioning sequence with all TPM 121 IOCs 210 on the circuit knowing how many wavelengths in each band are lit. Fast power detection at the WMXs 136 at each endpoint result in OCP 20 broadcast messages that change the TPM 121 equalization trigger points for all nodes in the circuit when a wavelength appears or drops out. In so doing, the TPM 121 set points are optimized for the engineering rules and reduce the dynamic range of the equalization to provide the best error performance on a long-term average.
9. For IOS, wavelength conversion is an O-E-O function, which ends one optical circuit and starts another one. The IOS engineering rules do not take advantage of this new optical partition due to the downstream possibility of and affordable all-optical wavelength conversion function that would coexist with O-E-O wavelength conversion.
10. The engineering rules do not hold for inclusion of other equipment in the optical lines or any mid-span meet with other DWDM equipment. The rules hold only for IOS DWDM equipment with optimized wavelength and band power level equalization, hot/cold wavelength power levels, absolute power levels, and dynamic set point adjustment.

IOS Uniform Span Engineering Rules

While uniform spans do not occur in nature, they are nonetheless useful for characterizing the performance of a DWDM system. FIG. 120 provides the OSNR for various numbers of uniform spans and span losses, assuming no λ switching at intermediate nodes (i.e. perfect band operation between the endpoints with no wavelength conversion, wavelength reorganization among bands, or additional add/drop at the intermediate nodes). The maximum range of each span and therefore of this table is 24 dB per span, reflecting the power levels at the egress points of each IOS node and the XP receiver sensitivity at each drop node OWI. The IOS XP receiver provides 10⁻¹² errors per bit with the worst-case received power level at 22 dB OSNR. However, it is prudent to add about 3 dB margin to the required OSNR to account for various tolerances and effects of variation with uncontrolled parameters (such as temperature), so the green region of the table is the one specified by the IOS primary engineering rules for uniform spans. For example, the primary engineering rules specify one span of up to 24 dB, three spans of Lip to 21 dB each, five spans of up to 18 dB each, and six spans of up to 15 dB each. For SSM fiber, such as SMF-28, with nominal 0.27 dB/kin and no special degradations, the span lengths corresponding to 15, 18, 21, and 24 dB are 56 km, 67 km, 78 km, and 89 km, respectively. However, non-uniform spans and special degradations are the rule and not the exception, and therefore the actual supplied or measured OSNR table value should guide the provisioning choices. The value of an OSNR measurement that supplies the actual OSNR value at the receiver is clearly a differentiator for IOS.

As a comparison, FIG. 121 depicts the secondary engineering rules regions using the 2.5 Gb/s XP receiver that provides 10 exp (−12) errors per bit with the worst-case received power level at an OSNR of 19 dB. However, it is prudent to add about 3 dB margin to the required OSNR to account for various tolerances and effects of variation with uncontrolled parameters (such as temperature), so the green region of the table is the one specified by the secondary IOS engineering rules for uniform spans.

Accordingly, the secondary engineering rules provide a larger number of spans for a given per span loss, but at the expense of 2.5 Gb/s wavelengths only.

FIGS. 122-124 provide the effects of λ switching at one through three intermediate nodes (i.e. wavelength conversion, wavelength reorganization among bands, or additional add/drop at the intermediate nodes). It is clear from these tables in comparison with FIG. 121 that a possibly useful range exists for one or two nodes of intermediate α switching, but λ switching reduces the OSNR at the receivers sufficiently to have a significant impact on the primary engineering rules for networks of IOS. Accordingly, such λ switching at intermediate nodes should be the provisioning of last resort, avoided whenever an unfilled band exists between destinations or whenever a new band could be created between those destinations. For three intermediate nodes with λ switching, there is no solution for 15 dB or greater that achieves 15 dB OSNR, and the system is not useful at the ranges most customers require.

Non-Uniform Span Engineering Rules

Engineering rules for non-uniform spans rely on the OSNR characterization table for the receive DWDM signals at the nodes in the optical circuit. For many Metro and Regional networks, the span lengths are very diverse, but the mean span length is less than 10 km (2.7 dB of fiber loss at 0.27 dB per km). Of course, the spans have special degradations to consider, including connectors, splices, in-line amplifiers, non-uniform and legacy fiber.

Therefore, the only effective way to determine whether a provisioned route has adequate QoS for 10 exp (−12) errors per bit its to have a characterization of OSNR.

For those cases of low loss spans, many nodes and spans are possible, still adhering to the primary (or secondary) IOS engineering rules. The determining factor for adequate QoS is the OSNR characterization table.

Long Span Engineering Rules

For power reasons, the maximum IOS span length is fixed at 24 dB.

1. (canceled)

2. A process for multi-wavelength band switching comprising:
banding a plurality of wavelengths into a band based on a common destination associated with the wavelengths;
multiplexing the band into a first optical composite signal;
receiving the first optical composite signal at a first optical switch;
demultiplexing the band from the first optical composite signal;
maintaining the band as an optical signal through only a band switch;
multiplexing the band from the band switch into a second optical composite signal; and
transmitting the second composite signal to a second optical switch enroute to the common destination of the plurality of wavelengths.

3. The process of claim 2 wherein the first and second composite signals are dense wave division multiplexing signals.

4. The process of claim 3 wherein the first optical switch includes a wavelength switch and further comprising:
demultiplexing one more other bands requiring individual wavelength operations from the first optical composite signal;
routing the one or more other bands following band demultiplexing from the band switch to a wavelength demultiplexer;
demultiplexing a plurality wavelengths from the one or more other bands to the wavelength switch; and
delivering at least one wavelength of the plurality wavelengths from the one or more other bands from the wavelength switch for conversion to a client optical signal.

5. An optical switch comprising at least one auxiliary wavelength switch module for receiving individual wavelengths of a band, wherein the wavelength switch module switches the individual wavelengths of the band for individual routing.

6. The optical switch of claim 5 further comprising a bay housing the at least one auxiliary wavelength switch at a node on a shelf.

7. The optical switch of claim 6 wherein the bay includes expandable shelves for accepting an increasing number of auxiliary wavelength switches according to traffic characteristics of the node.

8. The optical switch of claim 7 wherein the optical composite signals are dense wave division multiplexing signals.

9. The optical switch of claim 8 wherein at least one of the individual wavelengths of the band is routable for termination at the node.

10. The optical switch of claim 9 wherein the band includes wavelengths grouped by a common destination.

11. The optical switch of claim 8 wherein at least one of the individual wavelengths of the band is routable for reorganization into another band.

12. The optical switch of claim 11 wherein the band includes wavelengths grouped by a common destination.

13. The optical switch of claim 8 wherein at least one of the individual wavelengths of the band is routable for wavelength conversion.

14. The optical switch of claim 13 wherein the band includes wavelengths grouped by a common destination.

15. The optical switch of claim 8 wherein the band includes wavelengths grouped by a common destination.

16. The optical switch of claim 5 wherein the band includes wavelengths grouped by a common destination.

17. The optical switch of claim 6 wherein the band includes wavelengths grouped by a common destination.

18. The optical switch of claim 7 wherein the band includes wavelengths grouped by a common destination.

19. The optical switch of claim 6 further comprising one or more circuit packs co-housed in the bay, wherein the add/drop circuit packs are interchangeable and removable.

20. The optical switch of claim 19 wherein the one or more circuit packs are selected from the group consisting of a transponder circuit pack, active transparent circuit pack, passive transparent circuit pack, and a wavelength converter circuit pack.

21. An optical switch node comprising:
one or more bay shelves at a switching facility;
at least one optical band switch housed in the one or more bay shelves for switching band wavelengths;
at least one wavelength switch housed in the one or more bay shelves and connected to the at least one optical band switch for switching wavelengths; and
at least one circuit pack housed in the one or more bay shelves and connected to the at least one wavelength switch for providing add/drop and wavelength conversion of wavelengths switched from the at least one wavelength switch.

22. The optical switch node of claim 21 wherein the at least one circuit pack is selected from the group consisting of a transponder circuit pack, active transparent circuit pack, passive transparent circuit pack, and a wavelength converter circuit pack.

23. The optical switch node of claim 21 further comprising a controller for banding wavelengths into bands based on the destination of the wavelengths.

24. The optical switch node of claim 23 wherein the controller bands co-destinational wavelengths into a common band.

25. The optical switch node of claim 21 further comprising a plurality of auxiliary wavelength switches co-housed in the one or more bay shelves.

26. The optical switch node of claim 24 wherein the band switch is configured to optically-only pass-through a common band that includes co-destinational wavelengths.

27. The optical switch node of claim 25 wherein the controller bands co-destinational wavelengths into a common band.

28. The optical switch node of claim 27 wherein the band switch is configured to optically-only pass-through a common band that includes co-destinational wavelengths.

29. The optical switch node of claim 21 further comprising a plurality of connections to a plurality of optical switch nodes, wherein each of at least two of the plurality of optical switch nodes includes:
one or more bay shelves at a switching facility;
at least one optical band switch housed in the one or more bay shelves for switching bands of wavelengths;
at least one wavelength switch housed in the one or more bay shelves and connected to the at least one optical band switch for switching wavelengths; and
at least one circuit pack housed in the one or more bay shelves and connected to the at least one wavelength switch for providing add/drop and wavelength conversion of wavelengths switched from the at least one wavelength switch.

30. The optical switch node of claim 29 wherein the connections are a mesh network.
